(19) United States
(12) Patent Application Publication
(10) Pub. No.: US 2015/0205218 A1
(43) Pub. Date: Jul. 23, 2015

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Haruyuki Tsuji, Yokohama-shi (JP); Atsushi Fujii, Yokohama-shi (JP); Kazuhisa Shida, Kawasaki-shi (JP); Nobuhiro Nakamura, Numazu-shi (JP); Hideaki Matsuoka, Mishima-shi (JP); Hiroyuki Tomono, Numazu-shi (JP)

(21) Appl. No.: 14/418,868

(22) PCT Filed: Aug. 29, 2013
(86) PCT No.: PCT/JP2013/073860

§ 371 Date: Jan. 30, 2015

(30) Foreign Application Priority Data
Aug. 30, 2012 (JP) 2012-189532
Apr. 3, 2013 (JP) 2013-077617
Aug. 28, 2013 (JP) 2013-177141

(51) Int. Cl. G03G 15/00

(52) U.S. Cl. CPC G03G 5/087

(57) ABSTRACT

Provided are an electrophotographic photosensitive member in which a residual potential hardly increases at the time of image formation, a pattern memory hardly occurs, and the crack of a conductive layer hardly occurs, and a process cartridge and an electrophotographic apparatus each including the electrophotographic photosensitive member. To this end, the conductive layer of the electrophotographic photosensitive member contains a titanium oxide particle coated with tin oxide doped with phosphorus, a tin oxide particle doped with phosphorus, and a binding material, and when a total volume of the conductive layer is represented by V_{T}, a total volume of the titanium oxide particle coated with tin oxide doped with phosphorus in the conductive layer is represented by V_{1P}, and a total volume of the tin oxide particle doped with phosphorus in the conductive layer is represented by V_{2P}, the V_{T}, the V_{1P}, and the V_{2P} satisfy the following expressions: 2≦{(V_{2P}/V_{T})/(V_{1P}/V_{T})}×100≦25 and 15≦{(V_{1P}/V_{T})+(V_{2P}/V_{T})}×100≦45.

### TECHNICAL FIELD

The present invention relates to an electrophotographic photosensitive member, and a process cartridge and an electrophotographic apparatus each including the electrophotographic photosensitive member.

### BACKGROUND ART

An electrophotographic photosensitive member using an organic photo-conductive material (organic electrophotographic photosensitive member) has been intensively studied and developed in recent years.

The electrophotographic photosensitive member basically includes a support and a photosensitive layer formed on the support. In actuality, however, various layers are provided in many cases between the support and the photosensitive layer for the purposes of, for example, covering defects in the surface of the support, protecting the photosensitive layer from electrical destruction, enhancing chargeability, and improving charge injection blocking property from the support to the photosensitive layer.

Of the layers to be provided between the support and the photosensitive layer, a layer containing metal oxide particles is known as a layer to be provided for the purpose of covering defects in the surface of the support. The layer containing metal oxide particles generally has high electro-conductivity (for example, an initial volume resistivity of 1.0×10⁸ to 2.0×10¹³ Ω·cm) as compared to that of a layer not containing metal oxide particles, and even when the thickness of the layer is increased, a residual potential at the time of forming an image is difficult to increase. Therefore, the layer containing metal oxide particles covers defects in the surface of the support easily. When such layer having high electro-conductivity (hereinafter referred to as “conductive layer”) is provided between the support and the photosensitive layer to cover defects in the surface of the support, an allowable range of defects in the surface of the support is enlarged. As a result, an allowable range of the support to be used is enlarged. Thus, an advantage of enhancing productivity of an electrophotographic photosensitive member is provided.

Patent Literature 1 discloses a technology involving using, in a conductive layer between a support and a photosensitive layer, a titanium oxide particle coated with tin oxide doped with phosphorus or tungsten. In addition, Patent Literature 2 discloses a technology involving using, in a conductive layer between a support and a photosensitive layer, a titanium oxide particle coated with tin oxide doped with phosphorus, tungsten, or fluorine.

In addition, Patent Literature 3 discloses a technology involving incorporating, into the undercoat layer of an electrophotographic photosensitive member obtained by sequentially laminating the undercoat layer, an intermediate layer, and a photosensitive layer on a conductive support, two kinds of metal oxide particles having different average particle diameters. In addition, Patent Literature 4 discloses the following technology. Two or more kinds of electro-conductive particles having different primary particle diameters are incorporated into the intermediate layer of an electrophotographic photosensitive member obtained by laminating the intermediate layer and a photosensitive layer on a conductive support in the stated order, a ratio “A:B” between the average particle diameters of primary particles A having the largest average particle diameter of the electro-conductive particles and primary particles B having the smallest average particle diameter thereof is set to 12:1 to 30:1, and the average particle diameter of the primary particles B is set to 0.05 μm or less. In addition, Patent Literature 4 discloses a technology involving using a tin oxide particle doped with tantalum in the intermediate layer of the electrophotographic photosensitive member.

In addition, Patent Literatures 5 and 6 each describe a technology involving using a tin oxide particle doped with niobium in a conductive layer or an intermediate layer between a support and a photosensitive layer.

### CITATION LIST

### Patent Literature

### PTL 1: Japanese Patent Application Laid-Open No. 2012-18371

### PTL 2: Japanese Patent Application Laid-Open No. 2012-18370

### PTL 3: Japanese Patent Application Laid-Open No. 2007-187771

### PTL 4: Japanese Patent Application Laid-Open No. 2004-151349

PTL 5: Japanese Patent Application Laid-Open No. H01-248158
PTL 6: Japanese Patent Application Laid-Open No. H01-150150

### SUMMARY OF INVENTION

### Technical Problem

In recent years, the following opportunity has been increasing: a large amount of images identical to each other are output from one and the same electrophotographic photosensitive member in a short time period.

In such case, the direction of movement of a recording medium (such as a transfer material (e.g., paper) or an intermediate transfer member) in an electrophotographic photosensitive member and a vertical direction (longitudinal direction when the electrophotographic photosensitive member is cylindrical) do not deviate from each other. Accordingly, for example, when a solid black image or a half-tone image is output after a large amount of images each including vertical lines 306 (lines parallel to the direction of movement of the recording medium) like an image 301 of FIG. 4 have been continuously output, a product called a pattern memory occurs in a portion where a vertical line has been formed. More specifically, in essence, the solid black image is output like an image 302 of FIG. 4 and the half-tone image is output like an image 303 of FIG. 4. However, when the solid black image is output after a large amount of images each including the vertical lines 306 like the image 301 of FIG. 4 have been continuously output, the output image may be an image 304 with vertical lines 307 resulting from the repetition hysteresis of the vertical lines 306 of the image 301 of FIG. 4. In the case of the half-tone image as well, as in the case of the solid black image, the output image may be an image 305 with vertical lines 308 resulting from the repetition hysteresis of the vertical lines 306 of the image 301 of FIG. 4. An image portion where the repetition hysteresis has appeared like those vertical lines 307 and 308 is called a pattern memory.

In particular, the following opportunity has been recently increasing as compared with olden times in association with the lengthening of the lifetime of an electrophotographic photosensitive member: a large amount of images identical to each other are output from one and the same electrophotographic photosensitive member in a short time period. Accordingly, even in a conventional electrophotographic photosensitive member that has heretofore been able to be sufficiently used, the case where the pattern memory occurs when a large amount of images identical to each other are output in a short time period has started to become apparent. In this respect, each of the electrophotographic photosensitive members including conventional conductive layers disclosed in Patent Literatures 1 to 6 has sometimes involved the emergence of the case where the pattern memory occurs.

On the other hand, in the case of a conductive layer containing a binding material and metal oxide particles, a crack is liable to occur in the conductive layer even when the volume resistivity of the conductive layer is reduced merely by increasing the content of the metal oxide particles in the conductive layer in order that an increase in residual potential at the time of image formation may be suppressed. Accordingly, the following necessity arises: while the occurrence of the crack of the conductive layer is suppressed, the occurrence of a pattern memory is suppressed and the increase of the residual potential is suppressed.

In view of the foregoing, the present invention is directed to providing an electrophotographic photosensitive member in which a residual potential hardly increases at the time of image formation, a pattern memory hardly occurs, and the crack of a conductive layer hardly occurs, and a process cartridge and an electrophotographic apparatus each including the electrophotographic photosensitive member.

### Solution to Problem

According to one aspect of the present invention, there is provided an electrophotographic photosensitive member, including: a support; a conductive layer formed on the support; and a photosensitive layer formed on the conductive layer, in which: the conductive layer contains a titanium oxide particle coated with tin oxide doped with phosphorus, a tin oxide particle doped with phosphorus, and a binding material; and when a total volume of the conductive layer is represented by V_{T}, a total volume of the titanium oxide particle coated with tin oxide doped with phosphorus in the conductive layer is represented by V_{1P}, and a total volume of the tin oxide particle doped with phosphorus in the conductive layer is represented by V_{2P}, the V_{T}, the V_{1P}, and the V_{2P} satisfy the following expressions (1) and (2).

2≦{(V_{2P}/V_{T})/(V_{1P}/V_{T})}×100≦25 (1)

15≦{(V_{1P}/V_{T})+(V_{2P}/V_{T})}×100≦45 (2)

According to another aspect of the present invention, there is provided an electrophotographic photosensitive member, including: a support; a conductive layer formed on the support; and a photosensitive layer formed on the conductive layer, in which: the conductive layer contains a titanium oxide particle coated with tin oxide doped with tungsten, a tin oxide particle doped with tungsten, and a binding material; and when a total volume of the conductive layer is represented by V_{T}, a total volume of the titanium oxide particle coated with tin oxide doped with tungsten in the conductive layer is represented by V_{1W}, and a total volume of the tin oxide particle doped with tungsten in the conductive layer is represented by V_{2W}, the V_{T}, the V_{1W}, and the V_{2W} satisfy the following expressions (6) and (7).

2≦{(V_{2W}/V_{T})/(V_{1W}/V_{T})}×100×25 (6)

15×{(V_{1W}/V_{T})+(V_{2W}/V_{T})}×100≦45 (7)

According to still another aspect of the present invention, there is provided an electrophotographic photosensitive member, including: a support; a conductive layer formed on the support; and a photosensitive layer formed on the conductive layer, in which: the conductive layer contains a titanium oxide particle coated with tin oxide doped with fluorine, a tin oxide particle doped with fluorine, and a binding material; and when a total volume of the conductive layer is represented by V_{T}, a total volume of the titanium oxide particle coated with tin oxide doped with fluorine in the conductive layer is represented by V_{1F}, and a total volume of the tin oxide particle doped with fluorine in the conductive layer is represented by V_{2F}, the V_{T}, the V_{1F}, and the V_{2F} satisfy the following expressions (11) and (12).

2≦{(V_{2F}/V_{T})/(V_{1F}/V_{T})}×100×25 (11)

15≦{(V_{1F}/V_{T})+(V_{2F}/V_{T})}×100≦45 (12)

According to still another aspect of the present invention, there is provided an electrophotographic photosensitive member, including: a support; a conductive layer formed on the support; and a photosensitive layer formed on the conductive layer, in which: the conductive layer contains a titanium oxide particle coated with tin oxide doped with niobium, a tin oxide particle doped with niobium, and a binding material; and when a total volume of the conductive layer is represented by V_{T}, a total volume of the titanium oxide particle coated with tin oxide doped with niobium in the conductive layer is represented by V_{1Nb}, and a total volume of the tin oxide particle doped with niobium in the conductive layer is represented by V_{2Nb}, the V_{T}, the V_{1Nb}, and the V_{2Nb} satisfy the following expressions (16) and (17).

2≦{(V_{2Nb}/V_{T})/V_{1Nb}/V_{T})}×100≦25 (16)

15≦{(V_{1Nb}/V_{T})+(V_{2Nb}/V_{T})}×100≦45 (17)

According to still another aspect of the present invention, there is provided an electrophotographic photosensitive member, including: a support; a conductive layer formed on the support; and a photosensitive layer formed on the conductive layer, in which: the conductive layer contains a titanium oxide particle coated with tin oxide doped with tantalum, a tin oxide particle doped with tantalum, and a binding material; and when a total volume of the conductive layer is represented by V_{T}, a total volume of the titanium oxide particle coated with tin oxide doped with tantalum in the conductive layer is represented by V_{1Ta}, and a total volume of the tin oxide particle doped with tantalum in the conductive layer is represented by V_{2Ta}, the V_{T}, the V_{1Ta}, and the V_{2Ta} satisfy the following expressions (21) and (22).

2≦{(V_{2Ta}/V_{T})/(V_{1Ta}/V_{T})}×100≦25 (21)

15≦{(V_{1Ta}/V_{T})+(V_{2Ta}/V_{T})}×100≦45 (22)

According to still another aspect of the present invention, there is provided a process cartridge detachably mountable to a main body of an electrophotographic apparatus, in which the process cartridge integrally supports: the above-described electrophotographic photosensitive member; and at least one device selected from the group consisting of a charging device, a developing device, a transferring device, and a cleaning device.

According to still another aspect of the present invention, there is provided an electrophotographic apparatus, including: the above-described electrophotographic photosensitive member; a charging device; an exposing device; a developing device; and a transferring device.

### Advantageous Effects of Invention

According to the present invention, there is provided the electrophotographic photosensitive member in which a residual potential hardly increases at the time of image formation, a pattern memory hardly occurs, and the crack of a conductive layer hardly occurs, and the process cartridge and the electrophotographic apparatus each including the electrophotographic photosensitive member.

Further features of the present invention will become apparent from the following description of exemplary embodiments with reference to the attached drawings.

### BRIEF DESCRIPTION OF DRAWINGS

FIG. 1 is a view illustrating an example of the schematic construction of an electrophotographic apparatus including a process cartridge having an electrophotographic photosensitive member of the present invention.

FIG. 2 is a view (top view) for illustrating a method of measuring the volume resistivity of a conductive layer.

FIG. 3 is a view (cross-sectional view) for illustrating the method of measuring the volume resistivity of a conductive layer.

FIG. 4 is a view (image example) for illustrating a pattern memory.

FIG. 5 is a view illustrating a one-dot keima pattern image.

### DESCRIPTION OF EMBODIMENTS

An electrophotographic photosensitive member of the present invention is an electrophotographic photosensitive member including a support, a conductive layer formed on the support, and a photosensitive layer formed on the conductive layer.

The photosensitive layer may be a single-layer type photosensitive layer obtained by incorporating a charge-generating substance and a charge-transporting substance into a single layer, or may be a laminated type photosensitive layer obtained by laminating a charge-generating layer containing a charge-generating substance and a charge-transporting layer containing a charge-transporting substance. In addition, an undercoat layer may be provided between the conductive layer and photosensitive layer to be formed on the support as required.

A support having electro-conductivity (conductive support) is preferred as the support, and for example, a metal support formed of a metal such as aluminum, an aluminum alloy, or stainless steel can be used. When aluminum or an aluminum alloy is used, an aluminum tube produced by a production method including an extrusion process and a drawing process, or an aluminum tube produced by a production method including an extrusion process and an ironing process can be used. Such aluminum tube provides good dimensional accuracy and good surface smoothness without the cutting of its surface, and is advantageous in terms of cost. However, burr-like protruding defects are liable to occur on the uncut surface of the aluminum tube. Accordingly, it is particularly effective to provide the conductive layer.

In the electrophotographic photosensitive member of the present invention, any one of the following combinations of metal oxide particles as well as a binding material is used in the conductive layer to be formed on the support:

(p) a titanium oxide particle coated with tin oxide doped with phosphorus and a tin oxide particle doped with phosphorus;
(w) a titanium oxide particle coated with tin oxide doped with tungsten and a tin oxide particle doped with tungsten;
(f) a titanium oxide particle coated with tin oxide doped with fluorine and a tin oxide particle doped with fluorine;
(nb) a titanium oxide particle coated with tin oxide doped with niobium and a tin oxide particle doped with niobium; and
(ta) a titanium oxide particle coated with tin oxide doped with tantalum and a tin oxide particle doped with tantalum.

One of the features lies in that in each of the combinations (p), (w), (f), (nb), and (ta) of metal oxide particles, phosphorus (P), tungsten (W), fluorine (F), niobium (Nb), or tantalum (Ta) is common to the element with which tin oxide is doped. It should be noted that the titanium oxide particles are particles of titanium oxide (TiO₂) and the tin oxide particles are particles of tin oxide (SnO₂).

Hereinafter, the titanium oxide particle coated with tin oxide doped with phosphorus is also represented as “P-doped tin oxide-coated titanium oxide particles” and the tin oxide particle doped with phosphorus is also represented as “P-doped tin oxide particles.” In addition, the titanium oxide particle coated with tin oxide doped with tungsten is also represented as “W-doped tin oxide-coated titanium oxide particles” and the tin oxide particle doped with tungsten is also represented as “W-doped tin oxide particles.” In addition, the titanium oxide particle coated with tin oxide doped with fluorine is also represented as “F-doped tin oxide-coated titanium oxide particles” and the tin oxide particle doped with fluorine is also represented as “F-doped tin oxide particles.” In addition, the titanium oxide particle coated with tin oxide doped with niobium is also represented as “Nb-doped tin oxide-coated titanium oxide particles” and the tin oxide particle doped with niobium is also represented as “Nb-doped tin oxide particles.” In addition, the titanium oxide particle coated with tin oxide doped with tantalum is also represented as “Ta-doped tin oxide-coated titanium oxide particles” and the tin oxide particle doped with tantalum is also represented as “Ta-doped tin oxide particles.”

Further, in the electrophotographic photosensitive member of the present invention, in the case where the combination of metal oxide particles to be incorporated into the conductive layer is the combination (p), when the total volume of the conductive layer is represented by V_{T}, the volume of the P-doped tin oxide-coated titanium oxide particles in the conductive layer is represented by V_{1P}, and the volume of the P-doped tin oxide particles in the conductive layer is represented by V_{2P}, V_{T}, V_{1P}, and V_{2P} satisfy the following expressions (1) and (2).

2≦{(V_{2P}/V_{T})/(V_{1P}/V_{T})}×100≦25 (1)

15×{(V_{1P}/V_{T})+(V_{2P}/V_{T})}×100≦45 (2)

Further, in the case where the combination of metal oxide particles to be incorporated into the conductive layer is the combination (w), when the total volume of the conductive layer is represented by V_{T}, the volume of the W-doped tin oxide-coated titanium oxide particles in the conductive layer is represented by V_{1W}, and the volume of the W-doped tin oxide particles in the conductive layer is represented by V_{2W}, V_{T}, V_{1W}, and V_{2W} satisfy the following expressions (6) and (7).

2×{(V_{2W}/V_{T})/(V_{1W}/V_{T})}×100≦25 (6)

15≦{(V_{1W}/V_{T})+(V_{2W}/V_{T})}×100≦45 (7)

Further, in the case where the combination of metal oxide particles to be incorporated into the conductive layer is the combination (f), when the total volume of the conductive layer is represented by V_{T}, the volume of the F-doped tin oxide-coated titanium oxide particles in the conductive layer is represented by V_{1F}, and the volume of the F-doped tin oxide particles in the conductive layer is represented by V_{2F}, V_{T}, V_{1F}, and V_{2F} satisfy the following expressions (11) and (12).

2≦{(V_{2F}/V_{T})/(V_{1F}/V_{T})}×100≦25 (11)

15≦{(V_{1F}/V_{T})+(V_{2F}/V_{T})}×100≦45 (12)

Further, in the case where the combination of metal oxide particles to be incorporated into the conductive layer is the combination (nb), when the total volume of the conductive layer is represented by V_{T}, the volume of the Nb-doped tin oxide-coated titanium oxide particles in the conductive layer is represented by V_{1Nb}, and the volume of the Nb-doped tin oxide particles in the conductive layer is represented by V_{2Nb}, V_{T}, V_{1Nb}, and V_{2Nb} satisfy the following expressions (16) and (17).

2≦{(V_{2Nb}/V_{T})/(V_{1Nb}/V_{T})}×100≦25 (16)

15≦{(V_{1Nb}/V_{T})+(V_{2Nb}/V_{T})}×100≦45 (17)

Further, in the case where the combination of metal oxide particles to be incorporated into the conductive layer is the combination (ta), when the total volume of the conductive layer is represented by V_{T}, the volume of the Ta-doped tin oxide-coated titanium oxide particles in the conductive layer is represented by V_{1Ta}, and the volume of the Ta-doped tin oxide particles in the conductive layer is represented by V_{2Ta}, V_{T}, V_{1Ta}, and V_{2Ta} satisfy the following expressions (21) and (22).

2≦{(V_{2Ta}/V_{T})/(V_{1Ta}/V_{T})}×100×25 (21)

15≦{(V_{1Ta}/V_{T})+(V_{2Ta}/V_{T})}×100≦45 (22)

Hereinafter, V_{1P}, V_{1W}, V_{1F}, V_{1Nb}, and V_{1Ta} are also collectively represented as “V₁,” and V_{2P}, V_{2W}, V_{2F}, V_{2Nb}, and V_{2Ta} are also collectively represented as “V₂.” In addition, the P-doped tin oxide-coated titanium oxide particles, the W-doped tin oxide-coated titanium oxide particles, the F-doped tin oxide-coated titanium oxide particles, the Nb-doped tin oxide-coated titanium oxide particles, and the Ta-doped tin oxide-coated titanium oxide particles are also collectively represented as “a first metal oxide particle,” and the P-doped tin oxide particles, the W-doped tin oxide particles, the F-doped tin oxide particles, the Nb-doped tin oxide particles, and the Ta-doped tin oxide particles are also collectively represented as “a second metal oxide particle.”

The inventors of the present invention have made extensive studies to suppress the occurrence of a pattern memory. As a result, the inventors have found that the pattern memory is suppressed by the formation of a good electro-conductive path over a wide range in the conductive layer, in other words, uniform movement of charge in the conductive layer. This is probably because local retention or storage of the charge in the conductive layer hardly occurs. However, the retention or storage of the charge may not largely correlate with the volume resistivity or electric resistance of the conductive layer because the retention or storage is a local phenomenon. The formation of a good electro-conductive path in the conductive layer for suppressing the pattern memory requires the formation of an electro-conductive path that passes both the first metal oxide particle and the second metal oxide particle. To this end, the following necessity may arise for suppressing the occurrence of the pattern memory: instead of the formation of the conductive layer containing only the first metal oxide particle or the conductive layer containing only the second metal oxide particle, the first metal oxide particle and the second metal oxide particle are caused to exist in the conductive layer at a certain ratio, and then an electro-conductive path that passes both the first metal oxide particle and the second metal oxide particle is formed. That is, it may be necessary to satisfy the expression (1), (6), (11), (16), or (21). When the value for {(V₂/V_{T})/(V₁/V_{T})}×100 is less than 2, the ratio of the amount of the second metal oxide particle to the amount of the first metal oxide particle becomes insufficient. Accordingly, it is assumed that the situation becomes close to that in the case of the conductive layer containing only the first metal oxide particle and hence an electro-conductive path good for suppressing the occurrence of the pattern memory cannot be formed. On the other hand, when the value for {(V₂/V_{T})/(V₁/V_{T})}×100 is more than 25, the ratio of the amount of the second metal oxide particle to the amount of the first metal oxide particle becomes excessive. Accordingly, it is assumed that the situation becomes close to that in the case of the conductive layer containing only the second metal oxide particle and hence an electro-conductive path good for suppressing the occurrence of the pattern memory cannot be formed. When the following expression (3), (8), (13), (18), or (23) is satisfied, a suppressing effect on the occurrence of the pattern memory becomes additionally significant because the ratio between the first metal oxide particle and the second metal oxide particle becomes the ratio at which an electro-conductive path additionally good for suppressing the occurrence of the pattern memory can be formed.

5≦{(V_{2P}/V_{T})/(V_{1P}/V_{T})}×100≦20 (3)

5≦{(V_{2W}/V_{T})/(V_{1W}/V_{T})}×100≦20 (8)

5≦{(V_{2F}/V_{T})/(V_{1F}/V_{T})}×100≦20 (13)

5≦{(V_{2Nb}/V_{T})/(V_{1Nb}/V_{T})}×100≦20 (18)

5≦{(V_{2Ta}/V_{T})/(V_{1Ta}/V_{T})}×100≦20 (23)

In addition, the formation of the electro-conductive path that passes the first metal oxide particle and the second metal oxide particle in the conductive layer may require that the sum of the contents of the first metal oxide particle and a second metal oxide particle in the conductive layer fall within a certain range. That is, it may be necessary to satisfy the expression (2), (7), (12), (17), or (22). When the value for {(V₁+V₂)/V_{T}}×100 is less than 15, the retention or storage of the charge in the conductive layer is liable to occur and hence an increase in residual potential is liable to be large in the case of repeated use of the electrophotographic photosensitive member. The value for {(V₁+V₂)/V_{T}}×100 is more preferably 20 or more. On the other hand, when the value for {(V₁+V₂)/V_{T}}×100 is more than 45, the amount of the binding material becomes relatively small and hence a crack is liable to occur in the conductive layer. The value for {(V₁+V₂)/V_{T}}×100 is more preferably 40 or less. That is, the following expression (4), (9), (14), (19), or (24) is more preferably satisfied.

20≦{(V_{1P}/V_{T})+(V_{2P}/V_{T})}×100≦40 (4)

20≦{(V_{1W}/V_{T})+(V_{2W}/V_{T})}×100≦40 (9)

20≦{(V_{1F}/V_{T})+(V_{2F}/V_{T})}×100≦40 (14)

20≦{(V_{1Nb}/V_{T})+(V_{2Nb}/V_{T})}×100≦40 (19)

20≦{(V_{1Ta}/V_{T})+(V_{2Ta}/V_{T})}×100≦40 (24)

As described above, it is necessary to satisfy the expressions (1) and (2) simultaneously, to satisfy the expressions (6) and (7) simultaneously, to satisfy the expressions (11) and (12) simultaneously, to satisfy the expressions (16) and (17) simultaneously, or to satisfy the expressions (21) and (22) simultaneously for obtaining an electrophotographic photosensitive member in which a residual potential hardly increases at the time of image formation, a pattern memory hardly occurs, and the crack of a conductive layer hardly occurs.

With regard to the present invention, in the case where the combination of the metal oxide particles to be incorporated into the conductive layer is, for example, a combination of a titanium oxide particle coated with tin oxide doped with antimony and a tin oxide particle doped with antimony, or a combination of titanium oxide particles coated with oxygen-deficient tin oxide and oxygen-deficient tin oxide particles, the suppressing effect on the occurrence of the pattern memory deteriorates as compared with that in the case where the combination of the metal oxide particles to be incorporated into the conductive layer is the combination (p), (w), (f), (nb), or (ta).

In addition, even when a species (dopant) to be doped into tin oxide is phosphorus, tungsten, fluorine, niobium, or tantalum, in the case where a species to be doped into tin oxide of the first metal oxide particle and a species to be doped into tin oxide of the second metal oxide particle differ from each other such as the case where the combination of the metal oxide particles to be incorporated into the conductive layer is a combination of a titanium oxide particle coated with tin oxide doped with phosphorus and a tin oxide particle doped with tungsten, the suppressing effect on the occurrence of the pattern memory similarly deteriorates as compared with that in the case of the combination (p), (w), (f), (nb), or (ta) in which the species to be doped are identical to each other. This is probably because of the following reason: when the species to be doped into tin oxide of the first metal oxide particle and the species to be doped into tin oxide of the second metal oxide particle are identical to each other, the electrical properties, surface properties, and work functions of the first metal oxide particle and a second metal oxide particle become physical properties closest to each other in a comprehensive manner, and hence it becomes easy for the charge to move uniformly in the conductive layer.

In addition, in the case where the combination of the metal oxide particles to be incorporated into the conductive layer is the combination (p), when the abundance ratio of phosphorus to tin oxide in the P-doped tin oxide-coated titanium oxide particles is represented by R_{1P} [atom %] and the abundance ratio of phosphorus to tin oxide in the P-doped tin oxide particles is represented by R_{2P} [atom %], the following expression (5) is preferably satisfied.

0.9≦R_{2P}/R_{1P}≦1.1 (5)

In addition, in the case where the combination of the metal oxide particles to be incorporated into the conductive layer is the combination (w), when the abundance ratio of tungsten to tin oxide in the W-doped tin oxide-coated titanium oxide particles is represented by R_{1W} [atom %] and the abundance ratio of tungsten to tin oxide in the W-doped tin oxide particles is represented by R_{2W} [atom %], the following expression (10) is preferably satisfied.

0.9≦R_{2W}/R_{1W}≦1.1 (10)

In addition, in the case where the combination of the metal oxide particles to be incorporated into the conductive layer is the combination (f), when the abundance ratio of fluorine to tin oxide in the F-doped tin oxide-coated titanium oxide particles is represented by R_{1F} [atom %] and the abundance ratio of fluorine to tin oxide in the F-doped tin oxide particles is represented by R_{2F} [atom %], the following expression (15) is preferably satisfied.

0.9≦R_{2F}/R_{1F}≦1.1 (15)

In addition, in the case where the combination of the metal oxide particles to be incorporated into the conductive layer is the combination (nb), when the abundance ratio of niobium to tin oxide in the Nb-doped tin oxide-coated titanium oxide particles is represented by R_{1Nb} [atom %] and the abundance ratio of niobium to tin oxide in the Nb-doped tin oxide particles is represented by R_{2Nb} [atom %], the following expression (20) is preferably satisfied.

0.9≦R_{2Nb}/R_{1Nb}≦1.1 (20)

In addition, in the case where the combination of the metal oxide particles to be incorporated into the conductive layer is the combination (ta), when the abundance ratio of tantalum to tin oxide in the Ta-doped tin oxide-coated titanium oxide particles is represented by R_{1Ta} [atom %] and the abundance ratio of tantalum to tin oxide in the Ta-doped tin oxide particles is represented by R_{2Ta} [atom %], the following expression (25) is preferably satisfied.

0.9≦R_{2Ta}/R_{1Ta}≦1.1 (25)

Hereinafter, R_{1P}, R_{1W}, R_{1F}, R_{1Nb}, and R_{1Ta} are also collectively represented as “R₁,” and R_{2P}, R_{2W}, R_{2F}, R_{2Nb}, and R_{2Ta} are also collectively represented as “R₂.”

As represented by the expression (5), (10), (15), (20), or (25), the abundance ratios of phosphorus, tungsten, fluorine, niobium, or tantalum in tin oxide of the first metal oxide particle and tin oxide of the second metal oxide particle are preferably as close as possible to each other. In other words, the ratio R₂/R₁ is preferably as close as possible to 1.0, and specifically, the ratio is preferably 0.9 or more and 1.1 or less. When the ratio R₂/R₁ is 0.9 or more and 1.1 or less, an electro-conductive path additionally good for suppressing the occurrence of the pattern memory is formed and hence the suppressing effect on the occurrence of the pattern memory becomes additionally significant.

The measurement of R₁ and R₂ can be performed by STEM-EDX after taking out the conductive layer of the electrophotographic photosensitive member according to an FIB method. In addition, the measurement of V₁ and V₂ can be performed by the slice and view of an FIB-SEM after taking out the conductive layer of the electrophotographic photosensitive member according to the FIB method.

First, the measurement of R₁ and R₂ is described.

Sampling for the STEM-EDX analysis was performed as described below.

The sampling is performed with a supporting base made of copper (Cu) by an FIB-μ sampling method. An apparatus used by the inventors of the present invention is an FB-2000A μ-Sampling System (trade name) manufactured by Hitachi High-Technologies Corporation. The sampling was performed so that the horizontal and longitudinal sizes of a sample became such sizes that a measurement range could be secured, and the thickness of the sample became 150 nm.

The STEM-EDX analysis was performed as described below.

The inventors of the present invention have performed the analysis with a field emission electron microscope (HRTEM) (trade name: JEM2100F) manufactured by JEOL Ltd. and a JED-2300T (trade name) (having a resolution of 133 eV or less) (energy dispersive X-ray spectroscopy) manufactured by JEOL Ltd. as an EDX portion.

Analysis conditions were set as described below.
System: Analysis Station
Image acquisition: Digital Micrograph
Measurement conditions: Acceleration voltage: 200 kV, beam diameter (diameter): 1.0 nm, measurement time: 50 seconds (in point analysis) and 40 minutes (in area analysis)

The measurement range measured 3.6 μm long by 3.4 μm wide by 150 nm thick.

The abundance ratio of phosphorus to tin oxide in the P-doped tin oxide particles, the abundance ratio of phosphorus to tin oxide in the P-doped tin oxide-coated titanium oxide particles, the abundance ratio of tungsten to tin oxide in the W-doped tin oxide particles, the abundance ratio of tungsten to tin oxide in the W-doped tin oxide-coated titanium oxide particles, the abundance ratio of fluorine to tin oxide in the F-doped tin oxide particles, the abundance ratio of fluorine to tin oxide in the F-doped tin oxide-coated titanium oxide particles, the abundance ratio of niobium to tin oxide in the Nb-doped tin oxide particles, the abundance ratio of niobium to tin oxide in the Nb-doped tin oxide-coated titanium oxide particles, the abundance ratio of tantalum to tin oxide in the Ta-doped tin oxide particles, or the abundance ratio of tantalum to tin oxide in the Ta-doped tin oxide-coated titanium oxide particles can be determined from an atomic ratio because the identification of an element can be performed by the STEM-EDX.

The sampling was similarly performed ten times to provide ten samples, followed by the measurement. The average of a total of ten R₁'s and the average of a total of ten R₂'s were each defined as a value for R₁ or R₂ in the conductive layer of the electrophotographic photosensitive member as a measuring object.

Next, the measurement of the ratios (V₁/V_{T}) and (V₂/V_{T}) is described.

The volume of the P-doped tin oxide-coated titanium oxide particles and the volume of the P-doped tin oxide particles, and their ratios in the conductive layer can be determined by identifying tin oxide doped with phosphorus and titanium oxide based on their difference in contrast of the slice and view of the FIB-SEM. When the species to be doped into tin oxide is an element except phosphorus such as tungsten, fluorine, niobium, or tantalum, the volumes and the ratios in the conductive layer can be similarly determined.

Conditions for the slice and view in the present invention were set as described below.
Sampling for analysis: FIB method
Processing and observation apparatus: NVision 40 manufactured by SII-Zeiss
Slice interval: 10 nm
Observation conditions:
Acceleration voltage: 1.0 kV
Sample tilt: 54°
WD: 5 mm
Detector: BSE detector
Aperture: 60 μm, high current
ABC: ON
Image resolution: 1.25 nm/pixel

The analysis is performed in a region measuring 2 μm wide by 2 μm long, information on each cross-section is integrated, and the volumes V₁ and V₂ per space measuring 2 μm wide by 2 μm long by 2 μm thick (V_{T}=8 μm³) are determined. In addition, the measurement is performed under an environment having a temperature of 23° C. and a pressure of 1×10⁻⁴ Pa. It should be noted that a Strata 400S (sample tilt: 52°) manufactured by FEI Company can also be used as a processing and observation apparatus.

The sampling was similarly performed ten times to provide ten samples, followed by the measurement. A value obtained by dividing the average of a total of ten volumes V₁ per 8 μm³ by V_{T} (8 μm³) was defined as the ratio (V₁/V_{T}) in the conductive layer of the electrophotographic photosensitive member as a measuring object. In addition, a value obtained by dividing the average of a total of ten volumes V₂ per 8 μm³ by V_{T} (8 μm³) was defined as a value for the ratio (V₂/V_{T}) in the conductive layer of the electrophotographic photosensitive member as a measuring object.

It should be noted that the areas of identified tin oxide doped with phosphorus and titanium oxide were obtained from the information on each cross-section through image analysis. The image analysis was performed with the following image processing software.

Image processing software: Image-Pro Plus manufactured by Media Cybernetics

Of the metal oxide particles to be used in the present invention, the first metal oxide particle has a coating layer constituted of tin oxide doped with phosphorus, tungsten, fluorine, niobium, or tantalum, and a core particle constituted of titanium oxide. In addition, the first metal oxide particle is such a structure that the core particle is coated with the coating layer.

The ratio (coating ratio) of tin oxide (SnO₂) in the first metal oxide particle to be used in the present invention is preferably 10 to 60% by mass. A tin raw material needed for producing tin oxide (SnO₂) needs to be blended at the time of the production of the first metal oxide particle for controlling the coating ratio of tin oxide (SnO₂). For example, when tin chloride (SnCl₄) as a tin raw material is used, the blending needs to be performed in consideration of the amount of tin oxide (SnO₂) to be produced from tin chloride (SnCl₄). Although tin oxide (SnO₂) constituting the coating layer of each of the first metal oxide particle to be used in the present invention is doped with phosphorus (P), tungsten (W), fluorine (F), niobium (Nb), or tantalum (Ta), the coating ratio is a value calculated from the mass of tin oxide (SnO₂) with respect to the total mass of tin oxide (SnO₂) and titanium oxide (TiO₂) without any consideration of the mass of phosphorus (P), tungsten (W), fluorine (F), niobium (Nb), or tantalum (Ta) with which tin oxide (SnO₂) is doped.

In addition, it is preferred that tin oxide (SnO₂) in the first metal oxide particle or a second metal oxide particle be doped with phosphorus (P), tungsten (W), fluorine (F), niobium (Nb), or tantalum (Ta) in an amount (doping ratio) of 0.1 to 10 mass % with respect to tin oxide (SnO₂) (in terms of mass of the tin oxide containing no phosphorus (P), tungsten (W), fluorine (F), niobium (Nb), and tantalum (Ta)).

It should be noted that a method of producing the first metal oxide particle (P-doped tin oxide-coated titanium oxide particles, W-doped tin oxide-coated titanium oxide particles, F-doped tin oxide-coated titanium oxide particles, Nb-doped tin oxide-coated titanium oxide particles, or Ta-doped tin oxide-coated titanium oxide particles) is also disclosed in Japanese Patent Application Laid-Open No. H06-207118 and Japanese Patent Application Laid-Open No. 2004-349167.

In addition, a method of producing the second metal oxide particle (P-doped tin oxide particles, W-doped tin oxide particles, F-doped tin oxide particles, Nb-doped tin oxide particles, or Ta-doped tin oxide particles) is also disclosed in Japanese Patent No. 3365821, Japanese Patent Application Laid-Open No. H02-197014, Japanese Patent Application Laid-Open No. H09-278445, and Japanese Patent Application Laid-Open No. H10-53417.

A particulate shape, a spherical shape, a needle shape, a fibrous shape, a columnar shape, a rod shape, a spindle shape, a plate shape, and other analogous shapes can each be used as the shape of a titanium oxide (TiO₂) particle as the core particle in each of the first metal oxide particle to be used in the present invention. Of those, a spherical shape is preferred from such a viewpoint that an image defect such as a black spot hardly occurs.

In addition, any one of the crystal forms such as rutile, anatase, brookite, and amorphous forms can be used as the crystal form of the titanium oxide (TiO₂) particle as the core particle in each of the first metal oxide particle to be used in the present invention. In addition, any one of the production methods such as a sulfuric acid method and a hydrochloric acid method can be adopted as the production method.

In the present invention, a first reason why the first metal oxide particle having the core particles (titanium oxide (TiO₂) particles) are used is as described below. Tin oxide (SnO₂) constituting the coating layer of each of the first metal oxide particle has higher electro-conductivity than that of titanium oxide (TiO₂) constituting each core particle and charge received by the second metal oxide particle containing tin oxide (SnO₂) propagates mainly through the coating layer containing tin oxide (SnO₂) in each of the first metal oxide particle, i.e., the transfer of the charge between tin oxide (SnO₂) is mainly performed, and hence the transfer of the charge between the first metal oxide particle and the second metal oxide particle becomes smooth, and the charge uniformly moves in the conductive layer.

A second reason why the first metal oxide particle having the core particles (titanium oxide (TiO₂) particles) are used is that an improvement in dispersibility of the second metal oxide particle in a conductive-layer coating solution is achieved. When the second metal oxide particle is used without the use of the first metal oxide particle, the aggregation of the second metal oxide particle is liable to occur in the conductive-layer coating solution to enlarge their average particle diameter, and hence protrusive seeding defects occur in the surface of the conductive layer to be formed or the stability of the conductive-layer coating solution reduces in some cases. In addition, the suppressing effect on the pattern memory is not sufficiently obtained.

A third reason why the first metal oxide particle having the core particles (titanium oxide (TiO₂) particles) are used is that the titanium oxide (TiO₂) particles as the core particles of the first metal oxide particle each have low transparency as a particle and hence easily cover defects in the surface of the support. In contrast, for example, when barium sulfate particles are used as the core particles, the particles each have high transparency as a particle and hence a material for covering the defects in the surface of the support may be separately needed.

The particle diameter of each of the titanium oxide (TiO₂) particles as the core particles of the first metal oxide particle to be used in the present invention is preferably 0.05 μm or more and 0.40 μm or less from the viewpoint of adjusting the average particle diameter of the first metal oxide particle to a preferred range to be described later.

The powder resistivity of the first metal oxide particle to be used in the present invention is preferably 1.0×10¹ Ω·cm or more and 1.0×10⁶ Ω·cm or less, more preferably 1.0×10² Ω·cm or more and 1.0×10⁵ Ω·cm or less.

The powder resistivity of the second metal oxide particle to be used in the present invention is preferably 1.0×10⁰ Ω·cm or more and 1.0×10⁵ Ω·cm or less, more preferably 1.0×10¹ Ω·cm or more and 1.0×10⁴ Ω·cm or less.

The powder resistivity of the first metal oxide particle to be used in the present invention is preferably lower than the powder resistivity of the titanium oxide (TiO₂) particles as the core particles of the first metal oxide particle.

A method of measuring the powder resistivity of metal oxide particles such as the first metal oxide particle or a second metal oxide particle to be used in the present invention is as described below.

The powder resistivity of metal oxide particles such as the first metal oxide particle or a second metal oxide particle to be used in the present invention, or of the core particles of composite particles like the first metal oxide particle to be used in the present invention is measured under a normal-temperature and normal-humidity (23° C./50% RH) environment. In the present invention, a resistivity meter manufactured by Mitsubishi Chemical Corporation (trade name: Loresta GP (Hiresta UP when the powder resistivity exceeded 1.0×10⁷ Ω·cm)) was used as a measuring apparatus. The metal oxide particles as measuring objects are compressed into a pellet-shaped sample for measurement at a pressure of 500 kg/cm². A voltage of 100 V is applied. The core particles are subjected to the measurement before the formation of the coating layer.

The conductive layer can be formed by applying the conductive-layer coating solution containing a solvent, the binding material, and the first metal oxide particle and the second metal oxide particle onto the support, and drying and/or curing the resultant coating film.

The conductive-layer coating solution can be prepared by dispersing the first metal oxide particle and the second metal oxide particle together with the binding material into the solvent. As a dispersion method, there are given, for example, methods using a paint shaker, a sand mill, a ball mill, and a liquid collision type high-speed disperser.

Examples of the binding material to be used in the conductive layer include resins such as a phenol resin, polyurethane, polyamide, polyimide, polyamide-imide, polyvinyl acetal, an epoxy resin, an acrylic resin, a melamine resin, and polyester. The resins may be used alone or in combination of two or more kinds thereof. Further, of those resins, from the viewpoints of, for example, suppression of migration (dissolution) into another layer, adhesiveness with the support, dispersibility and dispersion stability of the particles of the present invention, and solvent resistance after layer formation, a curable resin is preferred, and a thermosetting resin is more preferred. Further, of the thermosetting resins, a thermosetting phenol resin and thermosetting polyurethane are preferred. In the case of using the curable resin as the binding material in the conductive layer, the binding material to be contained in the conductive-layer coating solution is a monomer and/or an oligomer of the curable resin.

Examples of the solvent to be used in the conductive-layer coating solution include alcohols such as methanol, ethanol, and isopropanol, ketones such as acetone, methyl ethyl ketone, and cyclohexanone, ethers such as tetrahydrofuran, dioxane, ethylene glycol monomethyl ether, and propylene glycol monomethyl ether, esters such as methyl acetate and ethyl acetate, and aromatic hydrocarbons such as toluene and xylene.

In addition, a surface roughness providing material for roughening the surface of the conductive layer may be incorporated into the conductive-layer coating solution in order to suppress the occurrence of interference fringes on an output image due to the interference of light reflected at the surface of the conductive layer. Resin particles having an average particle diameter of 1 μm or more and 5 μm or less are preferred as the surface roughness providing material. Examples of the resin particles include particles of curable resins such as a curable rubber, a polyurethane, an epoxy resin, an alkyd resin, a phenol resin, a polyester, a silicone resin, and an acryl-melamine resin. Of those, particles of a silicone resin that hardly aggregate are preferred. The density (0.5 to 2 g/cm³) of the resin particles is small as compared with the densities (4 to 8 g/cm³) of the first metal oxide particle and a second metal oxide particle to be used in the present invention, and hence the surface of the conductive layer can be efficiently roughened at the time of the formation of the conductive layer. In this regard, however, when the content of the surface roughness providing material in the conductive layer increases, the volume resistivity of the conductive layer tends to increase in some cases. Accordingly, the content of the surface roughness providing material in the conductive-layer coating solution is preferably 1 to 80% by mass with respect to the binding material in the conductive-layer coating solution for adjusting the volume resistivity of the conductive layer to 2.0×10¹³ Ω·cm or less. In the present invention, the densities [g/cm³] of the first metal oxide particle, the second metal oxide particle, the binding material (provided that when the binding material was liquid, a cured product thereof was subjected to the measurement), the silicone particles, and the like were determined with a dry auto-densimeter as described below. A helium gas purge was performed ten times as a pretreatment for particles as measuring objects at a temperature of 23° C. and a maximum pressure of 19.5 psig with a dry auto-densimeter manufactured by Shimadzu Corporation (trade name: Accupyc 1330) and a container having a capacity of 10 cm³. After that, a fluctuation in pressure in a sample chamber of 0.0050 psig/min was used as a pressure equilibrium judgment value as to whether a pressure in the container reached equilibrium. When the fluctuation was equal to or less than the value, the pressure was defined as being in an equilibrium state and then the measurement was initiated to measure any such density [g/cm³] automatically.

In addition, a leveling agent for improving the surface property of the conductive layer may be incorporated into the conductive-layer coating solution. In addition, pigment particles may be incorporated into the conductive-layer coating solution for additionally improving the coverage of the conductive layer.

In addition, the average particle diameter of the first metal oxide particle (P-doped tin oxide-coated titanium oxide particles, W-doped tin oxide-coated titanium oxide particles, F-doped tin oxide-coated titanium oxide particles, Nb-doped tin oxide-coated titanium oxide particles, or Ta-doped tin oxide-coated titanium oxide particles) in the conductive-layer coating solution is preferably 0.10 μm or more and 0.45 μm or less, more preferably 0.15 μm or more and 0.40 μm or less. When the average particle diameter is less than 0.10 μm, the reaggregation of the first metal oxide particle is liable to occur after the preparation of the conductive-layer coating solution and hence the stability of the conductive-layer coating solution may reduce. When the average particle diameter is more than 0.45 μm, the surface of the conductive layer roughens to promote the occurrence of local injection of charge into the photosensitive layer, and hence a black spot on the white background of an output image may become conspicuous.

In addition, the average particle diameter of the second metal oxide particle (P-doped tin oxide particles, W-doped tin oxide particles, F-doped tin oxide particles, Nb-doped tin oxide particles, or Ta-doped tin oxide particles) in the conductive-layer coating solution is preferably 0.01 μm or more and 0.45 μm or less, more preferably 0.01 μm or more and 0.10 μm or less.

The average particle diameters of metal oxide particles such as the first metal oxide particle and a second metal oxide particle in the conductive-layer coating solution can be determined by the following liquid phase sedimentation method or cross-sectional observation with an SEM.

First, the conductive-layer coating solution is diluted with the solvent used for its preparation so that its transmittance may fall within the range of 0.8 to 1.0. Next, a histogram of the average particle diameter (volume average particle diameter) and particle size distribution of the metal oxide particles is created with an ultracentrifugal automatic particle size distribution analyzer. In the present invention, the measurement was performed with an ultracentrifugal automatic particle size distribution analyzer (trade name: CAPA 700) manufactured by HORIBA, Ltd. as the ultracentrifugal automatic particle size distribution analyzer under the condition of a number of rotation of 3,000 rpm.

From the viewpoint of covering defects in the surface of the support, the thickness of the conductive layer is preferably 10 μm or more and 40 μm or less, more preferably 15 μm or more and 35 μm or less.

It should be noted that, in the present invention, as an apparatus for measuring the thickness of each layer of the electrophotographic photosensitive member including the conductive layer, FISHERSCOPE mms manufactured by Fisher Instruments K.K. was used.

The volume resistivity of the conductive layer is preferably 1.0×10⁸ Ω·cm or more and 2.0×10¹³ Ω·cm or less. When a layer having a volume resistivity of 2.0×10¹³ Ω·cm or less is provided on the support as a layer for covering the defects in the surface of the support, the flow of charge is hardly disrupted at the time of image formation and hence a residual potential hardly increases. Meanwhile, when the volume resistivity of the conductive layer is 1.0×10⁸ Ω·cm or more, the quantity of the charge flowing in the conductive layer at the time of the charging of the electrophotographic photosensitive member does not become excessively large and hence fogging due to an increase in dark attenuation of the electrophotographic photosensitive member hardly occurs.

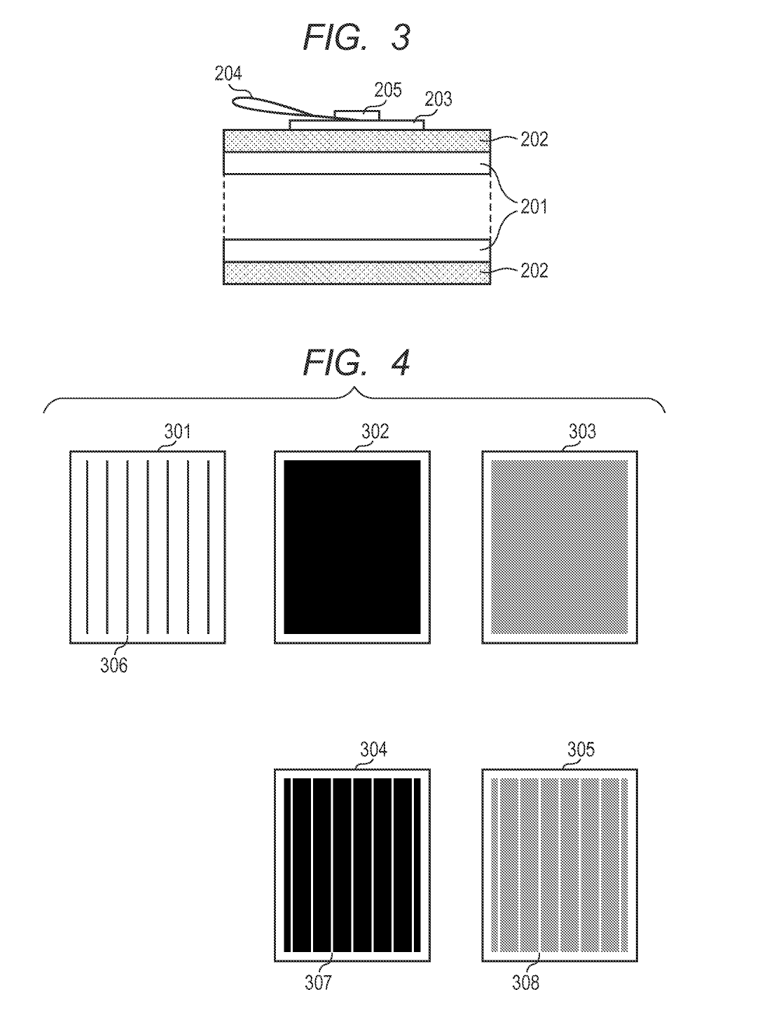

A method of measuring the volume resistivity of the conductive layer of the electrophotographic photosensitive member is described with reference to FIGS. 2 and 3. FIG. 2 is a top view for illustrating the method of measuring the volume resistivity of the conductive layer and FIG. 3 is a cross-sectional view for illustrating the method of measuring the volume resistivity of the conductive layer.

The volume resistivity of the conductive layer is measured under a normal-temperature and normal-humidity (23° C./50% RH) environment. A copper tape 203 (manufactured by Sumitomo 3M Limited, Type No. 1181) is attached to the surface of a conductive layer 202 and is used as an electrode on the front surface side of the conductive layer 202. In addition, a support 201 is used as an electrode on the back side of the conductive layer 202. A power source 206 for applying a voltage between the copper tape 203 and the support 201, and a current measurement appliance 207 for measuring a current flowing between the copper tape 203 and the support 201 are placed. In addition, a copper wire 204 is mounted on the copper tape 203 for applying a voltage to the copper tape 203 and then the copper wire 204 is fixed to the copper tape 203 by attaching a copper tape 205 similar to the copper tape 203 from above the copper wire 204 so that the copper wire 204 may not protrude from the copper tape 203. A voltage is applied to the copper tape 203 with the copper wire 204.

When a background current value in the case where no voltage is applied between the copper tape 203 and the support 201 is represented by I₀ [A], a current value in the case where a voltage of −1 V formed only of a DC voltage (DC component) is applied is represented by I [A], the thickness of the conductive layer 202 is represented by d [cm], and the area of the electrode (copper tape 203) on the front surface side of the conductive layer 202 is represented by S [cm²], a value represented by the following expression (26) is defined as a volume resistivity p [Ω·cm] of the conductive layer 202.

ρ=1/(I−I₀)×S/d [Ω·cm] (26)

This measurement is preferably performed with an appliance capable of measuring a minute current as the current measurement appliance 207 because a minute current quantity whose absolute value is 1×10⁻⁶ A or less is measured in the measurement. Examples of such appliance include a pA meter (trade name: 4140B) manufactured by Yokogawa Hewlett-Packard and a high resistance meter (trade name: 4339B) manufactured by Agilent Technologies.

It should be noted that the volume resistivity of the conductive layer measured in a state where only the conductive layer is formed on the support and that measured in a state where only the conductive layer is left on the support by peeling each layer (such as the photosensitive layer) on the conductive layer from the electrophotographic photosensitive member show the same value.

In order to prevent the injection of a charge from the conductive layer to the photosensitive layer, an undercoat layer (barrier layer) having electric barrier property may be provided between the conductive layer and the photosensitive layer.

The undercoat layer can be formed by coating the conductive layer with an undercoat-layer coating solution containing a resin (binder material) and drying the resultant coating film.

Examples of the resin (binder material) to be used in the undercoat layer include a polyvinyl alcohol, a polyvinyl methyl ether, a polyacrylic acids, a methylcellulose, an ethylcellulose, a polyglutamic acid, casein, starch, and other water-soluble resins, a polyamide, a polyimide, a polyamide-imide, a polyamic acid, a melamine resin, an epoxy resin, a polyurethane, and a polyglutamate. Of those, thermoplastic resins are preferred to effectively express the electric barrier property of the undercoat layer. Of the thermoplastic resins, a thermoplastic polyamide is preferred. The polyamide is preferably a copolymerized nylon.

The thickness of the undercoat layer is preferably 0.1 μm or more and 2.0 μm or less.

In addition, an electron-transporting substance (electron-accepting substance such as an acceptor) may be contained in the undercoat layer to prevent the flow of charge from being disrupted in the undercoat layer.

Examples of the electron-transporting substance include electron-withdrawing substances such as 2,4,7-trinitrofluorenone, 2,4,5,7-tetranitrofluorenone, chloranil, and tetracyanoquinodimethane, and polymers of those electron-withdrawing substances.

The photosensitive layer is provided on the conductive layer (undercoat layer).

Examples of the charge-generating substance to be used in the photosensitive layer include: azo pigments such as monoazo, disazo, and trisazo; phthalocyanine pigments such as metal phthalocyanine and non-metal phthalocyanine; indigo pigments such as indigo and thioindigo; perylene pigments such as perylene acid anhydride and perylene acid imide; polycyclic quinone pigments such as anthraquinone and pyrenequinone; squarylium dyes; pyrylium salts and thiapyrylium salts; triphenylmethane dyes; quinacridone pigments; azulenium salt pigments; cyanine dyes; xanthene dyes; quinonimine dyes; and styryl dyes. Of those, metal phthalocyanines such as oxytitanium phthalocyanine, hydroxygallium phthalocyanine, and chlorogallium phthalocyanine are preferred.

When the photosensitive layer is a laminated type photosensitive layer, the charge-generating layer can be formed by applying a charge-generating-layer coating solution, which is prepared by dispersing a charge-generating substance into a solvent together with a binder material, and then drying the resultant coating film. As a dispersion method, there are given, for example, methods using a homogenizer, an ultrasonic wave, a ball mill, a sand mill, an attritor, and a roll mill.

Examples of the binder material to be used in the charge-generating layer include a polycarbonate, a polyester, a polyarylate, a butyral resin, a polystyrene, a polyvinyl acetal, a diallyl phthalate resin, an acrylic resin, a methacrylic resin, a vinyl acetate resin, a phenol resin, a silicone resin, a polysulfone, a styrene-butadiene copolymer, an alkyd resin, an epoxy resin, a urea resin, and a vinyl chloride-vinyl acetate copolymer. Those binder materials may be used alone or as a mixture or a copolymer of two or more kinds thereof.

The ratio of the charge-generating substance to the binder material (charge-generating substance:binder material) falls within the range of preferably 10:1 to 1:10 (mass ratio), more preferably 5:1 to 1:1 (mass ratio).

Examples of the solvent to be used in the charge-generating-layer coating solution include an alcohol, a sulfoxide, a ketone, an ether, an ester, an aliphatic halogenated hydrocarbon, and an aromatic compound.

The thickness of the charge-generating layer is preferably 5 μm or less, more preferably 0.1 μm or more and 2 μm or less.

Further, any of various sensitizers, antioxidants, UV absorbers, plasticizers, and the like may be added to the charge-generating layer as required. Further, an electron-transporting substance (electron-accepting substance such as an acceptor) may be contained in the charge-generating layer to prevent the flow of charge from being disrupted in the charge-generating layer.

Examples of the electron-transporting substance include electron-withdrawing substances such as 2,4,7-trinitrofluorenone, 2,4,5,7-tetranitrofluorenone, chloranil, and tetracyanoquinodimethane, and polymers of those electron-withdrawing substances.

Examples of the charge-transporting substance to be used in the photosensitive layer include a triarylamine compound, a hydrazone compound, a styryl compound, a stilbene compound, a pyrazoline compound, an oxazole compound, a thiazole compound, and a triarylmethane compound.

When the photosensitive layer is a laminated type photosensitive layer, the charge-transporting layer can be formed by applying a charge-transporting-layer coating solution, which is prepared by dissolving a charge-transporting substance and a binder material in a solvent, and then drying the resultant coating film.

Examples of the binder material to be used in the charge-transporting layer include an acrylic resin, a styrene resin, a polyester, a polycarbonate, a polyarylate, a polysulfone, a polyphenylene oxide, an epoxy resin, a polyurethane, an alkyd resin, and an unsaturated resin. Those binder materials may be used alone or as a mixture or a copolymer of two or more kinds thereof.

The ratio of the charge-transporting substance to the binder material (charge-transporting substance:binder material) preferably falls within the range of 2:1 to 1:2 (mass ratio).

Examples of the solvent to be used in the charge-transporting-layer coating solution include: ketones such as acetone and methyl ethyl ketone; esters such as methyl acetate and ethyl acetate; ethers such as dimethoxymethane and dimethoxyethane; aromatic hydrocarbons such as toluene and xylene; and hydrocarbons each substituted by a halogen atom, such as chlorobenzene, chloroform, and carbon tetrachloride.

The thickness of the charge-transporting layer is preferably 3 μm or more and 40 μm or less, more preferably 4 μm or more and 30 μm or less from the viewpoints of charging uniformity and image reproducibility.

Further, an antioxidant, a UV absorber, or a plasticizer may be added to the charge-transporting layer as required.

When the photosensitive layer is a single-layer type photosensitive layer, the single-layer type photosensitive layer can be formed by applying a single-layer-type-photosensitive-layer coating solution containing a charge-generating substance, a charge-transporting substance, a binder material, and a solvent, and then drying the resultant coating film. As the charge-generating substance, the charge-transporting substance, the binder material, and the solvent, for example, those of various kinds described above can be used.

Further, a protective layer may be formed on the photosensitive layer to protect the photosensitive layer. The protective layer can be formed by applying a protective-layer coating solution containing a resin (binder material), and then drying and/or curing the resultant coating film.

The thickness of the protective layer is preferably 0.5 μm or more and 10 μm or less, more preferably 1 μm or more and 8 μm to less.

In the application of each of the coating solutions corresponding to the respective layers, coating methods such as dip coating, spray coating, spinner coating, roller coating, Meyer bar coating, and blade coating may be employed.

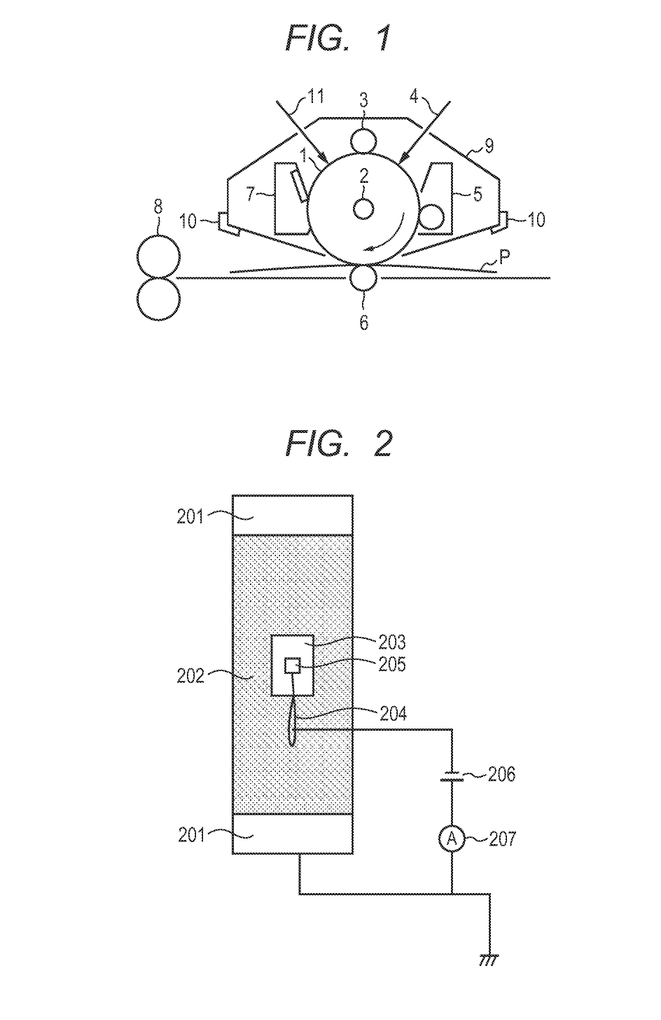

FIG. 1 illustrates an example of the schematic construction of an electrophotographic apparatus including a process cartridge having an electrophotographic photosensitive member.

In FIG. 1, an electrophotographic photosensitive member 1 having a drum shape (cylindrical shape) is driven to rotate around an axis 2 in a direction indicated by the arrow at a predetermined peripheral speed.

The circumferential surface of the electrophotographic photosensitive member 1 to be driven to rotate is uniformly charged at a positive or negative predetermined potential by a charging device (such as a primary charging device or a charging roller) 3, and then receives exposure light (image exposure light) 4 emitted from an exposing device (not shown) such as a slit exposure or a laser-beam scanning exposure. Thus, electrostatic latent images corresponding to images of interest are sequentially formed on the circumferential surface of the electrophotographic photosensitive member 1. A voltage to be applied to the charging device 3 may be only a DC voltage, or may be a DC voltage superimposed with an AC voltage.

The electrostatic latent images formed on the circumferential surface of the electrophotographic photosensitive member 1 are converted into toner images by development with toner of a developing device 5. Subsequently, the toner images formed on the circumferential surface of the electrophotographic photosensitive member 1 are transferred to a transfer material (such as paper) P by a transfer bias from a transferring device (such as a transfer roller) 6. The transfer material P is fed with a transfer material feeding device (not shown) to a portion (abutment portion) between the electrophotographic photosensitive member 1 and the transferring device 6 in synchronization with the rotation of the electrophotographic photosensitive member 1.

The transfer material P which has received the transfer of the toner images is separated from the circumferential surface of the electrophotographic photosensitive member 1, introduced to a fixing device 8, subjected to image fixation, and then printed as an image-formed product (print or copy) out of the apparatus.

The circumferential surface of the electrophotographic photosensitive member 1 after the transfer of the toner images undergoes removal of the remaining toner after the transfer by a cleaning device (such as a cleaning blade) 7. Further, the circumferential surface of the electrophotographic photosensitive member 1 is subjected to a neutralization process with pre-exposure light 11 from a pre-exposing device (not shown) and then repeatedly used in image formation. It should be noted that, when the charging device is a contact-charging device such as a charging roller, the pre-exposure is not always required. It should also be noted that, when the electrophotographic apparatus adopts a cleaner-less system, the cleaning device is not always required.

The electrophotographic photosensitive member 1 and at least one structural component selected from the charging device 3, the developing device 5, the transferring device 6, the cleaning device 7, and the like may be housed in a container and then integrally supported as a process cartridge. In addition, the process cartridge may be detachably mountable to the main body of an electrophotographic apparatus. In FIG. 1, the electrophotographic photosensitive member 1, and the charging device 3, the developing device 5, and the cleaning device 7 are integrally supported as a cartridge, thereby forming a process cartridge 9, which is detachably mountable to the main body of an electrophotographic apparatus, through use of a guiding device 10 such as a rail of the main body of the electrophotographic apparatus. Further, the electrophotographic apparatus may have a construction including the electrophotographic photosensitive member 1, and the charging device 3, the exposing device, the developing device 5, and the transferring device 6.

### EXAMPLE

Hereinafter, the present invention is described in more detail by way of specific examples, provided that the present invention is not limited thereto. It should be noted that the term “part(s)” in each of Examples and Comparative Examples means “part(s) by mass,” the term “average particle diameter” means “average primary particle diameter,” the unit “%” of a coating ratio in each table means “% by mass,” and the unit “%” of a doping ratio (doping amount) means “% by mass.” In addition, densities in Examples and the tables are each a value determined by the foregoing method and are each represented in the unit of “g/cm³.”

### Preparation Examples of Conductive-Layer Coating Solutions

(Preparation Example of Conductive-Layer Coating Solution CP-1)

112.00 Parts of P-doped tin oxide-coated titanium oxide particles (average primary particle diameter: 230 nm, powder resistivity: 5,000 Ω·cm, amount (doping ratio) of phosphorus doped into tin oxide: 4.50% by mass, coating ratio: 45% by mass, density: 5.1 g/cm³) as a first metal oxide particle, 3.00 parts of P-doped tin oxide particles (average primary particle diameter: 20 nm, powder resistivity: 300 Ω·cm, amount (doping ratio) of phosphorus doped into tin oxide: 3.60% by mass, density: 6.8 g/cm³) as a second metal oxide particle, 266.67 parts of a phenol resin (trade name: PLYOPHEN J-325, manufactured by DIC Corporation, resin solid content: 60% by mass) as a binding material, and 120 parts of 1-methoxy-2-propanol as a solvent were loaded into a sand mill using 465 parts of glass beads each having a diameter of 0.8 mm, and were then subjected to a dispersion treatment under the following dispersion treatment conditions to provide a dispersion solution: a disc rotation number of 2,000 rpm, a dispersion treatment time of 4.5 hours, and a setting temperature of cooling water of 18° C.

The glass beads were removed from the dispersion solution with a mesh. After that, 5.00 parts of silicone resin particles (trade name: TOSPEARL 120, manufactured by Momentive Performance Materials Inc., average particle diameter: 2 μm) as a surface roughness providing material and 0.30 part of a silicone oil (trade name: SH28PA, manufactured by Dow Corning Toray Silicone Co., Ltd.) as a leveling agent were added to the dispersion solution, and then the mixture was stirred for 30 minutes to prepare a conductive-layer coating solution CP-1.

(Preparation Examples of Conductive-Layer Coating Solutions CP-2 to CP-93, CP-141 to CP-233, CP-281 to CP-373, CP-421 to CP-513, and CP-561 to CP-653)

Conductive-layer coating solutions CP-2 to CP-93, CP-141 to CP-233, CP-281 to CP-373, CP-421 to CP-513, and CP-561 to CP-653 were prepared by the same operations as those of the preparation example of the conductive-layer coating solution CP-1 except that the kind (including a coating ratio, a doping ratio, and a density, the same holds true for the following) and amount of the first metal oxide particle, the kind (including a doping ratio and a density, the same holds true for the following) and amount of the second metal oxide particle, and the amount of the binding material were changed as shown in Tables 1 to 3, 8 to 10, 15 to 17, 44 to 46, and 49 to 51.

It should be noted that P-doped tin oxide-coated titanium oxide particles used as the first metal oxide particle in the preparation of the conductive-layer coating solutions CP-2 to CP-93 had a powder resistivity of 5,000 Ω·cm.

In addition, P-doped tin oxide particles used as the second metal oxide particle in the preparation of the conductive-layer coating solutions CP-7, CP-13, CP-19, CP-24, CP-29, CP-35, CP-40, CP-45, CP-50, CP-55, CP-61, CP-66, CP-71, CP-77, CP-83, and CP-89 had a powder resistivity of 300 Ω·cm.

In addition, P-doped tin oxide particles used as the second metal oxide particle in the preparation of the conductive-layer coating solutions CP-2, CP-8, CP-14, CP-20, CP-25, CP-30, CP-36, CP-41, CP-46, CP-51, CP-56, CP-62, CP-67, CP-72, CP-78, CP-84, and CP-90 had a powder resistivity of 250 Ω·cm. In addition, P-doped tin oxide particles used as the second metal oxide particle in the preparation of the conductive-layer coating solutions CP-3, CP-6, CP-9, CP-12, CP-15, CP-18, CP-21, CP-26, CP-31, CP-34, CP-37, CP-42, CP-47, CP-52, CP-57, CP-60, CP-63, CP-68, CP-73, CP-76, CP-79, CP-82, CP-85, CP-88, and CP-91 had a powder resistivity of 200 Ω·cm.

In addition, P-doped tin oxide particles used as the second metal oxide particle in the preparation of the conductive-layer coating solutions CP-4, CP-10, CP-16, CP-22, CP-27, CP-32, CP-38, CP-43, CP-48, CP-53, CP-58, CP-64, CP-69, CP-74, CP-80, CP-86, and CP-92 had a powder resistivity of 150 Ω·cm.

In addition, P-doped tin oxide particles used as the second metal oxide particle in the preparation of the conductive-layer coating solutions CP-5, CP-11, CP-17, CP-23, CP-28, CP-33, CP-39, CP-44, CP-49, CP-54, CP-59, CP-65, CP-70, CP-75, CP-81, CP-87, and CP-93 had a powder resistivity of 100 Ω·cm.

In addition, W-doped tin oxide-coated titanium oxide particles used as the first metal oxide particle in the preparation of the conductive-layer coating solutions CP-141 to CP-233 had a powder resistivity of 3,000 Ω·cm.

In addition, W-doped tin oxide particles used as the second metal oxide particle in the preparation of the conductive-layer coating solutions CP-141, CP-147, CP-153, CP-159, CP-164, CP-169, CP-175, CP-180, CP-185, CP-190, CP-195, CP-201, CP-206, CP-211, CP-217, CP-223, and CP-229 had a powder resistivity of 180 Ω·cm.

In addition, W-doped tin oxide particles used as the second metal oxide particle in the preparation of the conductive-layer coating solutions CP-142, CP-148, CP-154, CP-160, CP-165, CP-170, CP-176, CP-181, CP-186, CP-191, CP-196, CP-202, CP-207, CP-212, CP-218, CP-224, and CP-230 had a powder resistivity of 140 Ω·cm.

In addition, W-doped tin oxide particles used as the second metal oxide particle in the preparation of the conductive-layer coating solutions CP-143, CP-146, CP-149, CP-152, CP-155, CP-158, CP-161, CP-166, CP-171, CP-174, CP-177, CP-182, CP-187, CP-192, CP-197, CP-200, CP-203, CP-208, CP-213, CP-216, CP-219, CP-222, CP-225, CP-228, and CP-231 had a powder resistivity of 100 Ω·cm.

In addition, W-doped tin oxide particles used as the second metal oxide particle in the preparation of the conductive-layer coating solutions CP-144, CP-150, CP-156, CP-162, CP-167, CP-172, CP-178, CP-183, CP-188, CP-193, CP-198, CP-204, CP-209, CP-214, CP-220, CP-226, and CP-232 had a powder resistivity of 70 Ω·cm.

In addition, W-doped tin oxide particles used as the second metal oxide particle in the preparation of the conductive-layer coating solutions CP-145, CP-151, CP-157, CP-163, CP-168, CP-173, CP-179, CP-184, CP-189, CP-194, CP-199, CP-205, CP-210, CP-215, CP-221, CP-227, and CP-233 had a powder resistivity of 30 Ω·cm.

In addition, F-doped tin oxide-coated titanium oxide particles used as the first metal oxide particle in the preparation of the conductive-layer coating solutions CP-281 to CP-373 had a powder resistivity of 5,000 Ω·cm.

In addition, F-doped tin oxide particles used as the second metal oxide particle in the preparation of the conductive-layer coating solutions CP-281, CP-287, CP-293, CP-299, CP-304, CP-309, CP-315, CP-320, CP-325, CP-330, CP-335, CP-341, CP-346, CP-351, CP-357, CP-363, and CP-369 had a powder resistivity of 300 Ω·cm.

In addition, F-doped tin oxide particles used as the second metal oxide particle in the preparation of the conductive-layer coating solutions CP-282, CP-288, CP-294, CP-300, CP-305, CP-310, CP-316, CP-321, CP-326, CP-331, CP-336, CP-342, CP-347, CP-352, CP-358, CP-364 and CP-370 had a powder resistivity of 270 Ω·cm.

In addition, F-doped tin oxide particles used as the second metal oxide particle in the preparation of the conductive-layer coating solutions CP-283, CP-286, CP-289, CP-292, CP-295, CP-298, CP-301, CP-306, CP-311, CP-314, CP-317, CP-322, CP-327, CP-332, CP-337, CP-340, CP-343, CP-348, CP-353, CP-356, CP-359, CP-362, CP-365, CP-368, and CP-371 had a powder resistivity of 220 Ω·cm.

In addition, F-doped tin oxide particles used as the second metal oxide particle in the preparation of the conductive-layer coating solutions CP-284, CP-290, CP-296, CP-302, CP-307, CP-312, CP-318, CP-323, CP-328, CP-333, CP-338, CP-344, CP-349, CP-354, CP-360, CP-366, and CP-372 had a powder resistivity of 170 Ω·cm.

In addition, F-doped tin oxide particles used as the second metal oxide particle in the preparation of the conductive-layer coating solutions CP-285, CP-291, CP-297, CP-303, CP-308, CP-313, CP-319, CP-324, CP-329, CP-334, CP-339, CP-345, CP-350, CP-355, CP-361, CP-367, and CP-373 had a powder resistivity of 130 Ω·cm.

In addition, Nb-doped tin oxide-coated titanium oxide particles used as the first metal oxide particle in the preparation of the conductive-layer coating solutions CP-421 to CP-513 had a powder resistivity of 6,500 Ω·cm.

In addition, Nb-doped tin oxide particles used as the second metal oxide particle in the preparation of the conductive-layer coating solutions CP-421, CP-427, CP-433, CP-439, CP-444, CP-449, CP-455, CP-460, CP-465, CP-470, CP-475, CP-481, CP-486, CP-491, CP-497, CP-503, and CP-509 had a powder resistivity of 400 Ω·cm.

In addition, Nb-doped tin oxide particles used as the second metal oxide particle in the preparation of the conductive-layer coating solutions CP-422, CP-428, CP-434, CP-440, CP-445, CP-450, CP-456, CP-461, CP-466, CP-471, CP-476, CP-482, CP-487, CP-492, CP-498, CP-504, and CP-510 had a powder resistivity of 360 Ω·cm.

In addition, Nb-doped tin oxide particles used as the second metal oxide particle in the preparation of the conductive-layer coating solutions CP-423, CP-426, CP-429, CP-432, CP-435, CP-438, CP-441, CP-446, CP-451, CP-454, CP-457, CP-462, CP-467, CP-472, CP-477, CP-480, CP-483, CP-488, CP-493, CP-496, CP-499, CP-502, CP-505, CP-508, and CP-511 had a powder resistivity of 330 Ω·cm.

In addition, Nb-doped tin oxide particles used as the second metal oxide particle in the preparation of the conductive-layer coating solutions CP-424, CP-430, CP-436, CP-442, CP-447, CP-452, CP-458, CP-463, CP-468, CP-473, CP-478, CP-484, CP-489, CP-494, CP-500, CP-506, and CP-512 had a powder resistivity of 300 Ω·cm.

In addition, Nb-doped tin oxide particles used as the second metal oxide particle in the preparation of the conductive-layer coating solutions CP-425, CP-431, CP-437, CP-443, CP-448, CP-453, CP-459, CP-464, CP-469, CP-474, CP-479, CP-485, CP-490, CP-495, CP-501, CP-507, and CP-513 had a powder resistivity of 270 Ω·cm.

In addition, Ta-doped tin oxide-coated titanium oxide particles used as the first metal oxide particle in the preparation of the conductive-layer coating solutions CP-561 to CP-653 had a powder resistivity of 4,500 Ω·cm.

In addition, Ta-doped tin oxide particles used as the second metal oxide particle in the preparation of the conductive-layer coating solutions CP-561, CP-567, CP-573, CP-579, CP-584, CP-589, CP-595, CP-600, CP-605, CP-610, CP-615, CP-621, CP-626, CP-631, CP-637, CP-643, and CP-649 had a powder resistivity of 270 Ω·cm.

In addition, Ta-doped tin oxide particles used as the second metal oxide particle in the preparation of the conductive-layer coating solutions CP-562, CP-568, CP-574, CP-580, CP-585, CP-590, CP-596, CP-601, CP-606, CP-611, CP-616, CP-622, CP-627, CP-632, CP-638, CP-644, and CP-650 had a powder resistivity of 200 Ω·cm.

In addition, Ta-doped tin oxide particles used as the second metal oxide particle in the preparation of the conductive-layer coating solutions CP-563, CP-566, CP-569, CP-572, CP-575, CP-578, CP-581, CP-586, CP-591, CP-594, CP-597, CP-602, CP-607, CP-612, CP-617, CP-620, CP-623, CP-628, CP-633, CP-636, CP-639, CP-642, CP-645, CP-648, and CP-651 had a powder resistivity of 160 Ω·cm.

In addition, Ta-doped tin oxide particles used as the second metal oxide particle in the preparation of the conductive-layer coating solutions CP-564, CP-570, CP-576, CP-582, CP-587, CP-592, CP-598, CP-603, CP-608, CP-613, CP-618, CP-624, CP-629, CP-634, CP-640, CP-646, and CP-652 had a powder resistivity of 110 Ω·cm.

In addition, Ta-doped tin oxide particles used as the second metal oxide particle in the preparation of the conductive-layer coating solutions CP-565, CP-571, CP-577, CP-583, CP-588, CP-593, CP-599, CP-604, CP-609, CP-614, CP-619, CP-625, CP-630, CP-635, CP-641, CP-647, and CP-653 had a powder resistivity of 65 Ω·cm.

(Preparation Examples of Conductive-Layer Coating Solutions CP-94 to CP-140, CP-234 to CP-280, CP-374 to CP-420, CP-514 to CP-560, and CP-654 to CP-700)

Conductive-layer coating solutions CP-94 to CP-140, CP-234 to CP-280, CP-374 to CP-420, CP-514 to CP-560, and CP-654 to CP-700 were prepared by the same operations as those of the preparation example of the conductive-layer coating solution CP-1 except that: the kind and amount of the first metal oxide particle, the kind and amount of the second metal oxide particle, the amount of the binding material, and the amount of the silicone resin particles were changed as shown in Tables 3, 4, 11, 12, 18, 19, 46, 47, 52, and 53; and the operation for the dispersion treatment was carried out by adding 30.00 parts of uncoated titanium oxide particles (powder resistivity: 5.0×10⁷ Ω·cm, average particle diameter: 210 nm, density: 4.2 g/cm³) at the time of the operation for the dispersion treatment. It should be noted that when the conductive-layer coating solutions CP-139, CP-279, CP-419, CP-559, and CP-699 were prepared, the disc rotation number and dispersion treatment time in the dispersion treatment conditions were changed to 2,500 rpm and 10 hours, respectively. In addition, when the conductive-layer coating solutions CP-140, CP-280, CP-420, CP-560, and CP-700 were prepared, the disc rotation number and dispersion treatment time in the dispersion treatment conditions were changed to 2,500 rpm and 30 hours, respectively.

It should be noted that P-doped tin oxide-coated titanium oxide particles used as the first metal oxide particle in the preparation of the conductive-layer coating solutions CP-94 to CP-140 had a powder resistivity of 5,000 Ω·cm.

In addition, P-doped tin oxide particles used as the second metal oxide particle in the preparation of the conductive-layer coating solutions CP-94, CP-99, CP-104, CP-109, CP-114, CP-119, CP-124, CP-129, and CP-134 had a powder resistivity of 300 Ω·cm.

In addition, P-doped tin oxide particles used as the second metal oxide particle in the preparation of the conductive-layer coating solutions CP-95, CP-100, CP-105, CP-110, CP-115, CP-120, CP-125, CP-130, and CP-135 had a powder resistivity of 250 Ω·cm.

In addition, P-doped tin oxide particles used as the second metal oxide particle in the preparation of the conductive-layer coating solutions CP-96, CP-101, CP-106, CP-111, CP-116, CP-121, CP-126, CP-131, CP-136, CP-139, and CP-140 had a powder resistivity of 200 Ω·cm.

In addition, P-doped tin oxide particles used as the second metal oxide particle in the preparation of the conductive-layer coating solutions CP-97, CP-102, CP-107, CP-112, CP-117, CP-122, CP-127, CP-132, and CP-137 had a powder resistivity of 150 Ω·cm.

In addition, P-doped tin oxide particles used as the second metal oxide particle in the preparation of the conductive-layer coating solutions CP-98, CP-103, CP-108, CP-113, CP-118, CP-123, CP-128, CP-133, and CP-138 had a powder resistivity of 100 Ω·cm.

In addition, W-doped tin oxide-coated titanium oxide particles used as the first metal oxide particle in the preparation of the conductive-layer coating solutions CP-234 to CP-280 had a powder resistivity of 3,000 Ω·cm.

In addition, W-doped tin oxide particles used as the second metal oxide particle in the preparation of the conductive-layer coating solutions CP-234, CP-239, CP-244, CP-249, CP-254, CP-259, CP-264, CP-269, and CP-274 had a powder resistivity of 180 Ω·cm.

In addition, W-doped tin oxide particles used as the second metal oxide particle in the preparation of the conductive-layer coating solutions CP-235, CP-240, CP-245, CP-250, CP-255, CP-260, CP-265, CP-270, and CP-275 had a powder resistivity of 140 Ω·cm.

In addition, W-doped tin oxide particles used as the second metal oxide particle in the preparation of the conductive-layer coating solutions CP-236, CP-241, CP-246, CP-251, CP-256, CP-261, CP-266, CP-271, CP-276, CP-279, and CP-280 had a powder resistivity of 100 Ω·cm.

In addition, W-doped tin oxide particles used as the second metal oxide particle in the preparation of the conductive-layer coating solutions CP-237, CP-242, CP-247, CP-252, CP-257, CP-262, CP-267, CP-272, and CP-277 had a powder resistivity of 70 Ω·cm.

In addition, W-doped tin oxide particles used as the second metal oxide particle in the preparation of the conductive-layer coating solutions CP-238, CP-243, CP-248, CP-253, CP-258, CP-263, CP-268, CP-273, and CP-278 had a powder resistivity of 30 Ω·cm.

In addition, F-doped tin oxide-coated titanium oxide particles used as the first metal oxide particle in the preparation of the conductive-layer coating solutions CP-374 to CP-420 had a powder resistivity of 5,000 Ω·cm.

In addition, F-doped tin oxide particles used as the second metal oxide particle in the preparation of the conductive-layer coating solutions CP-374, CP-379, CP-384, CP-389, CP-394, CP-399, CP-404, CP-409, and CP-414 had a powder resistivity of 300 Ω·cm.

In addition, F-doped tin oxide particles used as the second metal oxide particle in the preparation of the conductive-layer coating solutions CP-375, CP-380, CP-385, CP-390, CP-395, CP-400, CP-405, CP-410, and CP-415 had a powder resistivity of 270 Ω·cm.

In addition, F-doped tin oxide particles used as the second metal oxide particle in the preparation of the conductive-layer coating solutions CP-376, CP-381, CP-386, CP-391, CP-396, CP-401, CP-406, CP-411, CP-416, CP-419, and CP-420 had a powder resistivity of 220 Ω·cm.

In addition, F-doped tin oxide particles used as the second metal oxide particle in the preparation of the conductive-layer coating solutions CP-377, CP-382, CP-387, CP-392, CP-397, CP-402, CP-407, CP-412, and CP-417 had a powder resistivity of 170 Ω·cm.

In addition, F-doped tin oxide particles used as the second metal oxide particle in the preparation of the conductive-layer coating solutions CP-378, CP-383, CP-388, CP-393, CP-398, CP-403, CP-408, CP-413, and CP-418 had a powder resistivity of 130 Ω·cm.

In addition, Nb-doped tin oxide-coated titanium oxide particles used as the first metal oxide particle in the preparation of the conductive-layer coating solutions CP-514 to CP-560 had a powder resistivity of 6,500 Ω·cm.

In addition, Nb-doped tin oxide particles used as the second metal oxide particle in the preparation of the conductive-layer coating solutions CP-514, CP-519, CP-524, CP-529, CP-534, CP-539, CP-544, CP-549, and CP-554 had a powder resistivity of 400 Ω·cm. In addition, Nb-doped tin oxide particles used as the second metal oxide particle in the preparation of the conductive-layer coating solutions CP-515, CP-520, CP-525, CP-530, CP-535, CP-540, CP-545, CP-550, and CP-555 had a powder resistivity of 360 Ω·cm.

In addition, Nb-doped tin oxide particles used as the second metal oxide particle in the preparation of the conductive-layer coating solutions CP-516, CP-521, CP-526, CP-531, CP-536, CP-541, CP-546, CP-551, CP-556, CP-559, and CP-560 had a powder resistivity of 330 Ω·cm.

In addition, Nb-doped tin oxide particles used as the second metal oxide particle in the preparation of the conductive-layer coating solutions CP-517, CP-522, CP-527, CP-532, CP-537, CP-542, CP-547, CP-552, and CP-557 had a powder resistivity of 300 Ω·cm.

In addition, Nb-doped tin oxide particles used as the second metal oxide particle in the preparation of the conductive-layer coating solutions CP-518, CP-523, CP-528, CP-533, CP-538, CP-543, CP-548, CP-553, and CP-558 had a powder resistivity of 270 Ω·cm.

In addition, Ta-doped tin oxide-coated titanium oxide particles used as the first metal oxide particle in the preparation of the conductive-layer coating solutions CP-654 to CP-700 had a powder resistivity of 4,500 Ω·cm.

In addition, Ta-doped tin oxide particles used as the second metal oxide particle in the preparation of the conductive-layer coating solutions CP-654, CP-659, CP-664, CP-669, CP-674, CP-679, CP-684, CP-689, and CP-694 had a powder resistivity of 270 Ω·cm.

In addition, Ta-doped tin oxide particles used as the second metal oxide particle in the preparation of the conductive-layer coating solutions CP-655, CP-660, CP-665, CP-670, CP-675, CP-680, CP-685, CP-690, and CP-695 had a powder resistivity of 200 Ω·cm.

In addition, Ta-doped tin oxide particles used as the second metal oxide particle in the preparation of the conductive-layer coating solutions CP-656, CP-661, CP-666, CP-671, CP-676, CP-681, CP-686, CP-691, CP-696, CP-699, and CP-700 had a powder resistivity of 160 Ω·cm.

In addition, Ta-doped tin oxide particles used as the second metal oxide particle in the preparation of the conductive-layer coating solutions CP-657, CP-662, CP-667, CP-672, CP-677, CP-682, CP-687, CP-692, and CP-697 had a powder resistivity of 110 Ω·cm.

In addition, Ta-doped tin oxide particles used as the second metal oxide particle in the preparation of the conductive-layer coating solutions CP-658, CP-663, CP-668, CP-673, CP-678, CP-683, CP-688, CP-693, and CP-698 had a powder resistivity of 65 Ω·cm.

(Preparation Examples of Conductive-Layer Coating Solutions CP-C1 to CP-C22, CP-C42 to CP-C63, CP-C76 to CP-C97, CP-C107 to CP-C128, and CP-C129 to CP-C150)

Conductive-layer coating solutions CP-C1 to CP-C22, CP-C42 to CP-C63, CP-C76 to CP-C97, CP-C107 to CP-C128, and CP-C129 to CP-C150 were prepared by the same operations as those of the preparation example of the conductive-layer coating solution CP-1 except that the kind and amount of the first metal oxide particle, the kind and amount of the second metal oxide particle, and the amount of the binding material were changed (including a change as to whether or not the first metal oxide particle or the second metal oxide particle were used, the same holds true for the following) as shown in Tables 5, 13, 20, 48, and 54.

It should be noted that P-doped tin oxide-coated titanium oxide particles used as the first metal oxide particle in the preparation of the conductive-layer coating solutions CP-C1 to CP-C9 and CP-C13 to CP-C22 had a powder resistivity of 5,000 Ω·cm.

In addition, P-doped tin oxide particles used as the second metal oxide particle in the preparation of the conductive-layer coating solutions CP-C4 to CP-C22 had a powder resistivity of 200 Ω·cm.

In addition, W-doped tin oxide-coated titanium oxide particles used as the first metal oxide particle in the preparation of the conductive-layer coating solutions CP-C42 to CP-050 and CP-054 to CP-C63 had a powder resistivity of 3,000 Ω·cm.

In addition, W-doped tin oxide particles used as the second metal oxide particle in the preparation of the conductive-layer coating solutions CP-C45 to CP-C63 had a powder resistivity of 100 Ω·cm.

In addition, F-doped tin oxide-coated titanium oxide particles used as the first metal oxide particle in the preparation of the conductive-layer coating solutions CP-C76 to CP-C84 and CP-C88 to CP-C97 had a powder resistivity of 5,000 Ω·cm.

In addition, F-doped tin oxide particles used as the second metal oxide particle in the preparation of the conductive-layer coating solutions CP-C79 to CP-C97 had a powder resistivity of 220 Ω·cm.

In addition, Nb-doped tin oxide-coated titanium oxide particles used as the first metal oxide particle in the preparation of the conductive-layer coating solutions CP-C107 to CP-C115 and CP-C119 to CP-C128 had a powder resistivity of 6,500 Ω·cm.

In addition, Nb-doped tin oxide particles used as the second metal oxide particle in the preparation of the conductive-layer coating solutions CP-C110 to CP-C128 had a powder resistivity of 330 Ω·cm.

In addition, Ta-doped tin oxide-coated titanium oxide particles used as the first metal oxide particle in the preparation of the conductive-layer coating solutions CP-C129 to CP-C137 and CP-C141 to CP-C150 had a powder resistivity of 4,500 Ω·cm.

In addition, Ta-doped tin oxide particles used as the second metal oxide particle in the preparation of the conductive-layer coating solutions CP-C132 to CP-C150 had a powder resistivity of 160 Ω·cm.

(Preparation Examples of Conductive-Layer Coating Solutions CP-C23 to CP-C35, CP-C64 to CP-C71, CP-C98 to CP-C105, CP-C151 to CP-C178, and CP-C179)

Conductive-layer coating solutions CP-C23 to CP-C35, CP-C64 to CP-C71, CP-C98 to CP-C105, and CP-C151 to CP-C179 were prepared by the same operations as those of the preparation example of the conductive-layer coating solution CP-1 except that the kind and amount of the first metal oxide particle, the kind and amount of the second metal oxide particle, and the amount of the binding material were changed as shown in Tables 6, 7, 14, 21, and 55 to 58. It should be noted that in the tables, for example, titanium oxide particles coated with oxygen-deficient tin oxide (oxygen-deficient tin oxide-coated titanium oxide particles) do not correspond to the first metal oxide particle according to the present invention and oxygen-deficient tin oxide particles do not correspond to the second metal oxide particle according to the present invention, but the particles were shown in the respective columns for convenience as examples to be compared with the present invention. The same holds true for the following.

It should be noted that P-doped tin oxide-coated titanium oxide particles used in the preparation of the conductive-layer coating solutions CP-C26 to CP-C28, CP-C31 to CP-C32, CP-C153, and CP-C154 had a powder resistivity of 5,000 Ω·cm.

In addition, P-doped tin oxide-coated barium sulfate particles used in the preparation of the conductive-layer coating solution CP-C35 had a powder resistivity of 5,000 Ω·cm.

In addition, P-doped tin oxide particles used in the preparation of the conductive-layer coating solutions CP-C23 to CP-C25, CP-C29, CP-C30, CP-C35, CP-151, and CP-152 had a powder resistivity of 200 Ω·cm.

In addition, W-doped tin oxide-coated titanium oxide particles used in the preparation of the conductive-layer coating solutions CP-C67 to CP-C69, CP-C104, CP-C157, and CP-C158 had a powder resistivity of 3,000 Ω·cm.

In addition, W-doped tin oxide-coated barium sulfate particles used in the preparation of the conductive-layer coating solution CP-C71 had a powder resistivity of 3,000 Ω·cm.

In addition, W-doped tin oxide particles used in the preparation of the conductive-layer coating solutions CP-C31, CP-C64 to CP-C66, CP-C70, CP-C71, CP-C155, and CP-C156 had a powder resistivity of 100 Ω·cm.

In addition, F-doped tin oxide-coated titanium oxide particles used in the preparation of the conductive-layer coating solutions CP-C30, CP-C70, CP-C101 to CP-C103, CP-C161, and CP-C162 had a powder resistivity of 5,000 Ω·cm.

In addition, F-doped tin oxide-coated barium sulfate particles used in the preparation of the conductive-layer coating solution CP-C105 had a powder resistivity of 5,000 Ω·cm.

In addition, F-doped tin oxide particles used in the preparation of the conductive-layer coating solutions CP-C32, CP-C159, and CP-C160 had a powder resistivity of 220 Ω·cm.

In addition, Nb-doped tin oxide-coated titanium oxide particles used in the preparation of the conductive-layer coating solutions CP-C151, CP-C155, CP-C159, CP-C166 to CP-C168, and CP-C170 had a powder resistivity of 6,500 Ω·cm.

In addition, Nb-doped tin oxide-coated barium sulfate particles used in the preparation of the conductive-layer coating solution CP-C171 had a powder resistivity of 6,500 Ω·cm.

In addition, Nb-doped tin oxide particles used in the preparation of the conductive-layer coating solutions CP-C153, CP-C157, CP-C161, CP-C163 to CP-C165, CP-C169, and CP-C171 had a powder resistivity of 330 Ω·cm.

In addition, Ta-doped tin oxide-coated titanium oxide particles used in the preparation of the conductive-layer coating solutions CP-C152, CP-C156, CP-C160, CP-C169, and CP-C175 to CP-C177 had a powder resistivity of 4,500 Ω·cm.

In addition, Ta-doped tin oxide-coated barium sulfate particles used in the preparation of the conductive-layer coating solution CP-C178 had a powder resistivity of 4,500 Ω·cm.

In addition, Ta-doped tin oxide particles used in the preparation of the conductive-layer coating solutions CP-C154, CP-C158, CP-C162, CP-C170, CP-C172 to CP-C174, and CP-C178 had a powder resistivity of 160 Ω·cm.

In addition, oxygen-deficient tin oxide-coated titanium oxide particles used in the preparation of the conductive-layer coating solutions CP-C23, CP-C64, CP-C98, CP-C163, and CP-C172 had a powder resistivity of 5,000 Ω·cm.

In addition, oxygen-deficient tin oxide-coated barium sulfate particles used in the preparation of the conductive-layer coating solutions CP-C24, CP-C33, CP-C65, CP-C99, CP-C164, CP-C173, and CP-C179 had a powder resistivity of 5,000 Ω·cm.

In addition, Sb-doped tin oxide-coated titanium oxide particles used in the preparation of the conductive-layer coating solutions CP-C25, CP-C34, CP-C66, CP-C100, CP-C165, and CP-C174 had a powder resistivity of 3,000 Ω·cm.

In addition, oxygen-deficient tin oxide particles used in the preparation of the conductive-layer coating solutions CP-C26, CP-C33, CP-C67, CP-C101, CP-C166, CP-C175, and CP-C179 had a powder resistivity of 200 Ω·cm.

In addition, indium tin oxide particles used in the preparation of the conductive-layer coating solutions CP-C27, CP-C68, CP-C102, CP-C167, and CP-C176 had a powder resistivity of 100 Ω·cm.

In addition, Sb-doped tin oxide particles used in the preparation of the conductive-layer coating solutions CP-C28, CP-C34, CP-C69, CP-C103, CP-C168, and CP-C177 had a powder resistivity of 100 Ω·cm.

(Preparation Example of Conductive-Layer Coating Solution CP-C36)

The intermediate-layer coating liquid of Example 1 described in Patent Literature 4 was prepared by the following operations and defined as a conductive-layer coating solution CP-C36.

That is, 20 parts of barium sulfate particles coated with oxygen-deficient tin oxide (coating ratio: 50% by mass, average primary particle diameter: 600 nm, specific gravity: 5.1 (density=5.1 g/cm³)), 100 parts of a tin oxide particle doped with antimony (trade name: T-1, manufactured by Mitsubishi Materials Corporation, average primary particle diameter: 20 nm, powder resistivity: 5 Ω·cm, specific gravity: 6.6 (density=6.6 g/cm³)), 70 parts of a resol-type phenol resin (trade name: PLYOPHEN J-325, manufactured by DIC Corporation, resin solid content: 60%) as a binding material, and 100 parts of 2-methoxy-1-propanol were loaded into a ball mill, and were then subjected to a dispersion treatment for 20 hours to prepare a conductive-layer coating solution CP-C36.

(Preparation Example of Conductive-Layer Coating Solution CP-C37)

A conductive-layer coating solution CP-C37 was prepared by the same operations as those of the preparation example of the conductive-layer coating solution CP-C36 except that the tin oxide particle doped with antimony were changed to a tin oxide particle doped with tantalum (average primary particle diameter: 20 nm, specific gravity: 6.1 (density=6.1 g/cm³)).

(Preparation Example of Conductive-Layer Coating Solution CP-C38)

The conductive layer coating fluid L-7 described in Patent Literature 2 was prepared by the following operations and defined as a conductive-layer coating solution CP-C38.

That is, 46 parts of P-doped tin oxide-coated titanium oxide particles (average primary particle diameter: 220 nm, powder resistivity: 100 Ω·cm, amount (doping ratio) of phosphorus doped into tin oxide: 7% by mass, coating ratio: 15%), 36.5 parts of a phenol resin (trade name: PLYOPHEN J-325, manufactured by DIC Corporation, resin solid content: 60% by mass) as a binding material, and 50 parts of 1-methoxy-2-propanol as a solvent were loaded into a sand mill using glass beads each having a diameter of 0.5 mm, and were then subjected to a dispersion treatment under the following dispersion treatment conditions to provide a dispersion solution: a disc rotation number of 2,500 rpm and a dispersion treatment time of 3.5 hours.

3.9 Parts of silicone resin particles (trade name: TOSPEARL 120, manufactured by Momentive Performance Materials Inc., average particle diameter: 2 μm) as a surface roughness providing material and 0.001 part of a silicone oil (trade name: SH28PA, manufactured by Dow Corning Toray Silicone Co., Ltd.) as a leveling agent were added to the dispersion solution, and then the mixture was stirred to prepare a conductive-layer coating solution CP-C38.

(Preparation Example of Conductive-Layer Coating Solution CP-C39)

The conductive layer coating fluid L-21 described in Patent Literature 2 was prepared by the following operations and defined as a conductive-layer coating solution CP-C39.

That is, 44 parts of P-doped tin oxide-coated titanium oxide particles (average primary particle diameter: 40 nm, powder resistivity: 500 Ω·cm, amount (doping ratio) of phosphorus doped into tin oxide: 8% by mass, coating ratio: 20%), 36.5 parts of a phenol resin (trade name: PLYOPHEN J-325, manufactured by DIC Corporation, resin solid content: 60% by mass) as a binding material, and 50 parts of 1-methoxy-2-propanol as a solvent were loaded into a sand mill using glass beads each having a diameter of 0.5 mm, and were then subjected to a dispersion treatment under the following dispersion treatment conditions to provide a dispersion solution: a disc rotation number of 2,500 rpm and a dispersion treatment time of 3.5 hours.

3.9 Parts of silicone resin particles (trade name: TOSPEARL 120, manufactured by Momentive Performance Materials Inc., average particle diameter: 2 μm) as a surface roughness providing material and 0.001 part of a silicone oil (trade name: SH28PA, manufactured by Dow Corning Toray Silicone Co., Ltd.) as a leveling agent were added to the dispersion solution, and then the mixture was stirred to prepare a conductive-layer coating solution CP-C39.

(Preparation Example of Conductive-Layer Coating Solution CP-C40)

The conductive layer coating fluid 1 described in Patent Literature 1 was prepared by the following operations and defined as a conductive-layer coating solution CP-C40.

That is, 204 parts of P-doped tin oxide-coated titanium oxide particles (powder resistivity: 40 Ω·cm, coating ratio: 35% by mass, amount (doping ratio) of phosphorus doped into tin oxide: 3% by mass), 148 parts of a phenol resin (trade name: PLYOPHEN J-325, manufactured by DIC Corporation, resin solid content: 60% by mass) as a binding material, and 98 parts of 1-methoxy-2-propanol as a solvent were loaded into a sand mill using 450 parts of glass beads each having a diameter of 0.8 mm, and were then subjected to a dispersion treatment under the following dispersion treatment conditions to provide a dispersion solution: a number of rotation of 2,000 rpm, a dispersion treatment time of 4 hours, and a setting temperature of cooling water of 18° C.

The glass beads were removed from the dispersion solution with a mesh. After that, 13.8 parts of silicone resin particles (trade name: TOSPEARL 120, manufactured by Momentive Performance Materials Inc., average particle diameter: 2 μm) as a surface roughness providing material, 0.014 part of a silicone oil (trade name: SH28PA, manufactured by Dow Corning Toray Silicone Co., Ltd.) as a leveling agent, 6 parts of methanol, and 6 parts of 1-methoxy-2-propanol were added to the dispersion solution, and then the mixture was stirred to prepare a conductive-layer coating solution CP-C40.

(Preparation Example of Conductive-Layer Coating Solution CP-C41)

The conductive layer coating fluid 4 described in Patent Literature 1 was prepared by the following operations and defined as a conductive-layer coating solution CP-C41.

That is, 204 parts of P-doped tin oxide-coated titanium oxide particles (powder resistivity: 500 Ω·cm, coating ratio: 35% by mass, amount (doping ratio) of phosphorus (P) doped into tin oxide (SnO₂): 0.05% by mass), 148 parts of a phenol resin (trade name: PLYOPHEN J-325, manufactured by DIC Corporation, resin solid content: 60% by mass) as a binding material, and 98 parts of 1-methoxy-2-propanol as a solvent were loaded into a sand mill using 450 parts of glass beads each having a diameter of 0.8 mm, and were then subjected to a dispersion treatment under the following dispersion treatment conditions to provide a dispersion solution: a number of rotation of 2,000 rpm, a dispersion treatment time of 4 hours, and a setting temperature of cooling water of 18° C.

The glass beads were removed from the dispersion solution with a mesh. After that, 13.8 parts of silicone resin particles (trade name: TOSPEARL 120, manufactured by Momentive Performance Materials Inc., average particle diameter: 2 μm) as a surface roughness providing material, 0.014 part of a silicone oil (trade name: SH28PA, manufactured by Dow Corning Toray Silicone Co., Ltd.) as a leveling agent, 6 parts of methanol, and 6 parts of 1-methoxy-2-propanol were added to the dispersion solution, and then the mixture was stirred to prepare a conductive-layer coating solution CP-C41.

(Preparation Example of Conductive-Layer Coating Solution CP-C72)

The conductive layer coating fluid L-10 described in Patent Literature 2 was prepared by the following operations and defined as a conductive-layer coating solution CP-C72.

That is, 53 parts of W-doped tin oxide-coated titanium oxide particles (average primary particle diameter: 220 nm, powder resistivity: 150 Ω·cm, amount (doping ratio) of tungsten doped into tin oxide: 7% by mass, coating ratio: 15%), 36.5 parts of a phenol resin (trade name: PLYOPHEN J-325, manufactured by DIC Corporation, resin solid content: 60% by mass) as a binding material, and 50 parts of 1-methoxy-2-propanol as a solvent were loaded into a sand mill using glass beads each having a diameter of 0.5 mm, and were then subjected to a dispersion treatment under the following dispersion treatment conditions to provide a dispersion solution: a disc rotation number of 2,500 rpm and a dispersion treatment time of 3.5 hours.

The glass beads were removed from the dispersion solution with a mesh. After that, 3.9 parts of silicone resin particles (trade name: TOSPEARL 120, manufactured by Momentive Performance Materials Inc., average particle diameter: 2 μm) as a surface roughness providing material and 0.001 part of a silicone oil (trade name: SH28PA, manufactured by Dow Corning Toray Silicone Co., Ltd.) as a leveling agent were added to the dispersion solution, and then the mixture was stirred to prepare a conductive-layer coating solution CP-C72.

(Preparation Example of Conductive-Layer Coating Solution CP-C73)

The conductive layer coating fluid L-22 described in Patent Literature 2 was prepared by the following operations and defined as a conductive-layer coating solution CP-C73.

That is, 46 parts of W-doped tin oxide-coated titanium oxide particles (average primary particle diameter: 40 nm, powder resistivity: 550 Ω·cm, amount (doping ratio) of tungsten doped into tin oxide: 8% by mass, coating ratio: 20%), 36.5 parts of a phenol resin (trade name: PLYOPHEN J-325, manufactured by DIC Corporation, resin solid content: 60% by mass) as a binding material, and 50 parts of 1-methoxy-2-propanol as a solvent were loaded into a sand mill using glass beads each having a diameter of 0.5 mm, and were then subjected to a dispersion treatment under the following dispersion treatment conditions to provide a dispersion solution: a disc rotation number of 2,500 rpm and a dispersion treatment time of 3.5 hours.

3.9 Parts of silicone resin particles (trade name: TOSPEARL 120, manufactured by Momentive Performance Materials Inc., average particle diameter: 2 μm) as a surface roughness providing material and 0.001 part of a silicone oil (trade name: SH28PA, manufactured by Dow Corning Toray Silicone Co., Ltd.) as a leveling agent were added to the dispersion solution, and then the mixture was stirred to prepare the conductive layer coating fluid L-22 described in Patent Literature 2. The coating solution was defined as the conductive-layer coating solution CP-C73.

(Preparation Example of Conductive-Layer Coating Solution CP-C74)

The conductive layer coating fluid 10 described in Patent Literature 1 was prepared by the following operations and defined as a conductive-layer coating solution CP-C74.

That is, 204 parts of W-doped tin oxide-coated titanium oxide particles (powder resistivity: 25 Ω·cm, coating ratio: 33% by mass, amount (doping ratio) of tungsten doped into tin oxide: 3% by mass), 148 parts of a phenol resin (trade name: PLYOPHEN J-325, manufactured by DIC Corporation, resin solid content: 60% by mass) as a binding material, and 98 parts of 1-methoxy-2-propanol as a solvent were loaded into a sand mill using 450 parts of glass beads each having a diameter of 0.8 mm, and were then subjected to a dispersion treatment under the following dispersion treatment conditions to provide a dispersion solution: a number of rotation of 2,000 rpm, a dispersion treatment time of 4 hours, and a setting temperature of cooling water of 18° C.

The glass beads were removed from the dispersion solution with a mesh. After that, 13.8 parts of silicone resin particles (trade name: TOSPEARL 120, manufactured by Momentive Performance Materials Inc., average particle diameter: 2 μm) as a surface roughness providing material, 0.014 part of a silicone oil (trade name: SH28PA, manufactured by Dow Corning Toray Silicone Co., Ltd.) as a leveling agent, 6 parts of methanol, and 6 parts of 1-methoxy-2-propanol were added to the dispersion solution, and then the mixture was stirred to prepare a conductive-layer coating solution CP-C74.

(Preparation Example of Conductive-Layer Coating Solution CP-C75)

The conductive layer coating fluid 13 described in Patent Literature 1 was prepared by the following operations and defined as a conductive-layer coating solution CP-C75.

That is, 204 parts of W-doped tin oxide-coated titanium oxide particles (powder resistivity: 69 Ω·cm, coating ratio: 33% by mass, amount (doping ratio) of tungsten doped into tin oxide: 0.1% by mass), 148 parts of a phenol resin (trade name: PLYOPHEN J-325, manufactured by DIC Corporation, resin solid content: 60% by mass) as a binding material, and 98 parts of 1-methoxy-2-propanol as a solvent were loaded into a sand mill using 450 parts of glass beads each having a diameter of 0.8 mm, and were then subjected to a dispersion treatment under the following dispersion treatment conditions to provide a dispersion solution: a number of rotation of 2,000 rpm, a dispersion treatment time of 4 hours, and a setting temperature of cooling water of 18° C.

The glass beads were removed from the dispersion solution with a mesh. After that, 13.8 parts of silicone resin particles (trade name: TOSPEARL 120, manufactured by Momentive Performance Materials Inc., average particle diameter: 2 um) as a surface roughness providing material, 0.014 part of a silicone oil (trade name: SH28PA, manufactured by Dow Corning Toray Silicone Co., Ltd.) as a leveling agent, 6 parts of methanol, and 6 parts of 1-methoxy-2-propanol were added to the dispersion solution, and then the mixture was stirred to prepare a conductive-layer coating solution CP-C75.

(Preparation Example of Conductive-Layer Coating Solution CP-C106)

The conductive layer coating fluid L-30 described in Patent Literature 2 was prepared by the following operations and defined as a conductive-layer coating solution CP-C106.

That is, 60 parts of F-doped tin oxide-coated titanium oxide particles (average primary particle diameter: 75 nm, powder resistivity: 300 Ω·cm, amount (doping ratio) of fluorine doped into tin oxide: 7% by mass, coating ratio: 15%), 36.5 parts of a phenol resin (trade name: PLYOPHEN J-325, manufactured by DIC Corporation, resin solid content: 60% by mass) as a binding material, and 50 parts of 1-methoxy-2-propanol as a solvent were loaded into a sand mill using glass beads each having a diameter of 0.5 mm, and were then subjected to a dispersion treatment under the following dispersion treatment conditions to provide a dispersion solution: a disc rotation number of 2,500 rpm and a dispersion treatment time of 3.5 hours.

The glass beads were removed from the dispersion solution with a mesh. After that, 3.9 parts of silicone resin particles (trade name: TOSPEARL 120, manufactured by Momentive Performance Materials Inc., average particle diameter: 2 μm) as a surface roughness providing material and 0.001 part of a silicone oil (trade name: SH28PA, manufactured by Dow Corning Toray Silicone Co., Ltd.) as a leveling agent were added to the dispersion solution, and then the mixture was stirred to prepare a conductive-layer coating solution CP-C106.

TABLE 1

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-1 | P-doped | 45 | 4.50 | 5.1 | 112.00 | P-doped | 3.60 | 6.8 | 3.00 | 1.3 | 266.67 | 1.3 | 5.00 | None |
| CP-2 | tin | 45 | 4.50 | 5.1 | 112.00 | tin oxide | 4.05 | 6.7 | 2.95 | 1.3 | 266.75 | 1.3 | 5.00 | |
| CP-3 | oxide- | 45 | 4.50 | 5.1 | 112.00 | particles | 4.50 | 6.7 | 2.95 | 1.3 | 266.75 | 1.3 | 5.00 | |
| CP-4 | coated | 45 | 4.50 | 5.1 | 112.00 | (average | 4.95 | 6.7 | 2.95 | 1.3 | 266.75 | 1.3 | 5.00 | |
| CP-5 | titanium | 45 | 4.50 | 5.1 | 112.00 | particle | 5.40 | 6.7 | 2.95 | 1.3 | 266.75 | 1.3 | 5.00 | |
| CP-6 | oxide | 45 | 4.50 | 5.1 | 108.50 | diameter: | 4.50 | 6.7 | 7.15 | 1.3 | 265.58 | 1.3 | 5.00 | |
| CP-7 | particles | 45 | 4.50 | 5.1 | 99.80 | 20 nm | 3.60 | 6.8 | 17.30 | 1.3 | 263.17 | 1.3 | 5.00 | |
| CP-8 | (average | 45 | 4.50 | 5.1 | 99.90 | | 4.05 | 6.7 | 17.06 | 1.3 | 263.40 | 1.3 | 5.00 | |
| CP-9 | particle | 45 | 4.50 | 5.1 | 99.90 | | 4.50 | 6.7 | 17.06 | 1.3 | 263.40 | 1.3 | 5.00 | |
| CP-10 | diameter: | 45 | 4.50 | 5.1 | 99.90 | | 4.95 | 6.7 | 17.06 | 1.3 | 263.40 | 1.3 | 5.00 | |
| CP-11 | 230 nm) | 45 | 4.50 | 5.1 | 99.90 | | 5.40 | 6.7 | 17.06 | 1.3 | 263.40 | 1.3 | 5.00 | |
| CP-12 | | 45 | 4.50 | 5.1 | 93.50 | | 4.50 | 6.7 | 24.60 | 1.3 | 261.50 | 1.3 | 5.00 | |
| CP-13 | | 45 | 4.50 | 5.1 | 89.30 | | 3.60 | 6.8 | 29.80 | 1.3 | 259.83 | 1.3 | 5.00 | |
| CP-14 | | 45 | 4.50 | 5.1 | 89.40 | | 4.05 | 6.7 | 29.40 | 1.3 | 260.33 | 1.3 | 5.00 | |
| CP-15 | | 45 | 4.50 | 5.1 | 89.40 | | 4.50 | 6.7 | 29.40 | 1.3 | 260.33 | 1.3 | 5.00 | |
| CP-16 | | 45 | 4.50 | 5.1 | 89.40 | | 4.95 | 6.7 | 29.40 | 1.3 | 260.33 | 1.3 | 5.00 | |
| CP-17 | | 45 | 4.50 | 5.1 | 89.40 | | 5.40 | 6.7 | 29.40 | 1.3 | 260.33 | 1.3 | 5.00 | |
| CP-18 | | 45 | 4.50 | 5.1 | 135.50 | | 4.50 | 6.7 | 3.00 | 1.3 | 226.50 | 1.3 | 5.00 | |
| CP-19 | | 45 | 4.50 | 5.1 | 131.00 | | 3.60 | 6.8 | 8.75 | 1.3 | 225.42 | 1.3 | 5.00 | |
| CP-20 | | 45 | 4.50 | 5.1 | 131.10 | | 4.05 | 6.7 | 8.65 | 1.3 | 225.42 | 1.3 | 5.00 | |
| CP-21 | | 45 | 4.50 | 5.1 | 131.10 | | 4.50 | 6.7 | 8.65 | 1.3 | 225.42 | 1.3 | 5.00 | |
| CP-22 | | 45 | 4.50 | 5.1 | 131.10 | | 4.95 | 6.7 | 8.65 | 1.3 | 225.42 | 1.3 | 5.00 | |
| CP-23 | | 45 | 4.50 | 5.1 | 131.10 | | 5.40 | 6.7 | 8.65 | 1.3 | 225.42 | 1.3 | 5.00 | |
| CP-24 | | 45 | 4.50 | 5.1 | 120.50 | | 3.60 | 6.8 | 20.90 | 1.3 | 222.67 | 1.3 | 5.00 | |
| CP-25 | | 45 | 4.50 | 5.1 | 120.60 | | 4.05 | 6.7 | 20.60 | 1.3 | 223.00 | 1.3 | 5.00 | |
| CP-26 | | 45 | 4.50 | 5.1 | 120.60 | | 4.50 | 6.7 | 20.60 | 1.3 | 223.00 | 1.3 | 5.00 | |
| CP-27 | | 45 | 4.50 | 5.1 | 120.60 | | 4.95 | 6.7 | 20.60 | 1.3 | 223.00 | 1.3 | 5.00 | |
| CP-28 | | 45 | 4.50 | 5.1 | 120.60 | | 5.40 | 6.7 | 20.60 | 1.3 | 223.00 | 1.3 | 5.00 | |
| CP-29 | | 45 | 4.50 | 5.1 | 112.50 | | 3.60 | 6.8 | 30.00 | 1.3 | 220.83 | 1.3 | 5.00 | |
| CP-30 | | 45 | 4.50 | 5.1 | 112.60 | | 4.05 | 6.7 | 29.60 | 1.3 | 221.33 | 1.3 | 5.00 | |
| CP-31 | | 45 | 4.50 | 5.1 | 112.60 | | 4.50 | 6.7 | 29.60 | 1.3 | 221.33 | 1.3 | 5.00 | |
| CP-32 | | 45 | 4.50 | 5.1 | 112.60 | | 4.95 | 6.7 | 29.60 | 1.3 | 221.33 | 1.3 | 5.00 | |
| CP-33 | | 45 | 4.50 | 5.1 | 112.60 | | 5.40 | 6.7 | 29.60 | 1.3 | 221.33 | 1.3 | 5.00 | |
| CP-34 | | 45 | 4.50 | 5.1 | 107.60 | | 4.50 | 6.7 | 35.35 | 1.3 | 220.08 | 1.3 | 5.00 | |
| CP-35 | | 45 | 4.30 | 5.1 | 171.50 | | 3.60 | 6.8 | 4.60 | 1.3 | 164.83 | 1.3 | 5.00 | |
| CP-36 | | 45 | 4.50 | 5.1 | 171.50 | | 4.05 | 6.7 | 4.50 | 1.3 | 165.00 | 1.3 | 5.00 | |
| CP-37 | | 45 | 4.50 | 5.1 | 171.50 | | 4.50 | 6.7 | 4.50 | 1.3 | 165.00 | 1.3 | 5.00 | |
| CP-38 | | 45 | 4.50 | 5.1 | 171.50 | | 4.95 | 6.7 | 4.50 | 1.3 | 165.00 | 1.3 | 5.00 | |
| CP-39 | | 45 | 4.50 | 5.1 | 171.50 | | 5.40 | 6.7 | 4.50 | 1.3 | 165.00 | 1.3 | 5.00 | |
| CP-40 | | 45 | 4.50 | 5.1 | 165.60 | | 3.60 | 6.8 | 11.05 | 1.3 | 163.92 | 1.3 | 5.00 | |

TABLE 2

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-41 | P-doped | 45 | 4.50 | 5.1 | 165.70 | P-doped | 4.05 | 6.7 | 10.90 | 1.3 | 164.00 | 1.3 | 5.00 | None |
| CP-42 | tin | 45 | 4.50 | 5.1 | 165.70 | tin oxide | 4.50 | 6.7 | 10.90 | 1.3 | 164.00 | 1.3 | 5.00 | |
| CP-43 | oxide- | 45 | 4.50 | 5.1 | 165.70 | particles | 4.95 | 6.7 | 10.90 | 1.3 | 164.00 | 1.3 | 5.00 | |
| CP-44 | coated | 45 | 4.50 | 5.1 | 165.70 | (average | 5.40 | 6.7 | 10.90 | 1.3 | 164.00 | 1.3 | 5.00 | |
| CP-45 | titanium | 45 | 4.50 | 5.1 | 151.80 | particle | 3.60 | 6.8 | 26.35 | 1.3 | 161.42 | 1.3 | 5.00 | |
| CP-46 | oxide | 45 | 4.50 | 5.1 | 151.95 | diameter: | 4.05 | 6.7 | 25.95 | 1.3 | 161.83 | 1.3 | 5.00 | |
| CP-47 | particles | 45 | 4.50 | 5.1 | 151.95 | 20 nm | 4.50 | 6.7 | 25.95 | 1.3 | 161.83 | 1.3 | 5.00 | |
| CP-48 | (average | 45 | 4.50 | 5.1 | 151.95 | | 4.95 | 6.7 | 25.95 | 1.3 | 161.83 | 1.3 | 5.00 | |
| CP-49 | particle | 45 | 4.50 | 5.1 | 151.95 | | 5.40 | 6.7 | 25.95 | 1.3 | 161.83 | 1.3 | 5.00 | |
| CP-50 | diameter: | 45 | 4.50 | 5.1 | 141.40 | | 3.60 | 6.8 | 37.70 | 1.3 | 159.83 | 1.3 | 5.00 | |
| CP-51 | 230 nm) | 45 | 4.50 | 5.1 | 141.70 | | 4.05 | 6.7 | 37.25 | 1.3 | 160.08 | 1.3 | 5.00 | |
| CP-52 | | 45 | 4.50 | 5.1 | 141.70 | | 4.50 | 6.7 | 37.25 | 1.3 | 160.08 | 1.3 | 5.00 | |
| CP-53 | | 45 | 4.50 | 5.1 | 141.70 | | 4.95 | 6.7 | 37.25 | 1.3 | 160.08 | 1.3 | 5.00 | |
| CP-54 | | 45 | 4.50 | 5.1 | 141.70 | | 5.40 | 6.7 | 37.25 | 1.3 | 160.08 | 1.3 | 5.00 | |
| CP-55 | | 45 | 4.50 | 5.1 | 134.80 | | 3.60 | 6.8 | 45.00 | 1.3 | 158.67 | 1.3 | 5.00 | |
| CP-56 | | 45 | 4.50 | 5.1 | 135.15 | | 4.05 | 6.7 | 44.40 | 1.3 | 159.08 | 1.3 | 5.00 | |
| CP-57 | | 45 | 4.50 | 5.1 | 135.15 | | 4.50 | 6.7 | 44.40 | 1.3 | 159.08 | 1.3 | 5.00 | |
| CP-58 | | 45 | 4.50 | 5.1 | 135.15 | | 4.95 | 6.7 | 44.40 | 1.3 | 159.08 | 1.3 | 5.00 | |
| CP-59 | | 45 | 4.50 | 5.1 | 135.15 | | 5.40 | 6.7 | 44.40 | 1.3 | 159.08 | 1.3 | 5.00 | |
| CP-60 | | 45 | 4.50 | 5.1 | 197.70 | | 4.50 | 6.7 | 5.20 | 1.3 | 120.17 | 1.3 | 5.00 | |
| CP-61 | | 45 | 4.50 | 5.1 | 190.70 | | 3.60 | 6.8 | 12.75 | 1.3 | 119.25 | 1.3 | 5.00 | |
| CP-62 | | 45 | 4.50 | 5.1 | 190.85 | | 4.05 | 6.7 | 12.55 | 1.3 | 119.33 | 1.3 | 5.00 | |
| CP-63 | | 45 | 4.50 | 5.1 | 190.85 | | 4.50 | 6.7 | 12.55 | 1.3 | 119.33 | 1.3 | 5.00 | |
| CP-64 | | 45 | 4.50 | 5.1 | 190.85 | | 4.95 | 6.7 | 12.55 | 1.3 | 119.33 | 1.3 | 5.00 | |
| CP-65 | | 45 | 4.50 | 5.1 | 190.85 | | 5.40 | 6.7 | 12.55 | 1.3 | 119.33 | 1.3 | 5.00 | |
| CP-66 | | 45 | 4.50 | 5.1 | 174.40 | | 3.60 | 6.8 | 30.30 | 1.3 | 117.17 | 1.3 | 5.00 | |
| CP-67 | | 45 | 4.50 | 5.1 | 174.70 | | 4.05 | 6.7 | 29.90 | 1.3 | 117.33 | 1.3 | 5.00 | |
| CP-68 | | 45 | 4.50 | 5.1 | 174.70 | | 4.50 | 6.7 | 29.90 | 1.3 | 117.33 | 1.3 | 5.00 | |
| CP-69 | | 45 | 4.50 | 5.1 | 174.70 | | 4.95 | 6.7 | 29.90 | 1.3 | 117.33 | 1.3 | 5.00 | |
| CP-70 | | 45 | 4.50 | 5.1 | 174.70 | | 5.40 | 6.7 | 29.90 | 1.3 | 117.33 | 1.3 | 5.00 | |
| CP-71 | | 45 | 4.50 | 5.1 | 162.30 | | 3.60 | 6.8 | 43.30 | 1.3 | 115.67 | 1.3 | 5.00 | |
| CP-72 | | 45 | 4.50 | 5.1 | 162.70 | | 4.05 | 6.7 | 42.75 | 1.3 | 115.92 | 1.3 | 5.00 | |
| CP-73 | | 45 | 4.50 | 5.1 | 162.70 | | 4.50 | 6.7 | 42.75 | 1.3 | 115.92 | 1.3 | 5.00 | |
| CP-74 | | 45 | 4.50 | 5.1 | 162.70 | | 4.95 | 6.7 | 42.75 | 1.3 | 115.92 | 1.3 | 5.00 | |
| CP-75 | | 45 | 4.50 | 5.1 | 162.70 | | 5.40 | 6.7 | 42.75 | 1.3 | 115.92 | 1.3 | 5.00 | |
| CP-76 | | 45 | 4.50 | 5.1 | 155.05 | | 4.50 | 6.7 | 50.95 | 1.3 | 115.00 | 1.3 | 5.00 | |
| CP-77 | | 45 | 4.50 | 5.1 | 208.30 | | 3.60 | 6.8 | 5.60 | 1.3 | 101.83 | 1.3 | 5.00 | |
| CP-78 | | 45 | 4.50 | 5.1 | 208.25 | | 4.05 | 6.7 | 5.56 | 1.3 | 101.98 | 1.3 | 5.00 | |
| CP-79 | | 45 | 4.50 | 5.1 | 208.25 | | 4.50 | 6.7 | 5.56 | 1.3 | 101.98 | 1.3 | 5.00 | |
| CP-80 | | 45 | 4.50 | 5.1 | 208.25 | | 4.95 | 6.7 | 5.56 | 1.3 | 101.98 | 1.3 | 5.00 | |

TABLE 3

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |
| CP-81 | P-doped | 45 | 4.50 | 5.1 | 208.25 | P-doped | 5.40 | 6.7 | 5.56 | 1.3 | 101.98 | 1.3 | 5.00 | None | | |
| CP-82 | tin | 45 | 4.50 | 5.1 | 201.10 | tin oxide | 4.50 | 6.7 | 13.20 | 1.3 | 101.17 | 1.3 | 5.00 | | | |
| CP-83 | oxide- | 45 | 4.50 | 5.1 | 183.55 | particles | 3.60 | 6.8 | 31.90 | 1.3 | 99.25 | 1.3 | 5.00 | | | |
| CP-84 | coated | 45 | 4.50 | 5.1 | 183.90 | (average | 4.05 | 6.7 | 31.40 | 1.3 | 99.50 | 1.3 | 5.00 | | | |
| CP-85 | titanium | 45 | 4.50 | 5.1 | 183.90 | particle | 4.50 | 6.7 | 31.40 | 1.3 | 99.50 | 1.3 | 5.00 | | | |
| CP-86 | oxide | 45 | 4.50 | 5.1 | 183.90 | diameter: | 4.95 | 6.7 | 31.40 | 1.3 | 99.50 | 1.3 | 5.00 | | | |
| CP-87 | particles | 45 | 4.50 | 5.1 | 183.90 | 20 nm | 5.40 | 6.7 | 31.40 | 1.3 | 99.50 | 1.3 | 5.00 | | | |
| CP-88 | (average | 45 | 4.50 | 5.1 | 171.10 | | 4.50 | 6.7 | 45.00 | 1.3 | 98.17 | 1.3 | 5.00 | | | |
| CP-89 | particle | 45 | 4.50 | 5.1 | 162.50 | | 3.60 | 6.8 | 54.20 | 1.3 | 97.17 | 1.3 | 5.00 | | | |
| CP-90 | diameter: | 45 | 4.50 | 5.1 | 163.00 | | 4.05 | 6.7 | 53.55 | 1.3 | 97.42 | 1.3 | 5.00 | | | |
| CP-91 | 230 nm) | 45 | 4.50 | 5.1 | 163.00 | | 4.50 | 6.7 | 53.55 | 1.3 | 97.42 | 1.3 | 5.00 | | | |
| CP-92 | | 45 | 4.50 | 5.1 | 163.00 | | 4.95 | 6.7 | 53.55 | 1.3 | 97.42 | 1.3 | 5.00 | | | |
| CP-93 | | 45 | 4.50 | 5.1 | 163.00 | | 5.40 | 6.7 | 53.55 | 1.3 | 97.42 | 1.3 | 5.00 | | | |
| CP-94 | | 45 | 4.50 | 5.1 | 135.40 | | 3.60 | 6.8 | 9.05 | 1.3 | 159.25 | 1.3 | 40.00 | Uncoated | 4.2 | 30.00 |
| CP-95 | | 45 | 4.50 | 5.1 | 135.40 | | 4.05 | 6.7 | 8.90 | 1.3 | 159.50 | 1.3 | 40.00 | titanium | 4.2 | 30.00 |
| CP-96 | | 45 | 4.50 | 5.1 | 135.40 | | 4.50 | 6.7 | 8.90 | 1.3 | 159.50 | 1.3 | 40.00 | oxide | 4.2 | 30.00 |
| CP-97 | | 45 | 4.50 | 5.1 | 135.40 | | 4.95 | 6.7 | 8.90 | 1.3 | 159.50 | 1.3 | 40.00 | particles | 4.2 | 30.00 |
| CP-98 | | 45 | 4.50 | 5.1 | 135.40 | | 5.40 | 6.7 | 8.90 | 1.3 | 159.50 | 1.3 | 40.00 | (average | 4.2 | 30.00 |
| CP-99 | | 45 | 4.50 | 5.1 | 124.50 | | 3.60 | 6.8 | 21.60 | 1.3 | 156.50 | 1.3 | 40.00 | particle | 4.2 | 30.00 |
| CP-100 | | 45 | 4.50 | 5.1 | 124.50 | | 4.05 | 6.7 | 21.30 | 1.3 | 157.00 | 1.3 | 40.00 | diameter: | 4.2 | 30.00 |
| CP-101 | | 45 | 4.50 | 5.1 | 124.50 | | 4.50 | 6.7 | 21.30 | 1.3 | 157.00 | 1.3 | 40.00 | 210 nm | 4.2 | 30.00 |
| CP-102 | | 45 | 4.50 | 5.1 | 124.50 | | 4.95 | 6.7 | 21.30 | 1.3 | 157.00 | 1.3 | 40.00 | | 4.2 | 30.00 |
| CP-103 | | 45 | 4.50 | 5.1 | 124.50 | | 5.40 | 6.7 | 21.30 | 1.3 | 157.00 | 1.3 | 40.00 | | 4.2 | 30.00 |
| CP-104 | | 45 | 4.50 | 5.1 | 116.20 | | 3.60 | 6.8 | 31.00 | 1.3 | 154.67 | 1.3 | 40.00 | | 4.2 | 30.00 |
| CP-105 | | 45 | 4.50 | 5.1 | 116.40 | | 4.05 | 6.7 | 30.60 | 1.3 | 155.00 | 1.3 | 40.00 | | 4.2 | 30.00 |
| CP-106 | | 45 | 4.50 | 5.1 | 116.40 | | 4.50 | 6.7 | 30.60 | 1.3 | 155.00 | 1.3 | 40.00 | | 4.2 | 30.00 |
| CP-107 | | 45 | 4.50 | 5.1 | 116.40 | | 4.95 | 6.7 | 30.60 | 1.3 | 155.00 | 1.3 | 40.00 | | 4.2 | 30.00 |
| CP-108 | | 45 | 4.50 | 5.1 | 116.40 | | 5.40 | 6.7 | 30.60 | 1.3 | 155.00 | 1.3 | 40.00 | | 4.2 | 30.00 |
| CP-109 | | 45 | 4.50 | 5.1 | 171.10 | | 3.60 | 6.8 | 11.40 | 1.3 | 95.83 | 1.3 | 40.00 | | 4.2 | 30.00 |
| CP-110 | | 45 | 4.50 | 5.1 | 171.20 | | 4.05 | 6.7 | 11.25 | 1.3 | 95.92 | 1.3 | 40.00 | | 4.2 | 30.00 |
| CP-111 | | 45 | 4.50 | 5.1 | 171.20 | | 4.50 | 6.7 | 11.25 | 1.3 | 95.92 | 1.3 | 40.00 | | 4.2 | 30.00 |
| CP-112 | | 45 | 4.50 | 5.1 | 171.20 | | 4.95 | 6.7 | 11.25 | 1.3 | 95.92 | 1.3 | 40.00 | | 4.2 | 30.00 |
| CP-113 | | 45 | 4.50 | 5.1 | 171.20 | | 5.40 | 6.7 | 11.25 | 1.3 | 95.92 | 1.3 | 40.00 | | 4.2 | 30.00 |
| CP-114 | | 45 | 4.50 | 5.1 | 156.80 | | 3.60 | 6.8 | 27.20 | 1.3 | 93.33 | 1.3 | 40.00 | | 4.2 | 30.00 |
| CP-115 | | 45 | 4.50 | 5.1 | 157.00 | | 4.05 | 6.7 | 26.85 | 1.3 | 93.58 | 1.3 | 40.00 | | 4.2 | 30.00 |
| CP-116 | | 45 | 4.50 | 5.1 | 157.00 | | 4.50 | 6.7 | 26.85 | 1.3 | 93.58 | 1.3 | 40.00 | | 4.2 | 30.00 |
| CP-117 | | 45 | 4.50 | 5.1 | 157.00 | | 4.95 | 6.7 | 26.85 | 1.3 | 93.58 | 1.3 | 40.00 | | 4.2 | 30.00 |
| CP-118 | | 45 | 4.50 | 5.1 | 157.00 | | 5.40 | 6.7 | 26.85 | 1.3 | 93.58 | 1.3 | 40.00 | | 4.2 | 30.00 |
| CP-119 | | 45 | 4.50 | 5.1 | 146.10 | | 3.60 | 6.8 | 39.00 | 1.3 | 91.50 | 1.3 | 40.00 | | 4.2 | 30.00 |
| CP-120 | | 45 | 4.50 | 5.1 | 146.40 | | 4.05 | 6.7 | 38.50 | 1.3 | 91.83 | 1.3 | 40.00 | | 4.2 | 30.00 |

TABLE 4

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |
| CP-121 | P-doped | 45 | 4.50 | 5.1 | 146.40 | P-doped | 4.50 | 6.7 | 38.50 | 1.3 | 91.83 | 1.3 | 40.00 | Uncoated | 4.2 | 30.00 |
| CP-122 | tin | 45 | 4.50 | 5.1 | 146.40 | tin oxide | 4.95 | 6.7 | 38.50 | 1.3 | 91.83 | 1.3 | 40.00 | titanium | 4.2 | 30.00 |
| CP-123 | oxide- | 45 | 4.50 | 5.1 | 146.40 | particles | 5.40 | 6.7 | 38.50 | 1.3 | 91.83 | 1.3 | 40.00 | oxide | 4.2 | 30.00 |
| CP-124 | coated | 45 | 4.50 | 5.1 | 197.05 | (average | 3.60 | 6.8 | 13.15 | 1.3 | 49.67 | 1.3 | 40.00 | particles | 4.2 | 30.00 |
| CP-125 | titanium | 45 | 4.50 | 5.1 | 197.20 | particle | 4.05 | 6.7 | 13.00 | 1.3 | 49.67 | 1.3 | 40.00 | (average | 4.2 | 30.00 |
| CP-126 | oxide | 45 | 4.50 | 5.1 | 197.20 | diameter: | 4.50 | 6.7 | 13.00 | 1.3 | 49.67 | 1.3 | 40.00 | particle | 4.2 | 30.00 |
| CP-127 | particles | 45 | 4.50 | 5.1 | 197.20 | 20 nm | 4.95 | 6.7 | 13.00 | 1.3 | 49.67 | 1.3 | 40.00 | diameter: | 4.2 | 30.00 |
| CP-128 | (average | 45 | 4.50 | 5.1 | 197.20 | | 5.40 | 6.7 | 13.00 | 1.3 | 49.67 | 1.3 | 40.00 | 210 nm | 4.2 | 30.00 |
| CP-129 | particle | 45 | 4.50 | 5.1 | 180.20 | | 3.60 | 6.8 | 31.30 | 1.3 | 47.50 | 1.3 | 40.00 | | 4.2 | 30.00 |
| CP-130 | diameter: | 45 | 4.50 | 5.1 | 180.50 | | 4.05 | 6.7 | 30.85 | 1.3 | 47.75 | 1.3 | 40.00 | | 4.2 | 30.00 |
| CP-131 | 230 nm) | 45 | 4.50 | 5.1 | 180.50 | | 4.50 | 6.7 | 30.85 | 1.3 | 47.75 | 1.3 | 40.00 | | 4.2 | 30.00 |
| CP-132 | | 45 | 4.50 | 5.1 | 180.50 | | 4.95 | 6.7 | 30.85 | 1.3 | 47.75 | 1.3 | 40.00 | | 4.2 | 30.00 |
| CP-133 | | 45 | 4.50 | 5.1 | 180.50 | | 5.40 | 6.7 | 30.85 | 1.3 | 47.75 | 1.3 | 40.00 | | 4.2 | 30.00 |
| CP-134 | | 45 | 4.50 | 5.1 | 167.65 | | 3.60 | 6.8 | 44.75 | 1.3 | 46.00 | 1.3 | 40.00 | | 4.2 | 30.00 |
| CP-135 | | 45 | 4.50 | 5.1 | 168.05 | | 4.05 | 6.7 | 44.16 | 1.3 | 46.32 | 1.3 | 40.00 | | 4.2 | 30.00 |
| CP-136 | | 45 | 4.50 | 5.1 | 168.05 | | 4.50 | 6.7 | 44.16 | 1.3 | 46.32 | 1.3 | 40.00 | | 4.2 | 30.00 |
| CP-137 | | 45 | 4.50 | 5.1 | 168.05 | | 4.95 | 6.7 | 44.16 | 1.3 | 46.32 | 1.3 | 40.00 | | 4.2 | 30.00 |
| CP-138 | | 45 | 4.50 | 5.1 | 168.05 | | 5.40 | 6.7 | 44.16 | 1.3 | 46.32 | 1.3 | 40.00 | | 4.2 | 30.00 |
| CP-139 | | 45 | 4.50 | 5.1 | 157.00 | | 4.50 | 6.7 | 26.85 | 1.3 | 93.58 | 1.3 | 40.00 | | 4.2 | 30.00 |
| CP-140 | | 45 | 4.50 | 5.1 | 161.00 | | 4.50 | 6.7 | 22.85 | 1.3 | 93.58 | 1.3 | 40.00 | | 4.2 | 30.00 |

TABLE 5

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| CP-C1 | P-doped tin | 45 | 4.50 | 5.1 | 114.60 | None | | | | 1.3 | 267.33 | 1.3 | 5.00 | None |
|---|---|---|---|---|---|---|---|---|---|---|---|---|---|---|
| CP-C2 | oxide-coated | 45 | 4.50 | 5.1 | 175.60 | | | | | 1.3 | 165.67 | 1.3 | 5.00 | |
| CP-C3 | titanium | 45 | 4.50 | 5.1 | 213.50 | | | | | 1.3 | 102.50 | 1.3 | 5.00 | |
| CP-C4 | oxide | 45 | 4.50 | 5.1 | 113.25 | P-doped | 4.50 | 6.7 | 1.49 | 1.3 | 267.10 | 1.3 | 5.00 | |
| CP-C5 | particles | 45 | 4.50 | 5.1 | 173.50 | tin oxide | 4.50 | 6.7 | 2.27 | 1.3 | 165.38 | 1.3 | 5.00 | |
| CP-C6 | (average | 45 | 4.50 | 5.1 | 210.90 | particles | 4.50 | 6.7 | 2.80 | 1.3 | 102.17 | 1.3 | 5.00 | |
| CP-C7 | particle | 45 | 4.50 | 5.1 | 85.60 | (average | 4.50 | 6.7 | 33.75 | 1.3 | 259.42 | 1.3 | 5.00 | |
| CP-C8 | diameter: | 45 | 4.50 | 5.1 | 129.20 | particle | 4.50 | 6.7 | 50.95 | 1.3 | 158.08 | 1.3 | 5.00 | |
| CP-C9 | 230 nm) | 45 | 4.50 | 5.1 | 155.65 | diameter: | 4.50 | 6.7 | 61.35 | 1.3 | 96.67 | 1.3 | 5.00 | |
| CP-C10 | None | | | | | 20 nm | 4.50 | 6.7 | 133.40 | 1.3 | 236.00 | 1.3 | 5.00 | |
| CP-C11 | | | | | | | 4.50 | 6.7 | 192.80 | 1.3 | 137.00 | 1.3 | 5.00 | |
| CP-C12 | | | | | | | 4.50 | 6.7 | 226.40 | 1.3 | 81.00 | 1.3 | 5.00 | |
| CP-C13 | P-doped tin | 45 | 4.50 | 5.1 | 83.20 | | 4.50 | 6.7 | 2.20 | 1.3 | 316.00 | 1.3 | 5.00 | |
| CP-C14 | oxide-coated | 45 | 4.50 | 5.1 | 80.60 | | 4.50 | 6.7 | 5.30 | 1.3 | 315.17 | 1.3 | 5.00 | |
| CP-C15 | titanium | 45 | 4.50 | 5.1 | 74.50 | | 4.50 | 6.7 | 12.75 | 1.3 | 312.92 | 1.3 | 5.00 | |
| CP-C16 | oxide | 45 | 4.50 | 5.1 | 69.75 | | 4.50 | 6.7 | 18.35 | 1.3 | 311.50 | 1.3 | 5.00 | |
| CP-C17 | particles | 45 | 4.50 | 5.1 | 66.70 | | 4.50 | 6.7 | 21.92 | 1.3 | 310.63 | 1.3 | 5.00 | |
| CP-C18 | (average | 45 | 4.50 | 5.1 | 217.70 | | 4.50 | 6.7 | 5.75 | 1.3 | 85.92 | 1.3 | 5.00 | |
| CP-C19 | particle | 45 | 4.50 | 5.1 | 210.05 | | 4.50 | 6.7 | 13.80 | 1.3 | 85.25 | 1.3 | 5.00 | |
| CP-C20 | diameter: | 45 | 4.50 | 5.1 | 191.95 | | 4.50 | 6.7 | 32.80 | 1.3 | 83.75 | 1.3 | 5.00 | |
| CP-C21 | 230 nm) | 45 | 4.50 | 5.1 | 178.50 | | 4.50 | 6.7 | 46.95 | 1.3 | 82.58 | 1.3 | 5.00 | |
| CP-C22 | | 45 | 4.50 | 5.1 | 169.98 | | 4.50 | 6.7 | 55.85 | 1.3 | 81.95 | 1.3 | 5.00 | |

TABLE 6

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-C23 | Oxygen- | 45 | — | 5.1 | 152.00 | P-doped tin | 4.50 | 6.7 | 26.00 | 1.3 | 161.67 | 1.3 | 5.00 | None |
| | deficient tin | | | | | oxide | | | | | | | | |
| | oxide-coated | | | | | particles | | | | | | | | |
| | titanium oxide | | | | | (average | | | | | | | | |
| | particles | | | | | particle | | | | | | | | |
| | (average | | | | | diameter | | | | | | | | |
| | particle | | | | | 20 nm) | | | | | | | | |
| | diameter: | | | | | | | | | | | | | |
| | 230 nm) | | | | | | | | | | | | | |
| CP-C24 | Oxygen- | 45 | — | 5.1 | 152.00 | | 4.50 | 6.7 | 26.00 | 1.3 | 161.67 | 1.3 | 5.00 | |
| | deficient tin | | | | | | | | | | | | | |
| | oxide-coated | | | | | | | | | | | | | |
| | barium sulfate | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |
| CP-C25 | Sb-doped tin | 45 | 4.50 | 5.1 | 152.00 | | 4.50 | 6.7 | 26.00 | 1.3 | 161.67 | 1.3 | 5.00 | |
| | oxide-coated | | | | | | | | | | | | | |
| | titanium oxide | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |
| CP-C26 | P-doped tin | 45 | 4.50 | 5.1 | 152.20 | Oxygen- | — | 6.6 | 25.60 | 1.3 | 162.00 | 1.3 | 5.00 | |
| | oxide-coated | | | | | deficient | | | | | | | | |
| | titanium oxide | | | | | tin oxide | | | | | | | | |
| | particles | | | | | particles | | | | | | | | |
| | (average | | | | | (average | | | | | | | | |
| | particle | | | | | particle | | | | | | | | |
| | diameter: | | | | | diameter: | | | | | | | | |
| | 230 nm) | | | | | 20 nm) | | | | | | | | |
| CP-C27 | P-doped tin | 45 | 4.50 | 5.1 | 152.10 | Indium tin | 4.50 | 7.1 | 27.35 | 1.3 | 160.92 | 1.3 | 5.00 | |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| CP-C28 | 230 nm) | 45 | 4.50 | 5.1 | 152.20 | Sb-doped | 4.50 | 6.6 | 25.60 | 1.3 | 162.00 | 1.3 | 5.00 | |
| | | | | | | tin oxide | | | | | | | | |
| | | | | | | particles | | | | | | | | |
| | | | | | | (average | | | | | | | | |
| | | | | | | particle | | | | | | | | |
| | | | | | | diameter: | | | | | | | | |
| | | | | | | 20 nm) | | | | | | | | |
| CP-C29 | W-doped tin | 45 | 4.50 | 52 | 153.30 | P-doped tin | 4.50 | 6.7 | 25.70 | 1.3 | 160.00 | 1.3 | 5.00 | |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |

TABLE 7

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-C30 | F-doped tin | 45 | 4.50 | 5.0 | 150.60 | P-doped tin | 4.50 | 6.7 | 26.25 | 1.3 | 163.58 | 1.3 | 5.00 | None |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C31 | P-doped tin | 45 | 4.50 | 5.1 | 150.20 | W-doped tin | 4.50 | 7.5 | 28.80 | 1.3 | 160.00 | 1.3 | 5.00 | |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| CP-C32 | 230 nm) | 45 | 4.50 | 5.1 | 152.20 | F-doped tin | 4.50 | 6.6 | 25.60 | 1.3 | 162.00 | 1.3 | 5.00 | |
| | | | | | | oxide | | | | | | | | |
| | | | | | | particles | | | | | | | | |
| | | | | | | (average | | | | | | | | |
| | | | | | | particle | | | | | | | | |
| | | | | | | diameter: | | | | | | | | |
| | | | | | | 20 nm) | | | | | | | | |
| CP-C33 | Oxygen- | 45 | — | 5.1 | 152.20 | Oxygen- | — | 6.6 | 25.60 | 1.3 | 162.00 | 1.3 | 5.00 | |
| | deficient tin | | | | | deficient | | | | | | | | |
| | oxide-coated | | | | | tin oxide | | | | | | | | |
| | barium sulfate | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C34 | Sb-doped tin | 45 | 4.50 | 5.1 | 152.20 | Sb-doped | 4.50 | 6.6 | 25.60 | 1.3 | 162.00 | 1.3 | 5.00 | |
| | oxide-coated | | | | | tin oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C35 | P-doped tin | 45 | 4.50 | 5.1 | 151.90 | P-doped tin | 4.50 | 6.7 | 26.00 | 1.3 | 161.83 | 1.3 | 5.00 | |
| | oxide-coated | | | | | oxide | | | | | | | | |
| | barium sulfate | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |

TABLE 8

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-141 | W-doped | 45 | 4.50 | 5.2 | 113.20 | W-doped | 3.60 | 7.4 | 3.22 | 1.3 | 264.30 | 1.3 | 5.00 | None |
| CP-142 | tin | 45 | 4.50 | 5.2 | 113.20 | tin oxide | 4.05 | 7.5 | 3.26 | 1.3 | 264.23 | 1.3 | 5.00 | |
| CP-143 | oxide- | 45 | 4.50 | 5.2 | 113.20 | particles | 4.50 | 7.5 | 3.26 | 1.3 | 264.23 | 1.3 | 5.00 | |
| CP-144 | coated | 45 | 4.50 | 5.2 | 113.20 | (average | 4.95 | 7.6 | 3.31 | 1.3 | 264.15 | 1.3 | 5.00 | |
| CP-145 | titanium | 45 | 4.50 | 5.2 | 113.20 | particle | 5.40 | 7.6 | 3.31 | 1.3 | 264.15 | 1.3 | 5.00 | |
| CP-146 | oxide | 45 | 4.50 | 5.2 | 109.40 | diameter: | 4.50 | 7.5 | 7.90 | 1.3 | 262.83 | 1.3 | 5.00 | |
| CP-147 | particles | 45 | 4.50 | 5.2 | 100.50 | 20 nm | 3.60 | 7.4 | 18.60 | 1.3 | 259.83 | 1.3 | 5.00 | |
| CP-148 | (average | 45 | 4.50 | 5.2 | 100.50 | | 4.05 | 7.5 | 18.85 | 1.3 | 259.42 | 1.3 | 5.00 | |
| CP-149 | particle | 45 | 4.50 | 5.2 | 100.50 | | 4.50 | 7.5 | 18.85 | 1.3 | 259.42 | 1.3 | 5.00 | |
| CP-150 | diameter: | 45 | 4.50 | 5.2 | 100.40 | | 4.95 | 7.6 | 19.10 | 1.3 | 259.17 | 1.3 | 5.00 | |
| CP-151 | 230 nm) | 45 | 4.50 | 5.2 | 100.40 | | 5.40 | 7.6 | 19.10 | 1.3 | 259.17 | 1.3 | 5.00 | |
| CP-152 | | 45 | 4.50 | 5.2 | 93.70 | | 4.50 | 7.5 | 27.05 | 1.3 | 257.08 | 1.3 | 5.00 | |
| CP-153 | | 45 | 4.50 | 5.2 | 89.55 | | 3.60 | 7.4 | 31.86 | 1.3 | 255.98 | 1.3 | 5.00 | |
| CP-154 | | 45 | 4.50 | 5.2 | 89.48 | | 4.05 | 7.5 | 32.26 | 1.3 | 255.43 | 1.3 | 5.00 | |
| CP-155 | | 45 | 4.50 | 5.2 | 89.48 | | 4.50 | 7.5 | 32.26 | 1.3 | 255.43 | 1.3 | 5.00 | |
| CP-156 | | 45 | 4.50 | 5.2 | 89.30 | | 4.95 | 7.6 | 32.65 | 1.3 | 255.08 | 1.3 | 5.00 | |
| CP-157 | | 45 | 4.50 | 5.2 | 89.30 | | 5.40 | 7.6 | 32.65 | 1.3 | 255.08 | 1.3 | 5.00 | |
| CP-158 | | 45 | 4.50 | 5.2 | 136.65 | | 4.50 | 7.5 | 3.97 | 1.3 | 223.97 | 1.3 | 5.00 | |
| CP-159 | | 45 | 4.50 | 5.2 | 132.00 | | 3.60 | 7.4 | 9.40 | 1.3 | 222.67 | 1.3 | 5.00 | |
| CP-160 | | 45 | 4.50 | 5.2 | 132.00 | | 4.05 | 7.5 | 9.55 | 1.3 | 222.42 | 1.3 | 5.00 | |
| CP-161 | | 45 | 4.50 | 5.2 | 132.00 | | 4.50 | 7.5 | 9.55 | 1.3 | 222.42 | 1.3 | 5.00 | |
| CP-162 | | 45 | 4.50 | 5.2 | 131.90 | | 4.95 | 7.6 | 9.65 | 1.3 | 222.42 | 1.3 | 5.00 | |
| CP-163 | | 45 | 4.50 | 5.2 | 131.90 | | 5.40 | 7.6 | 9.65 | 1.3 | 222.42 | 1.3 | 5.00 | |
| CP-164 | | 45 | 4.50 | 5.2 | 121.00 | | 3.60 | 7.4 | 22.40 | 1.3 | 219.33 | 1.3 | 5.00 | |
| CP-165 | | 45 | 4.50 | 5.2 | 120.85 | | 4.05 | 7.5 | 22.67 | 1.3 | 219.13 | 1.3 | 5.00 | |
| CP-166 | | 45 | 4.50 | 5.2 | 120.85 | | 4.50 | 7.5 | 22.67 | 1.3 | 219.13 | 1.3 | 5.00 | |
| CP-167 | | 45 | 4.50 | 5.2 | 120.70 | | 4.95 | 7.6 | 22.95 | 1.3 | 218.92 | 1.3 | 5.00 | |
| CP-168 | | 45 | 4.50 | 5.2 | 120.70 | | 5.40 | 7.6 | 22.95 | 1.3 | 218.92 | 1.3 | 5.00 | |
| CP-169 | | 45 | 4.50 | 5.2 | 112.75 | | 3.60 | 7.4 | 32.10 | 1.3 | 216.92 | 1.3 | 5.00 | |
| CP-170 | | 45 | 4.50 | 5.2 | 112.55 | | 4.05 | 7.5 | 32.50 | 1.3 | 216.58 | 1.3 | 5.00 | |
| CP-171 | | 45 | 4.50 | 5.2 | 112.55 | | 4.50 | 7.5 | 32.50 | 1.3 | 216.58 | 1.3 | 5.00 | |
| CP-172 | | 45 | 4.50 | 5.2 | 112.40 | | 4.95 | 7.6 | 32.85 | 1.3 | 216.25 | 1.3 | 5.00 | |
| CP-173 | | 45 | 4.50 | 5.2 | 112.40 | | 5.40 | 7.6 | 32.85 | 1.3 | 216.25 | 1.3 | 5.00 | |
| CP-174 | | 45 | 4.50 | 5.2 | 107.30 | | 4.50 | 7.5 | 38.70 | 1.3 | 215.00 | 1.3 | 5.00 | |
| CP-175 | | 45 | 4.50 | 5.2 | 172.50 | | 3.60 | 7.4 | 4.90 | 1.3 | 162.67 | 1.3 | 5.00 | |
| CP-176 | | 45 | 4.50 | 5.2 | 172.40 | | 4.05 | 7.5 | 5.00 | 1.3 | 162.67 | 1.3 | 5.00 | |
| CP-177 | | 45 | 4.50 | 5.2 | 172.40 | | 4.50 | 7.5 | 5.00 | 1.3 | 162.67 | 1.3 | 5.00 | |
| CP-178 | | 45 | 4.50 | 5.2 | 172.40 | | 4.95 | 7.6 | 5.05 | 1.3 | 162.58 | 1.3 | 5.00 | |
| CP-179 | | 45 | 4.50 | 5.2 | 172.40 | | 5.40 | 7.6 | 5.05 | 1.3 | 162.58 | 1.3 | 5.00 | |
| CP-180 | | 45 | 4.50 | 5.2 | 166.30 | | 3.60 | 7.4 | 11.05 | 1.3 | 161.42 | 1.3 | 5.00 | |

TABLE 9

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-181 | W-doped | 45 | 4.50 | 5.2 | 166.20 | W-doped | 4.05 | 7.5 | 12.00 | 1.3 | 161.33 | 1.3 | 5.00 | None |
| CP-182 | tin | 45 | 4.50 | 5.2 | 166.20 | tin oxide | 4.50 | 7.5 | 12.00 | 1.3 | 161.33 | 1.3 | 5.00 | |
| CP-183 | oxide- | 45 | 4.50 | 5.2 | 166.10 | particles | 4.95 | 7.6 | 12.15 | 1.3 | 161.25 | 1.3 | 5.00 | |
| CP-184 | coated | 45 | 4.50 | 5.2 | 166.10 | (average | 5.40 | 7.6 | 12.15 | 1.3 | 161.25 | 1.3 | 5.00 | |
| CP-185 | titanium | 45 | 4.50 | 5.2 | 151.80 | particle | 3.60 | 7.4 | 28.15 | 1.3 | 158.42 | 1.3 | 5.00 | |
| CP-186 | oxide | 45 | 4.50 | 5.2 | 151.60 | diameter: | 4.05 | 7.5 | 28.45 | 1.3 | 158.25 | 1.3 | 5.00 | |
| CP-187 | particles | 45 | 4.50 | 5.2 | 151.60 | 20 nm | 4.50 | 7.5 | 28.45 | 1.3 | 158.25 | 1.3 | 5.00 | |
| CP-188 | (average | 45 | 4.50 | 5.2 | 151.45 | | 4.95 | 7.6 | 28.80 | 1.3 | 157.92 | 1.3 | 5.00 | |
| CP-189 | particle | 45 | 4.50 | 5.2 | 151.45 | | 5.40 | 7.6 | 28.80 | 1.3 | 157.92 | 1.3 | 5.00 | |
| CP-190 | diameter: | 45 | 4.50 | 5.2 | 141.10 | | 3.60 | 7.4 | 40.20 | 1.3 | 156.17 | 1.3 | 5.00 | |
| CP-191 | 230 nm) | 45 | 4.50 | 5.2 | 140.85 | | 4.05 | 7.5 | 40.65 | 1.3 | 155.83 | 1.3 | 5.00 | |
| CP-192 | | 45 | 4.50 | 5.2 | 140.85 | | 4.50 | 7.5 | 40.65 | 1.3 | 155.83 | 1.3 | 5.00 | |
| CP-193 | | 45 | 4.50 | 5.2 | 140.55 | | 4.95 | 7.6 | 41.10 | 1.3 | 155.58 | 1.3 | 5.00 | |
| CP-194 | | 45 | 4.50 | 5.2 | 140.55 | | 5.40 | 7.6 | 41.10 | 1.3 | 155.58 | 1.3 | 5.00 | |
| CP-195 | | 45 | 4.50 | 5.2 | 134.30 | | 3.60 | 7.4 | 47.80 | 1.3 | 154.83 | 1.3 | 5.00 | |
| CP-196 | | 45 | 4.50 | 5.2 | 134.05 | | 4.05 | 7.5 | 48.35 | 1.3 | 154.33 | 1.3 | 5.00 | |
| CP-197 | | 45 | 4.50 | 5.2 | 134.05 | | 4.50 | 7.5 | 48.35 | 1.3 | 154.33 | 1.3 | 5.00 | |
| CP-198 | | 45 | 4.50 | 5.2 | 133.70 | | 4.95 | 7.6 | 48.90 | 1.3 | 154.00 | 1.3 | 5.00 | |
| CP-199 | | 45 | 4.50 | 5.2 | 133.70 | | 5.40 | 7.6 | 48.90 | 1.3 | 154.00 | 1.3 | 5.00 | |
| CP-200 | | 45 | 4.50 | 5.2 | 198.40 | | 4.50 | 7.5 | 5.75 | 1.3 | 118.08 | 1.3 | 5.00 | |
| CP-201 | | 45 | 4.50 | 5.2 | 191.15 | | 3.60 | 7.4 | 13.60 | 1.3 | 117.08 | 1.3 | 5.00 | |
| CP-202 | | 45 | 4.50 | 5.2 | 191.00 | | 4.05 | 7.5 | 13.80 | 1.3 | 117.00 | 1.3 | 5.00 | |
| CP-203 | | 45 | 4.50 | 5.2 | 191.00 | | 4.50 | 7.5 | 13.80 | 1.3 | 117.00 | 1.3 | 5.00 | |
| CP-204 | | 45 | 4.50 | 5.2 | 190.90 | | 4.95 | 7.6 | 13.95 | 1.3 | 116.92 | 1.3 | 5.00 | |
| CP-205 | | 45 | 4.50 | 5.2 | 190.90 | | 5.40 | 7.6 | 13.95 | 1.3 | 116.92 | 1.3 | 5.00 | |
| CP-206 | | 45 | 4.50 | 5.2 | 174.10 | | 3.60 | 7.4 | 32.20 | 1.3 | 114.50 | 1.3 | 5.00 | |
| CP-207 | | 45 | 4.50 | 5.2 | 173.76 | | 4.05 | 7.5 | 32.60 | 1.3 | 114.50 | 1.3 | 5.00 | |
| CP-208 | | 45 | 4.50 | 5.2 | 173.76 | | 4.50 | 7.5 | 32.60 | 1.3 | 114.50 | 1.3 | 5.00 | |
| CP-209 | | 45 | 4.50 | 5.2 | 173.50 | | 4.95 | 7.6 | 33.00 | 1.3 | 114.17 | 1.3 | 5.00 | |
| CP-210 | | 45 | 4.50 | 5.2 | 173.50 | | 5.40 | 7.6 | 33.00 | 1.3 | 114.17 | 1.3 | 5.00 | |
| CP-211 | | 45 | 4.50 | 5.2 | 161.45 | | 3.60 | 7.4 | 45.95 | 1.3 | 112.67 | 1.3 | 5.00 | |
| CP-212 | | 45 | 4.50 | 5.2 | 161.05 | | 4.05 | 7.5 | 46.50 | 1.3 | 112.42 | 1.3 | 5.00 | |
| CP-213 | | 45 | 4.50 | 5.2 | 161.05 | | 4.50 | 7.5 | 46.50 | 1.3 | 112.42 | 1.3 | 5.00 | |
| CP-214 | | 45 | 4.50 | 5.2 | 160.70 | | 4.95 | 7.6 | 47.00 | 1.3 | 112.17 | 1.3 | 5.00 | |
| CP-215 | | 45 | 4.30 | 5.2 | 160.70 | | 5.40 | 7.6 | 47.00 | 1.3 | 112.17 | 1.3 | 5.00 | |
| CP-216 | | 45 | 4.50 | 5.2 | 153.10 | | 4.50 | 7.5 | 55.20 | 1.3 | 111.17 | 1.3 | 5.00 | |
| CP-217 | | 45 | 4.50 | 5.2 | 208.90 | | 3.60 | 7.4 | 6.00 | 1.3 | 100.17 | 1.3 | 5.00 | |
| CP-218 | | 45 | 4.50 | 5.2 | 208.85 | | 4.05 | 7.5 | 6.07 | 1.3 | 100.13 | 1.3 | 5.00 | |
| CP-219 | | 45 | 4.50 | 5.2 | 208.85 | | 4.50 | 7.5 | 6.07 | 1.3 | 100.13 | 1.3 | 5.00 | |
| CP-220 | | 45 | 4.50 | 5.2 | 208.85 | | 4.95 | 7.6 | 6.10 | 1.3 | 100.08 | 1.3 | 5.00 | |

TABLE 10

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-221 | W-doped | 45 | 4.50 | 5.2 | 208.85 | W-doped | 5.40 | 7.6 | 6.10 | 1.3 | 100.08 | 1.3 | 5.00 | None |
| CP-222 | tin | 45 | 4.50 | 5.2 | 201.00 | tin oxide | 4.50 | 7.5 | 14.50 | 1.3 | 99.17 | 1.3 | 5.00 | |
| CP-223 | oxide- | 45 | 4.50 | 5.2 | 183.00 | particles | 3.60 | 7.4 | 33.85 | 1.3 | 96.92 | 1.3 | 5.00 | |
| CP-224 | coated | 45 | 4.50 | 5.2 | 182.65 | (average | 4.05 | 7.5 | 34.30 | 1.3 | 96.75 | 1.3 | 5.00 | |
| CP-225 | titanium | 45 | 4.50 | 5.2 | 182.65 | particle | 4.50 | 7.5 | 34.30 | 1.3 | 96.75 | 1.3 | 5.00 | |
| CP-226 | oxide | 45 | 4.50 | 5.2 | 182.35 | diameter: | 4.95 | 7.6 | 34.70 | 1.3 | 96.58 | 1.3 | 5.00 | |
| CP-227 | particles | 45 | 4.50 | 5.2 | 182.35 | 20 nm | 5.40 | 7.6 | 34.70 | 1.3 | 96.58 | 1.3 | 5.00 | |
| CP-228 | (average | 45 | 4.50 | 5.2 | 169.20 | | 4.50 | 7.5 | 48.80 | 1.3 | 95.00 | 1.3 | 5.00 | |
| CP-229 | particle | 45 | 4.50 | 5.2 | 161.10 | | 3.60 | 7.4 | 57.35 | 1.3 | 94.25 | 1.3 | 5.00 | |
| CP-230 | diameter: | 45 | 4.50 | 5.2 | 160.67 | | 4.05 | 7.5 | 57.95 | 1.3 | 93.97 | 1.3 | 5.00 | |
| CP-231 | 230 nm) | 45 | 4.50 | 5.2 | 160.67 | | 4.50 | 7.5 | 57.95 | 1.3 | 93.97 | 1.3 | 5.00 | |
| CP-232 | | 45 | 4.50 | 5.2 | 160.25 | | 4.95 | 7.6 | 58.55 | 1.3 | 93.67 | 1.3 | 5.00 | |
| CP-233 | | 45 | 4.50 | 5.2 | 160.25 | | 5.40 | 7.6 | 58.55 | 1.3 | 93.67 | 1.3 | 5.00 | |

TABLE 11

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |
| CP-234 | W-doped | 45 | 4.50 | 5.2 | 136.40 | W-doped | 3.60 | 7.4 | 9.72 | 1.3 | 156.47 | 1.3 | 40.00 | Uncoated | 4.2 | 30.00 |
| CP-235 | tin | 45 | 4.50 | 5.2 | 136.40 | tin oxide | 4.05 | 7.5 | 9.85 | 1.3 | 156.25 | 1.3 | 40.00 | titanium | 4.2 | 30.00 |
| CP-236 | oxide- | 45 | 4.50 | 5.2 | 136.40 | particles | 4.50 | 7.5 | 9.85 | 1.3 | 156.25 | 1.3 | 40.00 | oxide | 4.2 | 30.00 |
| CP-237 | coated | 45 | 4.50 | 5.2 | 136.30 | (average | 4.95 | 7.6 | 9.98 | 1.3 | 156.20 | 1.3 | 40.00 | particles | 4.2 | 30.00 |
| CP-238 | titanium | 45 | 4.50 | 5.2 | 136.30 | particle | 5.40 | 7.6 | 9.98 | 1.3 | 156.20 | 1.3 | 40.00 | (average | 4.2 | 30.00 |
| CP-239 | oxide | 45 | 4.50 | 5.2 | 125.00 | diameter: | 3.60 | 7.4 | 23.15 | 1.3 | 153.08 | 1.3 | 40.00 | particles | 4.2 | 30.00 |
| CP-240 | particles | 45 | 4.50 | 5.2 | 124.90 | 20 nm | 4.05 | 7.5 | 23.44 | 1.3 | 152.77 | 1.3 | 40.00 | diameter | 4.2 | 30.00 |
| CP-241 | (average | 45 | 4.50 | 5.2 | 124.90 | | 4.50 | 7.5 | 23.44 | 1.3 | 152.77 | 1.3 | 40.00 | 210 nm) | 4.2 | 30.00 |
| CP-242 | particle | 45 | 4.50 | 5.2 | 124.70 | | 4.95 | 7.6 | 23.70 | 1.3 | 152.67 | 1.3 | 40.00 | | 4.2 | 30.00 |
| CP-243 | diameter: | 45 | 4.50 | 5.2 | 124.70 | | 5.40 | 7.6 | 23.70 | 1.3 | 152.67 | 1.3 | 40.00 | | 4.2 | 30.00 |
| CP-244 | 230 nm) | 45 | 4.50 | 5.2 | 116.50 | | 3.60 | 7.4 | 33.15 | 1.3 | 150.58 | 1.3 | 40.00 | | 4.2 | 30.00 |
| CP-245 | | 45 | 4.50 | 5.2 | 116.30 | | 4.05 | 7.5 | 33.55 | 1.3 | 150.25 | 1.3 | 40.00 | | 4.2 | 30.00 |
| CP-246 | | 45 | 4.50 | 5.2 | 116.30 | | 4.50 | 7.5 | 33.55 | 1.3 | 150.25 | 1.3 | 40.00 | | 4.2 | 30.00 |
| CP-247 | | 45 | 4.50 | 5.2 | 116.10 | | 4.95 | 7.6 | 33.95 | 1.3 | 149.92 | 1.3 | 40.00 | | 4.2 | 30.00 |
| CP-248 | | 45 | 4.50 | 5.2 | 116.10 | | 5.40 | 7.6 | 33.95 | 1.3 | 149.92 | 1.3 | 40.00 | | 4.2 | 30.00 |
| CP-249 | | 45 | 4.50 | 5.2 | 171.80 | | 3.60 | 7.4 | 12.25 | 1.3 | 93.25 | 1.3 | 40.00 | | 4.2 | 30.00 |
| CP-250 | | 45 | 4.50 | 5.2 | 171.70 | | 4.05 | 7.5 | 12.40 | 1.3 | 93.17 | 1.3 | 40.00 | | 4.2 | 30.00 |
| CP-251 | | 45 | 4.50 | 5.2 | 171.70 | | 4.50 | 7.5 | 12.40 | 1.3 | 93.17 | 1.3 | 40.00 | | 4.2 | 30.00 |
| CP-252 | | 45 | 4.50 | 5.2 | 171.65 | | 4.95 | 7.6 | 12.55 | 1.3 | 93.00 | 1.3 | 40.00 | | 4.2 | 30.00 |
| CP-253 | | 45 | 4.50 | 5.2 | 171.65 | | 5.40 | 7.6 | 12.55 | 1.3 | 9300 | 1.3 | 40.00 | | 4.2 | 30.00 |
| CP-254 | | 45 | 4.50 | 5.2 | 156.85 | | 3.60 | 7.4 | 29.05 | 1.3 | 90.17 | 1.3 | 40.00 | | 4.2 | 30.00 |
| CP-255 | | 45 | 4.50 | 5.2 | 156.65 | | 4.05 | 7.5 | 29.40 | 1.3 | 89.92 | 1.3 | 40.00 | | 4.2 | 30.00 |
| CP-256 | | 45 | 4.50 | 5.2 | 156.65 | | 4.50 | 7.5 | 29.40 | 1.3 | 89.92 | 1.3 | 40.00 | | 4.2 | 30.00 |
| CP-257 | | 45 | 4.50 | 5.2 | 156.45 | | 4.95 | 7.6 | 29.75 | 1.3 | 89.67 | 1.3 | 40.00 | | 4.2 | 30.00 |
| CP-258 | | 45 | 4.50 | 5.2 | 156.45 | | 5.40 | 7.6 | 29.75 | 1.3 | 89.67 | 1.3 | 40.00 | | 4.2 | 30.00 |
| CP-259 | | 45 | 4.50 | 5.2 | 145.80 | | 3.60 | 7.4 | 41.40 | 1.3 | 87.83 | 1.3 | 40.00 | | 4.2 | 30.00 |
| CP-260 | | 45 | 4.50 | 5.2 | 145.50 | | 4.05 | 7.5 | 42.00 | 1.3 | 87.50 | 1.3 | 40.00 | | 4.2 | 30.00 |
| CP-261 | | 45 | 4.50 | 5.2 | 145.50 | | 4.50 | 7.5 | 42.00 | 1.3 | 87.50 | 1.3 | 40.00 | | 4.2 | 30.00 |
| CP-262 | | 45 | 4.50 | 5.2 | 145.20 | | 4.95 | 7.6 | 42.45 | 1.3 | 87.25 | 1.3 | 40.00 | | 4.2 | 30.00 |
| CP-263 | | 45 | 4.50 | 5.2 | 145.20 | | 5.40 | 7.6 | 42.45 | 1.3 | 87.25 | 1.3 | 40.00 | | 4.2 | 30.00 |
| CP-264 | | 45 | 4.50 | 5.2 | 197.50 | | 3.60 | 7.4 | 14.10 | 1.3 | 47.33 | 1.3 | 40.00 | | 4.2 | 30.00 |
| CP-265 | | 45 | 4.50 | 5.2 | 197.35 | | 4.05 | 7.5 | 14.25 | 1.3 | 47.33 | 1.3 | 40.00 | | 4.2 | 30.00 |
| CP-266 | | 45 | 4.50 | 5.2 | 197.35 | | 4.50 | 7.5 | 14.25 | 1.3 | 47.33 | 1.3 | 40.00 | | 4.2 | 30.00 |
| CP-267 | | 45 | 4.50 | 5.2 | 197.20 | | 4.95 | 7.6 | 14.45 | 1.3 | 47.25 | 1.3 | 40.00 | | 4.2 | 30.00 |
| CP-268 | | 45 | 4.50 | 5.2 | 197.20 | | 5.40 | 7.6 | 14.45 | 1.3 | 47.25 | 1.3 | 40.00 | | 4.2 | 30.00 |
| CP-269 | | 45 | 4.50 | 5.2 | 179.80 | | 3.60 | 7.4 | 33.30 | 1.3 | 44.83 | 1.3 | 40.00 | | 4.2 | 30.00 |
| CP-270 | | 45 | 4.50 | 5.2 | 179.55 | | 4.05 | 7.5 | 33.70 | 1.3 | 44.58 | 1.3 | 40.00 | | 4.2 | 30.00 |

TABLE 12

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |
| CP-271 | W-doped | 45 | 4.50 | 5.2 | 179.55 | W-doped | 4.50 | 7.5 | 33.70 | 1.3 | 44.58 | 1.3 | 40.00 | Uncoated | 4.2 | 30.00 |
| CP-272 | tin | 45 | 4.50 | 5.2 | 179.30 | tin oxide | 4.95 | 7.6 | 34.10 | 1.3 | 44.33 | 1.3 | 40.00 | titanium | 4.2 | 30.00 |
| CP-273 | oxide- | 45 | 4.50 | 5.2 | 179.30 | particles | 5.40 | 7.6 | 34.10 | 1.3 | 44.33 | 1.3 | 40.00 | oxide | 4.2 | 30.00 |
| CP-274 | coated | 45 | 4.50 | 5.2 | 166.75 | (average | 3.60 | 7.4 | 47.50 | 1.3 | 42.92 | 1.3 | 40.00 | particles | 4.2 | 30.00 |
| CP-275 | titanium | 45 | 4.50 | 5.2 | 166.40 | particle | 4.05 | 7.5 | 48.00 | 1.3 | 42.67 | 1.3 | 40.00 | (average | 4.2 | 30.00 |
| CP-276 | oxide | 45 | 4.50 | 5.2 | 166.40 | diameter: | 4.50 | 7.5 | 48.00 | 1.3 | 42.67 | 1.3 | 40.00 | particles | 4.2 | 30.00 |
| CP-277 | particles | 45 | 4.50 | 5.2 | 166.05 | 20 nm | 4.95 | 7.6 | 48.55 | 1.3 | 42.33 | 1.3 | 40.00 | diameter | 4.2 | 30.00 |
| CP-278 | (average | 45 | 4.50 | 5.2 | 166.05 | | 5.40 | 7.6 | 48.55 | 1.3 | 42.33 | 1.3 | 40.00 | 210 nm) | 4.2 | 30.00 |
| CP-279 | particle | 45 | 4.50 | 5.2 | 156.65 | | 4.50 | 7.5 | 29.40 | 1.3 | 89.92 | 1.3 | 40.00 | | 4.2 | 30.00 |
| CP-280 | diameter: | 45 | 4.50 | 5.2 | 160.55 | | 4.50 | 7.5 | 25.50 | 1.3 | 89.92 | 1.3 | 40.00 | | 4.2 | 30.00 |
| | 230 nm) | | | | | | | | | | | | | | | |

TABLE 13

| | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| | | Coating | Doping | | | | Doping | | | | Amount [part(s)] (resin | | Amount | | | Amount |
| Conductive-layer | | ratio | ratio | | Amount | | ratio | | Amount | | solid content thereof is 60% | | [part | | | [part |
| coating solution | Kind | [%] | [%] | Density | [part(s)] | Kind | [%] | Density | [part(s)] | Density | by mass of the following) | Density | (s)] | Kind | Density | (s)] |

| CP-C42 | W-doped tin | 45 | 4.50 | 5.2 | 115.85 | None | | | | 1.3 | 265.25 | 1.3 | 5.00 | None |
|---|---|---|---|---|---|---|---|---|---|---|---|---|---|---|
| CP-C43 | oxide-coated | 45 | 4.50 | 5.2 | 176.85 | | | | | 1.3 | 163.58 | 1.3 | 5.00 | |
| CP-C44 | titanium | 45 | 4.50 | 5.2 | 214.46 | | | | | 1.3 | 100.90 | 1.3 | 5.00 | |
| CP-C45 | oxide | 45 | 4.50 | 5.2 | 114.50 | W-doped | 4.50 | 7.5 | 1.65 | 5.00 | 264.75 | 1.3 | 5.00 | |
| CP-C46 | particles | 45 | 4.50 | 5.2 | 174.62 | tin oxide | 4.50 | 7.5 | 2.51 | 1.3 | 163.12 | 1.3 | 5.00 | |
| CP-C47 | (average | 45 | 4.50 | 5.2 | 211.63 | particles | 4.50 | 7.5 | 3.05 | 1.3 | 100.53 | 1.3 | 5.00 | |
| CP-C48 | particle | 45 | 4.50 | 5.2 | 85.50 | (average | 4.50 | 7.5 | 37.00 | 1.3 | 254.17 | 1.3 | 5.00 | |
| CP-C49 | diameter: | 45 | 4.50 | 5.2 | 127.80 | particle | 4.50 | 7.5 | 55.30 | 1.3 | 153.17 | 1.3 | 5.00 | |
| CP-C50 | 230 nm) | 45 | 4.50 | 5.2 | 153.01 | diameter: | 4.50 | 7.5 | 66.21 | 1.3 | 92.97 | 1.3 | 5.00 | |
| CP-C51 | None | | | | | 20 nm | 4.50 | 7.5 | 141.25 | 1.3 | 222.92 | 1.3 | 5.00 | |
| CP-C52 | | | | | | | 4.50 | 7.5 | 199.36 | 1.3 | 126.07 | 1.3 | 5.00 | |
| CP-C53 | | | | | | | 4.50 | 7.5 | 231.05 | 1.3 | 73.25 | 1.3 | 5.00 | |
| CP-C54 | W-doped tin | 45 | 4.50 | 5.2 | 85.25 | | 4.50 | 7.5 | 2.43 | 1.3 | 313.87 | 1.3 | 5.00 | |
| CP-C55 | oxide-coated | 45 | 4.50 | 5.2 | 81.50 | | 4.50 | 7.5 | 5.88 | 1.3 | 312.70 | 1.3 | 5.00 | |
| CP-C56 | titanium | 45 | 4.50 | 5.2 | 75.05 | | 4.50 | 7.5 | 14.07 | 1.3 | 309.80 | 1.3 | 5.00 | |
| CP-C57 | oxide | 45 | 4.50 | 5.2 | 70.20 | | 4.50 | 7.5 | 20.25 | 1.3 | 307.58 | 1.3 | 5.00 | |
| CP-C58 | particles | 45 | 4.50 | 5.2 | 67.10 | | 4.50 | 7.5 | 24.19 | 1.3 | 306.18 | 1.3 | 5.00 | |
| CP-C59 | (average | 45 | 4.50 | 5.2 | 218.08 | | 4.50 | 7.5 | 6.30 | 1.3 | 84.37 | 1.3 | 5.00 | |
| CP-C60 | particle | 45 | 4.50 | 5.2 | 209.80 | | 4.50 | 7.5 | 15.12 | 1.3 | 83.47 | 1.3 | 5.00 | |
| CP-C61 | diameter: | 45 | 4.50 | 5.2 | 190.47 | | 4.50 | 7.5 | 35.72 | 1.3 | 81.35 | 1.3 | 5.00 | |
| CP-C62 | 230 nm) | 45 | 4.50 | 5.2 | 176.27 | | 4.50 | 7.5 | 50.85 | 1.3 | 79.80 | 1.3 | 5.00 | |
| CP-C63 | | 45 | 4.50 | 5.2 | 167.35 | | 4.50 | 7.5 | 60.35 | 1.3 | 78.83 | 1.3 | 5.00 | |

TABLE 14

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-C64 | Oxygen- | 45 | — | 5.1 | 150.26 | W-doped tin | 4.50 | 7.5 | 28.73 | 1.3 | 160.02 | 1.3 | 5.00 | None |
| | deficient tin | | | | | oxide | | | | | | | | |
| | oxide-coated | | | | | particles | | | | | | | | |
| | titanium oxide | | | | | (average | | | | | | | | |
| | particles | | | | | particle | | | | | | | | |
| | (average | | | | | diameter: | | | | | | | | |
| | particle | | | | | 20 nm) | | | | | | | | |
| | diameter: | | | | | | | | | | | | | |
| | 230 nm) | | | | | | | | | | | | | |
| CP-C65 | Oxygen- | 45 | — | 5.1 | 150.26 | | 4.50 | 7.5 | 28.73 | 1.3 | 160.02 | 1.3 | 5.00 | |
| | deficient tin | | | | | | | | | | | | | |
| | oxide-coated | | | | | | | | | | | | | |
| | barium sulfate | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |
| CP-C66 | Sb-doped tin | 45 | 4.50 | 5.2 | 151.61 | | 4.50 | 7.5 | 28.43 | 1.3 | 158.27 | 1.3 | 5.00 | |
| | oxide-coated | | | | | | | | | | | | | |
| | titanium oxide | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |
| CP-C67 | W-doped tin | 45 | 4.50 | 5.2 | 153.50 | Oxygen- | — | 6.6 | 25.32 | 1.3 | 160.30 | 1.3 | 5.00 | |
| | oxide-coated | | | | | deficient | | | | | | | | |
| | titanium oxide | | | | | tin oxide | | | | | | | | |
| | particles | | | | | particles | | | | | | | | |
| | (average | | | | | (average | | | | | | | | |
| | particle | | | | | particle | | | | | | | | |
| | diameter: | | | | | diameter: | | | | | | | | |
| | 230 nm) | | | | | 20 nm) | | | | | | | | |
| CP-C68 | W-doped tin | 45 | 4.50 | 5.2 | 152.45 | Indium tin | 4.50 | 7.1 | 27.05 | 1.3 | 159.17 | 1.3 | 5.00 | |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C69 | W-doped tin | 45 | 4.50 | 5.2 | 153.50 | Sb-doped | 4.50 | 6.6 | 25.32 | 1.3 | 160.30 | 1.3 | 5.00 | |
| | oxide-coated | | | | | tin oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C70 | F-doped tin | 45 | 4.50 | 5.0 | 148.90 | W-doped tin | 4.50 | 7.5 | 29.03 | 1.3 | 161.78 | 1.3 | 5.00 | |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C71 | W-doped tin | 45 | 4.50 | 5.2 | 151.61 | | 4.50 | 7.5 | 28.43 | 1.3 | 158.27 | 1.3 | 5.00 | |
| | oxide-coated | | | | | | | | | | | | | |
| | barium sulfate | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |

TABLE 15

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-281 | F-doped | 45 | 4.50 | 5.0 | 110.70 | F-doped | 3.60 | 6.7 | 2.97 | 1.3 | 268.88 | 1.3 | 5.00 | None |
| CP-282 | tin | 45 | 4.50 | 5.0 | 110.70 | tin oxide | 4.05 | 6.7 | 2.97 | 1.3 | 268.88 | 1.3 | 5.00 | |
| CP-283 | oxide- | 45 | 4.50 | 5.0 | 110.70 | particles | 4.50 | 6.6 | 2.93 | 1.3 | 268.95 | 1.3 | 5.00 | |
| CP-284 | coated | 45 | 4.50 | 5.0 | 110.70 | (average | 4.95 | 6.6 | 2.93 | 1.3 | 268.95 | 1.3 | 5.00 | |
| CP-285 | titanium | 45 | 4.50 | 5.0 | 110.70 | particle | 5.40 | 6.6 | 2.93 | 1.3 | 268.95 | 1.3 | 5.00 | |
| CP-286 | oxide | 45 | 4.50 | 5.0 | 107.15 | diameter: | 4.50 | 6.6 | 7.08 | 1.3 | 267.95 | 1.3 | 5.00 | |
| CP-287 | particles | 45 | 4.50 | 5.0 | 98.70 | 20 nm) | 3.60 | 6.7 | 17.20 | 1.3 | 265.17 | 1.3 | 5.00 | |
| CP-288 | (average | 45 | 4.50 | 5.0 | 98.70 | | 4.05 | 6.7 | 17.20 | 1.3 | 265.17 | 1.3 | 5.00 | |
| CP-289 | particle | 45 | 4.50 | 5.0 | 98.70 | | 4.50 | 6.6 | 16.95 | 1.3 | 265.58 | 1.3 | 5.00 | |
| CP-290 | diameter: | 45 | 4.50 | 5.0 | 98.70 | | 4.95 | 6.6 | 16.95 | 1.3 | 265.58 | 1.3 | 5.00 | |
| CP-291 | 230 nm) | 45 | 4.50 | 5.0 | 98.70 | | 5.40 | 6.6 | 16.95 | 1.3 | 265.58 | 1.3 | 5.00 | |
| CP-292 | | 45 | 4.50 | 5.0 | 92.40 | | 4.50 | 6.6 | 24.40 | 1.3 | 263.67 | 1.3 | 5.00 | |
| CP-293 | | 45 | 4.50 | 5.0 | 88.20 | | 3.60 | 6.7 | 29.55 | 1.3 | 262.08 | 1.3 | 5.00 | |
| CP-294 | | 45 | 4.50 | 5.0 | 88.20 | | 4.05 | 6.7 | 29.55 | 1.3 | 262.08 | 1.3 | 5.00 | |
| CP-295 | | 45 | 4.50 | 5.0 | 88.30 | | 4.50 | 6.6 | 29.15 | 1.3 | 262.58 | 1.3 | 5.00 | |
| CP-296 | | 45 | 4.50 | 5.0 | 88.30 | | 4.95 | 6.6 | 29.15 | 1.3 | 262.58 | 1.3 | 5.00 | |
| CP-297 | | 45 | 4.50 | 5.0 | 88.30 | | 5.40 | 6.6 | 29.15 | 1.3 | 262.58 | 1.3 | 5.00 | |
| CP-298 | | 45 | 4.50 | 5.0 | 134.20 | | 4.50 | 6.6 | 3.55 | 1.3 | 228.75 | 1.3 | 5.00 | |
| CP-299 | | 45 | 4.50 | 5.0 | 129.70 | | 3.60 | 6.7 | 8.70 | 1.3 | 227.67 | 1.3 | 5.00 | |
| CP-300 | | 45 | 4.50 | 5.0 | 129.70 | | 4.05 | 6.7 | 8.70 | 1.3 | 227.67 | 1.3 | 5.00 | |
| CP-301 | | 45 | 4.50 | 5.0 | 129.73 | | 4.50 | 6.6 | 8.57 | 1.3 | 227.83 | 1.3 | 5.00 | |
| CP-302 | | 45 | 4.50 | 5.0 | 129.73 | | 4.95 | 6.6 | 8.57 | 1.3 | 227.83 | 1.3 | 5.00 | |
| CP-303 | | 45 | 4.50 | 5.0 | 129.73 | | 5.40 | 6.6 | 8.57 | 1.3 | 227.83 | 1.3 | 5.00 | |
| CP-304 | | 45 | 4.50 | 5.0 | 119.20 | | 3.60 | 6.7 | 20.80 | 1.3 | 225.00 | 1.3 | 5.00 | |
| CP-305 | | 45 | 4.50 | 5.0 | 119.20 | | 4.05 | 6.7 | 20.80 | 1.3 | 225.00 | 1.3 | 5.00 | |
| CP-306 | | 45 | 4.50 | 5.0 | 119.30 | | 4.50 | 6.6 | 20.50 | 1.3 | 225.33 | 1.3 | 5.00 | |
| CP-307 | | 45 | 4.50 | 5.0 | 119.30 | | 4.95 | 6.6 | 20.50 | 1.3 | 225.33 | 1.3 | 5.00 | |
| CP-308 | | 45 | 4.50 | 5.0 | 119.30 | | 5.40 | 6.6 | 20.50 | 1.3 | 225.33 | 1.3 | 5.00 | |
| CP-309 | | 45 | 4.50 | 5.0 | 111.40 | | 3.60 | 6.7 | 29.85 | 1.3 | 222.92 | 1.3 | 5.00 | |
| CP-310 | | 45 | 4.50 | 5.0 | 111.40 | | 4.05 | 6.7 | 29.85 | 1.3 | 222.92 | 1.3 | 5.00 | |
| CP-311 | | 45 | 4.50 | 5.0 | 111.45 | | 4.50 | 6.6 | 29.45 | 1.3 | 223.50 | 1.3 | 5.00 | |
| CP-312 | | 45 | 4.50 | 5.0 | 111.45 | | 4.95 | 6.6 | 29.45 | 1.3 | 223.50 | 1.3 | 5.00 | |
| CP-313 | | 45 | 4.50 | 5.0 | 111.45 | | 5.40 | 6.6 | 29.45 | 1.3 | 223.50 | 1.3 | 5.00 | |
| CP-314 | | 45 | 4.50 | 5.0 | 106.50 | | 4.50 | 6.6 | 35.15 | 1.3 | 222.25 | 1.3 | 5.00 | |
| CP-315 | | 45 | 4.50 | 5.0 | 170.20 | | 3.60 | 6.7 | 4.57 | 1.3 | 167.05 | 1.3 | 5.00 | |
| CP-316 | | 45 | 4.50 | 5.0 | 170.20 | | 4.05 | 6.7 | 4.57 | 1.3 | 167.05 | 1.3 | 5.00 | |
| CP-317 | | 45 | 4.50 | 5.0 | 170.20 | | 4.50 | 6.6 | 4.50 | 1.3 | 167.17 | 1.3 | 5.00 | |
| CP-318 | | 45 | 4.50 | 5.0 | 170.20 | | 4.95 | 6.6 | 4.50 | 1.3 | 167.17 | 1.3 | 5.00 | |
| CP-319 | | 45 | 4.50 | 5.0 | 170.20 | | 5.40 | 6.6 | 4.50 | 1.3 | 167.17 | 1.3 | 5.00 | |
| CP-320 | | 45 | 4.50 | 5.0 | 164.30 | | 3.60 | 6.7 | 11.05 | 1.3 | 166.08 | 1.3 | 5.00 | |

TABLE 16

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-321 | F-doped | 45 | 4.50 | 5.0 | 164.30 | F-doped | 4.05 | 6.7 | 11.05 | 1.3 | 166.08 | 1.3 | 5.00 | None |
| CP-322 | tin | 45 | 4.50 | 5.0 | 164.45 | tin oxide | 4.50 | 6.7 | 10.86 | 1.3 | 166.15 | 1.3 | 5.00 | |
| CP-323 | oxide- | 45 | 4.50 | 5.0 | 164.45 | particles | 4.95 | 6.6 | 10.86 | 1.3 | 166.15 | 1.3 | 5.00 | |
| CP-324 | coated | 45 | 4.50 | 5.0 | 164.45 | (average | 5.40 | 6.6 | 10.86 | 1.3 | 166.15 | 1.3 | 5.00 | |
| CP-325 | titanium | 45 | 4.50 | 5.0 | 150.60 | particle | 3.60 | 6.7 | 26.25 | 1.3 | 163.58 | 1.3 | 5.00 | |
| CP-326 | oxide | 45 | 4.50 | 5.0 | 150.60 | diameter: | 4.05 | 6.7 | 26.25 | 1.3 | 163.58 | 1.3 | 5.00 | |
| CP-327 | particles | 45 | 4.50 | 5.0 | 150.80 | 20 nm) | 4.50 | 6.6 | 25.90 | 1.3 | 163.83 | 1.3 | 5.00 | |
| CP-328 | (average | 45 | 4.50 | 5.0 | 150.80 | | 4.95 | 6.6 | 25.90 | 1.3 | 163.83 | 1.3 | 5.00 | |
| CP-329 | particle | 45 | 4.50 | 5.0 | 150.80 | | 5.40 | 6.6 | 25.90 | 1.3 | 163.83 | 1.3 | 5.00 | |
| CP-330 | diameter: | 45 | 4.50 | 5.0 | 140.30 | | 3.60 | 6.7 | 37.60 | 1.3 | 161.83 | 1.3 | 5.00 | |
| CP-331 | 230 nm) | 45 | 4.50 | 5.0 | 140.30 | | 4.05 | 6.7 | 37.60 | 1.3 | 161.83 | 1.3 | 5.00 | |
| CP-332 | | 45 | 4.50 | 5.0 | 140.55 | | 4.50 | 6.6 | 37.15 | 1.3 | 162.17 | 1.3 | 5.00 | |
| CP-333 | | 45 | 4.50 | 5.0 | 140.55 | | 4.95 | 6.6 | 37.15 | 1.3 | 162.17 | 1.3 | 5.00 | |
| CP-334 | | 45 | 4.50 | 5.0 | 140.55 | | 5.40 | 6.6 | 37.15 | 1.3 | 162.17 | 1.3 | 5.00 | |
| CP-335 | | 45 | 4.50 | 5.0 | 133.80 | | 3.60 | 6.7 | 44.82 | 1.3 | 160.63 | 1.3 | 5.00 | |
| CP-336 | | 45 | 4.50 | 5.0 | 133.80 | | 4.05 | 6.7 | 44.82 | 1.3 | 160.63 | 1.3 | 5.00 | |
| CP-337 | | 45 | 4.50 | 5.0 | 134.10 | | 4.50 | 6.6 | 44.25 | 1.3 | 161.08 | 1.3 | 5.00 | |
| CP-338 | | 45 | 4.50 | 5.0 | 134.10 | | 4.95 | 6.6 | 44.25 | 1.3 | 161.08 | 1.3 | 5.00 | |
| CP-339 | | 45 | 4.50 | 5.0 | 134.10 | | 5.40 | 6.6 | 44.25 | 1.3 | 161.08 | 1.3 | 5.00 | |
| CP-340 | | 45 | 4.50 | 5.0 | 196.60 | | 4.50 | 6.6 | 5.19 | 1.3 | 122.02 | 1.3 | 5.00 | |
| CP-341 | | 45 | 4.50 | 5.0 | 189.70 | | 3.60 | 6.7 | 12.74 | 1.3 | 120.93 | 1.3 | 5.00 | |
| CP-342 | | 45 | 4.50 | 5.0 | 189.70 | | 4.05 | 6.7 | 12.74 | 1.3 | 120.93 | 1.3 | 5.00 | |
| CP-343 | | 45 | 4.50 | 5.0 | 189.75 | | 4.50 | 6.6 | 12.55 | 1.3 | 121.17 | 1.3 | 5.00 | |
| CP-344 | | 45 | 4.50 | 5.0 | 189.75 | | 4.95 | 6.6 | 12.55 | 1.3 | 121.17 | 1.3 | 5.00 | |
| CP-345 | | 45 | 4.50 | 5.0 | 189.75 | | 5.40 | 6.6 | 12.55 | 1.3 | 121.17 | 1.3 | 5.00 | |
| CP-346 | | 45 | 4.50 | 5.0 | 173.40 | | 3.60 | 6.7 | 30.20 | 1.3 | 119.00 | 1.3 | 5.00 | |
| CP-347 | | 45 | 4.50 | 5.0 | 173.40 | | 4.05 | 6.7 | 30.20 | 1.3 | 119.00 | 1.3 | 5.00 | |
| CP-348 | | 45 | 4.50 | 5.0 | 173.70 | | 4.50 | 6.6 | 29.80 | 1.3 | 119.17 | 1.3 | 5.00 | |
| CP-349 | | 45 | 4.50 | 5.0 | 173.70 | | 4.95 | 6.6 | 29.80 | 1.3 | 119.17 | 1.3 | 5.00 | |
| CP-350 | | 45 | 4.50 | 5.0 | 173.70 | | 5.40 | 6.6 | 29.80 | 1.3 | 119.17 | 1.3 | 5.00 | |
| CP-351 | | 45 | 4.50 | 5.0 | 161.30 | | 3.60 | 6.7 | 43.25 | 1.3 | 117.42 | 1.3 | 5.00 | |
| CP-352 | | 45 | 4.50 | 5.0 | 161.30 | | 4.05 | 6.7 | 43.25 | 1.3 | 117.42 | 1.3 | 5.00 | |
| CP-353 | | 45 | 4.50 | 5.0 | 161.70 | | 4.50 | 6.6 | 42.70 | 1.3 | 117.67 | 1.3 | 5.00 | |
| CP-354 | | 45 | 4.50 | 5.0 | 161.70 | | 4.95 | 6.6 | 42.70 | 1.3 | 117.67 | 1.3 | 5.00 | |
| CP-355 | | 45 | 4.50 | 5.0 | 161.70 | | 5.40 | 6.6 | 42.70 | 1.3 | 117.67 | 1.3 | 5.00 | |
| CP-356 | | 45 | 4.50 | 5.0 | 154.10 | | 4.50 | 6.6 | 50.85 | 1.3 | 116.75 | 1.3 | 5.00 | |
| CP-357 | | 45 | 4.50 | 5.0 | 204.30 | | 3.60 | 6.7 | 5.56 | 1.3 | 103.57 | 1.3 | 5.00 | |
| CP-358 | | 45 | 4.50 | 5.0 | 207.30 | | 4.05 | 6.7 | 5.56 | 1.3 | 103.57 | 1.3 | 5.00 | |
| CP-359 | | 45 | 4.50 | 5.0 | 207.35 | | 4.50 | 6.6 | 5.48 | 1.3 | 103.62 | 1.3 | 5.00 | |
| CP-360 | | 45 | 4.50 | 5.0 | 207.35 | | 4.95 | 6.6 | 5.48 | 1.3 | 103.62 | 1.3 | 5.00 | |

TABLE 17

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-361 | F-doped | 45 | 4.50 | 5.0 | 207.35 | F-doped | 5.40 | 6.6 | 5.48 |
| CP-362 | tin | 45 | 4.50 | 5.0 | 200.07 | tin oxide | 4.50 | 6.6 | 13.21 |
| CP-363 | oxide- | 45 | 4.50 | 5.0 | 182.62 | particles | 3.60 | 6.7 | 31.82 |
| CP-364 | coated | 45 | 4.50 | 5.0 | 182.62 | (average | 4.05 | 6.7 | 31.82 |
| CP-365 | titanium | 45 | 4.50 | 5.0 | 182.95 | particle | 4.50 | 6.6 | 31.40 |
| CP-366 | oxide | 45 | 4.50 | 5.0 | 182.95 | diameter: | 4.95 | 6.6 | 31.40 |
| CP-367 | particles | 45 | 4.50 | 5.0 | 182.95 | 20 nm) | 5.40 | 6.6 | 31.40 |
| CP-368 | (average | 45 | 4.50 | 5.0 | 170.15 | | 4.50 | 6.6 | 44.95 |
| CP-369 | particle | 45 | 4.50 | 5.0 | 161.65 | | 3.60 | 6.7 | 54.18 |
| CP-370 | diameter: | 45 | 4.50 | 5.0 | 161.65 | | 4.05 | 6.7 | 54.18 |
| CP-371 | 230 nm) | 45 | 4.50 | 5.0 | 162.10 | | 4.50 | 6.6 | 53.50 |
| CP-372 | | 45 | 4.50 | 5.0 | 162.10 | | 4.95 | 6.6 | 53.50 |
| CP-373 | | 45 | 4.50 | 5.0 | 162.10 | | 5.40 | 6.6 | 53.50 |

| | (3) Binding material (phenol resin) | | | | | | |
|---|---|---|---|---|---|---|---|
| Conductive- | | Amount [part(s)] | (4) Silicone resin | | (5) Particles except | | |
| layer | | (resin solid content | particles | | (1) to (4) | | |
| coating | | thereof is 60% by | | Amount | | | Amount |
| solution | Density | mass of the following) | Density | [part(s)] | Kind | Density | [part(s)] |

| | | | | | |
|---|---|---|---|---|---|
| CP-361 | 1.3 | 103.62 | 1.3 | 5.00 | None |
| CP-362 | 1.3 | 102.87 | 1.3 | 5.00 | |
| CP-363 | 1.3 | 100.93 | 1.3 | 5.00 | |
| CP-364 | 1.3 | 100.93 | 1.3 | 5.00 | |
| CP-365 | 1.3 | 101.08 | 1.3 | 5.00 | |
| CP-366 | 1.3 | 101.08 | 1.3 | 5.00 | |
| CP-367 | 1.3 | 101.08 | 1.3 | 5.00 | |
| CP-368 | 1.3 | 99.83 | 1.3 | 5.00 | |
| CP-369 | 1.3 | 98.62 | 1.3 | 5.00 | |
| CP-370 | 1.3 | 98.62 | 1.3 | 5.00 | |
| CP-371 | 1.3 | 99.00 | 1.3 | 5.00 | |
| CP-372 | 1.3 | 99.00 | 1.3 | 5.00 | |
| CP-373 | 1.3 | 99.00 | 1.3 | 5.00 | |

TABLE 18

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |
| CP-374 | F-doped | 45 | 4.50 | 5.0 | 134.00 | F-doped | 3.60 | 6.7 | 9.00 | 1.3 | 161.67 | 1.3 | 40.00 | Uncoated | 4.2 | 30.00 |
| CP-375 | tin | 45 | 4.50 | 5.0 | 134.00 | tin oxide | 4.05 | 6.7 | 9.00 | 1.3 | 161.67 | 1.3 | 40.00 | titanium | 4.2 | 30.00 |
| CP-376 | oxide- | 45 | 4.50 | 5.0 | 134.10 | particles | 4.50 | 6.6 | 8.85 | 1.3 | 161.75 | 1.3 | 40.00 | oxide | 4.2 | 30.00 |
| CP-377 | coated | 45 | 4.50 | 5.0 | 134.10 | (average | 4.95 | 6.6 | 8.85 | 1.3 | 161.75 | 1.3 | 40.00 | particles | 4.2 | 30.00 |
| CP-378 | titanium | 45 | 4.50 | 5.0 | 134.10 | particle | 5.40 | 6.6 | 8.85 | 1.3 | 161.75 | 1.3 | 40.00 | (average | 4.2 | 30.00 |
| CP-379 | oxide | 45 | 4.50 | 5.0 | 123.15 | diameter: | 3.60 | 6.7 | 21.45 | 1.3 | 159.00 | 1.3 | 40.00 | particle | 4.2 | 30.00 |
| CP-380 | particles | 45 | 4.50 | 5.0 | 123.15 | 20 nm) | 4.05 | 6.7 | 21.45 | 1.3 | 159.00 | 1.3 | 40.00 | diameter: | 4.2 | 30.00 |
| CP-381 | (average | 45 | 4.50 | 5.0 | 123.25 | | 4.50 | 6.6 | 21.15 | 1.3 | 159.33 | 1.3 | 40.00 | 210 nm) | 4.2 | 30.00 |
| CP-382 | particle | 45 | 4.50 | 5.0 | 123.25 | | 4.95 | 6.6 | 21.15 | 1.3 | 159.33 | 1.3 | 40.00 | | 4.2 | 30.00 |
| CP-383 | diameter: | 45 | 4.50 | 5.0 | 123.25 | | 5.40 | 6.6 | 21.15 | 1.3 | 159.33 | 1.3 | 40.00 | | 4.2 | 30.00 |
| CP-384 | 230 nm) | 45 | 4.50 | 5.0 | 115.00 | | 3.60 | 6.7 | 30.85 | 1.3 | 156.92 | 1.3 | 40.00 | | 4.2 | 30.00 |
| CP-385 | | 45 | 4.50 | 5.0 | 115.00 | | 4.05 | 6.7 | 30.85 | 1.3 | 156.92 | 1.3 | 40.00 | | 4.2 | 30.00 |
| CP-386 | | 45 | 4.50 | 5.0 | 115.20 | | 4.50 | 6.6 | 30.45 | 1.3 | 157.25 | 1.3 | 40.00 | | 4.2 | 30.00 |
| CP-387 | | 45 | 4.50 | 5.0 | 115.20 | | 4.95 | 6.6 | 30.45 | 1.3 | 157.25 | 1.3 | 40.00 | | 4.2 | 30.00 |
| CP-388 | | 45 | 4.50 | 5.0 | 115.20 | | 5.40 | 6.6 | 30.45 | 1.3 | 157.25 | 1.3 | 40.00 | | 4.2 | 30.00 |
| CP-389 | | 45 | 4.50 | 5.0 | 169.80 | | 3.60 | 6.7 | 11.40 | 1.3 | 98.00 | 1.3 | 40.00 | | 4.2 | 30.00 |
| CP-390 | | 45 | 4.50 | 5.0 | 169.80 | | 4.05 | 6.7 | 11.40 | 1.3 | 98.00 | 1.3 | 40.00 | | 4.2 | 30.00 |
| CP-391 | | 45 | 4.50 | 5.0 | 169.85 | | 4.50 | 6.6 | 11.25 | 1.3 | 98.17 | 1.3 | 40.00 | | 4.2 | 30.00 |
| CP-392 | | 45 | 4.50 | 5.0 | 169.85 | | 4.95 | 6.6 | 11.25 | 1.3 | 98.17 | 1.3 | 40.00 | | 4.2 | 30.00 |
| CP-393 | | 45 | 4.50 | 5.0 | 169.85 | | 5.40 | 6.6 | 11.25 | 1.3 | 98.17 | 1.3 | 40.00 | | 4.2 | 30.00 |
| CP-394 | | 45 | 4.50 | 5.0 | 155.60 | | 3.60 | 6.7 | 27.10 | 1.3 | 95.50 | 1.3 | 40.00 | | 4.2 | 30.00 |
| CP-395 | | 45 | 4.50 | 5.0 | 155.60 | | 4.05 | 6.7 | 27.10 | 1.3 | 95.50 | 1.3 | 40.00 | | 4.2 | 30.00 |
| CP-396 | | 45 | 4.50 | 5.0 | 155.75 | | 4.50 | 6.6 | 26.75 | 1.3 | 95.83 | 1.3 | 40.00 | | 4.2 | 30.00 |
| CP-397 | | 45 | 4.50 | 5.0 | 155.75 | | 4.95 | 6.6 | 26.75 | 1.3 | 95.83 | 1.3 | 40.00 | | 4.2 | 30.00 |
| CP-398 | | 45 | 4.50 | 5.0 | 155.75 | | 5.40 | 6.6 | 26.75 | 1.3 | 95.83 | 1.3 | 40.00 | | 4.2 | 30.00 |
| CP-399 | | 45 | 4.50 | 5.0 | 144.95 | | 3.60 | 6.7 | 38.85 | 1.3 | 93.67 | 1.3 | 40.00 | | 4.2 | 30.00 |
| CP-400 | | 45 | 4.50 | 5.0 | 144.95 | | 4.05 | 6.7 | 38.85 | 1.3 | 93.67 | 1.3 | 40.00 | | 4.2 | 30.00 |
| CP-401 | | 45 | 4.50 | 5.0 | 145.20 | | 4.50 | 6.6 | 38.85 | 1.3 | 94.08 | 1.3 | 40.00 | | 4.2 | 30.00 |
| CP-402 | | 45 | 4.50 | 5.0 | 145.20 | | 4.95 | 6.6 | 38.35 | 1.3 | 94.08 | 1.3 | 40.00 | | 4.2 | 30.00 |
| CP-403 | | 45 | 4.50 | 5.0 | 145.20 | | 5.40 | 6.6 | 38.35 | 1.3 | 94.08 | 1.3 | 40.00 | | 4.2 | 30.00 |
| CP-404 | | 45 | 4.50 | 5.0 | 195.90 | | 3.60 | 6.7 | 13.15 | 1.3 | 51.58 | 1.3 | 40.00 | | 4.2 | 30.00 |

TABLE 19

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-405 | F-doped | 45 | 4.50 | 5.0 | 195.90 | F-doped | 4.05 | 6.7 | 13.15 |
| CP-406 | tin | 45 | 4.50 | 5.0 | 196.10 | tin oxide | 4.50 | 6.6 | 12.95 |
| CP-407 | oxide- | 45 | 4.50 | 5.0 | 196.10 | particles | 4.95 | 6.6 | 12.95 |
| CP-408 | coated | 45 | 4.50 | 5.0 | 196.10 | (average | 5.40 | 6.6 | 12.95 |
| CP-409 | titanium | 45 | 4.50 | 5.0 | 179.15 | particle | 3.60 | 6.7 | 31.20 |
| CP-410 | oxide | 45 | 4.50 | 5.0 | 179.15 | diameter: | 4.05 | 6.7 | 31.20 |
| CP-411 | particles | 45 | 4.50 | 5.0 | 179.45 | 20 nm) | 4.50 | 6.6 | 30.80 |
| CP-412 | (average | 45 | 4.50 | 5.0 | 179.45 | | 4.95 | 6.6 | 30.80 |
| CP-413 | particle | 45 | 4.50 | 5.0 | 179.45 | | 5.40 | 6.6 | 30.80 |
| CP-414 | diameter: | 45 | 4.50 | 5.0 | 166.60 | | 3.60 | 6.7 | 44.70 |
| CP-415 | 230 nm) | 45 | 4.50 | 5.0 | 166.60 | | 4.05 | 6.7 | 44.70 |
| CP-416 | | 45 | 4.50 | 5.0 | 167.05 | | 4.50 | 6.6 | 44.10 |
| CP-417 | | 45 | 4.50 | 5.0 | 167.05 | | 4.95 | 6.6 | 44.10 |
| CP-418 | | 45 | 4.50 | 5.0 | 167.05 | | 5.40 | 6.6 | 44.10 |
| CP-419 | | 45 | 4.50 | 5.0 | 155.75 | | 4.50 | 6.6 | 26.75 |
| CP-420 | | 45 | 4.50 | 5.0 | 159.00 | | 4.50 | 6.6 | 23.20 |

| | (3) Binding material | | | | | | |
|---|---|---|---|---|---|---|---|
| | (phenol resin) | | | | | | |
| Conductive- | | Amount [part(s)] | (4) Silicone resin | | (5) Particles except | | |
| layer | | (resin solid content | particles | | (1) to (4) | | |
| coating | | thereof is 60% by mass | | Amount | | | Amount |
| solution | Density | of the following) | Density | [part(s)] | Kind | Density | [part(s)] |
| CP-405 | 1.3 | 51.58 | 1.3 | 40.00 | Uncoated | 4.2 | 30.00 |
| CP-406 | 1.3 | 51.58 | 1.3 | 40.00 | titanium | 4.2 | 30.00 |
| CP-407 | 1.3 | 51.58 | 1.3 | 40.00 | oxide | 4.2 | 30.00 |
| CP-408 | 1.3 | 51.58 | 1.3 | 40.00 | particles | 4.2 | 30.00 |
| CP-409 | 1.3 | 49.42 | 1.3 | 40.00 | (average | 4.2 | 30.00 |
| CP-410 | 1.3 | 49.42 | 1.3 | 40.00 | particle | 4.2 | 30.00 |
| CP-411 | 1.3 | 49.58 | 1.3 | 40.00 | diameter: | 4.2 | 30.00 |
| CP-412 | 1.3 | 49.58 | 1.3 | 40.00 | 210 nm) | 4.2 | 30.00 |
| CP-413 | 1.3 | 49.58 | 1.3 | 40.00 | | 4.2 | 30.00 |
| CP-414 | 1.3 | 47.83 | 1.3 | 40.00 | | 4.2 | 30.00 |
| CP-415 | 1.3 | 47.83 | 1.3 | 40.00 | | 4.2 | 30.00 |
| CP-416 | 1.3 | 48.08 | 1.3 | 40.00 | | 4.2 | 30.00 |
| CP-417 | 1.3 | 48.08 | 1.3 | 40.00 | | 4.2 | 30.00 |
| CP-418 | 1.3 | 48.08 | 1.3 | 40.00 | | 4.2 | 30.00 |
| CP-419 | 1.3 | 95.83 | 1.3 | 40.00 | | 4.2 | 30.00 |
| CP-420 | 1.3 | 96.33 | 1.3 | 40.00 | | 4.2 | 30.00 |

TABLE 20

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-C76 | F-doped tin | 45 | 4.50 | 5.0 | 113.20 | None | | | |
| CP-C77 | oxide-coated | 45 | 4.50 | 5.0 | 174.30 | | | | |
| CP-C78 | titanium | 45 | 4.50 | 5.0 | 212.50 | | | | |
| CP-C79 | oxide | 45 | 4.50 | 5.0 | 112.00 | F-doped | 4.50 | 6.6 | 1.48 |
| CP-C80 | particles | 45 | 4.50 | 5.0 | 172.20 | tin oxide | 4.50 | 6.6 | 2.29 |
| CP-C81 | (average | 45 | 4.50 | 5.0 | 209.90 | particles | 4.50 | 6.6 | 2.78 |
| CP-C82 | particle | 45 | 4.50 | 5.0 | 84.60 | (average | 4.50 | 6.6 | 33.50 |
| CP-C83 | diameter: | 45 | 4.50 | 5.0 | 128.20 | particle | 4.50 | 6.6 | 50.76 |
| CP-C84 | 230 nm) | 45 | 4.50 | 5.0 | 154.80 | diameter: | 4.50 | 6.6 | 61.30 |
| CP-C85 | None | | | | | 20 nm) | 4.50 | 6.6 | 132.30 |
| CP-C86 | | | | | | | 4.50 | 6.6 | 191.85 |
| CP-C87 | | | | | | | 4.50 | 6.6 | 225.67 |
| CP-C88 | F-doped tin | 45 | 4.50 | 5.0 | 82.10 | | 4.50 | 6.6 | 2.17 |
| CP-C89 | oxide-coated | 45 | 4.50 | 5.0 | 79.50 | | 4.50 | 6.6 | 5.25 |
| CP-C90 | titanium | 45 | 4.50 | 5.0 | 73.50 | | 4.50 | 6.6 | 12.61 |
| CP-C91 | oxide | 45 | 4.50 | 5.0 | 68.80 | | 4.50 | 6.6 | 18.18 |
| CP-C92 | particles | 45 | 4.50 | 5.0 | 65.90 | | 4.50 | 6.6 | 21.75 |
| CP-C93 | (average | 45 | 4.50 | 5.0 | 216.76 | | 4.50 | 6.6 | 5.75 |
| CP-C94 | particle | 45 | 4.50 | 5.0 | 209.10 | | 4.50 | 6.6 | 13.81 |
| CP-C95 | diameter: | 45 | 4.50 | 5.0 | 191.10 | | 4.50 | 6.6 | 32.80 |
| CP-C96 | 230 nm) | 45 | 4.50 | 5.0 | 177.65 | | 4.50 | 6.6 | 46.95 |
| CP-C97 | | 45 | 4.50 | 5.0 | 169.20 | | 4.50 | 6.6 | 55.85 |

| | | | (4) Silicone resin | | (5) Particles except | | |
|---|---|---|---|---|---|---|---|
| Conductive- | (3) Binding material (phenol resin) | | particles | | (1) to (4) | | |
| layer | | Amount [part(s)] (resin | | Amount | | | Amount |
| coating | | solid content thereof is 60% | | [part | | | [part |
| solution | Density | by mass of the following) | Density | (s)] | Kind | Density | (s)] |

| | | | | | |
|---|---|---|---|---|---|
| CP-C76 | 1.3 | 269.67 | 1.3 | 5.00 | None |
| CP-C77 | 1.3 | 167.83 | 1.3 | 5.00 | |
| CP-C78 | 1.3 | 104.17 | 1.3 | 5.00 | |
| CP-C79 | 1.3 | 269.20 | 1.3 | 5.00 | |
| CP-C80 | 1.3 | 167.52 | 1.3 | 5.00 | |
| CP-C81 | 1.3 | 103.87 | 1.3 | 5.00 | |
| CP-C82 | 1.3 | 261.50 | 1.3 | 5.00 | |
| CP-C83 | 1.3 | 160.07 | 1.3 | 5.00 | |
| CP-C84 | 1.3 | 98.17 | 1.3 | 5.00 | |
| CP-C85 | 1.3 | 237.83 | 1.3 | 5.00 | |
| CP-C86 | 1.3 | 138.58 | 1.3 | 5.00 | |
| CP-C87 | 1.3 | 82.22 | 1.3 | 5.00 | |
| CP-C88 | 1.3 | 317.88 | 1.3 | 5.00 | |
| CP-C89 | 1.3 | 317.08 | 1.3 | 5.00 | |
| CP-C90 | 1.3 | 314.82 | 1.3 | 5.00 | |
| CP-C91 | 1.3 | 313.37 | 1.3 | 5.00 | |
| CP-C92 | 1.3 | 312.25 | 1.3 | 5.00 | |
| CP-C93 | 1.3 | 87.48 | 1.3 | 5.00 | |
| CP-C94 | 1.3 | 86.82 | 1.3 | 5.00 | |
| CP-C95 | 1.3 | 85.17 | 1.3 | 5.00 | |
| CP-C96 | 1.3 | 84.00 | 1.3 | 5.00 | |
| CP-C97 | 1.3 | 83.25 | 1.3 | 5.00 | |

TABLE 21

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-C98 | Oxygen- | 45 | — | 5.1 | 152.20 | F-doped tin | 4.50 | 6.6 | 25.60 | 1.3 | 162.00 | 1.3 | 5.00 | None |
| | deficient tin | | | | | oxide | | | | | | | | |
| | oxide-coated | | | | | particles | | | | | | | | |
| | titanium oxide | | | | | (average | | | | | | | | |
| | particles | | | | | particle | | | | | | | | |
| | (average | | | | | diameter: | | | | | | | | |
| | particle | | | | | 20 nm) | | | | | | | | |
| | diameter: | | | | | | | | | | | | | |
| | 230 nm) | | | | | | | | | | | | | |
| CP-C99 | Oxygen- | 45 | — | 5.1 | 152.20 | | 4.50 | 6.6 | 25.60 | 1.3 | 162.00 | 1.3 | 5.00 | |
| | deficient tin | | | | | | | | | | | | | |
| | oxide-coated | | | | | | | | | | | | | |
| | barium sulfate | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |
| CP-C100 | Sb-doped tin | 45 | 4.50 | 5.2 | 153.50 | | 4.50 | 6.6 | 25.35 | 1.3 | 160.25 | 1.3 | 5.00 | |
| | oxide-coated | | | | | | | | | | | | | |
| | titanium oxide | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |
| CP-C101 | F-doped tin | 45 | 4.50 | 5.0 | 150.75 | Oxygen- | — | 6.6 | 25.90 | 1.3 | 163.92 | 1.3 | 5.00 | |
| | oxide-coated | | | | | deficient | | | | | | | | |
| | titanium oxide | | | | | tin oxide | | | | | | | | |
| | particles | | | | | particles | | | | | | | | |
| | (average | | | | | (average | | | | | | | | |
| | particle | | | | | particle | | | | | | | | |
| | diameter: | | | | | diameter: | | | | | | | | |
| | 230 nm) | | | | | 20 nm) | | | | | | | | |
| CP-C102 | | 45 | 4.50 | 5.0 | 149.72 | Indium tin | 4.50 | 7.1 | 27.63 | 1.3 | 162.50 | 1.3 | 5.00 | |
| | | | | | | oxide | | | | | | | | |
| | | | | | | particles | | | | | | | | |
| | | | | | | (average | | | | | | | | |
| | | | | | | particle | | | | | | | | |
| | | | | | | diameter: | | | | | | | | |
| | | | | | | 20 nm) | | | | | | | | |
| CP-C103 | | 45 | 4.50 | 5.0 | 150.76 | Sb-doped | 4.50 | 6.6 | 25.87 | 1.3 | 163.95 | 1.3 | 5.00 | |
| | | | | | | tin oxide | | | | | | | | |
| | | | | | | particles | | | | | | | | |
| | | | | | | (average | | | | | | | | |
| | | | | | | particle | | | | | | | | |
| | | | | | | diameter: | | | | | | | | |
| | | | | | | 20 nm) | | | | | | | | |
| CP-C104 | W-doped tin | 45 | 4.50 | 5.2 | 153.50 | F-doped tin | 4.50 | 6.6 | 25.90 | 1.3 | 163.92 | 1.3 | 5.00 | |
| | oxide-coated | | | | | oxide | | | | | | | | |
| | titanium oxide | | | | | particles | | | | | | | | |
| | particles | | | | | (average | | | | | | | | |
| | (average | | | | | particle | | | | | | | | |
| | particle | | | | | diameter: | | | | | | | | |
| | diameter: | | | | | 20 nm) | | | | | | | | |
| | 230 nm) | | | | | | | | | | | | | |
| CP-C105 | F-doped tin | 45 | 4.50 | 5.0 | 150.75 | | 4.50 | 6.6 | 25.90 | 1.3 | 163.92 | 1.3 | 5.00 | |
| | oxide-coated | | | | | | | | | | | | | |
| | barium sulfate | | | | | | | | | | | | | |
| | particles | | | | | | | | | | | | | |
| | (average | | | | | | | | | | | | | |
| | particle | | | | | | | | | | | | | |
| | diameter: | | | | | | | | | | | | | |
| | 230 nm) | | | | | | | | | | | | | |

TABLE 44

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-421 | Nb-doped | 45 | 4.50 | 5.1 | 111.95 | Nb-doped | 3.60 | 7.0 | 3.07 | 1.3 | 266.63 | 1.3 | 5.00 | None |
| CP-422 | tin | 45 | 4.50 | 5.1 | 111.95 | tin oxide | 4.05 | 7.0 | 3.07 | 1.3 | 266.63 | 1.3 | 5.00 | |
| CP-423 | oxide- | 45 | 4.50 | 5.1 | 111.95 | particles | 4.50 | 7.0 | 3.07 | 1.3 | 266.63 | 1.3 | 5.00 | |
| CP-424 | coated | 45 | 4.50 | 5.1 | 111.95 | (average | 4.95 | 7.0 | 3.07 | 1.3 | 266.63 | 1.3 | 5.00 | |
| CP-425 | titanium | 45 | 4.50 | 5.1 | 111.95 | particle | 5.40 | 7.0 | 3.07 | 1.3 | 266.63 | 1.3 | 5.00 | |
| CP-426 | oxide | 45 | 4.50 | 5.1 | 108.30 | diameter: | 4.50 | 7.0 | 7.43 | 1.3 | 265.45 | 1.3 | 5.00 | |
| CP-427 | particles | 45 | 4.50 | 5.1 | 99.60 | 20 nm) | 3.60 | 7.0 | 17.77 | 1.3 | 262.72 | 1.3 | 5.00 | |
| CP-428 | (average | 45 | 4.50 | 5.1 | 99.60 | | 4.05 | 7.0 | 17.77 | 1.3 | 262.72 | 1.3 | 5.00 | |
| CP-429 | particle | 45 | 4.50 | 5.1 | 99.60 | | 4.50 | 7.0 | 17.77 | 1.3 | 262.72 | 1.3 | 5.00 | |
| CP-430 | diameter: | 45 | 4.50 | 5.1 | 99.60 | | 4.95 | 7.0 | 17.77 | 1.3 | 262.72 | 1.3 | 5.00 | |
| CP-431 | 230 nm) | 45 | 4.50 | 5.1 | 99.60 | | 5.40 | 7.0 | 17.77 | 1.3 | 262.72 | 1.3 | 5.00 | |
| CP-432 | | 45 | 4.50 | 5.1 | 93.10 | | 4.50 | 7.0 | 25.56 | 1.3 | 260.57 | 1.3 | 5.00 | |
| CP-433 | | 45 | 4.50 | 5.1 | 88.92 | | 3.60 | 7.0 | 30.51 | 1.3 | 259.28 | 1.3 | 5.00 | |
| CP-434 | | 45 | 4.50 | 5.1 | 88.92 | | 4.05 | 7.0 | 30.51 | 1.3 | 259.28 | 1.3 | 5.00 | |
| CP-435 | | 45 | 4.50 | 5.1 | 88.92 | | 4.50 | 7.0 | 30.51 | 1.3 | 259.28 | 1.3 | 5.00 | |
| CP-436 | | 45 | 4.50 | 5.1 | 88.92 | | 4.95 | 7.0 | 30.51 | 1.3 | 259.28 | 1.3 | 5.00 | |
| CP-437 | | 45 | 4.50 | 5.1 | 88.92 | | 5.40 | 7.0 | 30.51 | 1.3 | 259.28 | 1.3 | 5.00 | |
| CP-438 | | 45 | 4.50 | 5.1 | 135.45 | | 4.50 | 7.0 | 3.72 | 1.3 | 259.28 | 1.3 | 5.00 | |
| CP-439 | | 45 | 4.50 | 5.1 | 130.90 | | 3.60 | 7.0 | 8.98 | 1.3 | 225.20 | 1.3 | 5.00 | |
| CP-440 | | 45 | 4.50 | 5.1 | 130.90 | | 4.05 | 7.0 | 8.98 | 1.3 | 225.20 | 1.3 | 5.00 | |
| CP-441 | | 45 | 4.50 | 5.1 | 130.90 | | 4.50 | 7.0 | 8.98 | 1.3 | 225.20 | 1.3 | 5.00 | |
| CP-442 | | 45 | 4.50 | 5.1 | 130.90 | | 4.95 | 7.0 | 8.98 | 1.3 | 225.20 | 1.3 | 5.00 | |
| CP-443 | | 45 | 4.50 | 5.1 | 130.90 | | 5.40 | 7.0 | 8.98 | 1.3 | 225.20 | 1.3 | 5.00 | |
| CP-444 | | 45 | 4.50 | 5.1 | 120.15 | | 3.60 | 7.0 | 21.44 | 1.3 | 222.35 | 1.3 | 5.00 | |
| CP-445 | | 45 | 4.50 | 5.1 | 120.15 | | 4.05 | 7.0 | 21.44 | 1.3 | 222.35 | 1.3 | 5.00 | |
| CP-446 | | 45 | 4.50 | 5.1 | 120.15 | | 4.50 | 7.0 | 21.44 | 1.3 | 222.35 | 1.3 | 5.00 | |
| CP-447 | | 45 | 4.50 | 5.1 | 120.15 | | 4.95 | 7.0 | 21.44 | 1.3 | 222.35 | 1.3 | 5.00 | |
| CP-448 | | 45 | 4.50 | 5.1 | 120.15 | | 5.40 | 7.0 | 21.44 | 1.3 | 222.35 | 1.3 | 5.00 | |
| CP-449 | | 45 | 4.50 | 5.1 | 112.08 | | 3.60 | 7.0 | 30.77 | 1.3 | 220.25 | 1.3 | 5.00 | |
| CP-450 | | 45 | 4.50 | 5.1 | 112.08 | | 4.05 | 7.0 | 30.77 | 1.3 | 220.25 | 1.3 | 5.00 | |
| CP-451 | | 45 | 4.50 | 5.1 | 112.08 | | 4.50 | 7.0 | 30.77 | 1.3 | 220.25 | 1.3 | 5.00 | |
| CP-452 | | 45 | 4.50 | 5.1 | 112.08 | | 4.95 | 7.0 | 30.77 | 1.3 | 220.25 | 1.3 | 5.00 | |
| CP-453 | | 45 | 4.50 | 5.1 | 112.08 | | 5.40 | 7.0 | 30.77 | 1.3 | 220.25 | 1.3 | 5.00 | |
| CP-454 | | 45 | 4.50 | 5.1 | 106.95 | | 4.50 | 7.0 | 36.70 | 1.3 | 218.92 | 1.3 | 5.00 | |
| CP-455 | | 45 | 4.50 | 5.1 | 171.35 | | 3.60 | 7.0 | 4.70 | 1.3 | 164.92 | 1.3 | 5.00 | |
| CP-456 | | 45 | 4.50 | 5.1 | 171.35 | | 4.05 | 7.0 | 4.70 | 1.3 | 164.92 | 1.3 | 5.00 | |
| CP-457 | | 45 | 4.50 | 5.1 | 171.35 | | 4.50 | 7.0 | 4.70 | 1.3 | 164.92 | 1.3 | 5.00 | |
| CP-458 | | 45 | 4.50 | 5.1 | 171.35 | | 4.95 | 7.0 | 4.70 | 1.3 | 164.92 | 1.3 | 5.00 | |
| CP-459 | | 45 | 4.50 | 5.1 | 171.35 | | 5.40 | 7.0 | 4.70 | 1.3 | 164.92 | 1.3 | 5.00 | |
| CP-460 | | 45 | 4.50 | 5.1 | 165.37 | | 3.60 | 7.0 | 11.35 | 1.3 | 163.80 | 1.3 | 5.00 | |

TABLE 45

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-461 | Nb-doped | 45 | 4.50 | 5.1 | 165.37 | Nb-doped | 4.05 | 7.0 | 11.35 | 1.3 | 163.80 | 1.3 | 5.00 | None |
| CP-462 | tin | 45 | 4.50 | 5.1 | 165.37 | tin oxide | 4.50 | 7.0 | 11.35 | 1.3 | 163.80 | 1.3 | 5.00 | |
| CP-463 | oxide- | 45 | 4.50 | 5.1 | 165.37 | particles | 4.95 | 7.0 | 11.35 | 1.3 | 163.80 | 1.3 | 5.00 | |
| CP-464 | coated | 45 | 4.50 | 5.1 | 165.37 | (average | 5.40 | 7.0 | 11.35 | 1.3 | 163.80 | 1.3 | 5.00 | |
| CP-465 | titanium | 45 | 4.50 | 5.1 | 151.30 | particle | 3.60 | 7.0 | 27.00 | 1.3 | 161.17 | 1.3 | 5.00 | |
| CP-466 | oxide | 45 | 4.50 | 5.1 | 151.30 | diameter: | 4.05 | 7.0 | 27.00 | 1.3 | 161.17 | 1.3 | 5.00 | |
| CP-467 | particles | 45 | 4.50 | 5.1 | 151.30 | 20 nm) | 4.50 | 7.0 | 27.00 | 1.3 | 161.17 | 1.3 | 5.00 | |
| CP-468 | (average | 45 | 4.50 | 5.1 | 151.30 | | 4.95 | 7.0 | 27.00 | 1.3 | 161.17 | 1.3 | 5.00 | |
| CP-469 | particle | 45 | 4.50 | 5.1 | 151.30 | | 5.40 | 7.0 | 27.00 | 1.3 | 161.17 | 1.3 | 5.00 | |
| CP-470 | diameter: | 45 | 4.50 | 5.1 | 140.84 | | 3.60 | 7.0 | 38.66 | 1.3 | 159.17 | 1.3 | 5.00 | |
| CP-471 | 230 nm) | 45 | 4.50 | 5.1 | 140.84 | | 4.05 | 7.0 | 38.66 | 1.3 | 159.17 | 1.3 | 5.00 | |
| CP-472 | | 45 | 4.50 | 5.1 | 140.84 | | 4.50 | 7.0 | 38.66 | 1.3 | 159.17 | 1.3 | 5.00 | |
| CP-473 | | 45 | 4.50 | 5.1 | 140.84 | | 4.95 | 7.0 | 38.66 | 1.3 | 159.17 | 1.3 | 5.00 | |
| CP-474 | | 45 | 4.50 | 5.1 | 140.84 | | 5.40 | 7.0 | 38.66 | 1.3 | 159.17 | 1.3 | 5.00 | |
| CP-475 | | 45 | 4.50 | 5.1 | 134.20 | | 3.60 | 7.0 | 46.05 | 1.3 | 157.92 | 1.3 | 5.00 | |
| CP-476 | | 45 | 4.50 | 5.1 | 134.20 | | 4.05 | 7.0 | 46.05 | 1.3 | 157.92 | 1.3 | 5.00 | |
| CP-477 | | 45 | 4.50 | 5.1 | 134.20 | | 4.50 | 7.0 | 46.05 | 1.3 | 157.92 | 1.3 | 5.00 | |
| CP-478 | | 45 | 4.50 | 5.1 | 134.20 | | 4.95 | 7.0 | 46.05 | 1.3 | 157.92 | 1.3 | 5.00 | |
| CP-479 | | 45 | 4.50 | 5.1 | 134.20 | | 5.40 | 7.0 | 46.05 | 1.3 | 157.92 | 1.3 | 5.00 | |
| CP-480 | | 45 | 4.50 | 5.1 | 197.53 | | 4.50 | 7.0 | 5.43 | 1.3 | 120.07 | 1.3 | 5.00 | |
| CP-481 | | 45 | 4.50 | 5.1 | 190.45 | | 3.60 | 7.0 | 13.08 | 1.3 | 119.12 | 1.3 | 5.00 | |
| CP-482 | | 45 | 4.50 | 5.1 | 190.45 | | 4.05 | 7.0 | 13.08 | 1.3 | 119.12 | 1.3 | 5.00 | |
| CP-483 | | 45 | 4.50 | 5.1 | 190.45 | | 4.50 | 7.0 | 13.08 | 1.3 | 119.12 | 1.3 | 5.00 | |
| CP-484 | | 45 | 4.50 | 5.1 | 190.45 | | 4.95 | 7.0 | 13.08 | 1.3 | 119.12 | 1.3 | 5.00 | |
| CP-485 | | 45 | 4.50 | 5.1 | 190.45 | | 5.40 | 7.0 | 13.08 | 1.3 | 119.12 | 1.3 | 5.00 | |
| CP-486 | | 45 | 4.50 | 5.1 | 173.86 | | 3.60 | 7.0 | 31.02 | 1.3 | 116.87 | 1.3 | 5.00 | |
| CP-487 | | 45 | 4.50 | 5.1 | 173.86 | | 4.05 | 7.0 | 31.02 | 1.3 | 116.87 | 1.3 | 5.00 | |
| CP-488 | | 45 | 4.50 | 5.1 | 173.86 | | 4.50 | 7.0 | 31.02 | 1.3 | 116.87 | 1.3 | 5.00 | |
| CP-489 | | 45 | 4.50 | 5.1 | 173.86 | | 4.95 | 7.0 | 31.02 | 1.3 | 116.87 | 1.3 | 5.00 | |
| CP-490 | | 45 | 4.50 | 5.1 | 173.86 | | 5.40 | 7.0 | 31.02 | 1.3 | 116.87 | 1.3 | 5.00 | |
| CP-491 | | 45 | 4.50 | 5.1 | 161.54 | | 3.60 | 7.0 | 44.35 | 1.3 | 115.18 | 1.3 | 5.00 | |
| CP-492 | | 45 | 4.50 | 5.1 | 161.54 | | 4.05 | 7.0 | 44.35 | 1.3 | 115.18 | 1.3 | 5.00 | |
| CP-493 | | 45 | 4.50 | 5.1 | 161.54 | | 4.50 | 7.0 | 44.35 | 1.3 | 115.18 | 1.3 | 5.00 | |
| CP-494 | | 45 | 4.50 | 5.1 | 161.54 | | 4.95 | 7.0 | 44.35 | 1.3 | 115.18 | 1.3 | 5.00 | |
| CP-495 | | 45 | 4.50 | 5.1 | 161.54 | | 5.40 | 7.0 | 44.35 | 1.3 | 115.18 | 1.3 | 5.00 | |
| CP-496 | | 45 | 4.50 | 5.1 | 153.76 | | 4.50 | 7.0 | 52.76 | 1.3 | 114.13 | 1.3 | 5.00 | |
| CP-497 | | 45 | 4.50 | 5.1 | 208.14 | | 3.60 | 7.0 | 5.72 | 1.3 | 101.90 | 1.3 | 5.00 | |
| CP-498 | | 45 | 4.50 | 5.1 | 208.14 | | 4.05 | 7.0 | 5.72 | 1.3 | 101.90 | 1.3 | 5.00 | |
| CP-499 | | 45 | 4.50 | 5.1 | 208.14 | | 4.50 | 7.0 | 5.72 | 1.3 | 101.90 | 1.3 | 5.00 | |
| CP-500 | | 45 | 4.50 | 5.1 | 208.14 | | 4.95 | 7.0 | 5.72 | 1.3 | 101.90 | 1.3 | 5.00 | |

TABLE 46

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |
| CP-501 | Nb-doped tin | 45 | 4.50 | 5.1 | 208.14 | Nb-doped | 5.40 | 7.0 | 5.72 | 1.3 | 101.90 | 1.3 | 5.00 | None | | |
| CP-502 | oxide-coated | 45 | 4.50 | 5.1 | 200.62 | tin oxide | 4.50 | 7.0 | 13.76 | 1.3 | 101.03 | 1.3 | 5.00 | | | |
| CP-503 | titanium | 45 | 4.50 | 5.1 | 182.95 | particles | 3.60 | 7.0 | 32.64 | 1.3 | 99.02 | 1.3 | 5.00 | | | |
| CP-504 | oxide | 45 | 4.50 | 5.1 | 182.95 | (average | 4.05 | 7.0 | 32.64 | 1.3 | 99.02 | 1.3 | 5.00 | | | |
| CP-505 | particles | 45 | 4.50 | 5.1 | 182.95 | particle | 4.50 | 7.0 | 32.64 | 1.3 | 99.02 | 1.3 | 5.00 | | | |
| CP-506 | (average | 45 | 4.50 | 5.1 | 182.95 | diameter: | 4.95 | 7.0 | 32.64 | 1.3 | 99.02 | 1.3 | 5.00 | | | |
| CP-507 | particle | 45 | 4.50 | 5.1 | 182.95 | 20 nm) | 5.40 | 7.0 | 32.64 | 1.3 | 99.02 | 1.3 | 5.00 | | | |
| CP-508 | diameter: | 45 | 4.50 | 5.1 | 169.87 | | 4.50 | 7.0 | 46.62 | 1.3 | 97.52 | 1.3 | 5.00 | | | |
| CP-509 | 230 nm) | 45 | 4.50 | 5.1 | 161.62 | | 3.60 | 7.0 | 55.45 | 1.3 | 96.55 | 1.3 | 5.00 | | | |
| CP-510 | | 45 | 4.50 | 5.1 | 161.62 | | 4.05 | 7.0 | 55.45 | 1.3 | 96.55 | 1.3 | 5.00 | | | |
| CP-511 | | 45 | 4.50 | 5.1 | 161.62 | | 4.50 | 7.0 | 55.45 | 1.3 | 96.55 | 1.3 | 5.00 | | | |
| CP-512 | | 45 | 4.50 | 5.1 | 161.62 | | 4.95 | 7.0 | 55.45 | 1.3 | 96.55 | 1.3 | 5.00 | | | |
| CP-513 | | 45 | 4.50 | 5.1 | 161.62 | | 5.40 | 7.0 | 55.45 | 1.3 | 96.55 | 1.3 | 5.00 | | | |
| CP-514 | | 45 | 4.50 | 5.1 | 135.25 | | 3.60 | 7.0 | 9.28 | 1.3 | 159.12 | 1.3 | 40.00 | Uncoated | 4.2 | 30.00 |
| CP-515 | | 45 | 4.50 | 5.1 | 135.25 | | 4.05 | 7.0 | 9.28 | 1.3 | 159.12 | 1.3 | 40.00 | titanium | 4.2 | 30.00 |
| CP-516 | | 45 | 4.50 | 5.1 | 135.25 | | 4.50 | 7.0 | 9.28 | 1.3 | 159.12 | 1.3 | 40.00 | oxide | 4.2 | 30.00 |
| CP-517 | | 45 | 4.50 | 5.1 | 135.25 | | 4.95 | 7.0 | 9.28 | 1.3 | 159.12 | 1.3 | 40.00 | particles | 4.2 | 30.00 |
| CP-518 | | 45 | 4.50 | 5.1 | 135.25 | | 5.40 | 7.0 | 9.28 | 1.3 | 159.12 | 1.3 | 40.00 | (average | 4.2 | 30.00 |
| CP-519 | | 45 | 4.50 | 5.1 | 124.13 | | 3.60 | 7.0 | 22.15 | 1.3 | 156.20 | 1.3 | 40.00 | particle | 4.2 | 30.00 |
| CP-520 | | 45 | 4.50 | 5.1 | 124.13 | | 4.05 | 7.0 | 22.15 | 1.3 | 156.20 | 1.3 | 40.00 | diameter: | 4.2 | 30.00 |
| CP-521 | | 45 | 4.50 | 5.1 | 124.13 | | 4.50 | 7.0 | 22.15 | 1.3 | 156.20 | 1.3 | 40.00 | 210 nm) | 4.2 | 30.00 |
| CP-522 | | 45 | 4.50 | 5.1 | 124.13 | | 4.95 | 7.0 | 22.15 | 1.3 | 156.02 | 1.3 | 40.00 | | 4.2 | 30.00 |
| CP-523 | | 45 | 4.50 | 5.1 | 124.13 | | 5.40 | 7.0 | 22.15 | 1.3 | 156.20 | 1.3 | 40.00 | | 4.2 | 30.00 |
| CP-524 | | 45 | 4.50 | 5.1 | 115.80 | | 3.60 | 7.0 | 31.79 | 1.3 | 154.02 | 1.3 | 40.00 | | 4.2 | 30.00 |
| CP-525 | | 45 | 4.50 | 5.1 | 115.80 | | 4.05 | 7.0 | 31.79 | 1.3 | 154.02 | 1.3 | 40.00 | | 4.2 | 30.00 |
| CP-526 | | 45 | 4.50 | 5.1 | 115.80 | | 4.50 | 7.0 | 31.79 | 1.3 | 154.02 | 1.3 | 40.00 | | 4.2 | 30.00 |
| CP-527 | | 45 | 4.50 | 5.1 | 115.80 | | 4.95 | 7.0 | 31.79 | 1.3 | 154.02 | 1.3 | 40.00 | | 4.2 | 30.00 |
| CP-528 | | 45 | 4.50 | 5.1 | 115.80 | | 5.40 | 7.0 | 31.79 | 1.3 | 154.02 | 1.3 | 40.00 | | 4.2 | 30.00 |
| CP-529 | | 45 | 4.50 | 5.1 | 170.85 | | 3.60 | 7.0 | 11.72 | 1.3 | 95.72 | 1.3 | 40.00 | | 4.2 | 30.00 |
| CP-530 | | 45 | 4.50 | 5.1 | 170.85 | | 4.05 | 7.0 | 11.72 | 1.3 | 95.72 | 1.3 | 40.00 | | 4.2 | 30.00 |
| CP-531 | | 45 | 4.50 | 5.1 | 170.85 | | 4.50 | 7.0 | 11.72 | 1.3 | 95.72 | 1.3 | 40.00 | | 4.2 | 30.00 |
| CP-532 | | 45 | 4.50 | 5.1 | 170.85 | | 4.95 | 7.0 | 11.72 | 1.3 | 95.72 | 1.3 | 40.00 | | 4.2 | 30.00 |
| CP-533 | | 45 | 4.50 | 5.1 | 170.85 | | 5.40 | 7.0 | 11.72 | 1.3 | 95.72 | 1.3 | 40.00 | | 4.2 | 30.00 |
| CP-534 | | 45 | 4.50 | 5.1 | 156.32 | | 3.60 | 7.0 | 27.90 | 1.3 | 92.97 | 1.3 | 40.00 | | 4.2 | 30.00 |
| CP-535 | | 45 | 4.50 | 5.1 | 156.32 | | 4.05 | 7.0 | 27.90 | 1.3 | 92.97 | 1.3 | 40.00 | | 4.2 | 30.00 |
| CP-536 | | 45 | 4.50 | 5.1 | 156.32 | | 4.50 | 7.0 | 27.90 | 1.3 | 92.97 | 1.3 | 40.00 | | 4.2 | 30.00 |
| CP-537 | | 45 | 4.50 | 5.1 | 156.32 | | 4.95 | 7.0 | 27.90 | 1.3 | 92.97 | 1.3 | 40.00 | | 4.2 | 30.00 |
| CP-538 | | 45 | 4.50 | 5.1 | 156.32 | | 5.40 | 7.0 | 27.90 | 1.3 | 92.97 | 1.3 | 40.00 | | 4.2 | 30.00 |
| CP-539 | | 45 | 4.50 | 5.1 | 145.50 | | 3.60 | 7.0 | 39.95 | 1.3 | 90.92 | 1.3 | 40.00 | | 4.2 | 30.00 |
| CP-540 | | 45 | 4.50 | 5.1 | 145.50 | | 4.05 | 7.0 | 39.95 | 1.3 | 90.92 | 1.3 | 40.00 | | 4.2 | 30.00 |

TABLE 47

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-541 | Nb- | 45 | 4.50 | 5.1 | 145.50 | Nb- | 4.50 | 7.0 | 39.95 |
| CP-542 | doped | 45 | 4.50 | 5.1 | 145.50 | doped | 4.95 | 7.0 | 39.95 |
| CP-543 | tin | 45 | 4.50 | 5.1 | 145.50 | tin oxide | 5.40 | 7.0 | 39.95 |
| CP-544 | oxide- | 45 | 4.50 | 5.1 | 196.78 | particles | 3.60 | 7.0 | 13.50 |
| CP-545 | coated | 45 | 4.50 | 5.1 | 196.78 | (average | 4.05 | 7.0 | 13.50 |
| CP-546 | titanium | 45 | 4.50 | 5.1 | 196.78 | particle | 4.50 | 7.0 | 13.50 |
| CP-547 | oxide | 45 | 4.50 | 5.1 | 196.78 | diameter: | 4.95 | 7.0 | 13.50 |
| CP-548 | particles | 45 | 4.50 | 5.1 | 196.78 | 20 nm) | 5.40 | 7.0 | 13.50 |
| CP-549 | (average | 45 | 4.50 | 5.1 | 179.62 | | 3.60 | 7.0 | 32.05 |
| CP-550 | particle | 45 | 4.50 | 5.1 | 179.62 | | 4.05 | 7.0 | 32.05 |
| CP-551 | diameter: | 45 | 4.50 | 5.1 | 179.62 | | 4.50 | 7.0 | 32.05 |
| CP-552 | 230 nm) | 45 | 4.50 | 5.1 | 179.62 | | 4.95 | 7.0 | 32.05 |
| CP-553 | | 45 | 4.50 | 5.1 | 179.62 | | 5.40 | 7.0 | 32.05 |
| CP-554 | | 45 | 4.50 | 5.1 | 166.90 | | 3.60 | 7.0 | 45.82 |
| CP-555 | | 45 | 4.50 | 5.1 | 166.90 | | 4.05 | 7.0 | 45.82 |
| CP-556 | | 45 | 4.50 | 5.1 | 166.90 | | 4.50 | 7.0 | 45.82 |
| CP-557 | | 45 | 4.50 | 5.1 | 166.90 | | 4.95 | 7.0 | 45.82 |
| CP-558 | | 45 | 4.50 | 5.1 | 166.90 | | 5.40 | 7.0 | 45.82 |
| CP-559 | | 45 | 4.50 | 5.1 | 156.32 | | 4.50 | 7.0 | 27.90 |
| CP-560 | | 45 | 4.50 | 5.0 | 159.70 | | 4.50 | 7.0 | 24.15 |

| | (3) Binding material | | | | | | |
|---|---|---|---|---|---|---|---|
| | (phenol resin) | | | | | | |
| Conductive- | | Amount [part(s)] | (4) Silicone resin | | (5) Particles except | | |
| layer | | (resin solid content | particles | | (1) to (4) | | |
| coating | | thereof is 60% by | | Amount | | | Amount |
| solution | Density | mass of the following) | Density | [part(s)] | Kind | Density | [part(s)] |

| | | | | | | | |
|---|---|---|---|---|---|---|---|
| CP-541 | 1.3 | 90.92 | 1.3 | 40.00 | Uncoated | 4.2 | 30.00 |
| CP-542 | 1.3 | 90.92 | 1.3 | 40.00 | titanium | 4.2 | 30.00 |
| CP-543 | 1.3 | 90.92 | 1.3 | 40.00 | oxide | 4.2 | 30.00 |
| CP-544 | 1.3 | 49.53 | 1.3 | 40.00 | particles | 4.2 | 30.00 |
| CP-545 | 1.3 | 49.53 | 1.3 | 40.00 | (average | 4.2 | 30.00 |
| CP-546 | 1.3 | 49.53 | 1.3 | 40.00 | particle | 4.2 | 30.00 |
| CP-547 | 1.3 | 49.53 | 1.3 | 40.00 | diameter: | 4.2 | 30.00 |
| CP-548 | 1.3 | 49.53 | 1.3 | 40.00 | 210 nm) | 4.2 | 30.00 |
| CP-549 | 1.3 | 47.22 | 1.3 | 40.00 | | 4.2 | 30.00 |
| CP-550 | 1.3 | 47.22 | 1.3 | 40.00 | | 4.2 | 30.00 |
| CP-551 | 1.3 | 47.22 | 1.3 | 40.00 | | 4.2 | 30.00 |
| CP-552 | 1.3 | 47.22 | 1.3 | 40.00 | | 4.2 | 30.00 |
| CP-553 | 1.3 | 47.22 | 1.3 | 40.00 | | 4.2 | 30.00 |
| CP-554 | 1.3 | 45.47 | 1.3 | 40.00 | | 4.2 | 30.00 |
| CP-555 | 1.3 | 45.47 | 1.3 | 40.00 | | 4.2 | 30.00 |
| CP-556 | 1.3 | 45.47 | 1.3 | 40.00 | | 4.2 | 30.00 |
| CP-557 | 1.3 | 45.47 | 1.3 | 40.00 | | 4.2 | 30.00 |
| CP-558 | 1.3 | 45.47 | 1.3 | 40.00 | | 4.2 | 30.00 |
| CP-559 | 1.3 | 92.97 | 1.3 | 40.00 | | 4.2 | 30.00 |
| CP-560 | 1.3 | 93.58 | 1.3 | 40.00 | | 4.2 | 30.00 |

TABLE 48

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-C107 | Nb-doped tin | 45 | 4.50 | 5.1 | 114.55 | None | | | |
| CP-C108 | oxide-coated | 45 | 4.50 | 5.1 | 175.58 | | | | |
| CP-C109 | titanium | 45 | 4.50 | 5.1 | 213.48 | | | | |
| CP-C110 | oxide | 45 | 4.50 | 5.1 | 113.25 | Nb-doped | 4.50 | 7.0 | 1.55 |
| CP-C111 | particles | 45 | 4.50 | 5.1 | 173.45 | tin oxide | 4.50 | 7.0 | 2.37 |
| CP-C112 | (average | 45 | 4.50 | 5.1 | 210.77 | particles | 4.50 | 7.0 | 2.90 |
| CP-C113 | particle | 45 | 4.50 | 5.1 | 85.10 | (average | 4.50 | 7.0 | 35.04 |
| CP-C114 | diameter: | 45 | 4.50 | 5.1 | 128.15 | particle | 4.50 | 7.0 | 52.76 |
| CP-C115 | 230 nm) | 45 | 4.50 | 5.1 | 154.12 | diameter: | 4.50 | 7.0 | 63.46 |
| CP-C116 | None | | | | | 20 nm) | 4.50 | 7.0 | 136.40 |
| CP-C117 | | | | | | | 4.50 | 7.0 | 195.35 |
| CP-C118 | | | | | | | 4.50 | 7.0 | 228.20 |
| CP-C119 | Nb-doped tin | 45 | 4.50 | 5.1 | 83.15 | | 4.50 | 7.0 | 2.28 |
| CP-C120 | oxide-coated | 45 | 4.50 | 5.1 | 80.50 | | 4.50 | 7.0 | 5.53 |
| CP-C121 | titanium | 45 | 4.50 | 5.1 | 74.24 | | 4.50 | 7.0 | 13.25 |
| CP-C122 | oxide | 45 | 4.50 | 5.1 | 69.55 | | 4.50 | 7.0 | 19.09 |
| CP-C123 | particles | 45 | 4.50 | 5.1 | 66.50 | | 4.50 | 7.0 | 22.82 |
| CP-C124 | (average | 45 | 4.50 | 5.1 | 217.47 | | 4.50 | 7.0 | 5.98 |
| CP-C125 | particle | 45 | 4.50 | 5.1 | 209.55 | | 4.50 | 7.0 | 14.37 |
| CP-C126 | diameter: | 45 | 4.50 | 5.1 | 190.95 | | 4.50 | 7.0 | 34.06 |
| CP-C127 | 230 nm) | 45 | 4.50 | 5.1 | 177.18 | | 4.50 | 7.0 | 48.63 |
| CP-C128 | | 45 | 4.50 | 5.1 | 168.49 | | 4.50 | 7.0 | 57.82 |

| | | | (4) Silicone resin | | (5) Particles except) | | |
|---|---|---|---|---|---|---|---|
| Conductive- | (3) Binding material (phenol resin) | | particles | | (1) to (4 | | |
| layer | | Amount [part(s)] (resin | | Amount | | | Amount |
| coating | | solid content thereof is 60% | | [part | | | [part |
| solution | Density | by mass of the following) | Density | (s)] | Kind | Density | (s)] |

| | | | | | |
|---|---|---|---|---|---|
| CP-C107 | 1.3 | 267.42 | 1.3 | 5.00 | None |
| CP-C108 | 1.3 | 165.70 | 1.3 | 5.00 | |
| CP-C109 | 1.3 | 102.53 | 1.3 | 5.00 | |
| CP-C110 | 1.3 | 267.00 | 1.3 | 5.00 | |
| CP-C111 | 1.3 | 165.30 | 1.3 | 5.00 | |
| CP-C112 | 1.3 | 102.22 | 1.3 | 5.00 | |
| CP-C113 | 1.3 | 258.10 | 1.3 | 5.00 | |
| CP-C114 | 1.3 | 156.82 | 1.3 | 5.00 | |
| CP-C115 | 1.3 | 95.70 | 1.3 | 5.00 | |
| CP-C116 | 1.3 | 231.00 | 1.3 | 5.00 | |
| CP-C117 | 1.3 | 132.75 | 1.3 | 5.00 | |
| CP-C118 | 1.3 | 78.00 | 1.3 | 5.00 | |
| CP-C119 | 1.3 | 315.95 | 1.3 | 5.00 | |
| CP-C120 | 1.3 | 314.95 | 1.3 | 5.00 | |
| CP-C121 | 1.3 | 312.52 | 1.3 | 5.00 | |
| CP-C122 | 1.3 | 310.60 | 1.3 | 5.00 | |
| CP-C123 | 1.3 | 309.47 | 1.3 | 5.00 | |
| CP-C124 | 1.3 | 85.92 | 1.3 | 5.00 | |
| CP-C125 | 1.3 | 85.13 | 1.3 | 5.00 | |
| CP-C126 | 1.3 | 83.32 | 1.3 | 5.00 | |
| CP-C127 | 1.3 | 81.98 | 1.3 | 5.00 | |
| CP-C128 | 1.3 | 81.15 | 1.3 | 5.00 | |

TABLE 49

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-561 | Ta- | 45 | 4.50 | 5.2 | 113.20 | Ta- | 3.60 | 7.3 | 3.18 |
| CP-562 | doped | 45 | 4.50 | 5.2 | 113.20 | doped | 4.05 | 7.3 | 3.18 |
| CP-563 | tin | 45 | 4.50 | 5.2 | 113.20 | tin oxide | 4.50 | 7.4 | 3.22 |
| CP-564 | oxide- | 45 | 4.50 | 5.2 | 113.20 | particles | 4.95 | 7.4 | 3.22 |
| CP-565 | coated | 45 | 4.50 | 5.2 | 113.20 | (average | 5.40 | 7.5 | 3.26 |
| CP-566 | titanium | 45 | 4.50 | 5.2 | 109.45 | particle | 4.50 | 7.4 | 7.79 |
| CP-567 | oxide | 45 | 4.50 | 5.2 | 100.60 | diameter: | 3.60 | 7.3 | 18.36 |
| CP-568 | particles | 45 | 4.50 | 5.2 | 100.60 | 20 nm) | 4.05 | 7.3 | 18.36 |
| CP-569 | (average | 45 | 4.50 | 5.2 | 100.50 | | 4.50 | 7.4 | 18.59 |
| CP-570 | particle | 45 | 4.50 | 5.2 | 100.50 | | 4.95 | 7.4 | 18.59 |
| CP-571 | diameter: | 45 | 4.50 | 5.2 | 100.43 | | 5.40 | 7.5 | 18.83 |
| CP-572 | 230 nm) | 45 | 4.50 | 5.2 | 93.80 | | 4.50 | 7.4 | 26.70 |
| CP-573 | | 45 | 4.50 | 5.2 | 89.70 | | 3.60 | 7.3 | 31.48 |
| CP-574 | | 45 | 4.50 | 5.2 | 89.70 | | 4.05 | 7.3 | 31.48 |
| CP-575 | | 45 | 4.50 | 5.2 | 89.57 | | 4.50 | 7.4 | 31.87 |
| CP-576 | | 45 | 4.50 | 5.2 | 89.57 | | 4.95 | 7.4 | 31.87 |
| CP-577 | | 45 | 4.50 | 5.2 | 89.42 | | 5.40 | 7.5 | 32.24 |
| CP-578 | | 45 | 4.50 | 5.2 | 136.70 | | 4.50 | 7.4 | 3.90 |
| CP-579 | | 45 | 4.50 | 5.2 | 132.05 | | 3.60 | 7.3 | 9.27 |
| CP-580 | | 45 | 4.50 | 5.2 | 132.05 | | 4.05 | 7.3 | 9.27 |
| CP-581 | | 45 | 4.50 | 5.2 | 132.00 | | 4.50 | 7.4 | 9.40 |
| CP-582 | | 45 | 4.50 | 5.2 | 132.00 | | 4.95 | 7.4 | 9.40 |
| CP-583 | | 45 | 4.50 | 5.2 | 131.95 | | 5.40 | 7.5 | 9.52 |
| CP-584 | | 45 | 4.50 | 5.2 | 121.10 | | 3.60 | 7.3 | 22.10 |
| CP-585 | | 45 | 4.50 | 5.2 | 121.10 | | 4.05 | 7.3 | 22.10 |
| CP-586 | | 45 | 4.50 | 5.2 | 120.95 | | 4.50 | 7.4 | 22.38 |

| | (3) Binding material | | | | | | |
|---|---|---|---|---|---|---|---|
| | (phenol resin) | | | | | | |
| Conductive- | | Amount [part(s)] | (4) Silicone resin | | (5) Particles except | | |
| layer | | (resin solid content | particles | | (1) to (4) | | |
| coating | | thereof is 60% by | | Amount | | | Amount |
| solution | Density | mass of the following) | Density | [part(s)] | Kind | Density | [part(s)] |

| | | | | | |
|---|---|---|---|---|---|
| CP-561 | 1.3 | 264.37 | 1.3 | 5.00 | None |
| CP-562 | 1.3 | 264.37 | 1.3 | 5.00 | |
| CP-563 | 1.3 | 264.30 | 1.3 | 5.00 | |
| CP-564 | 1.3 | 264.30 | 1.3 | 5.00 | |
| CP-565 | 1.3 | 264.23 | 1.3 | 5.00 | |
| CP-566 | 1.3 | 262.93 | 1.3 | 5.00 | |
| CP-567 | 1.3 | 260.07 | 1.3 | 5.00 | |
| CP-568 | 1.3 | 260.07 | 1.3 | 5.00 | |
| CP-569 | 1.3 | 259.85 | 1.3 | 5.00 | |
| CP-570 | 1.3 | 259.85 | 1.3 | 5.00 | |
| CP-571 | 1.3 | 259.57 | 1.3 | 5.00 | |
| CP-572 | 1.3 | 257.50 | 1.3 | 5.00 | |
| CP-573 | 1.3 | 256.37 | 1.3 | 5.00 | |
| CP-574 | 1.3 | 256.37 | 1.3 | 5.00 | |
| CP-575 | 1.3 | 255.93 | 1.3 | 5.00 | |
| CP-576 | 1.3 | 255.93 | 1.3 | 5.00 | |
| CP-577 | 1.3 | 255.57 | 1.3 | 5.00 | |
| CP-578 | 1.3 | 224.00 | 1.3 | 5.00 | |
| CP-579 | 1.3 | 222.80 | 1.3 | 5.00 | |
| CP-580 | 1.3 | 222.80 | 1.3 | 5.00 | |
| CP-581 | 1.3 | 222.67 | 1.3 | 5.00 | |
| CP-582 | 1.3 | 222.67 | 1.3 | 5.00 | |
| CP-583 | 1.3 | 222.55 | 1.3 | 5.00 | |
| CP-584 | 1.3 | 219.67 | 1.3 | 5.00 | |
| CP-585 | 1.3 | 219.67 | 1.3 | 5.00 | |
| CP-586 | 1.3 | 219.45 | 1.3 | 5.00 | |

TABLE 50

| Conductive- | (1) A first metal oxide particle | | | | | (2) A second metal oxide particle | | | | (3) Binding material (phenol resin) | | (4) Silicone resin particles | | (5) Particles except (1) to (4) | | |
|---|---|---|---|---|---|---|---|---|---|---|---|---|---|---|---|---|
| layer | | Coating | Doping | | | | Doping | | | | Amount [part(s)] (resin | | Amount | | | Amount |
| coating | | ratio | ratio | | Amount | | ratio | | Amount | | solid content thereof is 60% | | [part | | | [part |
| solution | Kind | [%] | [%] | Density | [part(s)] | Kind | [%] | Density | [part(s)] | Density | by mass of the following) | Density | (s)] | Kind | Density | (s)] |

| | | | | | | | | | | | | | | |
|---|---|---|---|---|---|---|---|---|---|---|---|---|---|---|
| CP-601 | Ta-doped | 45 | 4.50 | 5.2 | 166.40 | Ta-doped | 4.05 | 7.3 | 11.68 | 1.3 | 161.53 | 1.3 | 5.00 | None |
| CP-602 | tin | 45 | 4.50 | 5.2 | 166.30 | tin oxide | 4.50 | 7.4 | 11.83 | 1.3 | 161.45 | 1.3 | 5.00 | |
| CP-603 | oxide- | 45 | 4.50 | 5.2 | 166.30 | particles | 4.95 | 7.4 | 11.83 | 1.3 | 161.45 | 1.3 | 5.00 | |
| CP-604 | coated | 45 | 4.50 | 5.2 | 166.22 | (average | 5.40 | 7.5 | 11.99 | 1.3 | 161.32 | 1.3 | 5.00 | |
| CP-605 | titanium | 45 | 4.50 | 5.2 | 152.02 | particle | 3.60 | 7.3 | 27.75 | 1.3 | 158.72 | 1.3 | 5.00 | |
| CP-606 | oxide | 45 | 4.50 | 5.2 | 152.02 | diameter: | 4.05 | 7.3 | 27.75 | 1.3 | 158.72 | 1.3 | 5.00 | |
| CP-607 | particles | 45 | 4.50 | 5.2 | 151.83 | 20 nm) | 4.50 | 7.4 | 28.09 | 1.3 | 158.47 | 1.3 | 5.00 | |
| CP-608 | (average | 45 | 4.50 | 5.2 | 151.83 | | 4.95 | 7.4 | 28.09 | 1.3 | 158.47 | 1.3 | 5.00 | |
| CP-609 | particle | 45 | 4.50 | 5.2 | 151.61 | | 5.40 | 7.5 | 28.43 | 1.3 | 158.27 | 1.3 | 5.00 | |
| CP-610 | diameter: | 45 | 4.50 | 5.2 | 141.37 | | 3.60 | 7.3 | 39.69 | 1.3 | 156.57 | 1.3 | 5.00 | |
| CP-611 | 230 nm) | 45 | 4.50 | 5.2 | 141.37 | | 4.05 | 7.3 | 39.69 | 1.3 | 156.57 | 1.3 | 5.00 | |
| CP-612 | | 45 | 4.50 | 5.2 | 141.10 | | 4.50 | 7.4 | 40.15 | 1.3 | 156.25 | 1.3 | 5.00 | |
| CP-613 | | 45 | 4.50 | 5.2 | 141.10 | | 4.95 | 7.4 | 40.15 | 1.3 | 156.25 | 1.3 | 5.00 | |
| CP-614 | | 45 | 4.50 | 5.2 | 140.82 | | 5.40 | 7.5 | 40.62 | 1.3 | 155.93 | 1.3 | 5.00 | |
| CP-615 | | 45 | 4.50 | 5.2 | 134.60 | | 3.60 | 7.3 | 47.24 | 1.3 | 155.27 | 1.3 | 5.00 | |
| CP-616 | | 45 | 4.50 | 5.2 | 134.60 | | 4.05 | 7.3 | 47.24 | 1.3 | 155.27 | 1.3 | 5.00 | |
| CP-617 | | 45 | 4.50 | 5.2 | 134.30 | | 4.50 | 7.4 | 47.78 | 1.3 | 154.87 | 1.3 | 5.00 | |
| CP-618 | | 45 | 4.50 | 5.2 | 134.30 | | 4.95 | 7.4 | 47.78 | 1.3 | 154.87 | 1.3 | 5.00 | |
| CP-619 | | 45 | 4.50 | 5.2 | 133.98 | | 5.40 | 7.5 | 48.31 | 1.3 | 154.52 | 1.3 | 5.00 | |
| CP-620 | | 45 | 4.50 | 5.2 | 198.45 | | 4.50 | 7.4 | 5.65 | 1.3 | 118.17 | 1.3 | 5.00 | |
| CP-621 | | 45 | 4.50 | 5.2 | 191.27 | | 3.60 | 7.3 | 13.43 | 1.3 | 117.17 | 1.3 | 5.00 | |
| CP-622 | | 45 | 4.50 | 5.2 | 191.27 | | 4.05 | 7.3 | 13.43 | 1.3 | 117.17 | 1.3 | 5.00 | |
| CP-623 | | 45 | 4.50 | 5.2 | 191.15 | | 4.50 | 7.4 | 13.60 | 1.3 | 117.08 | 1.3 | 5.00 | |
| CP-624 | | 45 | 4.50 | 5.2 | 191.15 | | 4.95 | 7.4 | 13.60 | 1.3 | 117.08 | 1.3 | 5.00 | |
| CP-625 | | 45 | 4.50 | 5.2 | 191.00 | | 5.40 | 7.5 | 13.78 | 1.3 | 117.03 | 1.3 | 5.00 | |
| CP-626 | | 45 | 4.50 | 5.2 | 174.32 | | 3.60 | 7.3 | 31.82 | 1.3 | 114.77 | 1.3 | 5.00 | |
| CP-627 | | 45 | 4.50 | 5.2 | 174.32 | | 4.05 | 7.3 | 31.82 | 1.3 | 114.77 | 1.3 | 5.00 | |
| CP-628 | | 45 | 4.50 | 5.2 | 174.05 | | 4.50 | 7.4 | 32.20 | 1.3 | 114.58 | 1.3 | 5.00 | |
| CP-629 | | 45 | 4.50 | 5.2 | 174.05 | | 4.95 | 7.4 | 32.20 | 1.3 | 114.58 | 1.3 | 5.00 | |
| CP-630 | | 45 | 4.50 | 5.2 | 173.78 | | 5.40 | 7.5 | 32.58 | 1.3 | 114.40 | 1.3 | 5.00 | |
| CP-631 | | 45 | 4.50 | 5.2 | 161.77 | | 3.60 | 7.3 | 45.42 | 1.3 | 113.02 | 1.3 | 5.00 | |
| CP-632 | | 45 | 4.50 | 5.2 | 161.77 | | 4.05 | 7.3 | 45.42 | 1.3 | 113.02 | 1.3 | 5.00 | |
| CP-633 | | 45 | 4.50 | 5.2 | 161.42 | | 4.50 | 7.4 | 45.95 | 1.3 | 112.72 | 1.3 | 5.00 | |
| CP-634 | | 45 | 4.50 | 5.2 | 161.42 | | 4.95 | 7.4 | 45.95 | 1.3 | 112.72 | 1.3 | 5.00 | |
| CP-635 | | 45 | 4.50 | 5.2 | 161.07 | | 5.40 | 7.5 | 46.46 | 1.3 | 112.45 | 1.3 | 5.00 | |
| CP-636 | | 45 | 4.50 | 5.2 | 153.46 | | 4.50 | 7.4 | 54.60 | 1.3 | 111.57 | 1.3 | 5.00 | |
| CP-637 | | 45 | 4.50 | 5.2 | 209.00 | | 3.60 | 7.3 | 5.87 | 1.3 | 100.22 | 1.3 | 5.00 | |
| CP-638 | | 45 | 4.50 | 5.2 | 209.00 | | 4.05 | 7.3 | 5.87 | 1.3 | 100.22 | 1.3 | 5.00 | |
| CP-639 | | 45 | 4.50 | 5.2 | 208.92 | | 4.50 | 7.4 | 5.96 | 1.3 | 100.20 | 1.3 | 5.00 | |
| CP-640 | | 45 | 4.50 | 5.2 | 208.92 | | 4.95 | 7.4 | 5.96 | 1.3 | 100.20 | 1.3 | 5.00 | |

TABLE 51

| Conductive- | (1) A first metal oxide particle | | | | | (2) A second metal oxide particle | | | |
|---|---|---|---|---|---|---|---|---|---|
| layer | | Coating | Doping | | | | Doping | | |
| coating | | ratio | ratio | | Amount | | ratio | | Amount |
| solution | Kind | [%] | [%] | Density | [part(s)] | Kind | [%] | Density | [part(s)] |
| CP-641 | Ta- | 45 | 4.50 | 5.2 | 208.87 | Ta- | 5.40 | 7.5 | 6.03 |
| CP-642 | doped | 45 | 4.50 | 5.2 | 201.16 | doped | 4.50 | 7.4 | 14.30 |
| CP-643 | tin | 45 | 4.50 | 5.2 | 183.27 | tin oxide | 3.60 | 7.3 | 33.45 |
| CP-644 | oxide- | 45 | 4.50 | 5.2 | 183.27 | particles | 4.05 | 7.3 | 33.45 |
| CP-645 | coated | 45 | 4.50 | 5.2 | 182.97 | (average | 4.50 | 7.4 | 33.85 |
| CP-646 | titanium | 45 | 4.50 | 5.2 | 182.97 | particle | 4.95 | 7.4 | 33.85 |
| CP-647 | oxide | 45 | 4.50 | 5.2 | 182.67 | diameter: | 5.40 | 7.5 | 34.25 |
| CP-648 | particles | 45 | 4.50 | 5.2 | 169.56 | 20 nm) | 4.50 | 7.4 | 48.27 |
| CP-649 | (average | 45 | 4.50 | 5.2 | 161.58 | | 3.60 | 7.3 | 56.71 |
| CP-650 | particle | 45 | 4.50 | 5.2 | 161.58 | | 4.05 | 7.3 | 56.71 |
| CP-651 | diameter: | 45 | 4.50 | 5.2 | 161.13 | | 4.50 | 7.4 | 57.32 |
| CP-652 | 230 nm) | 45 | 4.50 | 5.2 | 161.13 | | 4.95 | 7.4 | 57.32 |
| CP-653 | | 45 | 4.50 | 5.2 | 160.68 | | 5.40 | 7.5 | 57.94 |

| | (3) Binding material | | | | | | |
|---|---|---|---|---|---|---|---|
| | (phenol resin) | | | | | | |
| Conductive- | | Amount [part(s)] | (4) Silicone resin | | (5) Particles except | | |
| layer | | (resin solid content | particles | | (1) to (4) | | |
| coating | | thereof is 60% by | | Amount | | | Amount |
| solution | Density | mass of the following) | Density | [part(s)] | Kind | Density | [part(s)] |

| | | | | | |
|---|---|---|---|---|---|
| CP-641 | 1.3 | 100.17 | 1.3 | 5.00 | None |
| CP-642 | 1.3 | 99.23 | 1.3 | 5.00 | |
| CP-643 | 1.3 | 97.13 | 1.3 | 5.00 | |
| CP-644 | 1.3 | 97.13 | 1.3 | 5.00 | |
| CP-645 | 1.3 | 96.97 | 1.3 | 5.00 | |
| CP-646 | 1.3 | 96.97 | 1.3 | 5.00 | |
| CP-647 | 1.3 | 96.80 | 1.3 | 5.00 | |
| CP-648 | 1.3 | 95.28 | 1.3 | 5.00 | |
| CP-649 | 1.3 | 94.52 | 1.3 | 5.00 | |
| CP-650 | 1.3 | 94.52 | 1.3 | 5.00 | |
| CP-651 | 1.3 | 94.25 | 1.3 | 5.00 | |
| CP-652 | 1.3 | 94.25 | 1.3 | 5.00 | |
| CP-653 | 1.3 | 93.97 | 1.3 | 5.00 | |

TABLE 52

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part | | | | | |
| | | | | | | | | | | | (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | of the | | Amount | | | Amount |
| coating | | ratio | ratio | Den- | [part | | ratio | Den- | [part | Den- | follow- | Den- | [part | | Den- | [part |
| solution | Kind | [%] | [%] | sity | (s)] | Kind | [%] | sity | (s)] | sity | ing) | sity | (s)] | Kind | sity | (s)] |
| CP-654 | Ta- | 45 | 4.50 | 5.2 | 136.45 | Ta- | 3.60 | 7.3 | 9.58 | 1.3 | 156.62 | 1.3 | 40.00 | Uncoated | 4.2 | 30.00 |
| CP-655 | doped | 45 | 4.50 | 5.2 | 136.45 | doped | 4.05 | 7.3 | 9.58 | 1.3 | 156.62 | 1.3 | 40.00 | titanium | 4.2 | 30.00 |
| CP-656 | tin | 45 | 4.50 | 5.2 | 136.40 | tin | 4.50 | 7.4 | 9.70 | 1.3 | 156.50 | 1.3 | 40.00 | oxide- | 4.2 | 30.00 |
| CP-657 | oxide- | 45 | 4.50 | 5.2 | 136.40 | oxide- | 4.95 | 7.4 | 9.70 | 1.3 | 156.50 | 1.3 | 40.00 | particles | 4.2 | 30.00 |
| CP-658 | coated | 45 | 4.50 | 5.2 | 136.34 | particles | 5.40 | 7.5 | 9.83 | 1.3 | 156.38 | 1.3 | 40.00 | (average | 4.2 | 30.00 |
| CP-659 | titanium | 45 | 4.50 | 5.2 | 125.10 | (average | 3.60 | 7.3 | 22.83 | 1.3 | 153.45 | 1.3 | 40.00 | particle | 4.2 | 30.00 |
| CP-660 | oxide | 45 | 4.50 | 5.2 | 125.10 | particle | 4.05 | 7.3 | 22.83 | 1.3 | 153.45 | 1.3 | 40.00 | diameter: | 4.2 | 30.00 |
| CP-661 | particles | 45 | 4.50 | 5.2 | 124.95 | diameter: | 4.50 | 7.4 | 23.12 | 1.3 | 153.22 | 1.3 | 40.00 | 210 nm) | 4.2 | 30.00 |
| CP-662 | (aver- | 45 | 4.50 | 5.2 | 124.95 | 20 nm) | 4.95 | 7.4 | 23.12 | 1.3 | 153.22 | 1.3 | 40.00 | | 4.2 | 30.00 |
| CP-663 | age | 45 | 4.50 | 5.2 | 124.82 | | 5.40 | 7.5 | 23.40 | 1.3 | 152.97 | 1.3 | 40.00 | | 4.2 | 30.00 |
| CP-664 | part- | 45 | 4.50 | 5.2 | 116.60 | | 3.60 | 7.3 | 32.73 | 1.3 | 151.12 | 1.3 | 40.00 | | 4.2 | 30.00 |
| CP-665 | icle | 45 | 4.50 | 5.2 | 116.60 | | 4.05 | 7.3 | 32.73 | 1.3 | 151.12 | 1.3 | 40.00 | | 4.2 | 30.00 |
| CP-666 | dia- | 45 | 4.50 | 5.2 | 116.42 | | 4.50 | 7.4 | 33.13 | 1.3 | 150.75 | 1.3 | 40.00 | | 4.2 | 30.00 |
| CP-667 | meter: | 45 | 4.50 | 5.2 | 116.42 | | 4.95 | 7.4 | 33.13 | 1.3 | 150.75 | 1.3 | 40.00 | | 4.2 | 30.00 |
| CP-668 | 230 | 45 | 4.50 | 5.2 | 116.25 | | 5.40 | 7.5 | 33.53 | 1.3 | 150.37 | 1.3 | 40.00 | | 4.2 | 30.00 |
| CP-669 | nm) | 45 | 4.50 | 5.2 | 171.92 | | 3.60 | 7.3 | 12.06 | 1.3 | 93.37 | 1.3 | 40.00 | | 4.2 | 30.00 |
| CP-670 | | 45 | 4.50 | 5.2 | 171.92 | | 4.05 | 7.3 | 12.06 | 1.3 | 93.37 | 1.3 | 40.00 | | 4.2 | 30.00 |
| CP-671 | | 45 | 4.50 | 5.2 | 171.82 | | 4.50 | 7.4 | 12.23 | 1.3 | 93.25 | 1.3 | 40.00 | | 4.2 | 30.00 |
| CP-672 | | 45 | 4.50 | 5.2 | 171.82 | | 4.95 | 7.4 | 12.23 | 1.3 | 93.25 | 1.3 | 40.00 | | 4.2 | 30.00 |
| CP-673 | | 45 | 4.50 | 5.2 | 171.72 | | 5.40 | 7.5 | 12.38 | 1.3 | 93.17 | 1.3 | 40.00 | | 4.2 | 30.00 |
| CP-674 | | 45 | 4.50 | 5.2 | 157.08 | | 3.60 | 7.3 | 28.67 | 1.3 | 90.42 | 1.3 | 40.00 | | 4.2 | 30.00 |
| CP-675 | | 45 | 4.50 | 5.2 | 157.08 | | 4.05 | 7.3 | 28.67 | 1.3 | 90.42 | 1.3 | 40.00 | | 4.2 | 30.00 |
| CP-676 | | 45 | 4.50 | 5.2 | 156.85 | | 4.50 | 7.4 | 29.02 | 1.3 | 90.22 | 1.3 | 40.00 | | 4.2 | 30.00 |
| CP-677 | | 45 | 4.50 | 5.2 | 156.85 | | 4.95 | 7.4 | 29.02 | 1.3 | 90.22 | 1.3 | 40.00 | | 4.2 | 30.00 |
| CP-678 | | 45 | 4.50 | 5.2 | 156.64 | | 5.40 | 7.5 | 29.37 | 1.3 | 89.98 | 1.3 | 40.00 | | 4.2 | 30.00 |
| CP-679 | | 45 | 4.50 | 5.2 | 146.04 | | 3.60 | 7.3 | 41.00 | 1.3 | 88.27 | 1.3 | 40.00 | | 4.2 | 30.00 |
| CP-680 | | 45 | 4.50 | 5.2 | 146.04 | | 4.05 | 7.3 | 41.00 | 1.3 | 88.27 | 1.3 | 40.00 | | 4.2 | 30.00 |
| CP-681 | | 45 | 4.50 | 5.2 | 145.76 | | 4.50 | 7.4 | 41.48 | 1.3 | 87.93 | 1.3 | 40.00 | | 4.2 | 30.00 |
| CP-682 | | 45 | 4.50 | 5.2 | 145.76 | | 4.95 | 7.4 | 41.48 | 1.3 | 87.93 | 1.3 | 40.00 | | 4.2 | 30.00 |
| CP-683 | | 45 | 4.50 | 5.2 | 145.48 | | 5.40 | 7.5 | 41.96 | 1.3 | 87.60 | 1.3 | 40.00 | | 4.2 | 30.00 |
| CP-684 | | 45 | 4.50 | 5.2 | 197.62 | | 3.60 | 7.3 | 13.86 | 1.3 | 47.53 | 1.3 | 40.00 | | 4.2 | 30.00 |
| CP-685 | | 45 | 4.50 | 5.2 | 197.62 | | 4.05 | 7.3 | 13.86 | 1.3 | 47.53 | 1.3 | 40.00 | | 4.2 | 30.00 |
| CP-686 | | 45 | 4.50 | 5.2 | 197.48 | | 4.50 | 7.4 | 14.05 | 1.3 | 47.45 | 1.3 | 40.00 | | 4.2 | 30.00 |
| CP-687 | | 45 | 4.50 | 5.2 | 197.48 | | 4.95 | 7.4 | 14.05 | 1.3 | 47.45 | 1.3 | 40.00 | | 4.2 | 30.00 |
| CP-688 | | 45 | 4.50 | 5.2 | 197.36 | | 5.40 | 7.5 | 14.22 | 1.3 | 47.37 | 1.3 | 40.00 | | 4.2 | 30.00 |
| CP-689 | | 45 | 4.50 | 5.2 | 180.09 | | 3.60 | 7.3 | 32.87 | 1.3 | 45.07 | 1.3 | 40.00 | | 4.2 | 30.00 |
| CP-690 | | 45 | 4.50 | 5.2 | 180.09 | | 4.05 | 7.3 | 32.87 | 1.3 | 45.07 | 1.3 | 40.00 | | 4.2 | 30.00 |

TABLE 53

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | of the | | Amount | | | Amount |
| coating | | ratio | ratio | Den- | [part | | ratio | Den- | [part | Den- | follow- | Den- | [part | | Den- | [part |
| solution | Kind | [%] | [%] | sity | (s)] | Kind | [%] | sity | (s)] | sity | ing) | sity | (s)] | Kind | sity | (s)] |
| CP-691 | Ta- | 45 | 4.50 | 5.2 | 179.82 | Ta- | 4.50 | 7.4 | 33.26 | 1.3 | 44.87 | 1.3 | 40.00 | Uncoated | 4.2 | 30.00 |
| CP-692 | doped | 45 | 4.50 | 5.2 | 179.82 | doped | 4.95 | 7.4 | 33.26 | 1.3 | 44.87 | 1.3 | 40.00 | titanium | 4.2 | 30.00 |
| CP-693 | tin | 45 | 4.50 | 5.2 | 179.55 | tin | 5.40 | 7.5 | 33.66 | 1.3 | 44.65 | 1.3 | 40.00 | oxide- | 4.2 | 30.00 |
| CP-694 | oxide- | 45 | 4.50 | 5.2 | 167.15 | oxide- | 3.60 | 7.3 | 46.92 | 1.3 | 43.22 | 1.3 | 40.00 | particles | 4.2 | 30.00 |
| CP-695 | coated | 45 | 4.50 | 5.2 | 167.15 | particles | 4.05 | 7.3 | 46.92 | 1.3 | 43.22 | 1.3 | 40.00 | (average | 4.2 | 30.00 |
| CP-696 | titanium | 45 | 4.50 | 5.2 | 166.77 | (average | 4.50 | 7.4 | 47.46 | 1.3 | 42.95 | 1.3 | 40.00 | particle | 4.2 | 30.00 |
| CP-697 | oxide | 45 | 4.50 | 5.2 | 166.77 | particle | 4.95 | 7.4 | 47.46 | 1.3 | 42.95 | 1.3 | 40.00 | diameter: | 4.2 | 30.00 |
| CP-698 | particles | 45 | 4.50 | 5.2 | 166.40 | diameter: | 5.40 | 7.5 | 48.00 | 1.3 | 42.67 | 1.3 | 40.00 | 210 nm) | 4.2 | 30.00 |
| CP-699 | (average | 45 | 4.50 | 5.2 | 156.85 | 20 nm) | 4.50 | 7.4 | 29.02 | 1.3 | 90.22 | 1.3 | 40.00 | | 4.2 | 30.00 |
| CP-700 | particle | 45 | 4.50 | 5.2 | 160.36 | | 4.50 | 7.4 | 25.10 | 1.3 | 90.90 | 1.3 | 40.00 | | 4.2 | 30.00 |
| | diameter: | | | | | | | | | | | | | | | |
| | 230 nm) | | | | | | | | | | | | | | | |

TABLE 54

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | of the | | Amount | | | Amount |
| coating | | ratio | ratio | Den- | [part | | ratio | Den- | [part | Den- | follow- | Den- | [part | | Den- | [part |
| solution | Kind | [%] | [%] | sity | (s)] | Kind | [%] | sity | (s)] | sity | ing) | sity | (s)] | Kind | sity | (s)] |
| CP-C129 | Ta-doped | 45 | 4.50 | 5.2 | 115.85 | None | | | | 1.3 | 265.25 | 1.3 | 5.00 | None | | |
| CP-C130 | tin oxide- | 45 | 4.50 | 5.2 | 176.85 | | | | | 1.3 | 163.58 | 1.3 | 5.00 | | | |
| CP-C131 | coated | 45 | 4.50 | 5.2 | 214.46 | | | | | 1.3 | 100.90 | 1.3 | 5.00 | | | |
| CP-C132 | titanium | 45 | 4.50 | 5.2 | 114.50 | | 4.50 | 7.4 | 1.63 | 1.3 | 264.78 | 1.3 | 5.00 | | | |
| CP-C133 | oxide | 45 | 4.50 | 5.2 | 174.63 | | 4.50 | 7.4 | 2.40 | 1.3 | 163.15 | 1.3 | 5.00 | | | |
| CP-C134 | particles | 45 | 4.50 | 5.2 | 211.67 | | 4.50 | 7.4 | 3.00 | 1.3 | 100.55 | 1.3 | 5.00 | | | |
| CP-C135 | (average | 45 | 4.50 | 5.2 | 85.65 | | 4.50 | 7.4 | 36.57 | 1.3 | 254.63 | 1.3 | 5.00 | | | |
| CP-C136 | particle | 45 | 4.50 | 5.2 | 128.12 | | 4.50 | 7.4 | 54.70 | 1.3 | 153.63 | 1.3 | 5.00 | | | |
| CP-C137 | diameter: | 45 | 4.50 | 5.2 | 153.49 | | 4.50 | 7.4 | 65.53 | 1.3 | 93.30 | 1.3 | 5.00 | | | |
| | 230 nm) | | | | | | | | | | | | | | | |
| CP-C138 | None | | | | | Ta- | 4.50 | 7.4 | 140.30 | 1.3 | 224.50 | 1.3 | 5.00 | | | |
| CP-C139 | | | | | | doped | 4.50 | 7.4 | 198.60 | 1.3 | 127.33 | 1.3 | 5.00 | | | |
| CP-C140 | | | | | | tin | 4.50 | 7.4 | 230.50 | 1.3 | 74.17 | 1.3 | 5.00 | | | |
| CP-C141 | Ta-doped | 45 | 4.50 | 5.2 | 84.25 | oxide- | 4.50 | 7.4 | 2.40 | 1.3 | 313.92 | 1.3 | 5.00 | | | |
| CP-C142 | tin oxide- | 45 | 4.50 | 5.2 | 81.56 | particles | 4.50 | 7.4 | 5.80 | 1.3 | 312.73 | 1.3 | 5.00 | | | |
| CP-C143 | coated | 45 | 4.50 | 5.2 | 75.10 | (average | 4.50 | 7.4 | 13.89 | 1.3 | 310.02 | 1.3 | 5.00 | | | |
| CP-C144 | titanium | 45 | 4.50 | 5.2 | 70.28 | particle | 4.50 | 7.4 | 20.00 | 1.3 | 307.87 | 1.3 | 5.00 | | | |
| CP-C145 | oxide | 45 | 4.50 | 5.2 | 67.19 | diameter: | 4.50 | 7.4 | 23.90 | 1.3 | 306.57 | 1.3 | 5.00 | | | |
| CP-C146 | particles | 45 | 4.50 | 5.2 | 218.17 | 20 nm) | 4.50 | 7.4 | 6.20 | 1.3 | 84.38 | 1.3 | 5.00 | | | |
| CP-C147 | (average | 45 | 4.50 | 5.2 | 209.94 | | 4.50 | 7.4 | 14.95 | 1.3 | 83.52 | 1.3 | 5.00 | | | |
| CP-C148 | particle | 45 | 4.50 | 5.2 | 190.80 | | 4.50 | 7.4 | 35.30 | 1.3 | 81.50 | 1.3 | 5.00 | | | |
| CP-C149 | diameter: | 45 | 4.50 | 5.2 | 176.69 | | 4.50 | 7.4 | 50.30 | 1.3 | 80.02 | 1.3 | 5.00 | | | |
| CP-C150 | 230 nm) | 45 | 4.50 | 5.2 | 167.83 | | 4.50 | 7.4 | 59.72 | 1.3 | 79.08 | 1.3 | 5.00 | | | |

TABLE 55

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | of the | | Amount | | | Amount |
| coating | | ratio | ratio | Den- | [part | | ratio | Den- | [part | Den- | follow- | Den- | [part | | Den- | [part |
| solution | Kind | [%] | [%] | sity | (s)] | Kind | [%] | sity | (s)] | sity | ing) | sity | (s)] | Kind | sity | (s)] |
| CP-C151 | Nb- | 45 | 4.50 | 5.1 | 151.95 | P- | 4.50 | 6.7 | 25.95 | 1.3 | 161.83 | 1.3 | 5.00 | None | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C152 | Ta- | 45 | 4.50 | 5.2 | 153.28 | | 4.50 | 6.7 | 25.68 | 1.3 | 160.07 | 1.3 | 5.00 | | | |
| | doped | | | | | | | | | | | | | | | |
| | tin | | | | | | | | | | | | | | | |
| | oxide- | | | | | | | | | | | | | | | |
| | coated | | | | | | | | | | | | | | | |
| | titanium | | | | | | | | | | | | | | | |
| | oxide | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |
| CP-C153 | P- | 45 | 4.50 | 5.1 | 151.30 | Nb- | 4.50 | 7.0 | 27.00 | 1.3 | 161.17 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| CP-C154 | particle | 45 | 4.50 | 5.1 | 150.48 | Ta- | 4.50 | 7.4 | 28.38 | 1.3 | 160.23 | 1.3 | 5.00 | | | |
| | diameter: | | | | | doped | | | | | | | | | | |
| | 230 nm) | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |
| CP-C155 | Nb- | 45 | 4.50 | 5.1 | 150.28 | W- | 4.50 | 7.5 | 28.73 | 1.3 | 159.98 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C156 | Ta- | 45 | 4.50 | 5.2 | 151.63 | | 4.50 | 7.5 | 28.43 | 1.3 | 158.23 | 1.3 | 5.00 | | | |
| | doped | | | | | | | | | | | | | | | |
| | tin | | | | | | | | | | | | | | | |
| | oxide- | | | | | | | | | | | | | | | |
| | coated | | | | | | | | | | | | | | | |
| | titanium | | | | | | | | | | | | | | | |
| | oxide | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |
| CP-C157 | W- | 45 | 4.50 | 5.2 | 152.65 | Nb- | 4.50 | 7.0 | 26.72 | 1.3 | 159.38 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| CP-C158 | particle | 45 | 4.50 | 5.2 | 151.83 | Ta | 4.50 | 7.4 | 28.08 | 1.3 | 158.48 | 1.3 | 5.00 | | | |
| | diameter: | | | | | doped | | | | | | | | | | |
| | 230 nm) | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |

TABLE 56

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | | | Amount | | | Amount |
| coating | | ratio | ratio | Den- | [part | | ratio | Den- | [part | Den- | of the | Den- | [part | | Den- | [part |
| solution | Kind | [%] | [%] | sity | (s)] | Kind | [%] | sity | (s)] | sity | following) | sity | (s)] | Kind | sity | (s)] |
| CP-C159 | Nb- | 45 | 4.50 | 5.1 | 152.15 | F- | 4.50 | 6.6 | 25.60 | 1.3 | 162.08 | 1.3 | 5.00 | None | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C160 | Ta- | 45 | 4.50 | 5.2 | 153.50 | | 4.50 | 6.6 | 25.32 | 1.3 | 160.30 | 1.3 | 5.00 | | | |
| | doped | | | | | | | | | | | | | | | |
| | tin | | | | | | | | | | | | | | | |
| | oxide- | | | | | | | | | | | | | | | |
| | coated | | | | | | | | | | | | | | | |
| | titanium | | | | | | | | | | | | | | | |
| | oxide | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |
| CP-C161 | F- | 45 | 4.50 | 5.0 | 149.93 | Nb- | 4.50 | 7.0 | 27.29 | 1.3 | 162.97 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| CP-C162 | particle | 45 | 4.50 | 5.0 | 149.10 | Ta- | 4.50 | 7.4 | 28.38 | 1.3 | 162.03 | 1.3 | 5.00 | | | |
| | diameter: | | | | | doped | | | | | | | | | | |
| | 230 nm) | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |
| CP-C163 | Oxygen- | 45 | — | 5.1 | 152.00 | | 4.50 | 7.0 | 26.00 | 1.3 | 161.67 | 1.3 | 5.00 | | | |
| | deficient | | | | | | | | | | | | | | | |
| | tin | | | | | | | | | | | | | | | |
| | oxide- | | | | | | | | | | | | | | | |
| | coated | | | | | | | | | | | | | | | |
| | titanium | | | | | | | | | | | | | | | |
| | oxide | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |
| CP-C164 | Oxygen- | 45 | — | 5.1 | 152.00 | Nb- | 4.50 | 7.0 | 26.00 | 1.3 | 161.67 | 1.3 | 5.00 | | | |
| | deficient | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | barium | | | | | (average | | | | | | | | | | |
| | sulfate | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C165 | Sb- | 45 | 4.50 | 5.1 | 152.00 | | 4.50 | 7.0 | 26.00 | 1.3 | 161.67 | 1.3 | 5.00 | | | |
| | doped | | | | | | | | | | | | | | | |
| | tin | | | | | | | | | | | | | | | |
| | oxide- | | | | | | | | | | | | | | | |
| | coated | | | | | | | | | | | | | | | |
| | titanium | | | | | | | | | | | | | | | |
| | oxide | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |

TABLE 57

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | of the | | Amount | | | Amount |
| coating | | ratio | ratio | Den- | [part | | ratio | Den- | [part | Den- | follow- | Den- | [part | | Den- | [part |
| solution | Kind | [%] | [%] | sity | (s)] | Kind | [%] | sity | (s)] | sity | ing) | sity | (s)] | Kind | sity | (s)] |
| CP-C166 | Nb- | 45 | 4.50 | 5.1 | 152.20 | Oxygen- | — | 6.6 | 25.60 | 1.3 | 162.00 | 1.3 | 5.00 | None | | |
| | doped | | | | | deficient | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C167 | | 45 | 4.50 | 5.1 | 151.10 | Indium | 4.50 | 7.1 | 27.35 | 1.3 | 160.92 | 1.3 | 5.00 | | | |
| | | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |
| CP-C168 | | 45 | 4.50 | 5.1 | 152.20 | Sb- | 4.50 | 6.6 | 25.60 | 1.3 | 162.00 | 1.3 | 5.00 | | | |
| | | | | | | doped | | | | | | | | | | |
| | | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |
| CP-C169 | Ta- | 45 | 4.50 | 5.0 | 153.30 | Nb- | 4.50 | 7.0 | 25.70 | 1.3 | 160.00 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C170 | Nb- | 45 | 4.50 | 5.1 | 150.60 | Ta- | 4.50 | 7.0 | 26.25 | 1.3 | 163.58 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C171 | Nb- | 45 | 4.50 | 5.1 | 151.90 | Nb- | 4.50 | 7.0 | 26.00 | 1.3 | 161.83 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | barium | | | | | (average | | | | | | | | | | |
| | sulfate | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |

TABLE 58

| | | | | | | | | | | (3) Binding | | | | | | |
|---|---|---|---|---|---|---|---|---|---|---|---|---|---|---|---|---|
| | | | | | | | | | | material | | | | | | |
| | | | | | | | | | | (phenol resin) | | | | | | |
| | | | | | | | | | | | Amount | | | | | |
| | | | | | | | | | | | [part (s)] | | | | | |
| | | | | | | | | | | | (resin | | | | | |
| | | | | | | | | | | | solid | | | | | |
| | | | | | | | | | | | content | | | | | |
| | (1) A first metal | | | | | (2) A second metal | | | | | thereof | | | | | |
| Con- | oxide particle | | | | | oxide particle | | | | | is 60% | (4) Silicone | | (5) Particles except | | |
| ductive- | | Coat- | Dop- | | | | Dop- | | | | by mass | resin particles | | (1) to (4) | | |
| layer | | ing | ing | | Amount | | ing | | Amount | | of the | | Amount | | | Amount |
| coating | | ratio | ratio | Den- | [part | | ratio | Den- | [part | Den- | follow- | Den- | [part | | Den- | [part |
| solution | Kind | [%] | [%] | sity | (s)] | Kind | [%] | sity | (s)] | sity | ing) | sity | (s)] | Kind | sity | (s)] |
| CP-C172 | Oxygen- | 45 | — | 5.1 | 152.00 | Ta- | 4.50 | 7.4 | 26.00 | 1.3 | 161.67 | 1.3 | 5.00 | None | | |
| | deficient | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C173 | Oxygen- | 45 | — | 5.1 | 152.00 | | 4.50 | 7.4 | 26.00 | 1.3 | 161.67 | 1.3 | 5.00 | | | |
| | deficient | | | | | | | | | | | | | | | |
| | tin | | | | | | | | | | | | | | | |
| | oxide- | | | | | | | | | | | | | | | |
| | coated | | | | | | | | | | | | | | | |
| | barium | | | | | | | | | | | | | | | |
| | sulfate | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |
| CP-C174 | Sb- | 45 | 4.50 | 5.1 | 152.00 | | 4.50 | 7.4 | 26.00 | 1.3 | 161.67 | 1.3 | 5.00 | | | |
| | doped | | | | | | | | | | | | | | | |
| | tin | | | | | | | | | | | | | | | |
| | oxide- | | | | | | | | | | | | | | | |
| | coated | | | | | | | | | | | | | | | |
| | titanium | | | | | | | | | | | | | | | |
| | oxide | | | | | | | | | | | | | | | |
| | particles | | | | | | | | | | | | | | | |
| | (average | | | | | | | | | | | | | | | |
| | particle | | | | | | | | | | | | | | | |
| | diameter: | | | | | | | | | | | | | | | |
| | 230 nm) | | | | | | | | | | | | | | | |
| CP-C175 | Ta- | 45 | 4.50 | 5.2 | 152.20 | Oxygen- | — | 6.6 | 25.60 | 1.3 | 162.00 | 1.3 | 5.00 | | | |
| | doped | | | | | deficent | | | | | | | | | | |
| | tin | | | | | tin | | | | | | | | | | |
| | oxide- | | | | | oxide- | | | | | | | | | | |
| | coated | | | | | particles | | | | | | | | | | |
| | titanium | | | | | (average | | | | | | | | | | |
| | oxide | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C176 | | 45 | 4.50 | 5.2 | 151.10 | Indium | 4.50 | 7.1 | 27.35 | 1.3 | 160.92 | 1.3 | 5.00 | | | |
| | | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |
| CP-C177 | | 45 | 4.50 | 5.2 | 152.20 | Sb- | 4.50 | 6.6 | 25.60 | 1.3 | 162.00 | 1.3 | 5.00 | | | |
| | | | | | | doped | | | | | | | | | | |
| | | | | | | tin | | | | | | | | | | |
| | | | | | | oxide- | | | | | | | | | | |
| | | | | | | particles | | | | | | | | | | |
| | | | | | | (average | | | | | | | | | | |
| | | | | | | particle | | | | | | | | | | |
| | | | | | | diameter: | | | | | | | | | | |
| | | | | | | 20 nm) | | | | | | | | | | |
| CP-C178 | Ta- | 45 | 4.50 | 5.2 | 151.90 | Ta- | 4.50 | 7.0 | 26.00 | 1.3 | 161.83 | 1.3 | 5.00 | | | |
| | doped | | | | | doped | | | | | | | | | | |
| | tin | | | | | tin | | | | | | | | | | |
| | oxide- | | | | | oxide- | | | | | | | | | | |
| | coated | | | | | particles | | | | | | | | | | |
| | barium | | | | | (average | | | | | | | | | | |
| | sulfate | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |
| CP-C179 | Oxygen- | 45 | — | 5.1 | 152.20 | Oxygen- | — | 6.6 | 25.60 | 1.3 | 162.00 | 1.3 | 5.00 | | | |
| | deficient | | | | | deficent | | | | | | | | | | |
| | tin | | | | | tin | | | | | | | | | | |
| | oxide- | | | | | oxide- | | | | | | | | | | |
| | coated | | | | | particles | | | | | | | | | | |
| | barium | | | | | (average | | | | | | | | | | |
| | sulfate | | | | | particle | | | | | | | | | | |
| | particles | | | | | diameter: | | | | | | | | | | |
| | (average | | | | | 20 nm) | | | | | | | | | | |
| | particle | | | | | | | | | | | | | | | |
| | diameter: | | | | | | | | | | | | | | | |
| | 230 nm) | | | | | | | | | | | | | | | |

### Example 1

### Production Example of Electrophotographic Photosensitive Member 1

An aluminum cylinder (JIS-A3003, aluminum alloy) having a length of 251.5 mm, a diameter of 24 mm, and a thickness of 1.0 mm produced by a production method including an extrusion process and a drawing process was used as a support (cylindrical support).

The conductive-layer coating solution CP-1 was applied onto the support under a 22° C./55% RH environment by dip coating, and then the resultant coating film was dried and thermally cured for 30 minutes at 140° C. to form a conductive layer having a thickness of 20 μm.

The volume resistivity of the conductive layer was measured to be 2.2×10¹³ Ω·cm.

Next, 4.5 parts of N-methoxymethylated nylon (trade name: Toresin EF-30T, manufactured by Teikoku Chemical Industry Co., Ltd.) and 1.5 parts of a copolymerized nylon resin (trade name: Amilan CM8000, manufactured by Toray Industries, Inc.) were dissolved in a mixed solvent of 65 parts of methanol and 30 parts of n-butanol to prepare an undercoat-layer coating solution. The undercoat-layer coating solution was applied onto the conductive layer by dip coating, and then the resultant coating film was dried for 6 minutes at 70° C. to form an undercoat layer having a thickness of 0.85 μm.

Next, 10 parts of a hydroxygallium phthalocyanine crystal (charge-generating substance) in a crystal form having strong peaks at Bragg angles)(2θ±0.2° in CuKα-characteristic X-ray diffraction of 7.5°, 9.9°, 16.3°, 18.6°, 25.1°, and 28.3°, 5 parts of a polyvinyl butyral (trade name: S-LEC BX-1, manufactured by SEKISUI CHEMICAL, CO., LTD.), and 250 parts of cyclohexanone were loaded into a sand mill using glass beads each having a diameter of 1 mm, and were then subjected to a dispersion treatment under the condition of a dispersion treatment time of 3 hours. After the dispersion treatment, 250 parts of ethyl acetate were added to the treated product to prepare a charge-generating-layer coating solution. The charge-generating-layer coating solution was applied onto the undercoat layer by dip coating, and then the resultant coating film was dried for 10 minutes at 100° C. to form a charge-generating layer having a thickness of 0.12 μm.

Next, 56 parts of an amine compound (charge-transporting substance) represented by the following formula (CT-1):

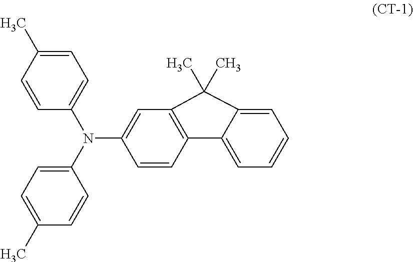 [SMILES: Cc1ccc(N(c2ccc(C)cc2)c2ccc3c(c2)C(C)(C)c2ccccc2-3)cc1]

24 parts of an amine compound (charge-transporting substance) represented by the following formula (CT-2):

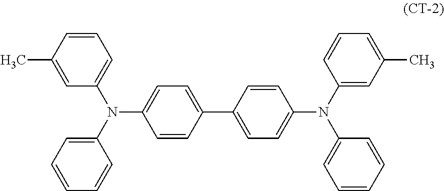

90 parts of a polycarbonate (trade name: Z200, manufactured by Mitsubishi Engineering-Plastics Corporation), 10 parts of a siloxane-modified polycarbonate having a repeating structural unit represented by the following formula (B-1) and a repeating structural unit represented by the following formula (B-2) ((B-1):(B-2)=98:2 (molar ratio)):

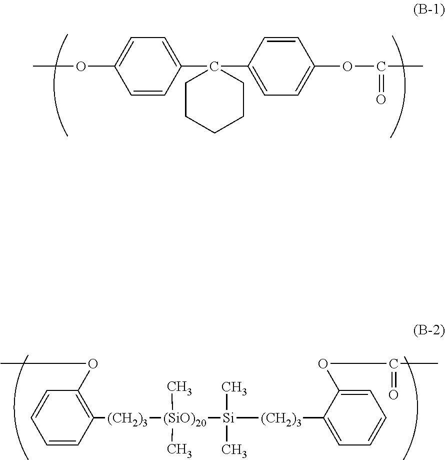

and 0.9 part of a siloxane-modified polycarbonate having a repeating structural unit represented by the following formula (B-3) and a repeating structural unit represented by the following formula (B-4), and having a terminal structure represented by the following formula (B-5) ((B-3):(B-4)=95:5 (molar ratio)):

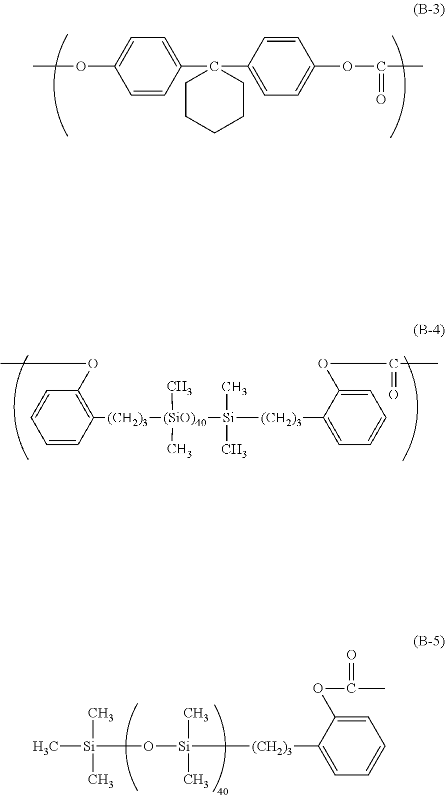

were dissolved in a mixed solvent of 300 parts of o-xylene, 250 parts of dimethoxymethane, and 27 parts of methyl benzoate to prepare a charge-transporting-layer coating solution. The charge-transporting-layer coating solution was applied onto the charge-generating layer by dip coating, and then the resultant coating film was dried for 30 minutes at 120° C. to form a charge-transporting layer having a thickness of 18.5 μm. Thus, an electrophotographic photosensitive member 1 including the charge-transporting layer as a surface layer was produced.

With regard to the electrophotographic photosensitive member 1, the abundance ratio of phosphorus to tin oxide in the P-doped tin oxide-coated titanium oxide particles and the abundance ratio of phosphorus to tin oxide in the P-doped tin oxide particles were each determined from an atomic ratio by employing the foregoing method.

Next, the volume of the P-doped tin oxide-coated titanium oxide particles and the volume of the P-doped tin oxide particles were measured by identifying the P-doped tin oxide-coated titanium oxide particles and the P-doped tin oxide particles based on their difference in contrast of the slice and view of the FIB-SEM by employing the foregoing method. The same holds true for the following examples.

### Examples 2 to 700 and Comparative Examples 1 to 179

### Production Examples of Electrophotographic Photosensitive Members 2 to 700 and C1 to C179

Electrophotographic photosensitive members 2 to 700 and C1 to C179 were produced by the same operations as those of Example 1 (production example of the electrophotographic photosensitive member 1) except that the conductive-layer coating solution was changed as shown in Tables 22 to 43 and Tables 59 to 73.

(Evaluation)

An evaluation for a crack was performed by observing the surface of a conductive layer at the stage of the formation of the conductive layer on a support with an optical microscope and by observing an image output from an electrophotographic apparatus (laser beam printer) mounted with a produced electrophotographic photosensitive member.

The image observation was performed as described below.

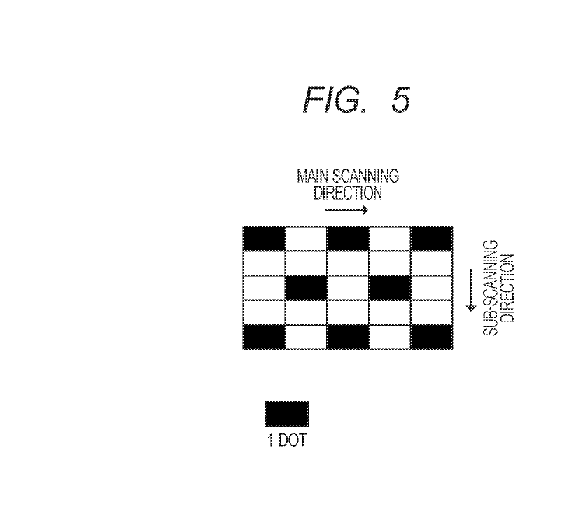

The produced electrophotographic photosensitive member was mounted on a laser beam printer manufactured by Hewlett-Packard Company (trade name: LaserJet P2055dn) as an evaluation apparatus. The resultant was placed under a normal-temperature and normal-humidity (23° C./50% RH) environment, and then a solid black image, a solid white image, and a half-tone image of a one-dot keima pattern were output, followed by the observation of the output images. The half-tone image of a one-dot keima pattern is a half-tone image of a pattern illustrated in FIG. 5.

The degrees of the occurrence of the crack were classified into ranks based on the observation of the images and the following microscopic observation of the conductive layer as described below.

The case where the observation of the surface of the conductive layer with the optical microscope could not confirm the occurrence of any crack was defined as a rank 3. In addition, the case where the observation of the surface of the conductive layer with the optical microscope was able to confirm the occurrence of a crack but an image defect due to the crack was not observed on any one of the solid black image, the solid white image, and the half-tone image of a one-dot keima pattern was defined as a rank 2. In addition, the case where the observation of the surface of the conductive layer with the optical microscope was able to confirm the occurrence of a crack, and an image defect probably due to the crack was observed on any one of the solid black image, the solid white image, and the half-tone image of a one-dot keima pattern was defined as a rank 1. The half-tone image of a one-dot keima pattern is a half-tone image of a pattern illustrated in FIG. 5.

An evaluation for a residual potential and an evaluation for a pattern memory were also performed with a laser beam printer manufactured by Hewlett-Packard Company (trade name: LaserJet P2055dn) as an evaluation apparatus.

The evaluation for a pattern memory was performed as described below.

A produced electrophotographic photosensitive member was mounted on the laser beam printer manufactured by Hewlett-Packard Company. The resultant was placed under a low-temperature and low-humidity (15° C./7% RH) environment, and then a durability test involving continuously outputting 15,000 images of a 3-dot and 100-space vertical line pattern in a repeated manner was performed. The degrees of the occurrence of a pattern memory were classified into six ranks as shown in Table 74 according to the manner in which vertical streaks resulting from the hysteresis of the vertical lines were observed on each of four kinds of half-tone images and a solid black image shown in Table 74 output after the test. The number of the rank becomes larger as the extent to which the pattern memory is suppressed improves. It should be noted that the four kinds of half-tone images are a half-tone image of a one-dot keima pattern, a half-tone image with one-dot and one-space lateral lines, a half-tone image with two-dot and three-space lateral lines, and a half-tone image with one-dot and two-space lateral lines.

The evaluation for a residual potential was performed as described below.

Before and after the durability test, residual potentials after continuous output of three solid white images and five solid black images were measured. An increase in residual potential of 10 V or less was defined as a rank 4. In addition, an increase of more than 10 V and 20 V or less was defined as a rank 3. In addition, an increase of more than 20 V and 30 V or less was defined as a rank 2. In addition, an increase of more than 30 V was defined as a rank 1.

Tables 22 to 43 and Tables 59 to 73 show the results.

TABLE 22

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Example 1 | CP-1 | 1 | 2 | 15 | 0.8 | 2.2 × 10¹³ | 4 | 3 | 3 |
| Example 2 | CP-2 | 2 | 2 | 15 | 0.9 | 2.2 × 10¹³ | 5 | 3 | 3 |
| Example 3 | CP-3 | 3 | 2 | 15 | 1.0 | 2.2 × 10¹³ | 5 | 3 | 3 |
| Example 9 | CP-4 | 4 | 2 | 15 | 1.1 | 2.2 × 10¹³ | 5 | 3 | 3 |
| Example 5 | CP-5 | 5 | 2 | 15 | 1.2 | 2.2 × 10¹³ | 4 | 3 | 3 |
| Example 6 | CP-6 | 6 | 5 | 15 | 1.0 | 2.1 × 10¹³ | 6 | 3 | 3 |
| Example 7 | CP-7 | 7 | 13 | 15 | 0.8 | 2.0 × 10¹³ | 5 | 3 | 3 |
| Example 8 | CP-8 | 8 | 13 | 15 | 0.9 | 2.0 × 10¹³ | 6 | 3 | 3 |
| Example 9 | CP-9 | 9 | 13 | 15 | 1.0 | 2.0 × 10¹³ | 6 | 3 | 3 |
| Example 10 | CP-10 | 10 | 13 | 15 | 1.1 | 2.0 × 10¹³ | 6 | 3 | 3 |
| Example 11 | CP-11 | 11 | 13 | 15 | 1.2 | 2.0 × 10¹³ | 5 | 3 | 3 |
| Example 12 | CP-12 | 12 | 20 | 15 | 1.0 | 1.9 × 10¹³ | 6 | 3 | 3 |
| Example 13 | CP-13 | 13 | 25 | 15 | 0.8 | 1.8 × 10¹³ | 3 | 3 | 3 |
| Example 14 | CP-14 | 14 | 25 | 15 | 0.9 | 1.8 × 10¹³ | 4 | 3 | 3 |
| Example 15 | CP-15 | 15 | 25 | 15 | 1.0 | 1.8 × 10¹³ | 4 | 3 | 3 |
| Example 16 | CP-16 | 16 | 25 | 15 | 1.1 | 1.8 × 10¹³ | 4 | 3 | 3 |
| Example 17 | CP-17 | 17 | 25 | 15 | 1.2 | 1.8 × 10¹³ | 3 | 3 | 3 |
| Example 18 | CP-18 | 16 | 2 | 20 | 1.0 | 6.6 × 10¹² | 5 | 4 | 3 |
| Example 19 | CP-19 | 19 | 5 | 20 | 0.8 | 6.3 × 10¹² | 5 | 4 | 3 |
| Example 10 | CP-20 | 20 | 5 | 20 | 0.9 | 6.3 × 10¹² | 6 | 4 | 3 |
| Example 21 | CP-21 | 21 | 5 | 20 | 1.0 | 6.3 × 10¹² | 6 | 4 | 3 |
| Example 22 | CP-22 | 22 | 5 | 20 | 1.1 | 6.3 × 10¹² | 6 | 4 | 3 |
| Example 23 | CP-23 | 23 | 5 | 20 | 1.2 | 6.3 × 10¹² | 5 | 4 | 3 |
| Example 29 | CP-24 | 24 | 13 | 20 | 0.8 | 5.8 × 10¹² | 5 | 4 | 3 |
| Example 25 | CP-25 | 25 | 13 | 20 | 0.9 | 5.8 × 10¹² | 6 | 4 | 3 |
| Example 26 | CP-26 | 26 | 13 | 20 | 1.0 | 5.8 × 10¹² | 6 | 4 | 3 |
| Example 27 | CP-27 | 27 | 13 | 20 | 1.1 | 5.8 × 10¹² | 6 | 4 | 3 |
| Example 28 | CP-28 | 28 | 13 | 20 | 1.2 | 5.8 × 10¹² | 5 | 4 | 3 |
| Example 29 | CP-29 | 29 | 20 | 20 | 0.8 | 5.4 × 10¹² | 5 | 4 | 3 |
| Example 30 | CP-30 | 30 | 20 | 20 | 0.9 | 5.5 × 10¹² | 6 | 4 | 3 |
| Example 31 | CP-31 | 31 | 20 | 20 | 1.0 | 5.5 × 10¹² | 6 | 4 | 3 |
| Example 32 | CP-32 | 32 | 20 | 20 | 1.1 | 5.5 × 10¹² | 6 | 4 | 3 |
| Example 33 | CP-33 | 33 | 20 | 20 | 1.2 | 5.5 × 10¹² | 5 | 4 | 3 |
| Example 34 | CP-34 | 34 | 25 | 20 | 1.0 | 5.2 × 10¹² | 4 | 4 | 3 |
| Example 35 | CP-35 | 35 | 2 | 30 | 0.8 | 3.6 × 10¹¹ | 4 | 4 | 3 |
| Example 36 | CP-36 | 36 | 2 | 30 | 0.9 | 3.6 × 10¹¹ | 5 | 4 | 3 |
| Example 37 | CP-37 | 37 | 2 | 30 | 1.0 | 3.6 × 10¹¹ | 5 | 4 | 3 |
| Example 38 | CP-38 | 38 | 2 | 30 | 1.1 | 3.6 × 10¹¹ | 5 | 4 | 3 |
| Example 39 | CP-39 | 39 | 2 | 30 | 1.2 | 3.6 × 10¹¹ | 4 | 4 | 3 |
| Example 40 | CP-40 | 40 | 5 | 30 | 0.2 | 3.4 × 10¹¹ | 5 | 4 | 3 |

TABLE 23

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Example 41 | CP-41 | 41 | 5 | 30 | 0.9 | 3.4 × 10¹¹ | 6 | 4 | 3 |
| Example 42 | CP-42 | 42 | 5 | 30 | 1.0 | 3.4 × 10¹¹ | 6 | 4 | 3 |
| Example 43 | CP-43 | 43 | 5 | 30 | 1.1 | 3.4 × 10¹¹ | 6 | 4 | 3 |
| Example 44 | CP-44 | 44 | 5 | 30 | 1.2 | 3.4 × 10¹¹ | 5 | 4 | 3 |
| Example 45 | CP-45 | 45 | 13 | 30 | 0.8 | 2.9 × 10¹¹ | 5 | 4 | 3 |
| Example 46 | CP-46 | 46 | 13 | 30 | 0.9 | 3.0 × 10¹¹ | 6 | 4 | 3 |
| Example 47 | CP-47 | 47 | 13 | 30 | 1.0 | 3.0 × 10¹¹ | 6 | 4 | 3 |
| Example 48 | CP-48 | 48 | 13 | 30 | 1.1 | 3.0 × 10¹¹ | 6 | 4 | 3 |
| Example 49 | CP-49 | 49 | 13 | 30 | 1.2 | 3.0 × 10¹¹ | 5 | 4 | 3 |
| Example 50 | CP-50 | 50 | 20 | 30 | 0.8 | 2.6 × 10¹¹ | 5 | 4 | 3 |
| Example 51 | CP-51 | 51 | 20 | 30 | 0.9 | 2.6 × 10¹¹ | 6 | 4 | 3 |
| Example 52 | CP-52 | 52 | 20 | 30 | 1.0 | 2.6 × 10¹¹ | 6 | 4 | 3 |
| Example 53 | CP-53 | 53 | 20 | 30 | 1.1 | 2.6 × 10¹¹ | 6 | 4 | 3 |
| Example 54 | CP-54 | 54 | 20 | 30 | 1.2 | 2.6 × 10¹¹ | 5 | 4 | 3 |
| Example 55 | CP-55 | 55 | 25 | 30 | 0.8 | 2.4 × 10¹¹ | 3 | 4 | 3 |
| Example 56 | CP-56 | 56 | 25 | 30 | 0.9 | 2.5 × 10¹¹ | 4 | 4 | 3 |
| Example 57 | CP-57 | 57 | 25 | 30 | 1.0 | 2.5 × 10¹¹ | 4 | 4 | 3 |
| Example 58 | CP-58 | 56 | 25 | 30 | 1.1 | 2.5 × 10¹¹ | 4 | 4 | 3 |
| Example 59 | CP-59 | 59 | 25 | 30 | 1.2 | 2.5 × 10¹¹ | 3 | 4 | 3 |
| Example 60 | CP-60 | 60 | 2 | 40 | 1.0 | 7.7 × 10⁹ | 5 | 4 | 3 |
| Example 61 | CP-61 | 61 | 5 | 40 | 0.8 | 6.9 × 10⁹ | 5 | 4 | 3 |
| Example 62 | CP-62 | 62 | 5 | 40 | 0.9 | 7.0 × 10⁹ | 6 | 4 | 3 |
| Example 63 | CP-63 | 63 | 5 | 40 | 1.0 | 7.0 × 10⁹ | 6 | 4 | 3 |
| Example 69 | CP-64 | 64 | 5 | 40 | 1.1 | 7.0 × 10⁹ | 6 | 4 | 3 |
| Example 65 | CP-65 | 65 | 5 | 40 | 1.2 | 7.0 × 10⁹ | 5 | 4 | 3 |
| Example 66 | CP-66 | 66 | 13 | 40 | 0.8 | 5.4 × 10⁹ | 5 | 4 | 3 |
| Example 67 | CP-67 | 67 | 13 | 40 | 0.9 | 5.5 × 10⁹ | 6 | 4 | 3 |
| Example 68 | CP-68 | 62 | 13 | 40 | 1.0 | 5.5 × 10⁹ | 6 | 4 | 3 |
| Example 69 | CP-69 | 69 | 13 | 40 | 1.1 | 5.5 × 10⁹ | 6 | 4 | 3 |
| Example 70 | CP-70 | 70 | 13 | 40 | 1.2 | 5.5 × 10⁹ | 5 | 4 | 3 |
| Example 71 | CP-71 | 71 | 20 | 40 | 0.8 | 4.5 × 10⁹ | 5 | 4 | 3 |
| Example 72 | CP-72 | 72 | 20 | 40 | 0.9 | 4.6 × 10⁹ | 6 | 4 | 3 |
| Example 73 | CP-73 | 73 | 20 | 40 | 1.0 | 4.6 × 10⁹ | 6 | 4 | 3 |
| Example 74 | CP-74 | 74 | 20 | 40 | 1.1 | 4.8 × 10⁹ | 6 | 4 | 3 |
| Example 75 | CP-75 | 75 | 20 | 40 | 1.2 | 4.6 × 10⁹ | 5 | 4 | 3 |
| Example 76 | CP-76 | 76 | 25 | 40 | 1.0 | 4.1 × 10⁹ | 4 | 4 | 3 |
| Example 77 | CP-77 | 77 | 2 | 45 | 0.8 | 6.4 × 10⁸ | 4 | 4 | 2 |
| Example 78 | CP-78 | 78 | 2 | 45 | 0.9 | 6.6 × 10⁸ | 5 | 4 | 2 |
| Example 79 | CP-79 | 79 | 2 | 45 | 1.0 | 6.6 × 10⁸ | 5 | 4 | 2 |
| Example 80 | CP-80 | 20 | 2 | 45 | 1.1 | 6.6 × 10⁸ | 5 | 4 | 2 |

TABLE 24

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Example 81 | CP-81 | 81 | 2 | 45 | 1.2 | 6.6 × 10⁸ | 4 | 4 | 2 |
| Example 82 | CP-82 | 82 | 5 | 45 | 1.0 | 5.8 × 10⁸ | 6 | 4 | 2 |
| Example 83 | CP-83 | 83 | 13 | 45 | 0.8 | 4.2 × 10⁸ | 5 | 4 | 2 |
| Example 84 | CP-84 | 84 | 13 | 45 | 0.9 | 4.4 × 10⁸ | 6 | 4 | 2 |
| Example 85 | CP-85 | 85 | 13 | 45 | 1.0 | 4.4 × 10⁸ | 6 | 4 | 2 |
| Example 86 | CP-26 | 26 | 13 | 45 | 1.1 | 4.4 × 10⁸ | 6 | 4 | 2 |
| Example 87 | CP-87 | 87 | 13 | 45 | 1.2 | 4.4 × 10⁸ | 5 | 4 | 2 |
| Example 88 | CP-88 | 88 | 20 | 45 | 1.0 | 3.5 × 10⁸ | 6 | 4 | 2 |
| Example 89 | CP-89 | 89 | 25 | 45 | 0.8 | 3.0 × 10⁸ | 3 | 4 | 2 |
| Example 90 | CP-90 | 90 | 25 | 45 | 0.9 | 3.1 × 10⁸ | 4 | 4 | 2 |
| Example 91 | CP-91 | 91 | 25 | 45 | 1.0 | 3.1 × 10⁸ | 4 | 4 | 2 |
| Example 92 | CP-92 | 92 | 25 | 45 | 1.1 | 3.1 × 10⁸ | 4 | 4 | 2 |
| Example 93 | CP-93 | 93 | 25 | 45 | 1.2 | 3.1 × 10⁸ | 3 | 4 | 2 |
| Example 94 | CP-94 | 94 | 5 | 20 | 0.8 | 4.8 × 10¹² | 5 | 4 | 3 |
| Example 95 | CP-95 | 95 | 5 | 20 | 0.9 | 4.8 × 10¹² | 6 | 4 | 3 |
| Example 96 | CP-96 | 96 | 5 | 20 | 1.0 | 4.2 × 10¹² | 6 | 4 | 3 |
| Example 97 | CP-97 | 97 | 5 | 20 | 1.1 | 4.8 × 10¹² | 6 | 4 | 3 |
| Example 98 | CP-98 | 98 | 5 | 20 | 1.2 | 4.8 × 10¹² | 5 | 4 | 3 |
| Example 99 | CP-99 | 99 | 13 | 20 | 0.8 | 4.3 × 10¹² | 5 | 4 | 3 |
| Example 100 | CP-100 | 100 | 13 | 20 | 0.9 | 4.4 × 10¹² | 6 | 4 | 3 |
| Example 101 | CP-101 | 101 | 13 | 20 | 1.0 | 4.4 × 10¹² | 6 | 4 | 3 |
| Example 102 | CP-102 | 102 | 13 | 20 | 1.1 | 4.4 × 10¹² | 6 | 4 | 3 |
| Example 103 | CP-103 | 103 | 13 | 20 | 1.2 | 4.4 × 10¹² | 5 | 4 | 3 |
| Example 104 | CP-104 | 104 | 20 | 20 | 0.8 | 4.0 × 10¹² | 5 | 4 | 3 |
| Example 105 | CP-105 | 105 | 20 | 20 | 0.9 | 4.1 × 10¹² | 6 | 4 | 3 |
| Example 106 | CP-106 | 106 | 20 | 20 | 1.0 | 4.1 × 10¹² | 6 | 4 | 3 |
| Example 107 | CP-107 | 107 | 20 | 20 | 1.1 | 4.1 × 10¹² | 6 | 4 | 3 |
| Example 108 | CP-108 | 108 | 20 | 20 | 1.2 | 4.1 × 10¹² | 5 | 4 | 3 |
| Example 109 | CP-109 | 109 | 5 | 30 | 0.8 | 1.7 × 10¹¹ | 5 | 4 | 3 |
| Example 110 | CP-110 | 110 | 5 | 30 | 0.9 | 1.8 × 10¹¹ | 6 | 4 | 3 |
| Example 111 | CP-111 | 111 | 5 | 30 | 1.0 | 1.8 × 10¹¹ | 6 | 4 | 3 |
| Example 112 | CP-112 | 112 | 5 | 30 | 1.1 | 1.8 × 10¹¹ | 6 | 4 | 3 |
| Example 113 | CP-113 | 113 | 5 | 30 | 1.2 | 1.2 × 10¹¹ | 5 | 4 | 3 |
| Example 114 | CP-114 | 114 | 13 | 30 | 0.8 | 1.4 × 10¹¹ | 5 | 4 | 3 |
| Example 115 | CP-115 | 115 | 13 | 30 | 0.9 | 1.5 × 10¹¹ | 6 | 4 | 3 |
| Example 116 | CP-116 | 116 | 13 | 30 | 1.0 | 1.5 × 10¹¹ | 6 | 4 | 3 |
| Example 117 | CP-117 | 117 | 13 | 30 | 1.1 | 1.5 × 10¹¹ | 6 | 4 | 3 |
| Example 118 | CP-118 | 118 | 13 | 30 | 1.2 | 1.5 × 10¹¹ | 5 | 4 | 3 |
| Example 119 | CP-119 | 119 | 20 | 30 | 0.8 | 1.3 × 10¹¹ | 5 | 4 | 3 |
| Example 120 | CP-120 | 120 | 20 | 30 | 0.9 | 1.3 × 10¹¹ | 6 | 4 | 3 |

TABLE 25

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Example 121 | CP-121 | 121 | 20 | 30 | 1.0 | 1.3 × 10¹¹ | 6 | 4 | 3 |
| Example 122 | CP-122 | 122 | 20 | 30 | 1.1 | 1.3 × 10¹¹ | 6 | 4 | 3 |
| Example 123 | CP-123 | 123 | 20 | 30 | 1.2 | 1.3 × 10¹¹ | 5 | 4 | 3 |
| Example 124 | CP-124 | 124 | 5 | 40 | 0.8 | 1.6 × 10⁹ | 5 | 4 | 3 |
| Example 125 | CP-125 | 125 | 5 | 40 | 0.9 | 1.6 × 10⁹ | 6 | 4 | 3 |
| Example 126 | CP-126 | 126 | 5 | 40 | 1.0 | 1.6 × 10⁹ | 6 | 4 | 3 |
| Example 127 | CP-127 | 127 | 5 | 40 | 1.1 | 1.6 × 10⁹ | 6 | 4 | 3 |
| Example 128 | CP-128 | 128 | 5 | 40 | 1.2 | 1.6 × 10⁹ | 5 | 4 | 3 |
| Example 129 | CP-129 | 129 | 13 | 40 | 0.8 | 1.2 × 10⁹ | 5 | 4 | 3 |
| Example 130 | CP-130 | 130 | 13 | 40 | 0.9 | 1.2 × 10⁹ | 6 | 4 | 3 |
| Example 131 | CP-131 | 131 | 13 | 40 | 1.0 | 1.2 × 10⁹ | 6 | 4 | 3 |
| Example 132 | CP-132 | 132 | 13 | 40 | 1.1 | 1.2 × 10⁹ | 6 | 4 | 3 |
| Example 133 | CP-133 | 133 | 13 | 40 | 1.2 | 1.2 × 10⁹ | 5 | 4 | 3 |
| Example 134 | CP-134 | 134 | 20 | 40 | 0.8 | 9.5 × 10⁸ | 5 | 4 | 3 |
| Example 135 | CP-135 | 135 | 20 | 40 | 0.9 | 9.9 × 10⁸ | 6 | 4 | 3 |
| Example 136 | CP-136 | 136 | 20 | 40 | 1.0 | 9.9 × 10⁸ | 6 | 4 | 3 |
| Example 137 | CP-137 | 137 | 20 | 40 | 1.1 | 9.9 × 10⁸ | 6 | 4 | 3 |
| Example 138 | CP-138 | 138 | 20 | 40 | 1.2 | 9.9 × 10⁸ | 5 | 4 | 3 |
| Example 139 | CP-139 | 139 | 13 | 30 | 1.0 | 2.5 × 10¹¹ | 6 | 4 | 3 |
| Example 140 | CP-140 | 140 | 13 | 30 | 1.0 | 5.5 × 10¹¹ | 6 | 4 | 3 |

TABLE 26

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Comparative Example 1 | CP-C1 | C1 | — | — | — | 2.2 × 10¹³ | 1 | 3 | 3 |
| Comparative Example 2 | CP-C2 | C2 | — | — | — | 3.8 × 10¹¹ | 1 | 4 | 3 |
| Comparative Example 3 | CP-C3 | C3 | — | — | — | 7.1 × 10⁸ | 1 | 4 | 2 |
| Comparative Example 9 | CP-C4 | C4 | 1 | 15 | 1.0 | 2.2 × 10¹³ | 2 | 3 | 3 |
| Comparative Example 5 | CP-C5 | C5 | 1 | 30 | 1.0 | 3.7 × 10¹¹ | 2 | 4 | 3 |
| Comparative Example 6 | CP-C6 | C6 | 1 | 45 | 1.2 | 6.8 × 10⁸ | 2 | 4 | 2 |
| Comparative Example 7 | CP-C7 | C7 | 30 | 15 | 1.0 | 1.8 × 10¹³ | 2 | 3 | 3 |
| Comparative Example 8 | CP-C8 | C8 | 30 | 30 | 1.0 | 2.3 × 10¹¹ | 2 | 4 | 3 |
| Comparative Example 9 | CP-C9 | C9 | 30 | 45 | 1.0 | 2.7 × 10⁸ | 2 | 4 | 2 |
| Comparative Example 10 | CP-C10 | C10 | — | — | — | 9.0 × 10¹² | 1 | 3 | 3 |
| Comparative Example 11 | CP-C11 | C11 | — | — | — | 4.3 × 10¹⁰ | 1 | 4 | 3 |
| Comparative Example 12 | CP-C12 | C12 | — | — | — | 1.1 × 10⁷ | 1 | 4 | 2 |
| Comparative Example 13 | CP-C13 | C13 | 2 | 10 | 1.0 | 6.3 × 10¹³ | 5 | 1 | 3 |
| Comparative Example 14 | CP-C14 | C14 | 5 | 10 | 1.0 | 6.2 × 10¹³ | 6 | 1 | 3 |
| Comparative Example 15 | CP-C15 | C15 | 13 | 10 | 1.0 | 5.9 × 10¹³ | 6 | 1 | 3 |
| Comparative Example 16 | CP-C16 | C16 | 20 | 10 | 1.0 | 5.8 × 10¹³ | 6 | 1 | 3 |
| Comparative Example 17 | CP-C17 | C17 | 25 | 10 | 1.0 | 5.7 × 10¹³ | 4 | 1 | 3 |
| Comparative Example 18 | CP-C18 | C18 | 2 | 50 | 1.0 | 3.4 × 10⁷ | 5 | 4 | 1 |
| Comparative Example 19 | CP-C19 | C19 | 5 | 50 | 1.0 | 3.0 × 10⁷ | 6 | 4 | 1 |
| Comparative Example 20 | CP-C20 | C20 | 13 | 50 | 1.0 | 2.1 × 10⁷ | 6 | 4 | 1 |
| Comparative Example 21 | CP-C21 | C21 | 20 | 50 | 1.0 | 1.6 × 10⁷ | 6 | 4 | 1 |
| Comparative Example 22 | CP-C22 | C22 | 25 | 50 | 1.0 | 1.4 × 10⁷ | 4 | 4 | 1 |

TABLE 27

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Comparative Example 23 | CP-023 | C23 | — | — | — | 2.9 × 10¹¹ | 1 | 4 | 3 |
| Comparative Example 29 | CP-C24 | C24 | — | — | — | 2.9 × 10¹¹ | 1 | 4 | 3 |
| Comparative Example 25 | CP-C25 | C25 | — | — | — | 2.9 × 10¹¹ | 1 | 4 | 3 |
| Comparative Example 26 | CP-C26 | C26 | — | — | — | 3.0 × 10¹¹ | 1 | 4 | 3 |
| Comparative Example 27 | CP-C27 | C27 | — | — | — | 2.8 × 10¹¹ | 1 | 4 | 3 |
| Comparative Example 28 | CP-020 | C28 | — | — | — | 3.0 × 10¹¹ | 1 | 4 | 3 |
| Comparative Example 29 | CP-C29 | C29 | — | — | — | 2.6 × 10¹¹ | 1 | 4 | 3 |

TABLE 28

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Comparative Example 30 | CP-C3C | C30 | — | — | — | 3.3 × 10¹¹ | 1 | 4 | 3 |
| Comparative Example 31 | CP-C31 | C31 | — | — | — | 2.6 × 10¹¹ | 1 | 4 | 3 |
| Comparative Example 32 | CP-C32 | C32 | — | — | — | 3.0 × 10¹¹ | 1 | 4 | 3 |
| Comparative Example 33 | CP-C33 | C33 | — | — | — | 3.0 × 10¹¹ | 1 | 4 | 3 |
| Comparative Example 34 | CP-C34 | C34 | — | — | — | 3.0 × 10¹¹ | 1 | 4 | 3 |
| Comparative Example 35 | CP-C35 | C35 | — | — | — | 3.0 × 10¹¹ | 1 | 4 | 3 |

TABLE 29

| | | | | | | Volume | | | |
|---|---|---|---|---|---|---|---|---|---|
| | | Production | | | | resistivity | | | |
| | Conductive- | example of | | | | of | | | |
| | layer | electrophotographic | {(V₂/V_{T})/ | {(V₁/V_{T})/ | | conductive | Result of evaluation | | |
| | coating | photosensitive | (V₁/V_{T}) × | (V₂/V_{T}) × | | layer | Pattern | Residual | |
| | solution | member | 100 | 100 | R₂/R₁ | [Ω · cm] | memory | potential | Crack |
| Example 141 | CP-141 | 141 | 2 | 15 | 0.9 | 2.0 × 10¹³ | 4 | 3 | 3 |
| Example 142 | CP-142 | 142 | 2 | 15 | 0.9 | 2.0 × 10¹³ | 5 | 3 | 3 |
| Example 143 | CP-143 | 143 | 2 | 15 | 1.0 | 2.0 × 10¹³ | 5 | 3 | 3 |
| Example 144 | CP-144 | 144 | 2 | 15 | 1.1 | 2.0 × 10¹³ | 5 | 3 | 3 |
| Example 145 | CP-145 | 145 | 2 | 15 | 1.2 | 2.0 × 10¹³ | 4 | 3 | 3 |
| Example 146 | CP-146 | 146 | 5 | 15 | 1.0 | 2.0 × 10¹³ | 6 | 3 | 3 |
| Example 147 | CP-147 | 147 | 13 | 15 | 0.8 | 1.8 × 10¹³ | 5 | 3 | 3 |
| Example 148 | CP-148 | 143 | 13 | 15 | 0.9 | 1.8 × 10¹³ | 6 | 3 | 3 |
| Example 149 | CP-149 | 149 | 13 | 15 | 1.0 | 1.8 × 10¹³ | 6 | 3 | 3 |
| Example 150 | CP-150 | 150 | 13 | 15 | 1.1 | 1.8 × 10¹³ | 6 | 3 | 3 |
| Example 151 | CP-151 | 151 | 13 | 15 | 1.2 | 1.8 × 10¹³ | 5 | 3 | 3 |
| Example 152 | CP-152 | 152 | 20 | 15 | 1.0 | 1.7 × 10¹³ | 6 | 3 | 3 |
| Example 153 | CP-153 | 153 | 25 | 15 | 0.8 | 1.6 × 10¹³ | 3 | 3 | 3 |
| Example 154 | CP-154 | 154 | 25 | 15 | 0.9 | 1.6 × 10¹³ | 4 | 3 | 3 |
| Example 155 | CP-155 | 155 | 25 | 15 | 1.0 | 1.6 × 10¹³ | 4 | 3 | 3 |
| Example 156 | CP-156 | 156 | 25 | 15 | 1.1 | 1.6 × 10¹³ | 4 | 3 | 3 |
| Example 157 | CP-157 | 157 | 25 | 15 | 1.2 | 1.6 × 10¹³ | 3 | 3 | 3 |
| Example 158 | CP-158 | 158 | 2 | 20 | 1.0 | 6.0 × 10¹² | 5 | 4 | 3 |
| Example 159 | CP-159 | 159 | 5 | 20 | 0.8 | 5.8 × 10¹² | 5 | 4 | 3 |
| Example 160 | CP-160 | 160 | 5 | 20 | 0.9 | 5.7 × 10¹² | 6 | 4 | 3 |
| Example 161 | CP-161 | 161 | 5 | 20 | 1.0 | 5.7 × 10¹² | 6 | 4 | 3 |
| Example 162 | CP-162 | 162 | 5 | 20 | 1.1 | 5.7 × 10¹² | 6 | 4 | 3 |
| Example 163 | CP-163 | 163 | 5 | 20 | 1.2 | 5.7 × 10¹² | 5 | 4 | 3 |
| Example 164 | CP-164 | 164 | 13 | 20 | 0.8 | 5.1 × 10¹² | 5 | 4 | 3 |
| Example 165 | CP-165 | 165 | 13 | 20 | 0.9 | 5.1 × 10¹² | 6 | 4 | 3 |
| Example 166 | CP-166 | 166 | 13 | 20 | 1.0 | 5.1 × 10¹² | 6 | 4 | 3 |
| Example 167 | CP-167 | 167 | 13 | 20 | 1.1 | 5.0 × 10¹² | 6 | 4 | 3 |
| Example 168 | CP-168 | 168 | 13 | 20 | 1.2 | 5.0 × 10¹² | 5 | 4 | 3 |
| Example 169 | CP-169 | 169 | 20 | 20 | 0.8 | 4.7 × 10¹² | 5 | 4 | 3 |
| Example 170 | CP-170 | 170 | 20 | 20 | 0.9 | 4.6 × 10¹² | 6 | 4 | 3 |
| Example 171 | CP-171 | 171 | 20 | 20 | 1.0 | 4.6 × 10¹² | 6 | 4 | 3 |
| Example 172 | CP-172 | 172 | 20 | 20 | 1.1 | 4.5 × 10¹² | 6 | 4 | 3 |
| Example 173 | CP-173 | 173 | 20 | 20 | 1.2 | 4.5 × 10¹² | 5 | 4 | 3 |
| Example 174 | CP-174 | 174 | 25 | 20 | 1.0 | 4.3 × 10¹² | 4 | 4 | 3 |
| Example 175 | CP-175 | 175 | 2 | 30 | 0.8 | 3.1 × 10¹¹ | 4 | 4 | 3 |
| Example 176 | CP-176 | 176 | 2 | 30 | 0.9 | 3.1 × 10¹¹ | 5 | 4 | 3 |
| Example 177 | CP-177 | 177 | 2 | 30 | 1.0 | 3.1 × 10¹¹ | 5 | 4 | 3 |
| Example 178 | CP-178 | 178 | 2 | 30 | 1.1 | 3.1 × 10¹¹ | 5 | 4 | 3 |
| Example 179 | CP-179 | 179 | 2 | 30 | 1.2 | 3.1 × 10¹¹ | 4 | 4 | 3 |
| Example 180 | CP-180 | 180 | 5 | 30 | 0.B | 2.9 × 10¹¹ | 5 | 4 | 3 |

TABLE 30

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 181 | CP-181 | 181 | 5 | 30 | 0.9 | 2.9 × 10¹¹ | 6 | 4 | 3 |
| Example 182 | CP-182 | 182 | 5 | 30 | 1.0 | 2.9 × 10¹¹ | 6 | 4 | 3 |
| Example 183 | CP-183 | 183 | 5 | 30 | 1.1 | 2.9 × 10¹¹ | 6 | 4 | 3 |
| Example 189 | CP-184 | 184 | 5 | 30 | 1.2 | 2.9 × 10¹¹ | 5 | 4 | 3 |
| Example 185 | CP-185 | 185 | 13 | 30 | 0.8 | 2.4 × 10¹¹ | 5 | 4 | 3 |
| Example 186 | CP-186 | 196 | 13 | 30 | 0.9 | 2.3 × 10¹¹ | 6 | 4 | 3 |
| Example 187 | CP-187 | 187 | 13 | 30 | 1.0 | 2.3 × 10¹¹ | 6 | 4 | 3 |
| Example 188 | CP-188 | 183 | 13 | 30 | 1.1 | 2.3 × 10¹¹ | 6 | 4 | 3 |
| Example 189 | CP-189 | 189 | 13 | 30 | 1.2 | 2.3 × 10¹¹ | 5 | 4 | 3 |
| Example 190 | CP-190 | 190 | 20 | 30 | 0.8 | 2.0 × 10¹¹ | 5 | 4 | 3 |
| Example 191 | CP-191 | 191 | 20 | 30 | 0.9 | 2.0 × 10¹¹ | 6 | 4 | 3 |
| Example 192 | CP-192 | 192 | 20 | 30 | 1.0 | 2.0 × 10¹¹ | 6 | 4 | 3 |
| Example 193 | CP-193 | 193 | 20 | 30 | 1.1 | 1.9 × 10¹¹ | 6 | 4 | 3 |
| Example 194 | CP-194 | 194 | 20 | 30 | 1.2 | 1.9 × 10¹¹ | 5 | 4 | 3 |
| Example 195 | CP-195 | 195 | 25 | 30 | 0.8 | 1.8 × 10¹¹ | 3 | 4 | 3 |
| Example 196 | CP-196 | 196 | 25 | 30 | 0.9 | 1.8 × 10¹¹ | 4 | 4 | 3 |
| Example 197 | CP-197 | 197 | 25 | 30 | 1.0 | 1.8 × 10¹¹ | 4 | 4 | 3 |
| Example 198 | CP-198 | 198 | 25 | 30 | 1.1 | 1.7 × 10¹¹ | 4 | 4 | 3 |
| Example 199 | CP-199 | 199 | 25 | 30 | 1.2 | 1.7 × 10¹¹ | 3 | 4 | 3 |
| Example 200 | CP-200 | 200 | 2 | 40 | 1.0 | 6.0 × 10⁹ | 5 | 4 | 3 |
| Example 201 | CP-201 | 201 | 5 | 40 | 0.8 | 5.3 × 10⁹ | 5 | 4 | 3 |
| Example 202 | CP-202 | 202 | 5 | 40 | 0.9 | 5.3 × 10⁹ | 6 | 4 | 3 |
| Example 203 | CP-203 | 203 | 5 | 40 | 1.0 | 5.3 × 10⁹ | 6 | 4 | 3 |
| Example 209 | CP-204 | 204 | 5 | 40 | 1.1 | 5.2 × 10⁹ | 6 | 4 | 3 |
| Example 205 | CP-205 | 205 | 5 | 40 | 1.2 | 5.2 × 10⁹ | 5 | 4 | 3 |
| Example 206 | CP-206 | 206 | 13 | 40 | 0.8 | 3.9 × 10⁹ | 5 | 4 | 3 |
| Example 207 | CP-207 | 207 | 13 | 40 | 0.9 | 3.8 × 10⁹ | 6 | 4 | 3 |
| Example 208 | CP-208 | 208 | 13 | 40 | 1.0 | 3.9 × 10⁹ | 6 | 4 | 3 |
| Example 209 | CP-209 | 209 | 13 | 40 | 1.1 | 3.7 × 10⁹ | 6 | 4 | 3 |
| Example 210 | CP-210 | 210 | 13 | 40 | 1.2 | 3.7 × 10⁹ | 5 | 4 | 3 |
| Example 211 | CP-211 | 211 | 20 | 40 | 0.8 | 3.1 × 10⁹ | 5 | 4 | 3 |
| Example 212 | CP-212 | 212 | 20 | 40 | 0.9 | 3.0 × 10⁹ | 6 | 4 | 3 |
| Example 213 | CP-213 | 213 | 20 | 40 | 1.0 | 3.0 × 10⁹ | 6 | 4 | 3 |
| Example 214 | CP-214 | 214 | 20 | 40 | 1.1 | 2.9 × 10⁹ | 6 | 4 | 3 |
| Example 215 | CP-215 | 215 | 20 | 40 | 1.2 | 2.9 × 10⁹ | 5 | 4 | 3 |
| Example 216 | CP-216 | 216 | 25 | 40 | 1.0 | 2.5 × 10⁹ | 4 | 4 | 3 |
| Example 217 | CP-217 | 217 | 2 | 45 | 0.8 | 4.9 × 10⁸ | 4 | 4 | 2 |
| Example 218 | CP-218 | 218 | 2 | 45 | 0.9 | 4.9 × 10⁸ | 5 | 4 | 2 |
| Example 219 | CP-219 | 219 | 2 | 45 | 1.0 | 4.9 × 10⁸ | 5 | 4 | 2 |
| Example 220 | CP-220 | 220 | 2 | 45 | 1.1 | 4.9 × 10⁸ | 5 | 4 | 2 |

TABLE 31

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 221 | CP-221 | 221 | 2 | 45 | 1.2 | 4.9 × 10⁸ | 4 | 4 | 2 |
| Example 222 | CP-222 | 222 | 5 | 45 | 1.0 | 4.2 × 10⁸ | 6 | 4 | 2 |
| Example 223 | CP-223 | 223 | 13 | 45 | 0.8 | 2.9 × 10⁸ | 5 | 4 | 2 |
| Example 224 | CP-224 | 224 | 13 | 45 | 0.9 | 2.8 × 10⁸ | 6 | 4 | 2 |
| Example 225 | CP-225 | 225 | 13 | 45 | 1.0 | 2.8 × 10⁸ | 6 | 4 | 2 |
| Example 226 | CP-226 | 226 | 13 | 45 | 1.1 | 2.7 × 10⁸ | 6 | 4 | 2 |
| Example 227 | CP-227 | 227 | 13 | 45 | 1.2 | 2.7 × 10⁸ | 5 | 4 | 2 |
| Example 228 | CP-228 | 228 | 20 | 45 | 1.0 | 2.0 × 10⁸ | 6 | 4 | 2 |
| Example 229 | CP-229 | 229 | 25 | 45 | 0.8 | 1.8 × 10⁸ | 3 | 4 | 2 |
| Example 230 | CP-230 | 230 | 25 | 45 | 0.9 | 1.7 × 10⁸ | 4 | 4 | 2 |
| Example 231 | CP-231 | 231 | 25 | 45 | 1.0 | 1.7 × 10⁸ | 4 | 4 | 2 |
| Example 232 | CP-232 | 232 | 25 | 45 | 1.1 | 1.6 × 10⁸ | 4 | 4 | 2 |
| Example 233 | CP-233 | 233 | 25 | 45 | 1.2 | 1.6 × 10⁸ | 3 | 4 | 2 |

TABLE 32

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 234 | CP-234 | 234 | 5 | 20 | 0.8 | 4.3 × 10¹² | 5 | 4 | 3 |
| Example 235 | CP-235 | 235 | 5 | 20 | 0.9 | 4.3 × 10¹² | 6 | 4 | 3 |
| Example 236 | CP-236 | 236 | 5 | 20 | 1.0 | 4.3 × 10¹² | 6 | 4 | 3 |
| Example 237 | CP-237 | 237 | 5 | 20 | 1.1 | 4.3 × 10¹² | 6 | 4 | 3 |
| Example 238 | CP-238 | 238 | 5 | 20 | 1.2 | 4.3 × 10¹² | 5 | 4 | 3 |
| Example 239 | CP-239 | 239 | 13 | 20 | 0.8 | 3.8 × 10¹² | 5 | 4 | 3 |
| Example 240 | CP-240 | 240 | 13 | 20 | 0.9 | 3.7 × 10¹² | 6 | 4 | 3 |
| Example 241 | CP-241 | 241 | 13 | 20 | 1.0 | 3.7 × 10¹² | 6 | 4 | 3 |
| Example 242 | CP-242 | 242 | 13 | 20 | 1.1 | 3.7 × 10¹² | 6 | 4 | 3 |
| Example 243 | CP-243 | 243 | 13 | 20 | 1.2 | 3.7 × 10¹² | 5 | 4 | 3 |
| Example 244 | CP-244 | 244 | 20 | 20 | 0.8 | 3.4 × 10¹² | 5 | 4 | 3 |
| Example 245 | CP-245 | 245 | 20 | 20 | 0.9 | 3.4 × 10¹² | 6 | 4 | 3 |
| Example 246 | CP-246 | 246 | 20 | 20 | 1.0 | 3.4 × 10¹² | 6 | 4 | 3 |
| Example 247 | CP-247 | 247 | 20 | 20 | 1.1 | 3.3 × 10¹² | 6 | 4 | 3 |
| Example 248 | CP-248 | 243 | 20 | 20 | 1.2 | 3.3 × 10¹² | 5 | 4 | 3 |
| Example 249 | CP-249 | 249 | 5 | 30 | 0.8 | 1.4 × 10¹¹ | 5 | 4 | 3 |
| Example 250 | CP-250 | 250 | 5 | 30 | 0.9 | 1.4 × 10¹¹ | 6 | 4 | 3 |
| Example 251 | CP-251 | 251 | 5 | 30 | 1.0 | 1.4 × 10¹¹ | 6 | 4 | 3 |
| Example 252 | CP-252 | 252 | 5 | 30 | 1.1 | 1.4 × 10¹¹ | 6 | 4 | 3 |
| Example 253 | CP-253 | 253 | 5 | 30 | 1.2 | 1.4 × 10¹¹ | 5 | 4 | 3 |
| Example 254 | CP-254 | 254 | 13 | 30 | 0.8 | 1.1 × 10¹¹ | 5 | 4 | 3 |
| Example 255 | CP-255 | 255 | 13 | 30 | 0.9 | 1.1 × 10¹¹ | 6 | 4 | 3 |
| Example 256 | CP-256 | 256 | 13 | 30 | 1.0 | 1.1 × 10¹¹ | 6 | 4 | 3 |
| Example 257 | CP-257 | 257 | 13 | 30 | 1.1 | 1.1 × 10¹¹ | 6 | 4 | 3 |
| Example 258 | CP-258 | 258 | 13 | 30 | 1.2 | 1.1 × 10¹¹ | 5 | 4 | 3 |
| Example 259 | CP-259 | 259 | 20 | 30 | 0.8 | 9.5 × 10¹⁰ | 5 | 4 | 3 |
| Example 260 | CP-260 | 260 | 20 | 30 | 0.9 | 9.2 × 10¹⁰ | 6 | 4 | 3 |
| Example 261 | CP-261 | 261 | 20 | 30 | 1.0 | 9.2 × 10¹⁰ | 6 | 4 | 3 |
| Example 262 | CP-262 | 262 | 20 | 30 | 1.1 | 9.0 × 10¹⁰ | 6 | 4 | 3 |
| Example 263 | CP-263 | 263 | 20 | 30 | 1.2 | 9.0 × 10¹⁰ | 5 | 4 | 3 |
| Example 269 | CP-264 | 264 | 5 | 40 | 0.8 | 1.2 × 10⁹ | 5 | 4 | 3 |
| Example 265 | CP-265 | 265 | 5 | 40 | 0.9 | 1.2 × 10⁹ | 6 | 4 | 3 |
| Example 266 | CP-266 | 266 | 5 | 40 | 1.0 | 1.2 × 10⁹ | 6 | 4 | 3 |
| Example 267 | CP-267 | 267 | 5 | 40 | 1.1 | 1.1 × 10⁹ | 6 | 4 | 3 |
| Example 268 | CP-268 | 268 | 5 | 40 | 1.2 | 1.1 × 10⁹ | 5 | 4 | 3 |
| Example 269 | CP-269 | 269 | 13 | 40 | 0.8 | 7.9 × 10⁸ | 5 | 4 | 3 |
| Example 270 | CP-270 | 270 | 13 | 40 | 0.9 | 7.6 × 10⁸ | 6 | 4 | 3 |

TABLE 33

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 271 | CP-271 | 271 | 13 | 40 | 1.0 | 7.6 × 10⁸ | 6 | 4 | 3 |
| Example 272 | CP-272 | 272 | 13 | 40 | 1.1 | 7.3 × 10⁸ | 6 | 4 | 3 |
| Example 273 | CP-273 | 273 | 13 | 40 | 1.2 | 7.3 × 10⁸ | 5 | 4 | 3 |
| Example 274 | CP-274 | 274 | 20 | 40 | 0.8 | 5.9 × 10⁸ | 5 | 4 | 3 |
| Example 275 | CP-275 | 275 | 20 | 40 | 0.9 | 5.6 × 10⁸ | 6 | 4 | 3 |
| Example 276 | CP-276 | 276 | 20 | 40 | 1.0 | 5.6 × 10⁸ | 6 | 4 | 3 |
| Example 277 | CP-277 | 277 | 20 | 40 | 1.1 | 5.3 × 10⁸ | 6 | 4 | 3 |
| Example 278 | CP-278 | 278 | 20 | 40 | 1.2 | 5.3 × 10⁸ | 5 | 4 | 3 |
| Example 279 | CP-279 | 279 | 13 | 30 | 1.0 | 2.1 × 10¹¹ | 6 | 4 | 3 |
| Example 280 | CP-280 | 280 | 13 | 30 | 1.0 | 5.1 × 10¹¹ | 6 | 4 | 3 |

TABLE 34

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Comparative Example 42 | CP-C42 | C42 | — | — | — | 2.1 × 10¹³ | 1 | 3 | 3 |
| Comparative Example 43 | CP-C43 | C43 | — | — | — | 3.3 × 10¹¹ | 1 | 4 | 3 |
| Comparative Example 44 | CP-C44 | C44 | — | — | — | 5.5 × 10⁸ | 1 | 4 | 2 |
| Comparative Example 45 | CP-C45 | C45 | 1 | 15 | 1.0 | 2.1 × 10¹³ | 2 | 3 | 3 |
| Comparative Example 46 | CP-C46 | C46 | 1 | 30 | 1.0 | 3.2 × 10¹¹ | 2 | 4 | 3 |
| Comparative Example 47 | CP-C47 | C47 | 1 | 45 | 1.0 | 5.2 × 10⁸ | 2 | 4 | 2 |
| Comparative Example 48 | CP-C48 | C48 | 30 | 15 | 1.0 | 1.6 × 10¹³ | 2 | 3 | 3 |
| Comparative Example 49 | CP-C49 | C49 | 30 | 30 | 1.0 | 1.6 × 10¹¹ | 2 | 4 | 3 |
| Comparative Example 50 | CP-C50 | C50 | 30 | 45 | 1.0 | 1.4 × 10⁸ | 2 | 4 | 2 |
| Comparative Example 51 | CP-C51 | C51 | — | — | — | 5.8 × 10¹² | 1 | 3 | 3 |
| Comparative Example 52 | CP-C52 | C52 | — | — | — | 1.5 × 10¹⁰ | 1 | 4 | 3 |
| Comparative Example 53 | CP-C53 | C53 | — | — | — | 1.5 × 10⁶ | 1 | 4 | 2 |
| Comparative Example 54 | CP-C54 | C54 | 2 | 10 | 1.0 | 6.0 × 10¹³ | 5 | 1 | 3 |
| Comparative Example 55 | CP-C55 | C55 | 5 | 10 | 1.0 | 5.9 × 10¹³ | 6 | 1 | 3 |
| Comparative Example 56 | CP-C56 | C56 | 13 | 10 | 1.0 | 5.6 × 10¹³ | 6 | 1 | 3 |
| Comparative Example 57 | CP-C57 | C57 | 20 | 10 | 1.0 | 5.4 × 10¹³ | 6 | 1 | 3 |
| Comparative Example 58 | CP-C58 | C58 | 25 | 10 | 1.0 | 5.2 × 10¹³ | 4 | 1 | 3 |
| Comparative Example 59 | CP-C59 | C59 | 2 | 50 | 1.0 | 2.4 × 10⁷ | 5 | 4 | 1 |
| Comparative Example 60 | CP-C60 | C60 | 5 | 50 | 1.0 | 2.0 × 10⁷ | 6 | 4 | 1 |
| Comparative Example 61 | CP-C61 | C61 | 13 | 50 | 1.0 | 1.2 × 10⁷ | 6 | 4 | 1 |
| Comparative Example 62 | CP-C62 | C62 | 20 | 50 | 1.0 | 8.3 × 10⁶ | 6 | 4 | 1 |
| Comparative Example 63 | CP-C63 | C63 | 25 | 50 | 1.0 | 6.5 × 10⁶ | 4 | 4 | 1 |

TABLE 35

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Comparative Example 64 | CP-C64 | C64 | — | — | — | 2.6 × 10¹¹ | 1 | 4 | 3 |
| Comparative Example 65 | CP-C65 | C65 | — | — | — | 2.6 × 10¹¹ | 1 | 4 | 3 |
| Comparative Example 66 | CP-C66 | C66 | — | — | — | 2.3 × 10¹¹ | 1 | 4 | 3 |
| Comparative Example 67 | CP-C67 | C67 | — | — | — | 2.7 × 10¹¹ | 1 | 4 | 3 |
| Comparative Example 68 | CP-C68 | C68 | — | — | — | 2.5 × 10¹¹ | 1 | 4 | 3 |
| Comparative Example 69 | CP-C69 | C69 | — | — | — | 2.7 × 10¹¹ | 1 | 4 | 3 |
| Comparative Example 70 | CP-C70 | C70 | — | — | — | 3.0 × 10¹¹ | 1 | 4 | 3 |
| Comparative Example 71 | CP-C71 | C71 | — | — | — | 2.3 × 10¹¹ | 1 | 4 | 3 |

TABLE 36

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 281 | CP-281 | 281 | 2 | 15 | 0.8 | 2.3 × 10¹³ | 4 | 3 | 3 |
| Example 282 | CP-282 | 282 | 2 | 15 | 0.9 | 2.3 × 10¹³ | 5 | 3 | 3 |
| Example 283 | CP-283 | 283 | 2 | 15 | 1.0 | 2.3 × 10¹³ | 5 | 3 | 3 |
| Example 289 | CP-284 | 284 | 2 | 15 | 1.1 | 2.3 × 10¹³ | 5 | 3 | 3 |
| Example 285 | CP-285 | 285 | 2 | 15 | 1.2 | 2.3 × 10¹³ | 4 | 3 | 3 |
| Example 286 | CP-286 | 286 | 5 | 15 | 1.0 | 2.2 × 10¹³ | 6 | 3 | 3 |
| Example 287 | CP-287 | 287 | 13 | 15 | 0.8 | 2.1 × 10¹³ | 5 | 3 | 3 |
| Example 288 | CP-288 | 283 | 13 | 15 | 0.9 | 2.1 × 10¹³ | 6 | 3 | 3 |
| Example 289 | CP-289 | 289 | 13 | 15 | 1.0 | 2.1 × 10¹³ | 6 | 3 | 3 |
| Example 290 | CP-290 | 290 | 13 | 15 | 1.1 | 2.1 × 10¹³ | 6 | 3 | 3 |
| Example 291 | CP-291 | 291 | 13 | 15 | 1.2 | 2.1 × 10¹³ | 5 | 3 | 3 |
| Example 292 | CP-292 | 292 | 20 | 15 | 1.0 | 2.0 × 10¹³ | 6 | 3 | 3 |
| Example 293 | CP-293 | 293 | 25 | 15 | 0.8 | 1.9 × 10¹³ | 3 | 3 | 3 |
| Example 294 | CP-294 | 294 | 25 | 15 | 0.9 | 1.9 × 10¹³ | 4 | 3 | 3 |
| Example 295 | CP-295 | 295 | 25 | 15 | 1.0 | 2.0 × 10¹³ | 4 | 3 | 3 |
| Example 296 | CP-296 | 296 | 25 | 15 | 1.1 | 2.0 × 10¹³ | 4 | 3 | 3 |
| Example 297 | CP-297 | 297 | 25 | 15 | 1.2 | 2.0 × 10¹³ | 3 | 3 | 3 |
| Example 298 | CP-290 | 298 | 2 | 20 | 1.0 | 7.1 × 10¹² | 5 | 4 | 3 |
| Example 299 | CP-299 | 299 | 5 | 20 | 0.8 | 6.9 × 10¹² | 5 | 4 | 3 |
| Example 300 | CP-300 | 300 | 5 | 20 | 0.9 | 6.9 × 10¹² | 6 | 4 | 3 |
| Example 301 | CP-301 | 301 | 5 | 20 | 1.0 | 6.9 × 10¹² | 6 | 4 | 3 |
| Example 302 | CP-302 | 302 | 5 | 20 | 1.1 | 6.9 × 10¹² | 6 | 4 | 3 |
| Example 303 | CP-303 | 303 | 5 | 20 | 1.2 | 6.9 × 10¹² | 5 | 4 | 3 |
| Example 309 | CP-304 | 304 | 13 | 20 | 0.8 | 6.3 × 10¹² | 5 | 4 | 3 |
| Example 305 | CP-305 | 305 | 13 | 20 | 0.9 | 6.3 × 10¹² | 6 | 4 | 3 |
| Example 306 | CP-306 | 306 | 13 | 20 | 1.0 | 6.3 × 10¹² | 6 | 4 | 3 |
| Example 307 | CP-307 | 307 | 13 | 20 | 1.1 | 6.3 × 10¹² | 6 | 4 | 3 |
| Example 308 | CP-300 | 308 | 13 | 20 | 1.2 | 6.3 × 10¹² | 5 | 4 | 3 |
| Example 309 | CP-309 | 309 | 20 | 20 | 0.8 | 5.8 × 10¹² | 5 | 4 | 3 |
| Example 310 | CP-310 | 310 | 20 | 20 | 0.9 | 5.8 × 10¹² | 6 | 4 | 3 |
| Example 311 | CP-311 | 311 | 20 | 20 | 1.0 | 5.9 × 10¹² | 6 | 4 | 3 |
| Example 312 | CP-312 | 312 | 20 | 20 | 1.1 | 5.9 × 10¹² | 6 | 4 | 3 |
| Example 313 | CP-313 | 313 | 20 | 20 | 1.2 | 5.9 × 10¹² | 5 | 4 | 3 |
| Example 314 | CP-314 | 314 | 25 | 20 | 1.0 | 5.7 × 10¹² | 4 | 4 | 3 |
| Example 315 | CP-315 | 315 | 2 | 30 | 0.8 | 4.1 × 10¹¹ | 4 | 4 | 3 |
| Example 316 | CP-316 | 316 | 2 | 30 | 0.9 | 4.1 × 10¹¹ | 5 | 4 | 3 |
| Example 317 | CP-317 | 317 | 2 | 30 | 1.0 | 4.2 × 10¹¹ | 5 | 4 | 3 |
| Example 318 | CP-318 | 318 | 2 | 30 | 1.1 | 4.2 × 10¹¹ | 5 | 4 | 3 |
| Example 319 | CP-319 | 319 | 2 | 30 | 1.2 | 4.2 × 10¹¹ | 4 | 4 | 3 |
| Example 320 | CP-320 | 320 | 5 | 30 | 0.6 | 3.9 × 10¹¹ | 5 | 4 | 3 |

TABLE 37

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 321 | CP-321 | 321 | 5 | 30 | 0.9 | 3.9 × 10¹¹ | 6 | 4 | 3 |
| Example 322 | CP-322 | 322 | 5 | 30 | 1.0 | 3.9 × 10¹¹ | 6 | 4 | 3 |
| Example 323 | CP-323 | 323 | 5 | 30 | 1.1 | 3.9 × 10¹¹ | 6 | 4 | 3 |
| Example 329 | CP-324 | 324 | 5 | 30 | 1.2 | 3.9 × 10¹¹ | 5 | 4 | 3 |
| Example 325 | CP-325 | 325 | 13 | 30 | 0.8 | 3.3 × 10¹¹ | 5 | 4 | 3 |
| Example 326 | CP-326 | 326 | 13 | 30 | 0.9 | 3.3 × 10¹¹ | 6 | 4 | 3 |
| Example 327 | CP-327 | 327 | 13 | 30 | 1.0 | 3.4 × 10¹¹ | 6 | 4 | 3 |
| Example 328 | CP-328 | 323 | 13 | 30 | 1.1 | 3.4 × 10¹¹ | 6 | 4 | 3 |
| Example 329 | CP-329 | 329 | 13 | 30 | 1.2 | 3.4 × 10¹¹ | 5 | 4 | 3 |
| Example 330 | CP-330 | 330 | 20 | 30 | 0.8 | 3.0 × 10¹¹ | 5 | 4 | 3 |
| Example 331 | CP-331 | 331 | 20 | 30 | 0.9 | 3.0 × 10¹¹ | 6 | 4 | 3 |
| Example 332 | CP-332 | 332 | 20 | 30 | 1.0 | 3.0 × 10¹¹ | 6 | 4 | 3 |
| Example 333 | CP-333 | 333 | 20 | 30 | 1.1 | 3.0 × 10¹¹ | 6 | 4 | 3 |
| Example 334 | CP-334 | 334 | 20 | 30 | 1.2 | 3.0 × 10¹¹ | 5 | 4 | 3 |
| Example 335 | CP-335 | 335 | 25 | 30 | 0.8 | 2.7 × 10¹¹ | 3 | 4 | 3 |
| Example 336 | CP-336 | 336 | 25 | 30 | 0.9 | 2.7 × 10¹¹ | 4 | 4 | 3 |
| Example 337 | CP-337 | 337 | 25 | 30 | 1.0 | 2.8 × 10¹¹ | 4 | 4 | 3 |
| Example 338 | CP-330 | 338 | 25 | 30 | 1.1 | 2.8 × 10¹¹ | 4 | 4 | 3 |
| Example 339 | CP-339 | 339 | 25 | 30 | 1.2 | 2.8 × 10¹¹ | 3 | 4 | 3 |
| Example 340 | CP-340 | 340 | 2 | 40 | 1.0 | 9.5 × 10⁹ | 5 | 4 | 3 |
| Example 341 | CP-341 | 341 | 5 | 40 | 0.8 | 8.4 × 10⁹ | 5 | 4 | 3 |
| Example 342 | CP-342 | 342 | 5 | 40 | 0.9 | 8.4 × 10⁹ | 6 | 4 | 3 |
| Example 343 | CP-343 | 343 | 5 | 40 | 1.0 | 8.6 × 10⁹ | 6 | 4 | 3 |
| Example 349 | CP-344 | 344 | 5 | 40 | 1.1 | 8.6 × 10⁹ | 6 | 4 | 3 |
| Example 345 | CP-345 | 345 | 5 | 40 | 1.2 | 8.6 × 10⁹ | 5 | 4 | 3 |
| Example 346 | CP-346 | 346 | 13 | 40 | 0.8 | 6.7 × 10⁹ | 5 | 4 | 3 |
| Example 347 | CP-347 | 347 | 13 | 40 | 0.9 | 6.7 × 10⁹ | 6 | 4 | 3 |
| Example 348 | CP-340 | 348 | 13 | 40 | 1.0 | 6.0 × 10⁹ | 6 | 4 | 3 |
| Example 349 | CP-349 | 349 | 13 | 40 | 1.1 | 6.0 × 10⁹ | 6 | 4 | 3 |
| Example 350 | CP-350 | 350 | 13 | 40 | 1.2 | 6.8 × 10⁹ | 5 | 4 | 3 |
| Example 351 | CP-351 | 351 | 20 | 40 | 0.8 | 5.6 × 10⁹ | 5 | 4 | 3 |
| Example 352 | CP-352 | 352 | 20 | 40 | 0.9 | 5.6 × 10⁹ | 6 | 4 | 3 |
| Example 353 | CP-353 | 353 | 20 | 40 | 1.0 | 5.7 × 10⁹ | 6 | 4 | 3 |
| Example 354 | CP-354 | 354 | 20 | 40 | 1.1 | 5.7 × 10⁹ | 6 | 4 | 3 |
| Example 355 | CP-355 | 355 | 20 | 40 | 1.2 | 5.7 × 10⁹ | 5 | 4 | 3 |
| Example 356 | CP-356 | 356 | 25 | 40 | 1.0 | 5.1 × 10⁹ | 4 | 4 | 3 |
| Example 357 | CP-357 | 357 | 2 | 45 | 0.8 | 8.4 × 10⁸ | 4 | 4 | 2 |
| Example 358 | CP-358 | 358 | 2 | 45 | 0.9 | 8.4 × 10⁸ | 5 | 4 | 2 |
| Example 359 | CP-359 | 359 | 2 | 45 | 1.0 | 8.5 × 10⁸ | 5 | 4 | 2 |
| Example 360 | CP-360 | 360 | 2 | 45 | 1.1 | 8.5 × 10⁸ | 5 | 4 | 2 |

TABLE 38

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 361 | CP-361 | 361 | 2 | 45 | 1.2 | 8.5 × 10⁸ | 4 | 4 | 2 |
| Example 362 | CP-362 | 362 | 5 | 45 | 1.0 | 7.6 × 10⁸ | 6 | 4 | 2 |
| Example 363 | CP-363 | 363 | 13 | 45 | 0.8 | 5.6 × 10⁸ | 5 | 4 | 2 |
| Example 364 | CP-364 | 364 | 13 | 45 | 0.9 | 5.6 × 10⁸ | 6 | 4 | 2 |
| Example 365 | CP-365 | 365 | 13 | 45 | 1.0 | 5.7 × 10⁸ | 6 | 4 | 2 |
| Example 366 | CP-366 | 366 | 13 | 45 | 1.1 | 5.7 × 10⁸ | 6 | 4 | 2 |
| Example 367 | CP-367 | 367 | 13 | 45 | 1.2 | 5.7 × 10⁸ | 5 | 4 | 2 |
| Example 368 | CP-368 | 368 | 20 | 45 | 1.0 | 4.7 × 10⁸ | 6 | 4 | 2 |
| Example 369 | CP-369 | 369 | 25 | 45 | 0.8 | 3.8 × 10⁸ | 3 | 4 | 2 |
| Example 370 | CP-370 | 370 | 25 | 45 | 0.9 | 3.8 × 10⁸ | 4 | 4 | 2 |
| Example 371 | CP-371 | 371 | 25 | 45 | 1.0 | 4.1 × 10⁸ | 4 | 4 | 2 |
| Example 372 | CP-372 | 372 | 25 | 45 | 1.1 | 4.1 × 10⁸ | 4 | 4 | 2 |
| Example 373 | CP-373 | 373 | 25 | 45 | 1.2 | 4.1 × 10⁸ | 3 | 4 | 2 |

TABLE 39

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 374 | CP-374 | 374 | 5 | 20 | 0.8 | 5.2 × 10¹² | 5 | 4 | 3 |
| Example 375 | CP-375 | 375 | 5 | 20 | 0.9 | 5.2 × 10¹² | 6 | 4 | 3 |
| Example 376 | CP-376 | 376 | 5 | 20 | 1.0 | 5.2 × 10¹² | 6 | 4 | 3 |
| Example 377 | CP-377 | 377 | 5 | 20 | 1.1 | 5.2 × 10¹² | 6 | 4 | 3 |
| Example 378 | CP-378 | 378 | 5 | 20 | 1.2 | 5.2 × 10¹² | 5 | 4 | 3 |
| Example 379 | CP-379 | 379 | 13 | 20 | 0.9 | 4.7 × 10¹² | 5 | 4 | 3 |
| Example 380 | CP-380 | 380 | 13 | 20 | 0.9 | 4.7 × 10¹² | 6 | 4 | 3 |
| Example 381 | CP-381 | 381 | 13 | 20 | 1.0 | 4.8 × 10¹² | 6 | 4 | 3 |
| Example 382 | CP-382 | 382 | 13 | 20 | 1.1 | 4.8 × 10¹² | 6 | 4 | 3 |
| Example 383 | CP-383 | 383 | 13 | 20 | 1.2 | 4.2 × 10¹² | 5 | 4 | 3 |
| Example 384 | CP-384 | 384 | 20 | 20 | 0.6 | 4.4 × 10¹² | 5 | 4 | 3 |
| Example 385 | CP-385 | 385 | 20 | 20 | 0.9 | 4.4 × 10¹² | 6 | 4 | 3 |
| Example 386 | CP-386 | 386 | 20 | 20 | 1.0 | 4.4 × 10¹² | 6 | 4 | 3 |
| Example 387 | CP-387 | 387 | 20 | 20 | 1.1 | 4.4 × 10¹² | 6 | 4 | 3 |
| Example 388 | CP-388 | 388 | 20 | 20 | 1.2 | 4.4 × 10¹² | 5 | 4 | 3 |
| Example 389 | CP-389 | 399 | 5 | 30 | 0.8 | 2.0 × 10¹¹ | 5 | 4 | 3 |
| Example 390 | CP-390 | 390 | 5 | 30 | 0.9 | 2.0 × 10¹¹ | 6 | 4 | 3 |
| Example 391 | CP-391 | 391 | 5 | 30 | 1.0 | 2.1 × 10¹¹ | 6 | 4 | 3 |
| Example 392 | CP-392 | 392 | 5 | 30 | 1.1 | 2.1 × 10¹¹ | 6 | 4 | 3 |
| Example 393 | CP-393 | 393 | 5 | 30 | 1.2 | 2.1 × 10¹¹ | 5 | 4 | 3 |
| Example 394 | CP-394 | 394 | 13 | 30 | 0.8 | 1.7 × 10¹¹ | 5 | 4 | 3 |
| Example 395 | CP-395 | 395 | 13 | 30 | 0.9 | 1.7 × 10¹¹ | 6 | 4 | 3 |
| Example 396 | CP-396 | 396 | 13 | 30 | 1.0 | 1.7 × 10¹¹ | 6 | 4 | 3 |
| Example 397 | CP-397 | 397 | 13 | 30 | 1.1 | 1.7 × 10¹¹ | 6 | 4 | 3 |
| Example 398 | CP-398 | 393 | 13 | 30 | 1.2 | 1.7 × 10¹¹ | 5 | 4 | 3 |
| Example 399 | CP-399 | 399 | 20 | 30 | 0.8 | 1.5 × 10¹¹ | 5 | 4 | 3 |
| Example 400 | CP-400 | 400 | 20 | 30 | 0.9 | 1.5 × 10¹¹ | 6 | 4 | 3 |
| Example 401 | CP-401 | 401 | 20 | 30 | 1.0 | 1.5 × 10¹¹ | 6 | 4 | 3 |
| Example 402 | CP-402 | 402 | 20 | 30 | 1.1 | 1.5 × 10¹¹ | 6 | 4 | 3 |
| Example 403 | CP-403 | 403 | 20 | 30 | 1.2 | 1.5 × 10¹¹ | 5 | 4 | 3 |
| Example 404 | CP-404 | 404 | 5 | 40 | 0.8 | 2.1 × 10⁹ | 5 | 4 | 3 |

TABLE 40

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 405 | CP-405 | 405 | 5 | 40 | 0.9 | 2.1 × 10⁹ | 6 | 4 | 3 |
| Example 406 | CP-406 | 406 | 5 | 40 | 1.0 | 2.1 × 10⁹ | 6 | 4 | 3 |
| Example 407 | CP-407 | 407 | 5 | 40 | 1.1 | 2.1 × 10⁹ | 6 | 4 | 3 |
| Example 408 | CP-408 | 408 | 5 | 40 | 1.2 | 2.1 × 10⁹ | 5 | 4 | 3 |
| Example 409 | CP-409 | 409 | 13 | 40 | 0.8 | 1.6 × 10⁹ | 5 | 4 | 3 |
| Example 410 | CP-410 | 410 | 13 | 40 | 0.9 | 1.6 × 10⁹ | 6 | 4 | 3 |
| Example 411 | CP-411 | 411 | 13 | 40 | 1.0 | 1.6 × 10⁹ | 6 | 4 | 3 |
| Example 412 | CP-412 | 412 | 13 | 40 | 1.1 | 1.6 × 10⁹ | 6 | 4 | 3 |
| Example 413 | CP-413 | 413 | 13 | 40 | 1.2 | 1.6 × 10⁹ | 5 | 4 | 3 |
| Example 414 | CP-414 | 414 | 20 | 40 | 0.8 | 1.2 × 10⁹ | 5 | 4 | 3 |
| Example 415 | CP-415 | 415 | 20 | 40 | 0.9 | 1.2 × 10⁹ | 6 | 4 | 3 |
| Example 416 | CP-416 | 416 | 20 | 40 | 1.0 | 1.3 × 10⁹ | 6 | 4 | 3 |
| Example 417 | CP-417 | 417 | 20 | 40 | 1.1 | 1.3 × 10⁹ | 6 | 4 | 3 |
| Example 418 | CP-418 | 418 | 20 | 40 | 1.2 | 1.3 × 10⁹ | 5 | 4 | 3 |
| Example 419 | CP-419 | 419 | 13 | 30 | 1.0 | 2.7 × 10¹¹ | 6 | 4 | 3 |
| Example 420 | CP-420 | 420 | 13 | 30 | 1.0 | 5.8 × 10¹¹ | 6 | 4 | 3 |

TABLE 41

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Comparative Example 76 | CP-C76 | C76 | — | — | — | 2.3 × 10¹³ | 1 | 3 | 3 |
| Comparative Example 77 | CP-C77 | C77 | — | — | — | 4.4 × 10¹¹ | 1 | 4 | 3 |
| Comparative Example 78 | CP-C78 | C73 | — | — | — | 9.2 × 10⁸ | 1 | 4 | 2 |
| Comparative Example 79 | CP-C79 | C79 | 1 | 15 | 1.0 | 2.3 × 10¹³ | 2 | 3 | 3 |
| Comparative Example 80 | CP-C80 | C80 | 1 | 30 | 1.0 | 4.3 × 10¹¹ | 2 | 4 | 3 |
| Comparative Example 81 | CP-C81 | C81 | 1 | 45 | 1.2 | 2.8 × 10⁸ | 2 | 4 | 2 |
| Comparative Example 82 | CP-C82 | C82 | 30 | 15 | 1.0 | 1.9 × 10¹³ | 2 | 3 | 3 |
| Comparative Example 83 | CP-C83 | C83 | 30 | 30 | 1.0 | 2.6 × 10¹¹ | 2 | 4 | 3 |
| Comparative Example 84 | CP-C84 | C84 | 30 | 45 | 1.0 | 3.5 × 10⁸ | 2 | 4 | 2 |
| Comparative Example 85 | CP-C85 | C85 | — | — | — | 9.6 × 10¹² | 1 | 3 | 3 |
| Comparative Example 86 | CP-C86 | C86 | — | — | — | 5.0 × 10¹⁰ | 1 | 4 | 3 |
| Comparative Example 87 | CP-C87 | C87 | — | — | — | 1.5 × 10⁷ | 1 | 4 | 2 |
| Comparative Example 88 | CP-C88 | C83 | 2 | 10 | 1.0 | 6.5 × 10¹³ | 5 | 1 | 3 |
| Comparative Example 89 | CP-C89 | C89 | 5 | 10 | 1.0 | 6.4 × 10¹³ | 6 | 1 | 3 |
| Comparative Example 90 | CP-C90 | C90 | 13 | 10 | 1.0 | 6.1 × 10¹³ | 6 | 1 | 3 |
| Comparative Example 91 | CP-C91 | C91 | 20 | 10 | 1.0 | 6.0 × 10¹³ | 6 | 1 | 3 |
| Comparative Example 92 | CP-C92 | C92 | 25 | 10 | 1.0 | 5.8 × 10¹³ | 4 | 1 | 3 |
| Comparative Example 93 | CP-C93 | C93 | 2 | 50 | 1.0 | 4.8 × 10⁷ | 5 | 4 | 1 |
| Comparative Example 94 | CP-C94 | C94 | 5 | 50 | 1.0 | 4.1 × 10⁷ | 6 | 4 | 1 |
| Comparative Example 95 | CP-C95 | C95 | 13 | 50 | 1.0 | 2.9 × 10⁷ | 6 | 4 | 1 |
| Comparative Example 96 | CP-C96 | C96 | 20 | 50 | 1.0 | 2.2 × 10⁷ | 6 | 4 | 1 |
| Comparative Example 97 | CP-C97 | C97 | 25 | 50 | 1.0 | 1.9 × 10⁷ | 4 | 4 | 1 |

TABLE 42

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Comparative Example 98 | CP-C98 | C98 | — | — | — | 3.0 × 10¹¹ | 1 | 4 | 3 |
| Comparative Example 99 | CP-C99 | C99 | — | — | — | 3.0 × 10¹¹ | 1 | 4 | 3 |
| Comparative Example 100 | CP-C100 | C100 | — | — | — | 2.7 × 10¹¹ | 1 | 4 | 3 |
| Comparative Example 101 | CP-C101 | C101 | — | — | — | 3.4 × 10¹¹ | 1 | 4 | 3 |
| Comparative Example 102 | CP-C102 | C102 | — | — | — | 3.1 × 10¹¹ | 1 | 4 | 3 |
| Comparative Example 103 | CP-C103 | C103 | — | — | — | 3.4 × 10¹¹ | 1 | 4 | 3 |
| Comparative Example 109 | CP-C104 | C104 | — | — | — | 2.7 × 10¹¹ | 1 | 4 | 3 |
| Comparative Example 105 | CP-C105 | C105 | — | — | — | 3.4 × 10¹¹ | 1 | 4 | 3 |

TABLE 43

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Comparative Example 36 | CP-C36 | C36 | — | — | — | 8.0 × 10⁶ | 1 | 4 | 3 |
| Comparative Example 37 | CP-C37 | C37 | — | — | — | 1.0 × 10⁷ | 1 | 4 | 3 |
| Comparative Example 38 | CP-C38 | C38 | — | — | — | 4.4 × 10¹⁰ | 1 | 4 | 3 |
| Comparative Example 39 | CP-C39 | C39 | — | — | — | 2.0 × 10¹³ | 1 | 4 | 3 |
| Comparative Example 40 | CP-C40 | C40 | — | — | — | 2.1 × 10⁹ | 1 | 4 | 3 |
| Comparative Example 41 | CP-C41 | C41 | — | — | — | 3.1 × 10⁹ | 1 | 4 | 3 |
| Comparative Example 72 | CP-C72 | C72 | — | — | — | 3.5 × 10¹⁰ | 1 | 4 | 3 |
| Comparative Example 73 | CP-C73 | C73 | — | — | — | 2.0 × 10¹³ | 1 | 4 | 3 |
| Comparative Example 74 | CP-C74 | C74 | — | — | — | 4.0 × 10⁹ | 1 | 4 | 3 |
| Comparative Example 75 | CP-C75 | C75 | — | — | — | 5.8 × 10⁹ | 1 | 4 | 3 |
| Comparative Example 106 | CP-C106 | C106 | — | — | — | 3.5 × 10¹⁰ | 1 | 4 | 3 |

TABLE 59

| | | | | | | Volume | | | |
|---|---|---|---|---|---|---|---|---|---|
| | | | | | | resistivity of | | | |
| | | Production example of | | | | conductive | Result of evaluation | | |
| | Conductive-layer | electrophotographic | {(V₂/V_{T})/(V₁/ | {(V₁/V_{T})/(V₂/ | | layer | Pattern | Residual | |
| | coating solution | photosensitive member | V_{T})} × 100 | V_{T})} × 100 | R₂/R₁ | [Ω · cm] | memory | potential | Crack |
| Example 421 | CP-421 | 421 | 2 | 15 | 0.9 | 2.2 × 10¹³ | 4 | 3 | 3 |
| Example 422 | CP-422 | 422 | 2 | 15 | 0.9 | 2.2 × 10¹³ | 5 | 3 | 3 |
| Example 423 | CP-423 | 423 | 2 | 15 | 1.0 | 2.2 × 10¹³ | 5 | 3 | 3 |
| Example 429 | CP-424 | 424 | 2 | 15 | 1.1 | 2.2 × 10¹³ | 5 | 3 | 3 |
| Example 425 | CP-425 | 425 | 2 | 15 | 1.2 | 2.2 × 10¹³ | 4 | 3 | 3 |
| Example 426 | CP-426 | 426 | 5 | 15 | 1.0 | 2.1 × 10¹³ | 6 | 3 | 3 |
| Example 427 | CP-427 | 427 | 13 | 15 | 0.8 | 2.0 × 10¹³ | 5 | 3 | 3 |
| Example 428 | CP-428 | 423 | 13 | 15 | 0.9 | 2.0 × 10¹³ | 6 | 3 | 3 |
| Example 429 | CP-429 | 429 | 13 | 15 | 1.0 | 2.0 × 10¹³ | 6 | 3 | 3 |
| Example 430 | CP-430 | 430 | 13 | 15 | 1.1 | 2.0 × 10¹³ | 6 | 3 | 3 |
| Example 431 | CP-431 | 431 | 13 | 15 | 1.2 | 2.0 × 10¹³ | 5 | 3 | 3 |
| Example 432 | CP-432 | 432 | 20 | 15 | 1.0 | 1.9 × 10¹³ | 6 | 3 | 3 |
| Example 433 | CP-433 | 433 | 25 | 15 | 0.8 | 1.8 × 10¹³ | 3 | 3 | 3 |
| Example 434 | CP-434 | 434 | 25 | 15 | 0.9 | 1.8 × 10¹³ | 4 | 3 | 3 |
| Example 435 | CP-435 | 435 | 25 | 15 | 1.0 | 1.8 × 10¹³ | 4 | 3 | 3 |
| Example 436 | CP-436 | 436 | 25 | 15 | 1.1 | 1.8 × 10¹³ | 4 | 3 | 3 |
| Example 437 | CP-437 | 437 | 25 | 15 | 1.2 | 1.8 × 10¹³ | 3 | 3 | 3 |
| Example 438 | CP-438 | 438 | 2 | 20 | 1.0 | 6.6 × 10¹² | 5 | 4 | 3 |
| Example 439 | CP-439 | 439 | 5 | 20 | 0.8 | 6.3 × 10¹² | 5 | 4 | 3 |
| Example 440 | CP-440 | 440 | 5 | 20 | 0.9 | 6.3 × 10¹² | 6 | 4 | 3 |
| Example 441 | CP-441 | 441 | 5 | 20 | 1.0 | 6.3 × 10¹² | 6 | 4 | 3 |
| Example 442 | CP-442 | 442 | 5 | 20 | 1.1 | 6.3 × 10¹² | 6 | 4 | 3 |
| Example 443 | CP-443 | 443 | 5 | 20 | 1.2 | 6.3 × 10¹² | 5 | 4 | 3 |
| Example 444 | CP-444 | 444 | 13 | 20 | 0.8 | 5.7 × 10¹² | 5 | 4 | 3 |
| Example 445 | CP-445 | 445 | 13 | 20 | 0.9 | 5.7 × 10¹² | 6 | 4 | 3 |
| Example 446 | CP-446 | 446 | 13 | 20 | 1.0 | 5.7 × 10¹² | 6 | 4 | 3 |
| Example 447 | CP-447 | 447 | 13 | 20 | 1.1 | 5.7 × 10¹² | 6 | 4 | 3 |
| Example 448 | CP-448 | 448 | 13 | 20 | 1.2 | 5.7 × 10¹² | 5 | 4 | 3 |
| Example 449 | CP-449 | 449 | 20 | 20 | 0.8 | 5.3 × 10¹² | 5 | 4 | 3 |
| Example 450 | CP-450 | 450 | 20 | 20 | 0.9 | 5.3 × 10¹² | 6 | 4 | 3 |
| Example 451 | CP-451 | 451 | 20 | 20 | 1.0 | 5.3 × 10¹² | 6 | 4 | 3 |
| Example 452 | CP-452 | 452 | 20 | 20 | 1.1 | 5.3 × 10¹² | 6 | 4 | 3 |
| Example 453 | CP-453 | 453 | 20 | 20 | 1.2 | 5.3 × 10¹² | 5 | 4 | 3 |
| Example 454 | CP-454 | 454 | 25 | 20 | 1.0 | 5.0 × 10¹² | 4 | 4 | 3 |
| Example 455 | CP-455 | 455 | 2 | 30 | 0.8 | 3.6 × 10¹¹ | 4 | 4 | 3 |
| Example 456 | CP-456 | 456 | 2 | 30 | 0.9 | 3.6 × 10¹¹ | 5 | 4 | 3 |
| Example 457 | CP-457 | 457 | 2 | 30 | 1.0 | 3.6 × 10¹¹ | 5 | 4 | 3 |
| Example 458 | CP-458 | 458 | 2 | 30 | 1.1 | 3.6 × 10¹¹ | 5 | 4 | 3 |
| Example 459 | CP-459 | 459 | 2 | 30 | 1.2 | 3.6 × 10¹¹ | 4 | 4 | 3 |
| Example 460 | CP-460 | 460 | 5 | 30 | 0.6 | 3.4 × 10¹¹ | 5 | 4 | 3 |

TABLE 60

| | | Production | | | | Volume | | | |
|---|---|---|---|---|---|---|---|---|---|
| | Conductive | example of | | | | resistivity of | | | |
| | layer- | electrophotographic | { (V₂/V_{T})/ | { (V₂/V_{T}) + | | conductive | Result of evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 461 | CP-461 | 461 | 5 | 30 | 0.9 | 3.4 × 10¹¹ | 6 | 4 | 3 |
| Example 962 | CP-462 | 462 | 5 | 30 | 1.0 | 3.4 × 10¹¹ | 6 | 4 | 3 |
| Example 463 | CP-463 | 463 | 5 | 30 | 1.1 | 3.4 × 10¹¹ | 6 | 4 | 3 |
| Example 969 | CP-464 | 464 | 5 | 30 | 1.2 | 3.4 × 10¹¹ | 5 | 4 | 3 |
| Example 965 | CP-465 | 465 | 13 | 30 | 0.8 | 2.8 × 10¹¹ | 5 | 4 | 3 |
| Example 466 | CP-466 | 466 | 13 | 30 | 0.9 | 2.9 × 10¹¹ | 6 | 4 | 3 |
| Example 967 | CP-467 | 467 | 13 | 30 | 1.0 | 2.8 × 10¹¹ | 6 | 4 | 3 |
| Example 468 | CP-468 | 463 | 13 | 30 | 1.1 | 2.8 × 10¹¹ | 6 | 4 | 3 |
| Example 469 | CP-469 | 469 | 13 | 30 | 1.2 | 2.5 × 10¹¹ | 5 | 4 | 3 |
| Example 470 | CP-470 | 470 | 20 | 30 | 0.3 | 2.5 × 10¹¹ | 5 | 4 | 3 |
| Example 471 | CP-471 | 471 | 20 | 30 | 0.9 | 2.5 × 10¹¹ | 6 | 4 | 3 |
| Example 472 | CP-472 | 472 | 20 | 30 | 1.0 | 2.5 × 10¹¹ | 6 | 4 | 3 |
| Example 473 | CP-473 | 473 | 20 | 30 | 1.1 | 2.5 × 10¹¹ | 6 | 4 | 3 |
| Example 474 | CP-474 | 474 | 20 | 30 | 1.2 | 2.5 × 10¹¹ | 5 | 4 | 3 |
| Example 475 | CP-475 | 475 | 25 | 30 | 0.3 | 2.3 × 10¹¹ | 3 | 4 | 3 |
| Example 476 | CP-476 | 476 | 25 | 30 | 0.9 | 2.3 × 10¹¹ | 4 | 4 | 3 |
| Example 477 | CP-477 | 477 | 25 | 30 | 1.0 | 2.3 × 10¹¹ | 4 | 4 | 3 |
| Example 478 | CP-478 | 478 | 25 | 30 | 1.1 | 2.3 × 10¹¹ | 4 | 4 | 3 |
| Example 479 | CP-479 | 479 | 25 | 30 | 1.2 | 2.3 × 10¹¹ | 3 | 4 | 3 |
| Example 480 | CP-480 | 480 | 2 | 40 | 1.0 | 7.6 × 10⁹ | 5 | 4 | 3 |
| Example 481 | CP-481 | 481 | 5 | 40 | 0.3 | 6.8 × 10⁹ | 5 | 4 | 3 |
| Example 482 | CP-482 | 482 | 5 | 40 | 0.9 | 6.8 × 10⁹ | 6 | 4 | 3 |
| Example 483 | CP-483 | 483 | 5 | 40 | 1.0 | 6.8 × 10⁹ | 6 | 4 | 3 |
| Example 989 | CP-484 | 484 | 5 | 40 | 1.1 | 6.8 × 10⁹ | 6 | 4 | 3 |
| Example 985 | CP-485 | 485 | 5 | 40 | 1.2 | 6.8 × 10⁹ | 5 | 4 | 3 |
| Example 486 | CP-486 | 486 | 13 | 40 | 0.3 | 5.2 × 10⁹ | 5 | 4 | 3 |
| Example 987 | CP-487 | 487 | 13 | 40 | 0.9 | 5.2 × 10⁹ | 6 | 4 | 3 |
| Example 488 | CP-498 | 488 | 13 | 40 | 1.0 | 5.2 × 10⁹ | 6 | 4 | 3 |
| Example 989 | CP-489 | 989 | 13 | 90 | 1.1 | 5.2 × 10⁹ | 6 | 4 | 3 |
| Example 990 | CP-490 | 490 | 13 | 40 | 1.2 | 5.2 × 10⁹ | 5 | 4 | 3 |
| Example 991 | CP-491 | 491 | 20 | 40 | 0.8 | 4.2 × 10⁹ | 5 | 4 | 3 |
| Example 492 | CP-492 | 492 | 20 | 40 | 0.9 | 4.2 × 10⁹ | 6 | 4 | 3 |
| Example 993 | CP-493 | 493 | 20 | 40 | 1.0 | 4.2 × 10⁹ | 6 | 4 | 3 |
| Example 494 | CP-494 | 499 | 20 | 40 | 1.1 | 4.2 × 10⁹ | 6 | 4 | 3 |
| Example 495 | CP-495 | 495 | 20 | 40 | 1.2 | 4.2 × 10⁹ | 5 | 4 | 3 |
| Example 996 | CP-496 | 496 | 25 | 40 | 1.0 | 3.7 × 10⁹ | 4 | 4 | 3 |
| Example 497 | CP-497 | 497 | 2 | 45 | 0.8 | 6.5 × 10⁸ | 4 | 4 | 2 |
| Example 998 | CP-498 | 498 | 2 | 45 | 0.9 | 6.5 × 10⁸ | 5 | 4 | 2 |
| Example 999 | CP-499 | 499 | 2 | 45 | 1.0 | 6.5 × 10⁸ | 5 | 4 | 2 |
| Example 500 | CP-500 | 500 | 2 | 45 | 1.1 | 6.5 × 10⁸ | 5 | 4 | 2 |

TABLE 61

| | | Production | | | | Volume | | | |
|---|---|---|---|---|---|---|---|---|---|
| | Conductive | example of | | | | resistivity of | | | |
| | layer- | electrophotographic | { (V₂/V_{T})/ | { (V₂/V_{T}) + | | conductive | Result of evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 501 | CP-501 | 501 | 2 | 45 | 1.2 | 6.5 × 10⁸ | 4 | 4 | 2 |
| Example 502 | CP-502 | 502 | 5 | 45 | 1.0 | 5.7 × 10⁸ | 6 | 4 | 2 |
| Example 503 | CP-503 | 503 | 13 | 45 | 0.8 | 4.1 × 10⁸ | 5 | 4 | 2 |
| Example 504 | CP-504 | 504 | 13 | 45 | 0.9 | 4.1 × 10⁸ | 6 | 4 | 2 |
| Example 505 | CP-505 | 505 | 13 | 45 | 1.0 | 4.1 × 10⁸ | 6 | 4 | 2 |
| Example 506 | CP-506 | 506 | 13 | 45 | 1.1 | 4.1 × 10⁸ | 6 | 4 | 2 |
| Example 507 | CP-507 | 507 | 13 | 45 | 1.2 | 4.1 × 10⁸ | 5 | 4 | 2 |
| Example 508 | CP-508 | 508 | 20 | 45 | 1.0 | 3.2 × 10⁸ | 6 | 4 | 2 |
| Example 509 | CP-509 | 509 | 25 | 45 | 0.8 | 2.7 × 10⁸ | 3 | 4 | 2 |
| Example 510 | CP-510 | 510 | 25 | 45 | 0.9 | 2.7 × 10⁸ | 4 | 4 | 2 |
| Example 511 | CP-511 | 511 | 25 | 45 | 1.0 | 2.7 × 10⁸ | 4 | 4 | 2 |
| Example 512 | CP-512 | 512 | 25 | 45 | 1.1 | 2.7 × 10⁸ | 4 | 4 | 2 |
| Example 513 | CP-513 | 513 | 25 | 45 | 1.2 | 2.7 × 10⁸ | 3 | 4 | 2 |
| Example 514 | Cl-514 | 514 | 5 | 20 | 0.8 | 4.8 × 10¹² | 5 | 4 | 3 |
| Example 515 | CP-515 | 515 | 5 | 20 | 0.9 | 4.8 × 10¹² | 6 | 4 | 3 |
| Example 516 | CP-516 | 516 | 5 | 20 | 1.0 | 4.2 × 10¹² | 6 | 4 | 3 |
| Example 517 | CP-517 | 517 | 5 | 20 | 1.1 | 4.8 × 10¹² | 6 | 4 | 3 |
| Example 518 | CP-518 | 518 | 5 | 20 | 1.2 | 4.8 × 10¹² | 5 | 4 | 3 |
| Example 519 | CP-519 | 519 | 13 | 20 | 0.8 | 4.3 × 10¹² | 5 | 4 | 3 |
| Example 520 | CP-520 | 520 | 13 | 20 | 0.9 | 4.3 × 10¹² | 6 | 4 | 3 |
| Example 521 | CP-521 | 521 | 13 | 20 | 1.0 | 4.3 × 10¹² | 6 | 4 | 3 |
| Example 522 | CP-522 | 522 | 13 | 20 | 1.1 | 4.3 × 10¹² | 6 | 4 | 3 |
| Example 523 | CP-523 | 523 | 13 | 20 | 1.2 | 4.3 × 10¹² | 5 | 4 | 3 |
| Example 524 | CP-524 | 524 | 20 | 20 | 0.8 | 3.9 × 10¹² | 5 | 4 | 3 |
| Example 525 | CP-525 | 525 | 20 | 20 | 0.9 | 3.9 × 10¹² | 6 | 4 | 3 |
| Example 526 | CP-526 | 526 | 20 | 20 | 1.0 | 3.9 × 10¹² | 6 | 4 | 3 |
| Example 527 | CP-527 | 527 | 20 | 20 | 1.1 | 3.9 × 10¹² | 6 | 4 | 3 |
| Example 528 | CP-528 | 528 | 20 | 20 | 1.2 | 3.9 × 10¹² | 5 | 4 | 3 |
| Example 529 | CP-529 | 529 | 5 | 30 | 0.8 | 1.7 × 10¹¹ | 5 | 4 | 3 |
| Example 530 | CP-530 | 530 | 5 | 30 | 0.9 | 1.7 × 10¹¹ | 6 | 4 | 3 |
| Example 531 | CP-531 | 531 | 5 | 30 | 1.0 | 1.7 × 10¹¹ | 6 | 4 | 3 |
| Example 532 | CP-532 | 532 | 5 | 30 | 1.1 | 1.7 × 10¹¹ | 6 | 4 | 3 |
| Example 533 | CP-533 | 533 | 5 | 30 | 1.2 | 1.7 × 10¹¹ | 5 | 4 | 3 |
| Example 539 | CP-534 | 534 | 13 | 30 | 0.8 | 1.4 × 10¹¹ | 5 | 4 | 3 |
| Example 535 | CP-535 | 535 | 13 | 30 | 0.9 | 1.4 × 10¹¹ | 6 | 4 | 3 |
| Example 536 | CP-536 | 536 | 13 | 30 | 1.0 | 1.4 × 10¹¹ | 6 | 4 | 3 |
| Example 537 | CP-537 | 537 | 13 | 30 | 1.1 | 1.4 × 10¹¹ | 6 | 4 | 3 |
| Example 538 | CP-538 | 538 | 13 | 30 | 1.2 | 1.4 × 10¹¹ | 5 | 4 | 3 |
| Example 539 | CP-539 | 539 | 20 | 30 | 0.8 | 1.2 × 10¹¹ | 5 | 4 | 3 |
| Example 540 | CP-540 | 540 | 20 | 30 | 0.9 | 1.2 × 10¹¹ | 6 | 4 | 3 |

TABLE 62

| | | Production | | | | Volume | | | |
|---|---|---|---|---|---|---|---|---|---|
| | Conductive | example of | | | | resistivity of | | | |
| | layer- | electrophotographic | { (V₂/V_{T})/ | { (V₂/V_{T}) + | | conductive | Result of evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 541 | CP-541 | 541 | 20 | 30 | 1.0 | 1.2 × 10¹¹ | 6 | 4 | 3 |
| Example 542 | CP-542 | 542 | 20 | 30 | 1.1 | 1.2 × 10¹¹ | 6 | 4 | 3 |
| Example 543 | CP-543 | 543 | 20 | 30 | 1.2 | 1.2 × 10¹¹ | 5 | 4 | 3 |
| Example 544 | CP-544 | 544 | 5 | 40 | 0.8 | 1.6 × 10⁹ | 5 | 4 | 3 |
| Example 545 | CP-545 | 545 | 5 | 40 | 0.9 | 1.6 × 10⁹ | 6 | 4 | 3 |
| Example 546 | CP-546 | 546 | 5 | 40 | 1.0 | 1.6 × 10⁹ | 6 | 4 | 3 |
| Example 547 | CP-547 | 547 | 5 | 40 | 1.1 | 1.6 × 10⁹ | 6 | 4 | 3 |
| Example 548 | CP-548 | 548 | 5 | 40 | 1.2 | 1.6 × 10⁹ | 5 | 4 | 3 |
| Example 549 | CP-549 | 549 | 13 | 40 | 0.8 | 1.1 × 10⁹ | 5 | 4 | 3 |
| Example 550 | CP-550 | 550 | 13 | 40 | 0.9 | 1.1 × 10⁹ | 6 | 4 | 3 |
| Example 551 | CP-551 | 551 | 13 | 40 | 1.0 | 1.1 × 10⁹ | 6 | 4 | 3 |
| Example 552 | CP-552 | 552 | 13 | 40 | 1.1 | 1.1 × 10⁹ | 6 | 4 | 3 |
| Example 553 | CP-553 | 553 | 13 | 40 | 1.2 | 1.1 × 10⁹ | 5 | 4 | 3 |
| Example 554 | CP-554 | 554 | 20 | 40 | 0.8 | 8.7 × 10¹¹ | 5 | 4 | 3 |
| Example 555 | CP-555 | 555 | 20 | 40 | 0.9 | 8.7 × 10¹¹ | 6 | 4 | 3 |
| Example 556 | CP-556 | 556 | 20 | 40 | 1.0 | 8.7 × 10¹¹ | 6 | 4 | 3 |
| Example 557 | CP-557 | 557 | 20 | 40 | 1.1 | 8.7 × 10¹¹ | 6 | 4 | 3 |
| Example 558 | CP-550 | 558 | 20 | 40 | 1.2 | 8.7 × 10¹¹ | 5 | 4 | 3 |
| Example 559 | CP-559 | 559 | 13 | 30 | 1.0 | 1.4 × 10¹¹ | 6 | 4 | 3 |
| Example 560 | CP-560 | 560 | 11 | 30 | 1.0 | 4.8 × 10¹¹ | 6 | 4 | 3 |

TABLE 63

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Comparative Example 107 | CP-C107 | C107 | — | — | — | 2.2 × 10¹³ | 1 | 3 | 3 |
| Comparative Example 108 | CP-C108 | C108 | — | — | — | 3.8 × 10¹¹ | 1 | 4 | 3 |
| Comparative Example 109 | CP-C109 | C109 | — | — | — | 7.2 × 10⁸ | 1 | 4 | 2 |
| Comparative Example 110 | CP-C11C | C110 | 1 | 15 | 1.0 | 2.2 × 10¹¹ | 2 | 3 | 3 |
| Comparative Example 111 | CP-C111 | C111 | 1 | 30 | 1.0 | 3.7 × 10¹¹ | 2 | 4 | 3 |
| Comparative Example 112 | CP-C112 | C112 | 1 | 45 | 1.0 | 6.8 × 10⁸ | 2 | 4 | 2 |
| Comparative Example 113 | CP-C113 | C113 | 30 | 15 | 1.0 | 1.7 × 10¹¹ | 2 | 3 | 3 |
| Comparative Example 114 | CP-C114 | C114 | 30 | 30 | 1.0 | 2.1 × 10¹¹ | 2 | 4 | 3 |
| Comparative Example 115 | CP-C115 | C115 | 30 | 45 | 1.0 | 2.3 × 10⁸ | 2 | 4 | 2 |
| Comparative Example 116 | CP-C116 | C116 | — | — | — | 7.7 × 10¹² | 1 | 3 | 3 |
| Comparative Example 117 | CP-C117 | C117 | — | — | — | 2.9 × 10¹¹ | 1 | 4 | 3 |
| Comparative Example 118 | CP-C119 | C118 | — | — | — | 5.3 × 10⁶ | 1 | 4 | 2 |
| Comparative Example 119 | CP-C119 | C119 | 2 | 10 | 1.0 | 6.3 × 10¹³ | 5 | 1 | 3 |
| Comparative Example 120 | CP-C120 | C120 | 5 | 10 | 1.0 | 6.1 × 10¹³ | 6 | 1 | 3 |
| Comparative Example 121 | CP-C121 | C121 | 13 | 10 | 1.0 | 5.9 × 10¹¹ | 6 | 1 | 3 |
| Comparative Example 122 | CP-C122 | C122 | 20 | 10 | 1.0 | 5.7 × 10¹¹ | 6 | 1 | 3 |
| Comparative Example 123 | CP-C123 | C123 | 25 | 10 | 1.0 | 5.5 × 10¹³ | 4 | 1 | 3 |
| Comparative Example 124 | CP-C124 | C124 | 2 | 50 | 1.0 | 3.4 × 10⁷ | 5 | 4 | 1 |
| Comparative Example 125 | CP-C125 | C125 | 5 | 50 | 1.0 | 2.9 × 10⁷ | 6 | 4 | 1 |
| Comparative Example 126 | CP-C126 | C126 | 13 | 50 | 1.0 | 1.9 × 10⁷ | 6 | 4 | 1 |
| Comparative Example 127 | CP-C127 | C127 | 20 | 50 | 1.0 | 1.4 × 10⁷ | 6 | 4 | 1 |
| Comparative Example 128 | CP-C128 | C128 | 25 | 50 | 1.0 | 1.2 × 10⁷ | 4 | 4 | 1 |

TABLE 64

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 561 | CP-561 | 561 | 2 | 15 | 0.8 | 2.0 × 10¹³ | 4 | 3 | 3 |
| Example 562 | CP-562 | 562 | 2 | 15 | 0.9 | 2.0 × 10¹³ | 5 | 3 | 3 |
| Example 563 | CP-563 | 563 | 2 | 15 | 1.0 | 2.0 × 10¹³ | 5 | 3 | 3 |
| Example 569 | CP-564 | 564 | 2 | 15 | 1.1 | 2.0 × 10¹³ | 5 | 3 | 3 |
| Example 565 | CP-565 | 565 | 2 | 15 | 1.2 | 2.0 × 10¹³ | 4 | 3 | 3 |
| Example 566 | CP-566 | 566 | 5 | 15 | 1.0 | 2.0 × 10¹³ | 6 | 3 | 3 |
| Example 567 | CP-567 | 567 | 13 | 15 | 0.8 | 1.8 × 10¹³ | 5 | 3 | 3 |
| Example 568 | CP-568 | 568 | 13 | 15 | 0.9 | 1.8 × 10¹³ | 6 | 3 | 3 |
| Example 569 | CP-569 | 569 | 13 | 15 | 1.0 | 1.8 × 10¹³ | 6 | 3 | 3 |
| Example 570 | CP-570 | 570 | 13 | 15 | 1.1 | 1.8 × 10¹³ | 6 | 3 | 3 |
| Example 571 | CP-571 | 571 | 13 | 15 | 1.2 | 1.8 × 10¹³ | 5 | 3 | 3 |
| Example 572 | CP-572 | 572 | 20 | 15 | 1.0 | 1.7 × 10¹³ | 6 | 3 | 3 |
| Example 573 | CP-573 | 573 | 25 | 15 | 0.8 | 1.7 × 10¹³ | 3 | 3 | 3 |
| Example 574 | CP-574 | 574 | 25 | 15 | 0.9 | 1.7 × 10¹³ | 4 | 3 | 3 |
| Example 575 | CP-575 | 575 | 25 | 15 | 1.0 | 1.6 × 10¹³ | 4 | 3 | 3 |
| Example 576 | CP-576 | 576 | 25 | 15 | 1.1 | 1.6 × 10¹³ | 4 | 3 | 3 |
| Example 577 | CP-577 | 577 | 25 | 15 | 1.2 | 1.6 × 10¹³ | 3 | 3 | 3 |
| Example 578 | CP-578 | 578 | 2 | 20 | 1.0 | 6.0 × 10¹² | 5 | 4 | 3 |
| Example 579 | CP-579 | 579 | 5 | 20 | 0.8 | 5.8 × 10¹² | 5 | 4 | 3 |
| Example 580 | CP-580 | 580 | 5 | 20 | 0.9 | 5.8 × 10¹² | 6 | 4 | 3 |
| Example 581 | CP-581 | 581 | 5 | 20 | 1.0 | 5.8 × 10¹² | 6 | 4 | 3 |
| Example 582 | CP-582 | 582 | 5 | 20 | 1.1 | 5.8 × 10¹² | 6 | 4 | 3 |
| Example 583 | CP-583 | 583 | 5 | 20 | 1.2 | 5.7 × 10¹² | 5 | 4 | 3 |
| Example 589 | CP-584 | 584 | 13 | 20 | 0.8 | 5.2 × 10¹² | 5 | 4 | 3 |
| Example 585 | CP-585 | 585 | 13 | 20 | 0.9 | 5.2 × 10¹² | 6 | 4 | 3 |
| Example 586 | CP-586 | 586 | 13 | 20 | 1.0 | 5.1 × 10¹² | 6 | 4 | 3 |
| Example 587 | CP-587 | 587 | 13 | 20 | 1.1 | 5.1 × 10¹² | 6 | 4 | 3 |
| Example 588 | CP-580 | 588 | 13 | 20 | 1.2 | 5.1 × 10¹² | 5 | 4 | 3 |
| Example 589 | CP-589 | 589 | 20 | 20 | 0.8 | 4.7 × 10¹² | 5 | 4 | 3 |
| Example 590 | CP-590 | 590 | 20 | 20 | 0.9 | 4.7 × 10¹² | 6 | 4 | 3 |
| Example 591 | CP-591 | 591 | 20 | 20 | 1.0 | 4.7 × 10¹² | 6 | 4 | 3 |
| Example 592 | CP-592 | 592 | 20 | 20 | 1.1 | 4.7 × 10¹² | 6 | 4 | 3 |
| Example 593 | CP-593 | 593 | 20 | 20 | 1.2 | 4.6 × 10¹² | 5 | 4 | 3 |
| Example 594 | CP-594 | 594 | 25 | 20 | 1.0 | 4.4 × 10¹² | 4 | 4 | 3 |
| Example 595 | CP-595 | 595 | 2 | 30 | 0.8 | 3.1 × 10¹¹ | 4 | 4 | 3 |
| Example 596 | CP-596 | 596 | 2 | 30 | 0.9 | 3.1 × 10¹¹ | 5 | 4 | 3 |
| Example 597 | CP-597 | 597 | 2 | 30 | 1.0 | 3.1 × 10¹¹ | 5 | 4 | 3 |
| Example 598 | CP-598 | 598 | 2 | 30 | 1.1 | 3.1 × 10¹¹ | 5 | 4 | 3 |
| Example 599 | CP-599 | 599 | 2 | 30 | 1.2 | 3.1 × 10¹¹ | 4 | 4 | 3 |
| Example 600 | CP-600 | 600 | 5 | 30 | 0.6 | 2.9 × 10¹¹ | 5 | 4 | 3 |

TABLE 65

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 601 | CP-601 | 601 | 5 | 30 | 0.9 | 2.9 × 10¹¹ | 6 | 4 | 3 |
| Example 602 | CP-602 | 602 | 5 | 30 | 1.0 | 2.9 × 10¹¹ | 6 | 4 | 3 |
| Example 603 | CP-603 | 603 | 5 | 30 | 1.1 | 2.9 × 10¹¹ | 6 | 4 | 3 |
| Example 609 | CP-604 | 604 | 5 | 30 | 1.2 | 2.9 × 10¹¹ | 5 | 4 | 3 |
| Example 605 | CP-605 | 605 | 13 | 30 | 0.8 | 2.4 × 10¹¹ | 5 | 4 | 3 |
| Example 606 | CP-606 | 606 | 13 | 30 | 0.9 | 2.4 × 10¹¹ | 6 | 4 | 3 |
| Example 607 | CP-607 | 607 | 13 | 30 | 1.0 | 2.4 × 10¹¹ | 6 | 4 | 3 |
| Example 608 | CP-608 | 608 | 13 | 30 | 1.1 | 2.4 × 10¹¹ | 6 | 4 | 3 |
| Example 609 | CP-609 | 609 | 13 | 30 | 1.2 | 2.3 × 10¹¹ | 5 | 4 | 3 |
| Example 610 | CP-610 | 610 | 20 | 30 | 0.8 | 2.1 × 10¹¹ | 5 | 4 | 3 |
| Example 611 | CP-611 | 611 | 20 | 30 | 0.9 | 2.1 × 10¹¹ | 6 | 4 | 3 |
| Example 612 | CP-612 | 612 | 20 | 30 | 1.0 | 2.0 × 10¹¹ | 6 | 4 | 3 |
| Example 613 | CP-613 | 613 | 20 | 30 | 1.1 | 2.0 × 10¹¹ | 6 | 4 | 3 |
| Example 614 | CP-614 | 614 | 20 | 30 | 1.2 | 2.0 × 10¹¹ | 5 | 4 | 3 |
| Example 615 | CP-615 | 615 | 25 | 30 | 0.8 | 1.9 × 10¹¹ | 3 | 4 | 3 |
| Example 616 | CP-616 | 616 | 25 | 30 | 0.9 | 1.9 × 10¹¹ | 4 | 4 | 3 |
| Example 617 | CP-617 | 617 | 25 | 30 | 1.0 | 1.8 × 10¹¹ | 4 | 4 | 3 |
| Example 618 | CP-618 | 618 | 25 | 30 | 1.1 | 1.8 × 10¹¹ | 4 | 4 | 3 |
| Example 619 | CP-619 | 619 | 25 | 30 | 1.2 | 1.8 × 10¹¹ | 3 | 4 | 3 |
| Example 620 | CP-620 | 620 | 2 | 40 | 1.0 | 6.1 × 10⁹ | 5 | 4 | 3 |
| Example 621 | CP-621 | 621 | 5 | 40 | 0.8 | 5.4 × 10⁹ | 5 | 4 | 3 |
| Example 622 | CP-622 | 622 | 5 | 40 | 0.9 | 5.4 × 10⁹ | 6 | 4 | 3 |
| Example 623 | CP-623 | 623 | 5 | 40 | 1.0 | 5.3 × 10⁹ | 6 | 4 | 3 |
| Example 629 | CP-624 | 624 | 5 | 40 | 1.1 | 5.3 × 10⁹ | 6 | 4 | 3 |
| Example 625 | CP-625 | 625 | 5 | 40 | 1.2 | 5.3 × 10⁹ | 5 | 4 | 3 |
| Example 626 | CP-626 | 626 | 13 | 40 | 0.8 | 4.0 × 10⁹ | 5 | 4 | 3 |
| Example 627 | CP-627 | 627 | 13 | 40 | 0.9 | 4.0 × 10⁹ | 6 | 4 | 3 |
| Example 628 | CP-628 | 628 | 13 | 40 | 1.0 | 3.9 × 10⁹ | 6 | 4 | 3 |
| Example 629 | CP-629 | 629 | 13 | 40 | 1.1 | 3.9 × 10⁹ | 6 | 4 | 3 |
| Example 630 | CP-630 | 630 | 13 | 40 | 1.2 | 3.8 × 10⁹ | 5 | 4 | 3 |
| Example 631 | CP-631 | 631 | 20 | 40 | 0.8 | 3.2 × 10⁹ | 5 | 4 | 3 |
| Example 632 | CP-632 | 632 | 20 | 40 | 0.9 | 3.2 × 10⁹ | 6 | 4 | 3 |
| Example 633 | CP-633 | 633 | 20 | 40 | 1.0 | 3.1 × 10⁹ | 6 | 4 | 3 |
| Example 634 | CP-634 | 634 | 20 | 40 | 1.1 | 3.1 × 10⁹ | 6 | 4 | 3 |
| Example 635 | CP-635 | 635 | 20 | 40 | 1.2 | 3.0 × 10⁹ | 5 | 4 | 3 |
| Example 636 | CP-636 | 636 | 25 | 40 | 1.0 | 2.6 × 10⁹ | 4 | 4 | 3 |
| Example 637 | CP-637 | 637 | 2 | 45 | 0.8 | 5.0 × 10⁸ | 4 | 4 | 2 |
| Example 638 | CP-638 | 638 | 2 | 45 | 0.9 | 5.0 × 10⁸ | 5 | 4 | 2 |
| Example 639 | CP-639 | 639 | 2 | 45 | 1.0 | 5.0 × 10⁸ | 5 | 4 | 2 |
| Example 640 | CP-640 | 640 | 2 | 45 | 1.1 | 5.0 × 10⁸ | 5 | 4 | 2 |

TABLE 66

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 641 | CP-641 | 641 | 2 | 45 | 1.2 | 4.9 × 10⁸ | 4 | 4 | 2 |
| Example 642 | CP-642 | 642 | 5 | 45 | 1.0 | 4.2 × 10⁸ | 6 | 4 | 2 |
| Example 643 | CP-643 | 643 | 13 | 45 | 0.8 | 3.0 × 10⁸ | 5 | 4 | 2 |
| Example 644 | CP-644 | 644 | 13 | 45 | 0.9 | 2.9 × 10⁸ | 6 | 4 | 2 |
| Example 645 | CP-645 | 645 | 13 | 45 | 1.0 | 2.9 × 10⁸ | 6 | 4 | 2 |
| Example 646 | CP-646 | 646 | 13 | 45 | 1.1 | 2.9 × 10⁸ | 6 | 4 | 2 |
| Example 647 | CP-647 | 647 | 13 | 45 | 1.2 | 2.8 × 10⁸ | 5 | 4 | 2 |
| Example 648 | CP-648 | 648 | 20 | 45 | 1.0 | 2.1 × 10⁸ | 6 | 4 | 2 |
| Example 649 | CP-649 | 649 | 25 | 45 | 0.8 | 1.9 × 10⁸ | 3 | 4 | 2 |
| Example 650 | CP-650 | 650 | 25 | 45 | 0.9 | 1.9 × 10⁸ | 4 | 4 | 2 |
| Example 651 | CP-651 | 651 | 25 | 45 | 1.0 | 1.8 × 10⁸ | 4 | 4 | 2 |
| Example 652 | CP-652 | 652 | 25 | 45 | 1.1 | 1.8 × 10⁸ | 4 | 4 | 2 |
| Example 653 | CP-653 | 653 | 25 | 45 | 1.2 | 1.7 × 10⁸ | 3 | 4 | 2 |

TABLE 67

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 654 | CP-654 | 654 | 5 | 20 | 0.8 | 4.3 × 10¹² | 5 | 4 | 3 |
| Example 655 | CP-655 | 655 | 5 | 20 | 0.9 | 4.3 × 10¹² | 6 | 4 | 3 |
| Example 656 | CP-656 | 656 | 5 | 20 | 1.0 | 4.3 × 10¹² | 6 | 4 | 3 |
| Example 657 | CP-657 | 657 | 5 | 20 | 1.1 | 4.3 × 10¹² | 6 | 4 | 3 |
| Example 658 | CP-658 | 656 | 5 | 20 | 1.2 | 4.3 × 10¹¹ | 5 | 4 | 3 |
| Example 659 | CP-659 | 659 | 13 | 20 | 0.8 | 3.2 × 10¹² | 5 | 4 | 3 |
| Example 660 | CP-660 | 660 | 13 | 20 | 0.9 | 3.8 × 10¹² | 6 | 4 | 3 |
| Example 661 | CP-661 | 661 | 13 | 20 | 1.0 | 3.8 × 10¹² | 6 | 4 | 3 |
| Example 662 | CP-662 | 662 | 13 | 20 | 1.1 | 3.8 × 10¹² | 6 | 4 | 3 |
| Example 663 | CP-663 | 663 | 13 | 20 | 1.2 | 3.7 × 10¹² | 5 | 4 | 3 |
| Example 664 | CP-664 | 664 | 20 | 20 | 0.8 | 3.5 × 10¹² | 5 | 4 | 3 |
| Example 665 | CP-665 | 665 | 20 | 20 | 0.9 | 3.5 × 10¹² | 6 | 4 | 3 |
| Example 666 | CP-666 | 666 | 20 | 20 | 1.0 | 3.4 × 10¹² | 6 | 4 | 3 |
| Example 667 | CP-667 | 667 | 20 | 20 | 1.1 | 3.4 × 10¹² | 6 | 4 | 3 |
| Example 668 | CP-668 | 668 | 20 | 20 | 1.2 | 3.4 × 10¹² | 5 | 4 | 3 |
| Example 669 | CP-669 | 669 | 5 | 30 | 0.8 | 1.5 × 10¹¹ | 5 | 4 | 3 |
| Example 670 | CP-670 | 670 | 5 | 30 | 0.9 | 1.5 × 10¹¹ | 6 | 4 | 3 |
| Example 671 | CP-671 | 671 | 5 | 30 | 1.0 | 1.4 × 10¹¹ | 6 | 4 | 3 |
| Example 672 | CP-672 | 672 | 5 | 30 | 1.1 | 1.4 × 10¹¹ | 6 | 4 | 3 |
| Example 673 | CP-673 | 673 | 5 | 30 | 1.2 | 1.4 × 10¹¹ | 5 | 4 | 3 |
| Example 674 | CP-674 | 674 | 13 | 30 | 0.8 | 1.2 × 10¹¹ | 5 | 4 | 3 |
| Example 675 | CP-675 | 675 | 13 | 30 | 0.9 | 1.2 × 10¹¹ | 6 | 4 | 3 |
| Example 676 | CP-676 | 676 | 13 | 30 | 1.0 | 1.1 × 10¹¹ | 6 | 4 | 3 |
| Example 677 | CP-677 | 677 | 13 | 30 | 1.1 | 1.1 × 10¹¹ | 6 | 4 | 3 |
| Example 678 | CP-678 | 678 | 13 | 30 | 1.2 | 1.1 × 10¹¹ | 5 | 4 | 3 |
| Example 679 | CP-679 | 679 | 20 | 30 | 0.8 | 9.8 × 10¹⁰ | 5 | 4 | 3 |
| Example 680 | CP-680 | 680 | 20 | 30 | 0.9 | 9.8 × 10¹⁰ | 6 | 4 | 3 |
| Example 681 | CP-691 | 621 | 20 | 30 | 1.0 | 9.5 × 10¹⁰ | 6 | 4 | 3 |
| Example 682 | CP-692 | 682 | 20 | 30 | 1.1 | 9.5 × 10¹⁰ | 6 | 4 | 3 |
| Example 683 | CP-683 | 683 | 20 | 30 | 1.2 | 9.3 × 10¹⁰ | 5 | 4 | 3 |
| Example 689 | CP-684 | 684 | 5 | 40 | 0.8 | 1.2 × 10⁹ | 5 | 4 | 3 |
| Example 685 | CP-685 | 685 | 5 | 40 | 0.9 | 1.0 × 10⁹ | 6 | 4 | 3 |
| Example 686 | CP-686 | 686 | 5 | 40 | 1.0 | 1.2 × 10⁹ | 6 | 4 | 3 |
| Example 687 | CP-697 | 687 | 5 | 40 | 1.1 | 1.2 × 10⁹ | 6 | 4 | 3 |
| Example 688 | CP-688 | 688 | 5 | 40 | 1.2 | 1.0 × 10⁹ | 5 | 4 | 3 |
| Example 689 | CP-689 | 689 | 13 | 40 | 0.8 | 8.2 × 10⁸ | 5 | 4 | 3 |
| Example 690 | CP-690 | 690 | 13 | 40 | 0.9 | 8.2 × 10⁸ | 6 | 4 | 3 |

TABLE 68

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Example 691 | CP-691 | 691 | 13 | 40 | 1.0 | 8.0 ×10⁸ | 6 | 4 | 3 |
| Example 692 | CP-692 | 692 | 13 | 40 | 1.1 | 8.0 × 10⁸ | 6 | 4 | 3 |
| Example 693 | CP-693 | 693 | 13 | 40 | 1.2 | 7.7 × 10⁸ | 5 | 4 | 3 |
| Example 694 | CP-694 | 694 | 20 | 40 | 0.8 | 6.2 × 10⁸ | 5 | 4 | 3 |
| Example 695 | CP-695 | 695 | 20 | 40 | 0.9 | 6.2 × 10⁸ | 6 | 4 | 3 |
| Example 696 | CP-696 | 696 | 20 | 40 | 1.0 | 5.9 × 10⁸ | 6 | 4 | 3 |
| Example 697 | CP-697 | 697 | 20 | 40 | 1.1 | 5.9 × 10⁸ | 6 | 4 | 3 |
| Example 698 | CP-698 | 698 | 20 | 40 | 1.2 | 5.6 × 10⁸ | 5 | 4 | 3 |
| Example 699 | CP-699 | 699 | 13 | 30 | 1.0 | 1.1 × 10¹¹ | 6 | 4 | 3 |
| Example 700 | CP-700 | 700 | 13 | 30 | 1.0 | 4.7 ×10¹¹ | 6 | 4 | 3 |

TABLE 69

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Comparative Example 129 | CP-C129 | C129 | — | — | — | 2.1 × 10¹³ | 1 | 3 | 3 |
| Comparative Example 130 | CP-C130 | C130 | — | — | — | 3.3 × 10¹¹ | 1 | 4 | 3 |
| Comparative Example 131 | CP-C131 | C131 | — | — | — | 5.5 × 10⁸ | 1 | 4 | 2 |
| Comparative Example 132 | CP-C132 | C132 | 1 | 15 | 1.0 | 2.1 × 10¹³ | 2 | 3 | 3 |
| Comparative Example 133 | CP-C133 | C133 | 1 | 31 | 1.0 | 3.2 × 10¹¹ | 2 | 4 | 3 |
| Comparative Example 134 | CP-C134 | C134 | 1 | 47 | 1.0 | 5.2 × 10⁸ | 2 | 4 | 2 |
| Comparative Example 135 | CP-C135 | C135 | 30 | 15 | 1.0 | 1.6 × 10¹³ | 2 | 3 | 3 |
| Comparative Example 136 | CP-C136 | C136 | 30 | 31 | 1.0 | 1.7 × 10¹¹ | 2 | 4 | 3 |
| Comparative Example 137 | CP-C137 | C137 | 30 | 47 | 1.0 | 1.5 × 10⁸ | 2 | 4 | 2 |
| Comparative Example 138 | CP-C138 | C133 | — | — | — | 6.1 × 10¹² | 1 | 3 | 3 |
| Comparative Example 139 | CP-C139 | C139 | — | — | — | 1.7 × 10¹⁰ | 1 | 4 | 3 |
| Comparative Example 140 | CP-C140 | C140 | — | — | — | 1.9 × 10⁶ | 1 | 4 | 2 |
| Comparative Example 141 | CP-C141 | C141 | 2 | 10 | 1.0 | 6.0 × 10¹³ | 5 | 1 | 3 |
| Comparative Example 142 | CP-C142 | C142 | 5 | 10 | 1.0 | 5.9 × 10¹³ | 6 | 1 | 3 |
| Comparative Example 143 | CP-C143 | C143 | 13 | 10 | 1.0 | 5.6 × 10¹³ | 6 | 1 | 3 |
| Comparative Example 144 | CP-C144 | C144 | 20 | 10 | 1.0 | 5.4 × 10¹³ | 6 | 1 | 3 |
| Comparative Example 145 | CP-C145 | C145 | 25 | 10 | 1.0 | 5.2 × 10¹³ | 4 | 1 | 3 |
| Comparative Example 146 | CP-C146 | C146 | 2 | 52 | 1.0 | 2.4 × 10⁷ | 5 | 4 | 1 |
| Comparative Example 147 | CP-C147 | C147 | 5 | 52 | 1.0 | 2.0 × 10⁷ | 6 | 4 | 1 |
| Comparative Example 148 | CP-C148 | C143 | 13 | 52 | 1.0 | 1.3 × 10⁷ | 6 | 4 | 1 |
| Comparative Example 149 | CP-C149 | C149 | 20 | 52 | 1.0 | 8.8 × 10⁶ | 6 | 4 | 1 |
| Comparative Example 150 | CP-C150 | C150 | 25 | 52 | 1.0 | 7.0 × 10⁶ | 4 | 4 | 1 |

TABLE 70

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Comparative Example 151 | CP-C151 | C151 | — | — | — | 3.0 × 10¹¹ | 1 | 4 | 3 |
| Comparative Example 152 | CP-C152 | C152 | — | — | — | 2.6 × 10¹¹ | 1 | 4 | 3 |
| Comparative Example 153 | CP-C153 | C153 | — | — | — | 2.8 × 10¹¹ | 1 | 4 | 3 |
| Comparative Example 154 | CP-C154 | C154 | — | — | — | 2.7 × 10¹¹ | 1 | 4 | 3 |
| Comparative Example 155 | CP-C155 | C155 | — | — | — | 2.6 × 10¹¹ | 1 | 4 | 3 |
| Comparative Example 156 | CP-C156 | C156 | — | — | — | 2.3 × 10¹¹ | 1 | 4 | 3 |
| Comparative Example 157 | CP-C157 | C157 | — | — | — | 2.5 × 10¹¹ | 1 | 4 | 3 |
| Comparative Example 158 | CP-C158 | C153 | — | — | — | 2.4 × 10¹¹ | 1 | 4 | 3 |

TABLE 71

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Comparative Example 159 | CP-C159 | C159 | — | — | — | 3.0 × 10¹¹ | 1 | 4 | 3 |
| Comparative Example 160 | CP-C160 | C160 | — | — | — | 2.7 × 10¹¹ | 1 | 4 | 3 |
| Comparative Example 161 | CP-C161 | C161 | — | — | — | 3.2 × 10¹¹ | 1 | 4 | 3 |
| Comparative Example 162 | CP-C162 | C162 | — | — | — | 3.0 × 10¹¹ | 1 | 4 | 3 |
| Comparative Example 163 | CP-C163 | C163 | — | — | — | 2.9 × 10¹¹ | 1 | 4 | 3 |
| Comparative Example 164 | CP-C164 | C164 | — | — | — | 2.9 × 10¹¹ | 1 | 4 | 3 |
| Comparative Example 165 | CP-C165 | C165 | — | — | — | 2.9 × 10¹¹ | 1 | 4 | 3 |

TABLE 72

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Comparative Example 166 | CP-C166 | C166 | — | — | — | 3.0 × 10¹¹ | 1 | 4 | 3 |
| Comparative Example 167 | CP-C167 | C167 | — | — | — | 2.8 × 10¹¹ | 1 | 4 | 3 |
| Comparative Example 168 | CP-C168 | C168 | — | — | — | 3.0 × 10¹¹ | 1 | 4 | 3 |
| Comparative Example 169 | CP-C169 | C169 | — | — | — | 2.6 × 10¹¹ | 1 | 4 | 3 |
| Comparative Example 170 | CP-C170 | C170 | — | — | — | 3.3 × 10¹¹ | 1 | 4 | 3 |
| Comparative Example 171 | CP-C171 | C171 | — | — | — | 3.0 × 10¹¹ | 1 | 4 | 3 |

TABLE 73

| | | Production | | | | Volume | | | |
|---|---|---|---|---|---|---|---|---|---|
| | Conductive | example of | | | | resistivity of | Result of | | |
| | layer- | electrophotographic | { (V₂/V_{T})/ | { (V₂/V_{T}) + | | conductive | evaluation | | |
| | coating | photo-sensitive | V₁/V_{T}) } × | (V₂/V_{T}) } × | | layer | Pattern | Residual | |
| | solution | member | 100 | 100 | R₂/R₁ | [Ω·cm] | memory | potential | Crack |
| Comparative Example 172 | CP-C172 | C172 | — | — | — | 2.9 × 10¹¹ | 1 | 4 | 3 |
| Comparative Example 173 | CP-C173 | C173 | — | — | — | 2.9 × 10¹¹ | 1 | 4 | 3 |
| Comparative Example 174 | CP-C174 | C174 | — | — | — | 2.9 × 10¹¹ | 1 | 4 | 3 |
| Comparative Example 175 | CP-C175 | C175 | — | — | — | 3.0 × 10¹¹ | 1 | 4 | 3 |
| Comparative Example 176 | CP-C176 | C176 | — | — | — | 2.8 × 10¹¹ | 1 | 4 | 3 |
| Comparative Example 177 | CP-C177 | C177 | — | — | — | 3.0 × 10¹¹ | 1 | 4 | 3 |
| Comparative Example 178 | CP-C178 | C178 | — | — | — | 3.0 × 10¹¹ | 1 | 4 | 3 |
| Comparative Example 179 | CP-C179 | C179 | — | — | — | 1.9 × 10¹² | 1 | 4 | 3 |

TABLE 74

| | | Rank of pattern memory | | | | | |
|---|---|---|---|---|---|---|---|
| | | 6 | 5 | 4 | 3 | 2 | 1 |
| | Solid black image | Unobservable | Observable | Observable | Observable | Observable | Observable |
| | One-dot keima pattern | Unobservable | Unobservable | Observable | Observable | Observable | Observable |
| Half-tone | One-dot and one-space lateral line | Unobservable | Unobservable | Unobservable | Observable | Observable | Observable |
| image | Two-dot and three-space lateral line | Unobservable | Unobservable | Unobservable | Unobservable | Observable | Observable |
| | One-dot and two-space lateral line | Unobservable | Unobservable | Unobservable | Unobservable | Unobservable | Observable |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2012-189532, filed on Aug. 30, 2012, No. 2013-077617, filed on Apr. 3, 2013, and No. 2013-177141, filed on Aug. 28, 2013, which are hereby incorporated by reference herein in its entirety.

### REFERENCE SIGNS LIST

1 electrophotographic photosensitive member
2 axis
3 charging device (primary charging device)
4 exposure light (image exposure light)
5 developing device
6 transferring device (such as transfer roller)
7 cleaning device (such as cleaning blade)
8 fixing device
9 process cartridge
10 guiding device
11 pre-exposure light
P transfer material (such as paper)

1. An electrophotographic photosensitive member, comprising:
a support;
a conductive layer formed on the support; and
a photosensitive layer formed on the conductive layer,
wherein:
the conductive layer comprises:
a titanium oxide particle coated with tin oxide doped with phosphorus,
a tin oxide particle doped with phosphorus, and
a binding material; and
when a total volume of the conductive layer is represented by V_{T}, a total volume of the titanium oxide particle coated with tin oxide doped with phosphorus in the conductive layer is represented by V_{1P}, and a total volume of the tin oxide particle doped with phosphorus in the conductive layer is represented by V_{2P}, the V_{T}, the V_{1P}, and the V_{2P} satisfy the following expressions (1) and (2).
2≦{(V_{2P}/V_{T})/(V₁/V_{T})}×100≦25 (1)
15≦{(V_{1P}/V_{T})+(V₂/V_{T})}×100≦45 (2)

2. The electrophotographic photosensitive member according to claim 1, wherein the V_{T}, the V_{1P}, and the V_{2P} satisfy the following expression (3).
5≦{(V_{2P}/V_{T})/(V₁/V_{T})}×100≦20 (3)

3. The electrophotographic photosensitive member according to claim 1, wherein the V_{T}, the V_{1P}, and the V_{2P} satisfy the following expression (4).
20≦{(V₁/V_{T})+(V₂/V_{T})}×100≦40 (4)

4. The electrophotographic photosensitive member according to claim 1, wherein when an abundance ratio of phosphorus to tin oxide in the titanium oxide particle coated with tin oxide doped with phosphorus is represented by R_{1P} [atom %] and an abundance ratio of phosphorus to tin oxide in the tin oxide particle doped with phosphorus is represented by R_{2P} [atom %], the R_{1P} and the R_{2P} satisfy the following expression (5).
0.9≦R_{2P}/R_{1P}≦1.1 (5)

5. An electrophotographic photosensitive member, comprising:
a support;
a conductive layer formed on the support; and
a photosensitive layer formed on the conductive layer,
wherein:
the conductive layer comprises:
a titanium oxide particle coated with tin oxide doped with tungsten,
a tin oxide particle doped with tungsten, and
a binding material; and
when a total volume of the conductive layer is represented by V_{T}, a total volume of the titanium oxide particle coated with tin oxide doped with tungsten in the conductive layer is represented by V_{1W}, and a total volume of the tin oxide particle doped with tungsten in the conductive layer is represented by V_{2W}, the V_{T}, the V_{1W}, and the V_{2W} satisfy the following expressions (6) and (7).
2≦{(V_{2W}/V_{T})/(V_{1W}/V_{T})}×100≦25 (6)
15≦{(V_{1W}/V_{T})+(V_{2W}/V_{T})}×100≦45 (7)

6. The electrophotographic photosensitive member according to claim 5, wherein the V_{T}, the V_{1W}, and the V_{2W} satisfy the following expression (8).
5≦{(V_{2W}/V_{T})/(V_{1W}/V_{T})}×100≦20 (8)

7. The electrophotographic photosensitive member according to claim 5, wherein the V_{T}, the V_{1W}, and the V_{2W} satisfy the following expression (9).
20≦{(V_{1W}/V_{T})+(V_{2W}/V_{T})}×100≦40 (9)

8. The electrophotographic photosensitive member according to claim 5, wherein when an abundance ratio of tungsten to tin oxide in the titanium oxide particle coated with tin oxide doped with tungsten is represented by R_{1W} [atom %] and an abundance ratio of tungsten to tin oxide in the tin oxide particle doped with tungsten is represented by R_{2W} [atom %], the R_{iw} and the R_{2W} satisfy the following expression (10).
0.9≦R_{2W}/R_{1W}≦1.1 (10)

9. An electrophotographic photosensitive member, comprising:
a support;
a conductive layer formed on the support; and
a photosensitive layer formed on the conductive layer,
wherein:
the conductive layer comprises:
a titanium oxide particle coated with tin oxide doped with fluorine,
a tin oxide particle doped with fluorine, and
a binding material; and
when a total volume of the conductive layer is represented by V_{T}, a total volume of the titanium oxide particle coated with tin oxide doped with fluorine in the conductive layer is represented by V_{1F}, and a total volume of the tin oxide particle doped with fluorine in the conductive layer is represented by V_{2F}, the V_{T}, the V_{1F}, and the V_{2F} satisfy the following expressions (11) and (12).
2≦{(V_{2F}/V_{T})/(V_{1F}/V_{T})}×100≦25 (11)
15≦{(V_{1F}/V_{T})+(V_{2F}/V_{T})}×100≦45 (12)

10. The electrophotographic photosensitive member according to claim 9, wherein the V_{T}, the V_{1F}, and the V_{2F} satisfy the following expression (13).
5≦{(V_{2F}/V_{T})/(V_{1F}/V_{T})}×100≦20 (13)

11. The electrophotographic photosensitive member according to claim 9, wherein the V_{T}, the V_{1F}, and the V_{2F} satisfy the following expression (14).
20≦{(V_{1F}/V_{T})+(V_{2F}/V_{T})}×100≦40 (14)

12. The electrophotographic photosensitive member according to claim 9, wherein when an abundance ratio of fluorine to tin oxide in the titanium oxide particle coated with tin oxide doped with fluorine is represented by R_{1F} [atom %] and an abundance ratio of fluorine to tin oxide in the tin oxide particle doped with fluorine is represented by R_{2F} [atom %], the R_{1F} and the R_{2F} satisfy the following expression (15).
0.9≦R_{2F}/R_{1F}≦1.1 (15)

13. An electrophotographic photosensitive member, comprising:
a support;
a conductive layer formed on the support; and
a photosensitive layer formed on the conductive layer,
wherein:
the conductive layer comprises:
a titanium oxide particle coated with tin oxide doped with niobium,
a tin oxide particle doped with niobium, and
a binding material; and
when a total volume of the conductive layer is represented by V_{T}, a total volume of the titanium oxide particle coated with tin oxide doped with niobium in the conductive layer is represented by V_{1Nb}, and a total volume of the tin oxide particle doped with niobium in the conductive layer is represented by V_{2Nb}, the V_{T}, the V_{1Nb}, and the V_{2Nb} satisfy the following expressions (16) and (17).
2≦{(V_{2Nb}/V_{T})/(V_{1Nb}/V_{T})}×100≦25 (16)
15≦{(V_{1Nb}/V_{T})+(V_{2Nb}/V_{T})}×100≦45 (17)

14. The electrophotographic photosensitive member according to claim 13, wherein the V_{T}, the V_{1Nb}, and the V_{2Nb} satisfy the following expression (18).
5≦{(V_{2Nb}/V_{T})/(V_{1Nb}/V_{T})}×100≦20 (18)

15. The electrophotographic photosensitive member according to claim 13, wherein the V_{T}, the V_{1Nb}, and the V_{2Nb} satisfy the following expression (19).
20≦{(V_{1Nb}/V_{T})+(V_{2Nb}/V_{T})}×100≦40 (19)

16. The electrophotographic photosensitive member according to claim 13, wherein when an abundance ratio of niobium to tin oxide in the titanium oxide particle coated with tin oxide doped with niobium is represented by R_{1Nb} [atom %] and an abundance ratio of niobium to tin oxide in the tin oxide particle doped with niobium is represented by R_{2Nb} [atom %], the R_{1Nb} and the R_{2Nb} satisfy the following expression (20).
0.9≦R_{2Nb}/R_{1Nb}≦1.1 (20)

17. An electrophotographic photosensitive member, comprising:
a support;
a conductive layer formed on the support; and
a photosensitive layer formed on the conductive layer,
wherein:
the conductive layer comprises:
a titanium oxide particle coated with tin oxide doped with tantalum,
a tin oxide particle doped with tantalum, and
a binding material; and
when a total volume of the conductive layer is represented by V_{T}, a total volume of the titanium oxide particle coated with tin oxide doped with tantalum in the conductive layer is represented by V_{1Ta}, and a total volume of the tin oxide particle doped with tantalum in the conductive layer is represented by V_{2Ta}, the V_{T}, the V_{1Ta}, and the V_{2Ta} satisfy the following expressions (21) and (22).
2≦{(V_{2Ta}/V_{T})/(V_{1Ta}/V_{T})}×100≦25 (21)
15≦{(V_{1Ta}/V_{T})+(V_{2Ta}/V_{T})}×100≦45 (22)

18. The electrophotographic photosensitive member according to claim 17, wherein the V_{T}, the V_{1TA}, and the V_{2Ta} satisfy the following expression (23).
5≦{(V_{2Ta}/V_{T})/(V_{1Ta}/V_{T})}×100≦20 (23)

19. The electrophotographic photosensitive member according to claim 17, wherein the V_{T}, the V_{1Ta}, and the V_{2Ta} satisfy the following expression (24).
20≦{(V_{1Ta}/V_{T})+(V_{2Ta}/V_{T})}×100≦40 (24)

20. The electrophotographic photosensitive member according to claim 17, wherein when an abundance ratio of tantalum to tin oxide in the titanium oxide particle coated with tin oxide doped with tantalum is represented by R_{1Ta} [atom %] and an abundance ratio of tantalum to tin oxide in the tin oxide particle doped with tantalum is represented by R_{2Ta} [atom %], the R_{1Ta} and the R_{2Ta} satisfy the following expression (25).
0.9≦R_{2Ta}/R_{1Ta}≦1.1 (25)

21. A process cartridge detachably mountable to a main body of an electrophotographic apparatus, wherein the process cartridge integrally supports:
the electrophotographic photosensitive member according to claim 1; and
at least one device selected from the group consisting of a charging device, a developing device, a transferring device, and a cleaning device.

22. An electrophotographic apparatus, comprising:
the electrophotographic photosensitive member according to claim 1;
a charging device;
an exposing device;
a developing device; and
a transferring device.
